(19) United States
(12) Patent Application Publication
(10) Pub. No.: US 2015/0006265 A1
(43) Pub. Date: Jan. 1, 2015

(54) Systems and Methods of Loyalitization for Incentivizing, Facilitating and Reporting Urgent Needs Fulfillment

(71) Applicant: HELP!BOOK INC., Walnut Creek, CA (US)

(72) Inventors: Keith T. White, Danville, CA (US); Michael A. Keefe, Danville, CA (US)

(21) Appl. No.: 14/329,931

(22) Filed: Jul. 12, 2014

Related U.S. Application Data
(63) Continuation-in-part of application No. 14/217,014, filed on Mar. 17, 2014.
Application No. 14/217,014 is a continuation-in-part of application No. 13/910,812, filed on Jun. 5, 2013.
Application No. 13/910,812 is a continuation-in-part of application No. 13/910,825, filed on Jun. 5, 2013.
Application No. 13/910,825 is a continuation of application No. 13/910,831, filed on Jun. 5, 2013.
(60) Provisional application No. 61/657,013, filed on Jun. 7, 2012.
(60) Provisional application No. 61/657,015, filed on Jun. 7, 2012.
(60) Provisional application No. 61/657,018, filed on Jun. 7, 2012.

(51) Int. Cl. G06Q 30/02; G06Q 50/22

(52) U.S. Cl. CPC G06Q 30/0229; G06Q 50/22
USPC 705/14.3

(57) ABSTRACT

A computerized fulfillment system incentivizes loyaltization between providers and seekers by enrolling providers in an agnostic morphable voucher program for the recruiting of seekers. The agnostic morphable voucher program has a variable plurality of morphable fungible virtualized voucher options; and the plurality of providers includes at least two categories of providers. The voucher options are configured to be morphed by a recruited seeker of the plurality of seekers; the recruited seeker morphing one of the voucher options into a potentially redeemable voucher redeemed for an urgent goods or service by one of a plurality of providers. The plurality of morphable fungible virtualized voucher options are distributed to the plurality of seekers.

### CROSS REFERENCE TO RELATED APPLICATIONS

This Continuation-in-Part application claims priority to non-provisional application Ser. No. 14/217,014, filed on Mar. 17, 2014, entitled “Systems and Methods for Micro-Casting in Urgent Needs Fulfillment Matching” which also claims the benefit of the below six listed application, which all applications are incorporated herein in their entirety by this reference.

This Continuation-in-Part application claims priority to non-provisional application Ser. No. 13/910,812, filed on Jun. 5, 2013, which claims the benefit of provisional application No. 61/657,013 filed on Jun. 7, 2012, both entitled “Systems and Methods for Screening and Proffering Providers of an Urgent Goods or Service”, which applications are incorporated herein in their entirety by this reference.

This Continuation-in-Part application also claims priority to non-provisional application Ser. No. 13/910,825, filed on Jun. 5, 2013, which claims the benefit of provisional application No. 61/657,015 filed on Jun. 7, 2012, both entitled “Systems and Methods for Matching a Seeker with a Proffered Provider of an Urgent Goods or Service”, which applications are incorporated herein in their entirety by this reference.

Additionally, this Continuation-in-Part application claims priority to non-provisional application Ser. No. 13/910,831, filed on Jun. 5, 2013, which claims the benefit of provisional application No. 61/657,018 filed on Jun. 7, 2012, both entitled “Systems and Methods for Facilitating Transactions Between a Seeker and a Proffered Provider of an Urgent Goods or Service”, which applications are incorporated herein in their entirety by this reference.

### BACKGROUND

The present invention relates to systems and methods to incentivize and facilitate “Seekers” who desire urgently required goods and/or services (“URGS”) to transact initial and repeat business with matching “Providers” who can fulfill those URGS need(s); and further to incentivize and facilitate such “matched Providers” to make their availability for such URGS fulfillment known to such Seekers and to incentivize such Seekers to do business; and furthermore to incentivize and facilitate such Seekers and matched Providers to report transacting such business together.

Increasingly social networking services, mobile computing devices, and digitized media exchanges have resulted in adding more and more barriers and distance between people rather than bringing them closer and in more direct contact. This applies to providers and seekers of urgently required goods and services (“URGS”) as much as it does to the broader society.

Networked computerized systems have had the effect of making it much easier for seekers to locate the providers of services, but much harder to actually effectively communicate with those providers. Even after hunting down a ‘contact us’ link on a web site, it is often hard to find either an address or a phone number, and phoning often just ensnarls one in an endlessly voluble automated phone service menu tree. The net effect of such technology may be to attract new clients only to drive them away.

Many URGS providers are exceptionally skilled at providing their specialty services, but not nearly as skilled at attracting and retaining clients. Seekers who may be driven by the logistics and expediency of urgency also may be harder to retain as repeat clients. Many of the networking services available to providers are devised to create loyalty to the system rather than loyalty to the provider and are at best ill-focused and counterproductive.

Computerized systems and networking technologies have hugely increased the ability of individuals and small businesses to distribute information, but have also created so much traffic that it is hard to ‘cut through the noise’. In many instances, hugely powerful mechanisms for disseminating information are not effectively matched by corresponding means to determine, track and exploit the results of such dissemination.

URGS providers desire to attract and retain new clients utilizing streamlined and appropriately filtered communication, which increases and improves effective communication with clients without frustrating, alienating or under-serving them but instead favorably impressing, incentivizing, and loyaltizing them as a direct part of the fulfillment experience. URGS seekers desire a convenient and reliable means to locate, communicate with and obtain URGS and other goods and/or services from a provider that is reasonably available and reachable.

It is therefore apparent that an urgent need exists for systems and methods that recruit and loyaltize URGS seekers and other potential clients to URGS providers. Concomitantly, an urgent need exists for systems and methods that enable URGS seekers to locate, communicate with and obtain URGS and other goods and/or services from a provider that is not only reasonably available, but also provides effective incentivization. This improved systemic incentivized loyaltization coupled with a micro-casting distributed URGS fulfillment system (“SILCM”) enables loyaltization binding of URGS providers—utilizing facilities to recruit, fulfill and retain new clients—with URGS seekers—utilizing facilities to locate and do business with providers that may serve both urgent and longer-term needs.

### SUMMARY

To achieve the foregoing and in accordance with the present invention, systems and methods for loyaltizing providers of urgent goods and services and the seekers of such urgent goods and services is provided. In particular the systems and methods for facilitating incentivization of pluralities of both providers and seekers. Additionally, such systems and methods may facilitate incentivize the loyaltization of third parties such as business directories and ratings agencies

In one embodiment, a computerized fulfillment system for incentivized loyaltization of providers and seekers of urgently required good(s) and/or service(s) is configured to facilitate one or more agnostic morphable voucher programs wherein providers and seekers utilize respective client devices running corresponding client application logic to participate in agnostic morphable voucher program(s).

The computerized fulfillment system incentivizes loyaltization between providers and seekers by enrolling providers in an agnostic morphable voucher program for the recruiting of seekers. The agnostic morphable voucher program has a variable plurality of morphable fungible virtualized voucher options; and the plurality of providers includes at least two categories of providers.

In this embodiment, the voucher options are configured to be morphed by a recruited seeker of the plurality of seekers; the recruited seeker morphing at least one of the voucher options into a potentially redeemable voucher redeemed for an urgent goods or service by one of a plurality of providers. The plurality of morphable fungible virtualized voucher options are distributed to the plurality of seekers by a variety of parties including providers, seekers and third-party issuers.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a System Level Block Diagram of one embodiment of an URGS Fulfillment System in accordance with the present invention;

FIG. 2 is an exemplary Top Level Logic Flow Diagram for the embodiment of FIG. 1;

FIG. 3 is a Logic Flow Diagram that further decomposes Step 230 of the Flow Diagram of FIG. 2;

FIG. 4 is a Logic Flow Diagram that further decomposes Step 340 of the Flow Diagram of FIG. 3;

FIG. 5 is a Logic Flow Diagram that further decomposes Step 240 of the Flow Diagram of FIG. 2;

FIGS. 6, 7 and 8 are exemplary screen images illustrating the Seeker experience in three different scenarios for the embodiment of FIG. 1;

FIG. 9 is an exemplary screen image illustrating the Seeker experience wherein the Seeker selects from a icon-based list of URGS for the embodiment of FIG. 1;

FIG. 10A is an exemplary screen image wherein the Seeker is proffered a set of proximate Providers as displayed as icons on a map for the embodiment of FIG. 1;

FIG. 10B is an exemplary screen image wherein the Seeker is proffered a set of proximate Providers as displayed as icons on a map and wherein one Provider is described by a pop-up sub-screen display for the embodiment of FIG. 1;

FIG. 11 is an exemplary screen image wherein the Seeker is offered two choices to contact the selected Provider—either phoning or texting—directly from the Seeker's terminal device for the embodiment of FIG. 1;

FIG. 12 is an exemplary screen image wherein a Provider is alerted of selection and likely contact by a new Seeker for the embodiment of FIG. 1;

FIG. 13A is an exemplary screen image wherein a map displays to a Provider the most recently determined Locales of Seekers who have selected that Provider for the embodiment of FIG. 1;

FIG. 13B is an exemplary screen image wherein a map displays to a Provider the most recently determined Locales of Seekers who have selected that Provider, wherein Seeker Locales have changed from FIG. 13A, for the embodiment of FIG. 1;

FIG. 14 is an exemplary screen image wherein the Seeker is proffered a set of proximate Providers as displayed as icons on a map for the embodiment of FIG. 1;

FIG. 15 is an exemplary screen image wherein the Seeker is offered two choices to contact the selected Provider—either phoning or texting—directly from the Seeker's terminal device for the embodiment of FIG. 1;

FIG. 16 is an exemplary screen image wherein a Provider is alerted of selection and likely contact by a new Seeker for the embodiment of FIG. 1;

FIG. 17A is an exemplary screen image wherein a map displays to a Provider the most recently determined Locale of a Seeker who has selected that Provider for the embodiment of FIG. 1;

FIG. 17B is an exemplary screen image wherein a map displays to a Provider the most recently determined Locale of a Seeker who has selected that Provider, wherein the Provider Locale has changed from FIG. 17A, for the embodiment of FIG. 1;

FIG. 18 is an exemplary screen image wherein the Seeker is proffered a set of proximate Providers as displayed as icons on a map, and wherein a location is displayed for a rendezvous, for the embodiment of FIG. 1;

FIG. 19 is an exemplary screen image wherein the Seeker is offered one choice to contact the selected Provider—by phoning—directly from the Seeker's terminal device for the embodiment of FIG. 1;

FIG. 20 is an exemplary screen image wherein a Provider is alerted of selection and likely contact by a new Seeker for the embodiment of FIG. 1;

FIG. 21 is an exemplary screen image wherein a map displays to a Provider the most recently determined Locale of a Seeker who has selected that Provider, and wherein the most recently determined Locale of the Provider is also displayed, for the embodiment of FIG. 1;

FIG. 22A is an exemplary screen image wherein the Seeker is proffered a set of proximate Providers as displayed as icons on a map for the embodiment of FIG. 1;

FIG. 22B is an exemplary screen image wherein the Seeker is proffered a set of proximate Providers as displayed as icons on a map, wherein the Provider Locales have changed from those in FIG. 22A, for the embodiment of FIG. 1;

FIG. 23A is an exemplary screen image wherein the Seeker is offered one choice to contact the selected Provider—by texting—directly from the Seeker's terminal device for the embodiment of FIG. 1;

FIG. 23B is an exemplary screen image wherein the Seeker is offered two choices to contact the selected Provider—either phoning or texting—directly from the Seeker's terminal device, wherein the Provider is different than the Provider in FIG. 23A, for the embodiment of FIG. 1;

FIG. 24 is an exemplary screen image wherein a Provider is alerted of selection and likely contact by a new Seeker for the embodiment of FIG. 1;

FIG. 25A is an exemplary screen image wherein a map displays to a Provider the most recently determined Locale of a Seeker who has selected that Provider, and wherein the most recently determined Locale of the Provider is also displayed, for the embodiment of FIG. 1;

FIG. 25B is an exemplary screen image wherein a map displays to a Provider the most recently determined Locale of a Seeker who has selected that Provider, and wherein the most recently determined Locale of the Provider is also displayed, and wherein the Locales of both the Seeker and the Provider have changed from FIG. 25A for the embodiment of FIG. 1;

FIG. 26 is an exemplary screen image wherein a map displays to a Seeker the most recently determined Locales of both the Seeker the Provider that the Seeker has selected for the embodiment of FIG. 1;

FIG. 27 is a System Level Block Diagram of one embodiment of an micro-casting distributed URGS fulfillment (MCDUF) system in accordance with the present invention;

FIG. 28 is an exemplary Top Level Logic Flow Diagram for the embodiment of FIG. 27;

FIG. 29 is a Logic Flow Diagram that further decomposes Step 2820 of the Flow Diagram of FIG. 28;

FIG. 30 is a Logic Flow Diagram that further decomposes Step 2840 of the Flow Diagram of FIG. 28;

FIGS. 31A and 31B are exemplary screen images illustrating the first use Seeker's experience for the embodiment of FIG. 27;

FIGS. 32, 33 and 34 are exemplary screen images illustrating the Seeker's navigational menus experience for the embodiment of FIG. 27;

FIG. 35 is an exemplary screen image illustrating the Seeker's Methods options experience for the embodiment of FIG. 27;

FIG. 36 is an exemplary screen image illustrating the Seeker's Provider Menu experience for the embodiment of FIG. 27;

FIGS. 37A and 37B are exemplary screen images illustrating the Seeker's Urgency Selection screen experience for the embodiment of FIG. 27;

FIG. 38 is an exemplary screen image illustrating the Seeker's Contact Information Screen experience for the embodiment of FIG. 27;

FIGS. 39A and 39B are exemplary screen images illustrating the Seeker's Locale Selection screen experience for the embodiment of FIG. 27;

FIGS. 40A, 40B, 40C and 40D are exemplary screen images illustrating the Seeker's Search Status screen experience for the embodiment of FIG. 27;

FIG. 41 is an exemplary screen image illustrating the user's Recommending a Provider screen experience for the embodiment of FIG. 27;

FIGS. 42A and 42B are exemplary screen images illustrating the Provider's Registration screen experience for the embodiment of FIG. 27;

FIG. 43 is an exemplary screen image illustrating the Provider's Introductory screen experience for the embodiment of FIG. 27;

FIGS. 44A and 44B are exemplary screen images illustrating the Provider's Profile screen experience for the embodiment of FIG. 27;

FIG. 45 is an exemplary screen image illustrating the Provider's Description screen experience for the embodiment of FIG. 27;

FIG. 46 is an exemplary screen image illustrating the Provider's Call and Message Routing screen experience for the embodiment of FIG. 27;

FIG. 47 is an exemplary screen image illustrating the Provider's Typical Week Schedule screen experience for the embodiment of FIG. 27;

FIGS. 48A and 48B are exemplary screen images illustrating the Provider's Typical Day Schedule screen experience for the embodiment of FIG. 27;

FIG. 49 is an exemplary screen image illustrating the Provider's Calendar Schedule screen experience for the embodiment of FIG. 27;

FIG. 50 is an exemplary screen image illustrating the Provider's Day Schedule screen experience for the embodiment of FIG. 27;

FIG. 51 is an exemplary screen image illustrating the Provider's Caller Map Introduction screen experience for the embodiment of FIG. 27;

FIG. 52 is an exemplary screen image illustrating the Provider's Account Preview screen experience for the embodiment of FIG. 27;

FIGS. 53A and 53B are exemplary screen images illustrating the Provider's Account Enable and Home screens experience for the embodiment of FIG. 27;

FIG. 54 is an exemplary screen image illustrating the Provider's Caller Map screen experience for the embodiment of FIG. 27;

FIG. 55 is an exemplary screen image illustrating the Provider's Account screen experience for the embodiment of FIG. 27;

FIG. 56 is an exemplary screen image illustrating the Provider's Settings Menu screen experience for the embodiment of FIG. 27;

FIG. 57 is an exemplary subscreen image illustrating the Provider's Help Request screen experience for the embodiment of FIG. 27;

FIG. 58 is an exemplary screen image illustrating the Seeker's Seeker Gets Offer screen experience for the embodiment of FIG. 27;

FIG. 59 is an exemplary screen image illustrating the Seeker's Seeker Declines Offer screen experience for the embodiment of FIG. 27;

FIG. 60 is an exemplary screen image illustrating the Seeker's Seeker Held Off on Offer screen experience for the embodiment of FIG. 27;

FIG. 61 is an exemplary screen image illustrating the Seeker's Seeker Views All Offers screen experience for the embodiment of FIG. 27;

FIG. 62 is an exemplary screen image illustrating the Seeker's Seeker Coupled with Provider screen experience for the embodiment of FIG. 27;

FIG. 63 is an exemplary subscreen image illustrating the Provider's Provider Gets Offer Acceptance screen experience for the embodiment of FIG. 27;

FIG. 64 is an exemplary screen image illustrating the Seeker's Seeker Coupon screen experience for the embodiment of FIG. 27;

FIG. 65 is a System Level Block Diagram of one embodiment of systemic incentivized loyaltization coupled with a micro-casting distributed URGS fulfillment system (“SILCM”) in accordance with the present invention;

FIG. 66 is an exemplary Top Level Logic Flow Diagram for the embodiment of FIG. 65;

FIG. 67 is a Logic Flow Diagram that further decomposes Step 6620 of the Flow Diagram of FIG. 66;

FIG. 68 is a Logic Flow Diagram that further decomposes Step 6710 of the Flow Diagram of FIG. 67;

FIG. 69 is a Logic Flow Diagram that further decomposes Step 6640 of the Flow Diagram of FIG. 66;

FIG. 70 is an exemplary screen image wherein a seeker's search result map is displayed;

FIG. 71 is an exemplary screen image wherein a provider descriptive ‘info’ screen is displayed;

FIG. 72 is an exemplary screen image wherein a voucher non-redemption detail subscreen is displayed;

FIG. 73A is an exemplary screen image wherein a provider descriptive ‘info’ screen including voucher redemption status is displayed;

FIG. 73B is an exemplary screen image wherein a voucher options detail subscreen is displayed;

FIG. 74 is an exemplary screen image wherein a voucher option morphing and voucher redemption information screen is displayed;

FIG. 75 is an exemplary screen image wherein a help request accepted by provider subscreen is displayed;

FIG. 76 is an exemplary screen image wherein an option ID entry subscreen is displayed;

FIG. 77 is an exemplary screen image wherein a voucher option morphing subscreen is displayed;

FIG. 78 is an exemplary screen image wherein a voucher option morphing re-try option subscreen is displayed;

FIG. 79A is an exemplary screen image wherein a voucher redemption advisory subscreen is displayed;

FIG. 79B is an exemplary screen image wherein a voucher redemption subscreen is displayed;

FIG. 80 is an exemplary screen image wherein a voucher-to-caller match selection screen is displayed;

FIG. 81A is an exemplary screen image wherein a voucher redemption code entry subscreen is displayed;

FIG. 81B is an exemplary screen image wherein a voucher redemption credit confirmation subscreen is displayed;

FIG. 82 is an exemplary screen image wherein a thank you to gifter subscreen is displayed;

FIG. 83A is an exemplary screen image wherein a voucher option gifted by provider subscreen is displayed;

FIG. 83B is an exemplary screen image wherein a voucher option banking information subscreen is displayed;

FIG. 83C is an exemplary screen image wherein a voucher option gifted by seeker subscreen is displayed;

FIG. 84A is an exemplary screen image wherein a provider group screen is displayed;

FIG. 84B is an exemplary screen image wherein a provider group copy source screen displayed;

FIG. 84C is an exemplary screen image wherein a provider group copy destination screen as shown by the Provider app is displayed;

FIG. 84D is an exemplary screen image wherein a provider group copy selection screen as shown by the Provider app is displayed; and

FIG. 85 is an exemplary screen image wherein a Seeker's ‘URGS need contextual media’ image is shared with Provider(s) via the Seeker App.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

Of note is that, in the remainder of this application, particular attention is placed upon visual displays on a mobile communication device. It is important to realize that the present invention may apply equally well to operation with all manner of consumer electronic network terminal devices including, but not limited to, computers, tablet computer systems, e-reader devices, and virtually any electronic device which includes WAN access and a user interface. In addition, while examples of a visual interface are described in great detail, the present invention is entirely capable of operation with a wide range of interface types, including any combination of a visual display, tactile and audio output and a visual, tactile or acoustic user interface (UI). Although the present invention may utilize the PSTN for communication between Seeker and Provider, it may equally well utilize equivalent communication over other WANs using services such as, but not limited to, VoIP and Skype.

The present application for letters patent describes a directory, request processing and fulfillment agent system which interposes between database(s) and the user interfaces of electronic network terminal devices in such a way as to bring Seekers and Providers of URGS together virtually and/or physically in a timely fashion.

The present invention enables a Provider to adaptably conduct commercial activities such as: to advertise and offer URGS, detail the type of URGS provided, accumulate independent third-party assessments and reviews, display credentials, leverage the draw of a centralized need-targeted electronic directory, offer informative mini-tutorials and FAQs, update and display availability status, prequalify prospective Seeker customers, provide repeatable direct Seeker-Provider communication, arrange for commercial transactions, facilitate and track progress towards consummating commercial transactions, consummate commercial transactions for URGS and possibly other service(s) and/or good(s) with Seekers, follow-up post-transaction with Seekers to encourage and enhance good-will, and measure and evaluate the effectiveness of the foregoing and make adjustments and refinements.

Additionally, the present invention enables a unified adaptable facility for a Seeker to prequalify, locate, evaluate, make repeatable contact with, and acquire URGS from, one or several Providers.

Although at first consideration, the present invention may have some resemblance to generic search engines such as Google, it is much different in operation, function and result. Unlike a generic search engine, it uses a great deal of specificity—including Seeker—and Provider—sourced Profiles—in selecting a usably small set of well qualified results. Furthermore, it provides a much richer service that is tailored to urgent requirement fulfillment. When using a generic search engine, a user is generally anonymous and the user's motivations not apparent, and therefore the results provided are often voluminous, non-applicable, poorly differentiated, commonly misranked and generally of little or no use. The present invention on the other hand—based in part on information provided by a given Seeker specifically for this purpose—may pre-authenticate, validate, rank and otherwise screen Providers before responding with a vetted set of Providers in reply to that Seeker's specific request.

### I. Urgent Requirement Fulfillment System and Methods Thereof

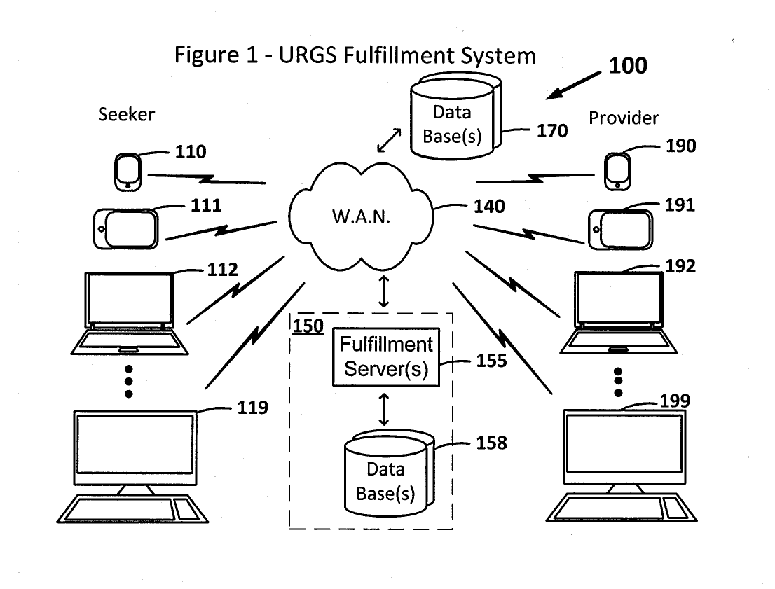

FIG. 1 provides a structural block diagram for an example of an Urgent Requirement Fulfillment System in accordance with an embodiment of the present invention. Such a Fulfillment System 2700 may be accessed using a mobile communication device or any other electronic network terminal device with a user interface. For brevity, an electronic network terminal device may be referred to as a “terminal”, which can either be a dedicated purpose-built device or a suitable general purpose device.

The services of the Fulfillment System 2700 are provided by the Fulfillment Server(s) 155, which utilize one or more Database(s) 158 containing information about users who can utilize the Fulfillment System 2700 either as a Seeker or as a Provider. This distinction of two separate types of users does not prevent a user who is a Provider from also separately using the System 2700 as a Seeker; nor does it prevent a Seeker from separately using the System 2700 as a Provider. When describing use of the Fulfillment System 2700 that is equivalent whether by a Seeker or by a Provider, the term “User” is used to mean either of these two types of users.

Seeker terminal choices, 110 through 119, represent the multiplicity of devices that can support access to the Fulfillment System 150. Often these terminals are mobile communication devices—i.e., devices that can be carried easily from place to place by the Seeker—typically with Wi-Fi or cellular data or other wireless connectivity and in numerous instances with built-in mobile telephone capability. However, less portable or fixed installation terminals may also support access to the Fulfillment System 150.

Provider terminal choices, 190 through 199, mirror the choices available to a Seeker. They differ specifically in the role of the User, i.e., Provider rather than Seeker, and the specific device chosen by each individual User. So for instance a given Seeker may use a “smart phone” mobile communication device, 110, whereas a Provider may use a desktop computer, 199.

In some embodiments, a Seeker or Provider's use of the Fulfillment System 150 is not bound to a specific terminal device, so for instance a Seeker could initially access the Fulfillment System 150 using a laptop computer, say from home, and subsequently use the Fulfillment System 150 with a tablet computer, while traveling in a car.

In some instances, a User's electronic network terminal device that is dedicated to providing data access, e.g., a desktop computer, 119/199, may be augmented for telephone communication by a separate telephony device (not shown) and/or third party telephony software (not shown) running on the terminal device. Such separate telephony devices may include, but not be limited to: a mobile cellular phone or a landline telephone, or a headset paired with third party telephony software running on the terminal device, e.g., Skype.

At the level of network connectivity, a Seeker's terminal and a Provider's terminal operate in equivalent ways, therefore for simplicity: the terms “User's” device or “User's” terminal is used when operation of a Fulfillment System 150 feature applies in the same fashion to either a Seeker's terminal or a Provider's terminal device.

Inter-communication between a User's terminal device and the Fulfillment System 150 may use a Wide Area Network (WAN), 140, such as the Internet. Communication between a User and the Fulfillment System 150, or between a Seeker and a Provider, may involve traversing more than one WAN (not shown). In some embodiments, Fulfillment System-facilitated communication between a Seeker and a Provider may also involve a WAN or WANs such as the PSTN and/or the Internet.

The Database(s) 158 used by the Fulfillment System 150 may be centralized or distributed. In some embodiments, the Fulfillment System 150 is coupled to one or more external database(s) 170 via WAN 140.

Generally, the Database 158 used by the Fulfillment System 150 is remote from the User's terminal; however in some embodiments, portions of database(s) used by the System 150 may reside on the User's electronic terminal device (not shown).

Depending on the embodiment, the Fulfillment System 150 may use one or several models of connectivity including, but not limited to: client/server and peer-to-peer. Client/server connectivity may use a WAN such as the Internet for access between the User's terminal device and the Fulfillment System's server(s) 155. Peer-to-peer connectivity, such as a Fulfillment System-facilitated telephone call or text message exchange between a Seeker and a Provider, may typically also use a WAN such as the PSTN or the Internet.

In some embodiments, communication between a Seeker and a Provider may be intermediated by the Fulfillment System 150. In such intermediation—sometimes referred to as “proxying”—the System 150 may source, receive, reroute, multicast, broadcast or otherwise initiate or respond to and/or terminate communication: from a Seeker (or on a Seeker's behalf) intended for a Provider, and/or; from a Provider (or on a Provider's behalf) intended for a Seeker. In addition, the System 150, may translate, clarify, expand, simplify, repeat, and/or generally modify or enhance the content communicated between Users in such a way as to improve or enhance comprehension or to increase the likelihood of successful completion of the communication. Such intermediation services may have varying mixes of automation and/or direct human participation depending on the embodiment.

Additionally, the Fulfillment System 150 may translate, clarify, expand, simplify and otherwise modify or enhance what is communicated. At a signal content level, the System 150 may amplify, filter, encode, decode, transcode, compress, expand, error correct and generally process the signal corresponding to the communication in ways well understood to one well versed in the art.

In some embodiments, voice communication may be intermediated by the Fulfillment System 150 in such a way that the telephone number(s) nominally routed directly to a User are actually directed to and/or are routed by the System 150. For example, the Fulfillment System 150 may provide additional services to a Provider or on a Provider's behalf including, but not limited to: PBX services including call routing/forwarding, call attendance, voice mail, call center and client notifications by outgoing call.

In some embodiments, data communication may be intermediated by the Fulfillment System 150 in such a way that logical network addresses—e.g., web site URLs and email addresses—nominally routed directly to a User are actually routed to and/or sourced from and/or redirected by the System 150. For example, the Fulfillment System 150 may provide additional services to a Provider or on a Provider's behalf including, but not limited to: Web site, email, blog, on-line forum/social network posts, electronic newsletters, and push notifications to clients.

In some embodiments, text messaging communication may be intermediated by the Fulfillment System 150 in such a way that logical texting addresses—e.g., Universal Resource Identifiers—nominally routed directly to a User are actually routed to and/or sourced by and/or redirected by and/or translated by the System 150. For example, the Fulfillment System 150 may provide additional services to a Provider or on a Provider's behalf including, but not limited to: text-email translation, text-voice translation, system-to-system gateway (e.g., between SMS and IM) and push text messaging notifications to clients.

A number of third parties, such as Better Business Bureau, Chamber of Commerce, professional/trade organizations and consumer rating sites—e.g., Angie's List and 1800Dentist—maintain large databases describing service vendors. In some embodiments, the Fulfillment System 150 may use data from such third party databases and/or from Users' terminal devices. Hence, Seekers have access to a very wide variety of Providers listed in a virtual aggregate database or virtual composite database comprised of Database 158 plus data accessed or acquired from third parties plus data stored on or acquired from Users' terminal devices. For simplicity in the following description, we refer to representative Database 158.

A large number of third parties, such as telephone companies, business journals, professional associations, and business directory companies—e.g., yp.com—maintain directories of service vendors as a business. In some embodiments, the Fulfillment System 150 may redirect certain Seekers to third party directory sites; or the System 150 may display contents from third party sites to Seekers. Motivations to do so may include, but not be limited to: Seeker requires non-urgent service, the third party pays for referrals, no suitable Providers are found in the Database 158 for the URGS the Seeker requires.

Elemental to the operation of the Fulfillment System 150 is User-descriptive data entered into the Database 158 voluntarily by Seekers and Providers themselves. In some embodiments, this data may be augmented with data from third parties, which may be copied or simply utilized on a one-time basis. Such User-descriptive data for a given User may be referred to as a “Profile” or for multiple Users or in aggregate—“Profiles”.

Profiles may be stored in Database 158 and can be organized, portioned, sorted, encrypted, firewalled, access-restricted, backed-up, transaction logged and otherwise managed, maintained and protected using techniques familiar to one skilled in the art.

In general, industry best practices are applied so as to comply with any legal mandates, regulatory requirements, or industry consensus on the protection of private, sensitive and proprietary information or otherwise privileged information. So for instance when a Profile includes or the System 150 accesses a User's medical records, appropriate HIPPA standards are complied with. Encryption may be applied to protect information in the Database 158 and also protect information communicated between Users and the System 150 and/or third parties and the System 150. In many embodiments, encryption may occur as appropriate using technologies familiar to one well versed in the art, such as Secure Sockets Layer (SSL), Transport Layer Security (TLS) and Virtual Private Network (VPN).

In some embodiments, Seekers' Profiles may describe things such as their creditworthiness, their employment, their recent purchases, their property, their health, their physical and work addresses, their phone number(s), their email address(es), and similar descriptive information that may assist in determining whether a given Seeker is someone a given Provider might want to do business with. The Fulfillment System 150 may automatically and transparently vet some Seekers so as to preempt a potential match with a Provider. In other instances, portions of a Seeker's Profile may be viewable to a Provider to assist that Provider in deciding whether to do business with a given Seeker.

In the case of Providers, their Profiles may describe details such as their qualifications and specializations, their education and training, their credentials and licenses, their professional memberships and associations, their career histories, their work philosophies, languages they may speak, as well as more prosaic information such as a business address, telephone number and email address.

In a typical embodiment, a User's Profile may specify requirements that User has for transacting commerce with their counterpart User—i.e., a Seeker with a given Provider; and a Provider with a given Seeker. So for instance, a Seeker may indicate what form of payment they wish to have accepted, what awards programs they wish to have credited, what language they prefer to be spoken to them, and other details of how they prefer or require a transaction to be conducted. Similarly, a Provider may indicate what form of payment they are willing to accepted, what awards programs they support, what language(s) they speak, and other details of how they prefer or require a transaction to be conducted.

Sources for information in a User's Profile may include, but are not limited to: the User directly, private records from third parties (possibly with the User's permission), and publicly accessible records. Some Profile information may be placed into the Database 158 and not be updated for indeterminate periods of time. Other Profile information may have a specific “time to live” after which it is either updated or simply deleted. The shortest such “time to live” may be per access. Other Profile information may be sourced from a User or a third party on a per use basis. This may be done for instance because the sources prohibit retaining copies of it, or because there is a need to get the most up-to-date information, e.g., checking criminal records.

Information in a User's Profile may be beneficial or derogatory. The information in a Provider's Profile is generally there for the use of Seekers. Similarly, the information in a Seeker's Profile is generally there for the use of Providers. Consequently, even if a User can enter or view an item of information in their Profile, they may not necessarily be able to alter or delete it.

Some information in a Provider's Profile may be entered by Seekers—typically in the form of ratings. Similarly, a Seeker's Profile may contain information entered by Providers. Additionally, third parties may source some information in a User's Profile. In some instances, such ratings or characterizations may be unsolicited or gathered as part of a follow-up instigated by the Fulfillment System 150.

Profiles for Seekers contain generally different information than, and are commonly kept separate from, Profiles for Providers. In the instance where a User is both a Seeker and (separately) a Provider, the contents of the User's Seeker and Provider Profiles are typically not intermingled. Of course, some User information may be duplicated in both Profiles, for example the User's name.

Some portions of a User's Profile may be used strictly internal to the Fulfillment System 150 or for the purposes of operators of the Fulfillment System and never be visible to any Users—Seeker or Provider—nor utilized on their behalf by the System 150.

Some Seeker Profile information may be visible to a Provider or to the Fulfillment System 150 on a Provider's behalf, but not visible to that Seeker. Similarly, some Provider Profile information may be visible to a Seeker or to the System 150 on a Seeker's behalf, but not visible to that Provider.

Some of the Profile information of a Seeker may be visible to other Seekers. For example, in some embodiments limited Profile information may be viewable via an on-line user forum that is part of the Fulfillment System 150.

A User who is a Provider may conceivably offer several different types of URGS as separate businesses. The Fulfillment System 150 may allow multiple Provider Profiles for such a User, where some of the information in the Profiles is duplicated in each Profile and other information is unique to a Profile specific to the corresponding URGS provided. In some embodiments, such Profiles may be accessed using separate unique accounts.

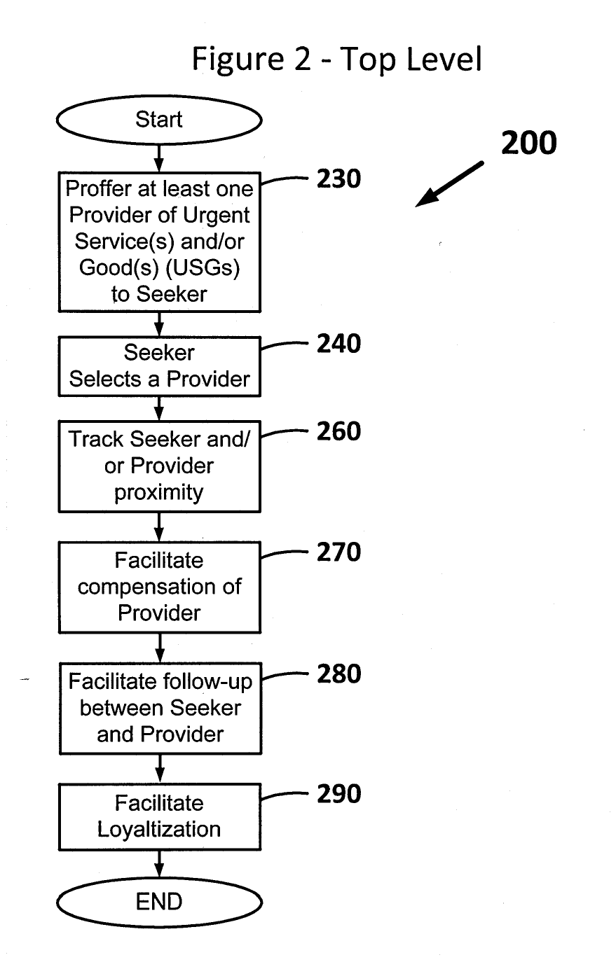

Referring to FIG. 2, the Fulfillment System 150 may serve to fulfill a Seeker's need for URGS using a winnowing and matching process that commonly results in the Seeker being paired with a well suited Provider that the Seeker selects from a list of qualified potential Providers. FIG. 2 illustrates the process used in some embodiments. Steps appearing in FIG. 2 are illustrated by several different examples in the discussions that follow.

In step 230, the Fulfillment System 150 prepares to proffer a set of potential Providers to the Seeker. Substantial amounts of information about the Seeker and about potential Providers may be retrieved from the Database 158 and utilized by the System 150 to either validate or reject potential pairings of the Seeker to proximate Providers.

As mentioned above, both the Profiles of the Seeker and potential Providers may contain requirements that are mandatory qualifiers as well as other requirements that reflect non-mandatory preferences. Accordingly, some embodiments may apply weightings to Profile preferences and instantiate rankings of potential Providers based on the degree of “acceptability” or “goodness” of a given Provider as determined algorithmically based on Seeker and Provider Profiles, third party ratings, and other external data. In some embodiments, the ranking of potential Providers may be displayed for the Seeker's use (not shown herein) prior to selecting a Provider. A given Provider's ranking may be represented by a color code, icon size, some number of stars, a ranking number, or any of a multiplicity of indicators of relative rank familiar to one skilled in the art. In some embodiments and some instances, there may be more potential Providers than is practical to proffer. In some embodiments, the Fulfillment System 150 may limit the number of potential Providers proffered to a number lower than the total available. In such instances, the ranking of a given Provider—relative to other potential Providers—may determine whether or not that Provider is proffered.

Some of the Profile information of a User may affect other aspects of Fulfillment System 150 operation and use. For example, language preference may cause the System 150 to generate displays in a language suited to the User. A “zooming” feature and/or audio dialog may support the visually impaired. A multiplicity of behaviors—System 150 operation in general and display operation specifically—may be influenced by User Profile preference settings.

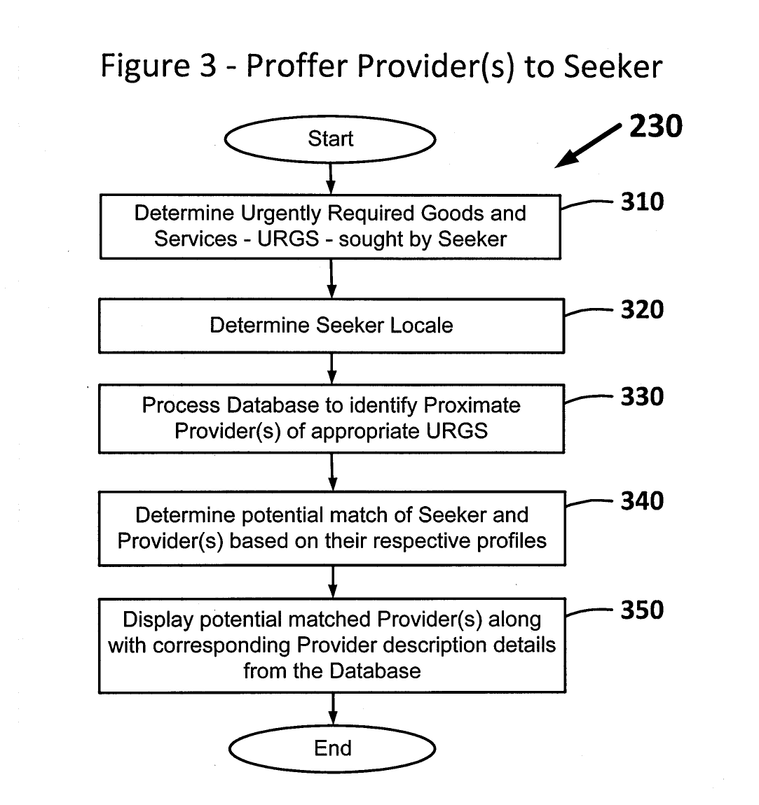

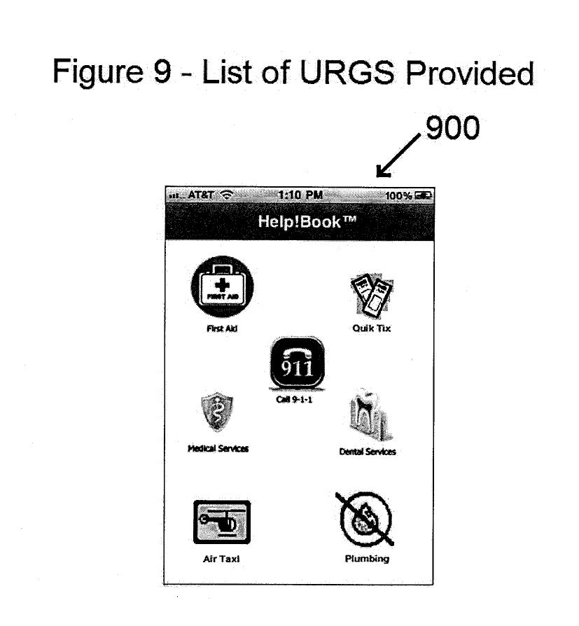

FIG. 3 shows step 230 in greater detail. Referring to step 310, the Fulfillment System 150 determines the URGS sought by the Seeker. In some embodiments, this is accomplished by offering a list of the URGS to select from. In some embodiments, such a list may be in the form of graphic icons—as in FIG. 9. Other embodiments, which may support substantial numbers of URGS, may provide various facilities to allow a Seeker to locate and select the URGS sought—for instance, key word search.

As shown in step 320 of FIG. 3, the Fulfillment System 150 determines the Seeker's Locale. The Seeker's Locale may be determined in a multiplicity of ways depending on a variety of factors including but not limited to: the type of URGS sought by the Seeker; whether the Seeker is required to travel to a rendezvous location to acquire the URGS; whether the Seeker cannot or does not want to travel. The Seeker's Locale may be determined around the time that the Seeker utilizes the System 150 to seek URGS or it may be previously determined. So for instance, the Seeker's Locale may be taken to be the Seeker's home or place of work as defined by the Seeker's Profile in the Database 158. Or the Seeker's Locale may be taken to be the expected location of the Seeker based on a schedule defined by the Seeker's Profile in the Database 158. Or the Seeker's Locale may be taken as a geo-location provided by the Seeker or by a mobile communication device in the Seeker's possession or by a third party geo-location service such as a telephone service company, a security surveillance company, or other organizations that utilize or commerce in the geo-location of individuals to conduct their own business and/or facilitate the businesses of others.

Information from the Seeker's Profile may include preferences that affect how the Seeker's Locale is determined. In many embodiments, the Fulfillment System 150 displays information reflecting the Fulfillment System 150's calculation of the Seeker's Locale (not shown)—allowing the Seeker to determine if the Fulfillment System 150 has made a mistake in attempting to establish a Locale for the Seeker.

Having ascribed a Locale to the Seeker, in Step 330 the Fulfillment System 150 processes the Database 158 to identify proximate Provider(s) of the URGS sought by the Seeker. Proximity typically involves measuring between locations. As relates to URGS fulfillment, those locations commonly correspond to the Seeker's Locale and to the Provider's Locale. Where the Seeker's Locale or a given Provider's Locale may be ascertained to be—for the purpose of determining proximity—can depend on a number of factors. In some instances, determination of proximity may be affected by preferences in the Seeker's Profile in the Database 158 and/or in a given Provider's Profile in the Database 158. For example, a given Provider's Profile preference may require the rendezvous location and/or the Seeker's Locale to lie within a specific region or territory based on the strictures of a License or Certificate or third party permission issued to that Provider. If that preference is not met, the Provider is determined by the Fulfillment System 150 to not be proximate to the Seeker.

Proximity may also have temporal determining factors. For instance, a potential Provider may be relatively near a Seeker, but have prior commitments that must be seen to first. Or for example, bad traffic may slow the time it takes to travel to a rendezvous location. In an urgent situation, temporal proximity may be more important than physical proximity. In many embodiments, the Fulfillment System 150 may ascribe proximity to a given Provider based on a multiplicity of temporal-related factors including, but not limited to: projected travel route, third party traffic congestion and weather reports, historical traffic patterns and records, and Provider promptness ratings. In some instances, factors impacting temporal proximity may not be apparent to the System 150 such that communication between the Seeker and a Potential Provider may indicate a different—perhaps less attractive—temporal proximity.

For the purposes of Step 330, the Provider's Locale may be ascribed in a number of different ways depending on numerous factors including but not limited to: the type of URGS provided; whether the acquisition of the URGS requires the actual physical presence of the Provider and/or of the Seeker; whether the Provider operates from a fixed business location; and/or whether it is necessary for the Provider to travel to provide the URGS. So for instance, the Provider's Locale may be taken to be the Provider's place of business as defined by the Provider's Profile in the Database 158. Or the Provider's Locale may be taken to be the expected location of the Provider based on a schedule defined by the Provider's Profile in the Database 158. Or the Provider's Locale may be taken as a geo-location provided by the Provider or by a mobile communication device in the Provider's possession. Information from the Provider's Profile may include preferences that affect how the Provider's Locale is determined.

In many embodiments, the information: URGS sought, Seeker's Locale, and each Provider's availability and Locale is deemed sufficient to allow the Fulfillment System 150 to process the Database 158 to identify proximate Provider(s) of the sought after URGS—see 330.

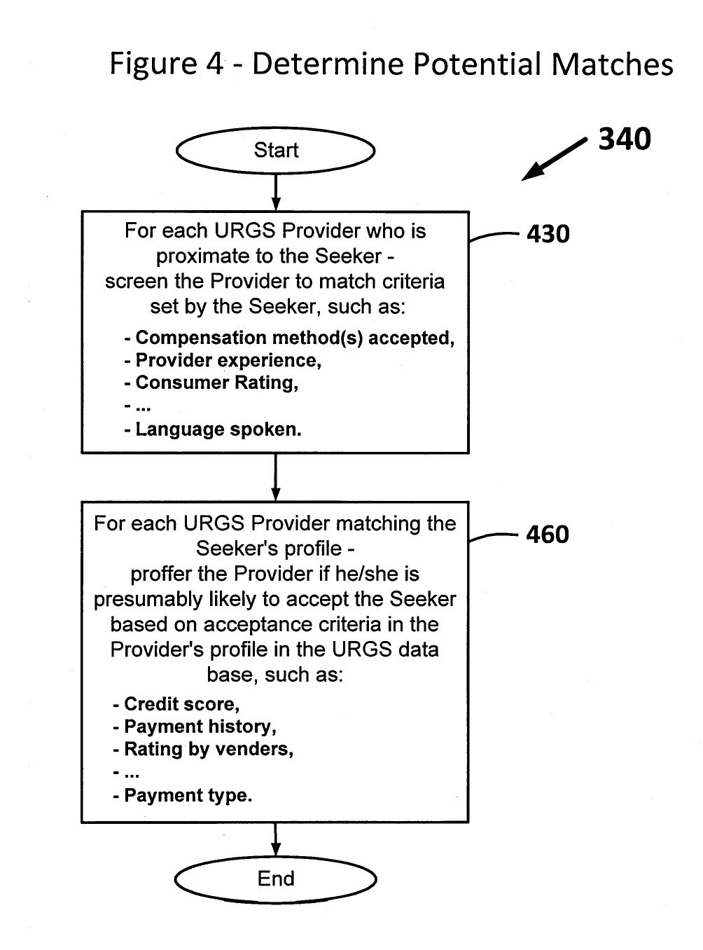

In many embodiments, additional winnowing of the set of potential Provider's may occur based on additional preferences a Seeker has indicated in their Profile and/or additional preferences a given Provider has in theirs—reference 340. FIG. 4 provides instances of some additional Seeker and Provider criteria—430 and 460, respectively—that in some embodiments may serve to further cull the set of potential Providers.

In some embodiments, the Fulfillment System 150 may attempt to winnow down the set of potential Providers. In 350, the Fulfillment System 150 may present the resulting set of potential Providers to the Seeker. In some embodiments, the System 150 may modulate the winnowing process so as to proffer at least two potential Providers.

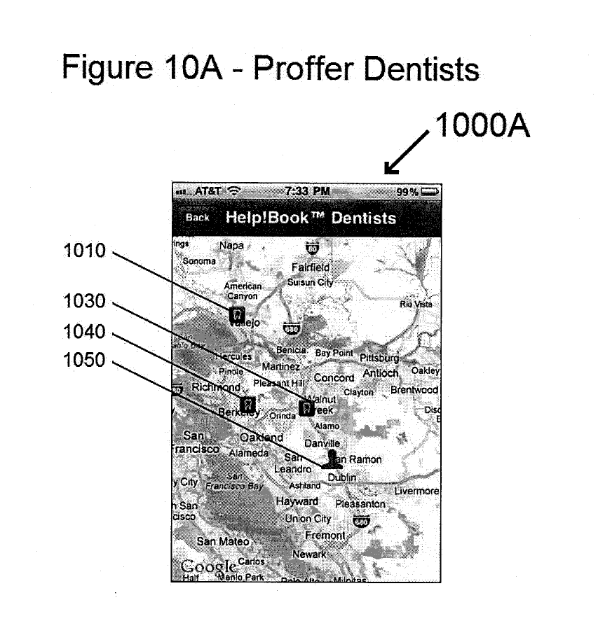

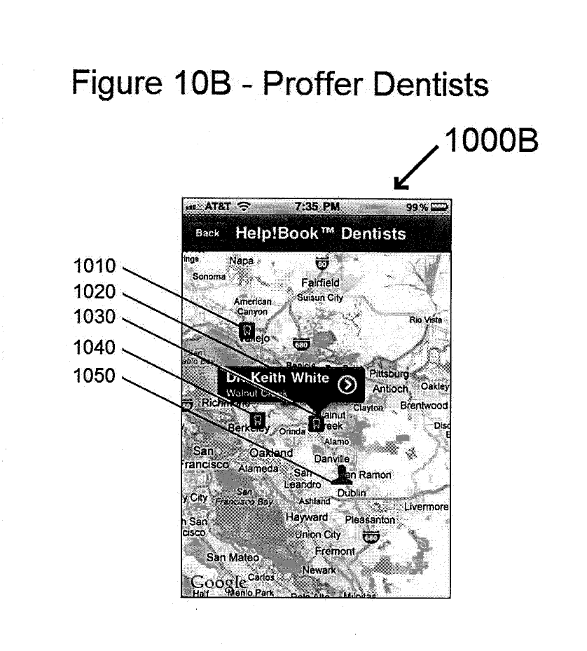

In some embodiments, the set of potential Providers is displayed on a map that shows their approximate Locales and their relative proximity to the Seeker—see FIG. 10A for an example. In some embodiments, a Seeker may further open a pop-up subscreen to view additional Provider details—see 1020 in FIG. 10B.

Referring to 240—the Seeker typically selects one of the Providers proffered by the Fulfillment System 150.

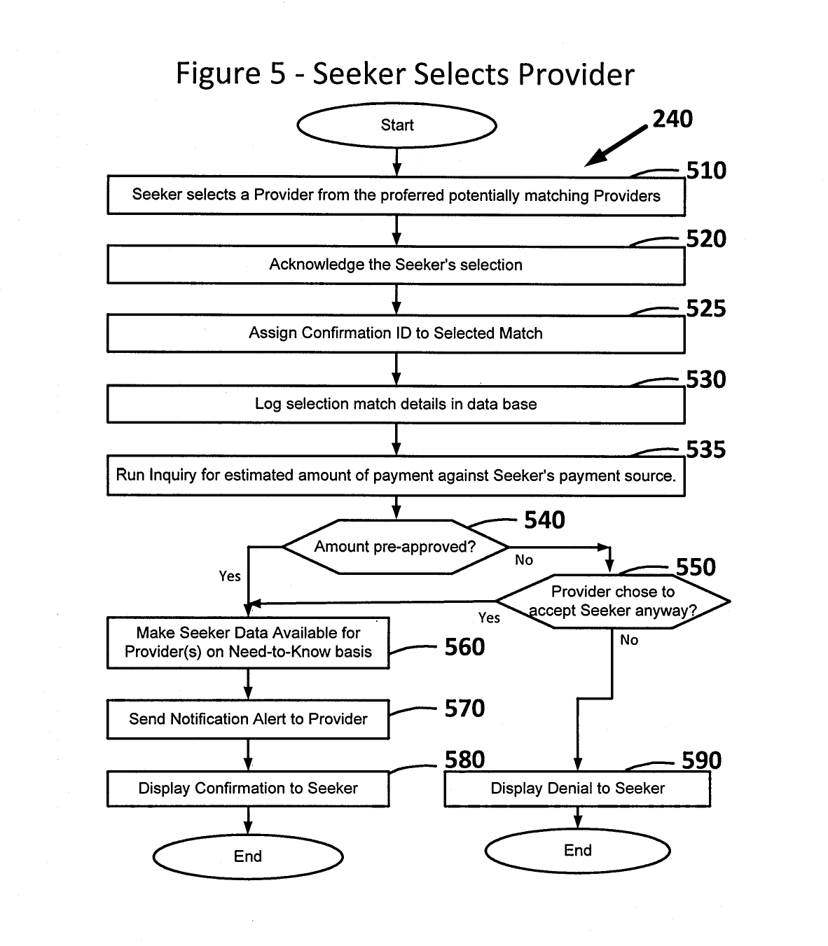

The response by the Fulfillment System 150 to the Seeker's selection of a URGS Provider may vary between embodiments, but also in some instances, within a given embodiment based on the Provider's Profile. FIG. 5 provides an example of one such embodiment.

A Seeker's selection of an URGS Provider—see 510—may be acknowledged by the Fulfillment System 150—reference 520—so the Seeker knows the Fulfillment System 150 has recorded the correct selection.

Referring to 525, a confirmation ID may be assigned that may be used subsequently to look up a record of the Seeker-Provider match that is stored in the Transaction Log—see 530.

In some embodiments, the Fulfillment System 150 may attempt—on behalf of the Provider—to pre-qualify the Seeker's ability to pay by running a test charge for a pre-set amount—typically a minimum payment—against the Seeker's payment card, insurance payer, or other payment source—see 535. Referencing 540, the Fulfillment System 150 may query the payment source for pre-approval.

In such embodiments, if the test charge is rejected by the payer, the Provider's Profile may be checked to see if the Provider accepts Seekers with potential payment problems—see 550. If not, the Fulfillment System 150 may inform the Seeker of denial—see 590—typically causing the Seeker to select a different potential Provider.

If on the other hand, the Seeker's payment source can pay, or the Provider accepts Seekers with potential payment problems, appropriate data about the Seeker—see 560—may be made available for the Provider and notification of the selection sent to the Provider—see 570—and a corresponding confirmation to the Seeker—see 580.

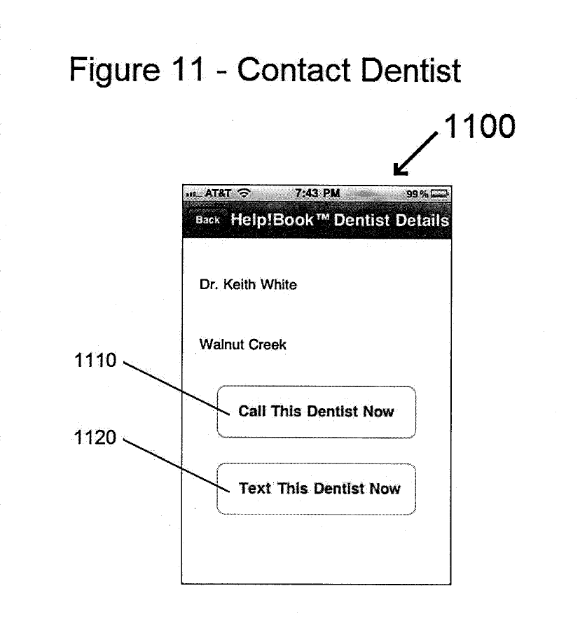

In some embodiments, the Fulfillment System 150 offers the Seeker the opportunity to initiate contact with the selected Provider immediately—FIG. 11. In other embodiments the Fulfillment System 150 may act on the Provider's behalf to arrange the details of providing the URGS to the Seeker.

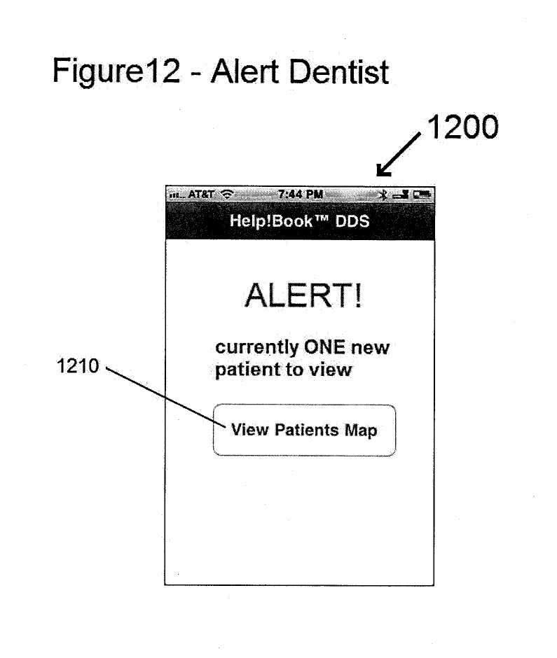

In most embodiments, particularly those where the Seeker contacts the Provider to complete the transaction, the Fulfillment System 150 acts to notify the Provider promptly of the selection—FIG. 12.

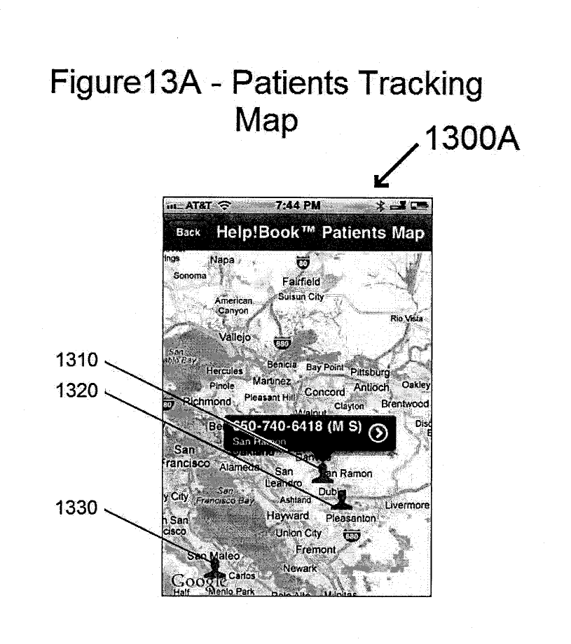

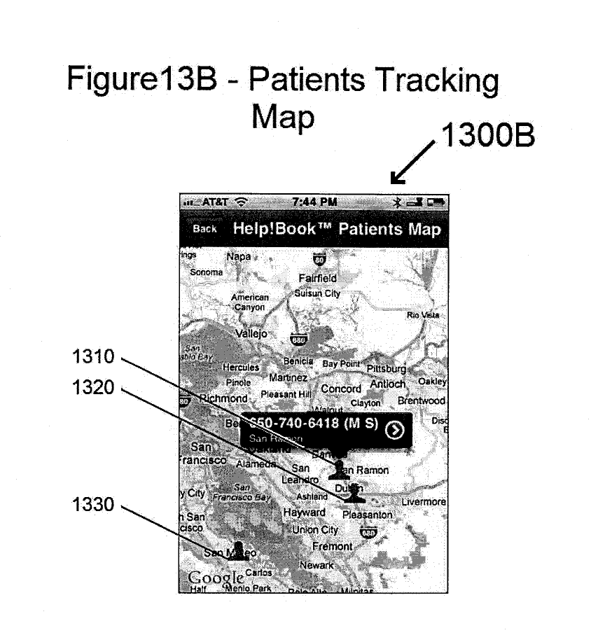

To assist both the Seeker and the Provider, the Fulfillment System 150 may provide a tracking service—see 260—and corresponding map-based display mechanism that periodically updates, substantially in real-time, the geo-location of the traveler(s)—be it the Seeker, the Provider, or both—relative to the rendezvous location where the Seeker and Provider intend to transact the acquisition of the URGS. In some embodiments, tracking maps are made available for both the Seeker—FIG. 10A, and the Provider—FIG. 13A.

In some instances, where the URGS are a good or goods, it may be the good(s) traveling and the tracking map reflecting the current Locale of the good(s). In some instances, the URGS may be provided by ways that are not well suited to tracking on a map, e.g., funds may be wired electronically with seeming instantaneous travel.

The Fulfillment System 150 may utilize an internal set of identifiers and transaction records in the process of matching Seekers to Providers for the purpose of acquiring URGS. In a typical embodiment, a stored set of records is retained in the Database 158 (“Transaction Log”) that records the details of each such process.

Operators of the Fulfillment System may derive revenue or other recompense—from Seekers and/or Providers and/or third parties—for use of the System 150 and/or use of information accumulated in the Database 158. Information stored in the Transaction Log may serve to determine what recompense is appropriate and from whom. It may be used for instance, to provide details that may appear in an invoice. Such details may for example include transaction information representing a “billable moment”—e.g., when a valued service—such as facilitating a Seeker to contact a Provider—instantiated and correspondingly recorded in the Transaction Log.

In addition to maintaining Transaction Logs, in some embodiments, the Fulfillment System 150 may maintain in its Database 158 algorithmic manipulations of various log data (“Metrics”) for a single User or several Users individually or a set of Users as an aggregate—where a given User may be a Provider, or a Seeker, or both a Provider and a Seeker (dual use of Fulfillment System 150). Such data may be measurements, statistics, and correlations for an individual Provider, or Providers as individuals, or Providers as an aggregate, and/or Multiple Providers.

In addition to maintaining Transaction Logs, and Metrics, in some embodiments the Fulfillment System 150 may keep stored copies (as permissible) or aggregations of any information—from or about Users or third parties—that enters the Fulfillment System 150. This information may at some time be manipulated to derive useful data that may be of value to operators of the Fulfillment System, Fulfillment System Users, or third parties.

For most Providers, a key goal of providing URGS is to be compensated. In many instances a Seeker may contemplate using the Provider again, and therefore want the Provider to be pleased with being compensated. Also—for both a Seeker and a Provider—having a record of having transacted the requisite compensation is useful in case of a dispute, or more in general, to maintain good credit histories.

The Fulfillment System 150 may facilitate the compensation of Providers—270. In some embodiments, the Fulfillment System 150 provides a basic service to the Provider—access to a reproduction of the Transaction Log record reflecting the pairing of the Provider and the Seeker.

In some embodiments, the Provider may enter additional information into the Transaction Log to record the status of the transaction with the Seeker and the status of the corresponding compensation by the Seeker. Such information may include third party confirmation of compensation of the Provider by the Seeker. In some instances, such information may be provided to the Fulfillment System 150 directly from authoritative third parties.

Some embodiments may provide broader facilitation to a Provider such as Appointments, Billing and Accounting.

In some embodiments, a Seeker has access to a record of Provider searches and pairings conducted by the Fulfillment System 150 on behalf of the Seeker. Furthermore, in some embodiments, a Seeker may have access to a record of other related transactions conducted by the Fulfillment System 150 on behalf of the Seeker.

Facilitating follow-up between Seekers and their Providers—see 280—is another utilization of the Transaction Log. For instance, the Fulfillment System 150 may communicate instructions from a selected Provider to the corresponding Seeker. In the opposite direction, the System 150 may communicate feedback from a Seeker to a Provider selected by that Seeker. Additionally, in some embodiments, the System 150 may obtain Provider ratings from Seekers and Seeker ratings from Providers and add these to User metrics in the Database 158. In some embodiments, positive or negative ratings may cause the System 150 to increase or decrease a given Provider's ranking, which may in turn impact the frequency of that Provider being proffered.

Follow-up with Seekers may be a key component of a Provider's client loyalty program. In some instances, it may generate immediate follow-on transactions. In other instances, it may generate good-will. By facilitating follow-ups, the Fulfillment System 150 may gain access to the Seeker's opinions, and help increase the Seeker's loyalty to the Provider. A side benefit may be increased loyalty of both the Seeker and the Provider to the Fulfillment System 150.

In addition to direct follow-up, the System 150, may provide, support, be affiliated with, link to, direct Users to, or otherwise facilitate follow-up via user forums/social media. Many consumers use social media such as Yelp, Facebook and Twitter to express their praise and/or criticisms regarding a vendor.

The Fulfillment System 150 facilitates Loyaltization—i.e., creating, maintaining, promoting and expanding User loyalty to the Fulfillment System 150—focused on both Providers and Seekers—see 290. Loyaltization may play an important role in the commercial acceptance and success of the Fulfillment System 150.

Loyalty may be created as a byproduct of the inherent usefulness of the Fulfillment System 150, but in some embodiments loyalty may be actively sought—using additional features and incentives—to make Providers and Seekers want to recommend the Fulfillment System 150 to others and continue using it themselves. For example, the System 150 may increase the ranking of a valued Provider and thereby increase the likelihood and frequency of that Provider being proffered. Additionally, in some embodiments, the System 150 may improve other metrics associated with a valued Seeker or Provider. Such metrics might be shared for instance with other Users and/or third parties.

In some embodiments, the Fulfillment System 150 may administer loyalty programs on the behalf of individual Providers. Additionally, the Fulfillment System 150 may operate loyalty programs on behalf of an aggregate of multiple Providers and offer incentives to Seekers based on desired behavior relative to any Provider within said aggregation. Such loyalty programs conducted on behalf of Providers also have the benefit of Loyaltization of Providers to the Fulfillment System 150. Similarly, in some embodiments, the System 150 may administer loyalty programs—on behalf of individual Seekers or Seekers in aggregate—that reward Providers and increase good-will between Providers and Seekers and perhaps the System 150 as well. Loyalty programs, whether on behalf of Seekers or Providers, may award benefits to Users—for example discounts for future URGS acquired using the System 150 or rewards such as goods and/or services from Providers and/or third parties. For instance, rewards may include airline frequent flier miles or hotel stay points. Also, in some embodiments, the System 150 may offer enrollment in third party loyalty programs.

In many urgent situations, a Seeker may have need for more than one URGS. For example, a vacationer with a broken down car may need a place to stay overnight in addition to automotive repair. If the car is seriously damaged, a rental vehicle may be needed. In typical embodiments, the Fulfillment System 150 may proactively facilitate the proffering of a set of related URGS based on Seeker-provided information and/or inference by the System 150. In some embodiments, the System 150 may facilitate the proffering of non-urgent services and goods that might be useful in the context of the Seeker's circumstances. For instance, the stranded traveler might like a book or newspaper to read or perhaps some comfort food—once the car and a place to stay have been taken care of. A Seeker's Profile may determine whether and how the System 150 proffers, suggests or recommends additional services and goods.

In addition to directly facilitating the Seeker's acquisition of a set of circumstance-related URGS and non-urgent services and goods—in some embodiments—the Fulfillment System 150, may suggest, recommend or otherwise prompt a Provider to proffer additional URGS and other non-urgent services and goods to a Seeker.

### II. Exemplary Scenarios

The following discussions and references to figures are provided to illustrate a set of exemplary scenarios for some embodiments of the Fulfillment System 150. The examples may include particular limitations which are unique to the given example and are not intended to extend to the invention as a whole. Likewise, some examples may have been simplified in order to aid in clarity. It is understood that while the foregoing examples aid in explanation and clarification of the present invention, these examples do not limit the scope or function of the present invention.

In some instances, graphic representations with the appearance of screenshots from mobile communication devices are provided by way of example to aid in the illustration of some embodiments. This is not intended to imply that mobile communication devices are preferred to the exclusion of other terminal device types.

Several different fulfillment scenarios may occur when a Seeker and Provider are not situated at the same place. Such scenarios include, but are not necessarily limited to:

The Seeker travels to a rendezvous location that is the Provider's Locale,

The Provider travels to a rendezvous location that is the Seeker's Locale,

The Seeker and the Provider both travel to a fixed rendezvous location.

The Seeker and the Provider both travel towards each other without a fixed rendezvous location until they converge.

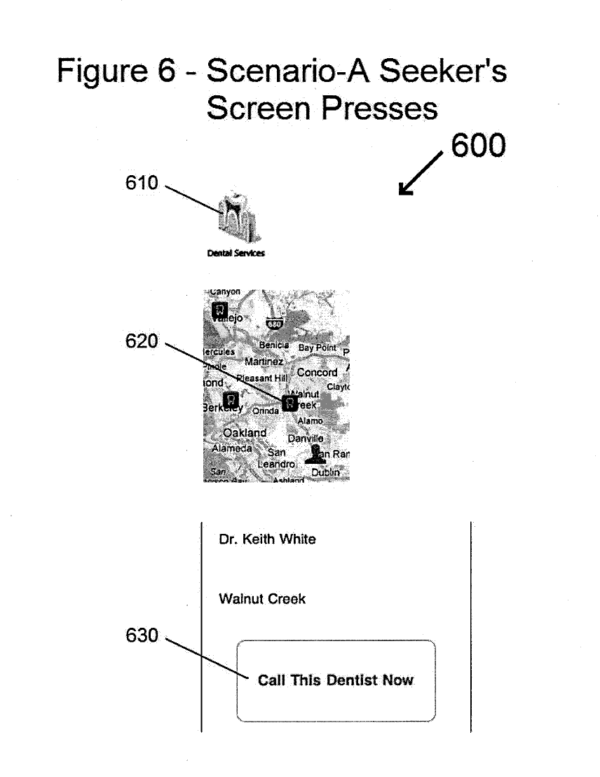

The scenario descriptions that follow detail the individual Scenarios—A, B, C and D—by stepping through the logic flow diagrams—FIGS. 2, 3, 4 and 5—and by providing corresponding exemplary screen shots to illustrate the User experience. FIGS. 6, 7 and 8—corresponding to Scenarios A, B and C, respectively—illustrate the process of selecting and contacting a Provider from the Seeker's perspective. In each instance, the Seeker actuates a virtual button on each of a sequence of three screens: button actuation 1—Select URGS; button actuation 2—Select a Provider; and button actuation 3—Contact that Provider.

Scenario a—Seeker Travels to Provider's Locale

To illustrate the scenario of a Seeker traveling to the Provider's Locale, the Seeker is imagined to be a business traveler from Spain—Mirabella Sanchez—who has a severe toothache; the URGS is urgent dental care; and the URGS Providers are dentists. Referring back to FIG. 6, it is possible for the Seeker to use a small number of virtual button actuations to: 1) select URGS Services (dental)—610; 2) select a Provider (dentist)—620; and 3) contact that Provider (dentist)—630.

Referring to FIG. 2 step 230, the Fulfillment System 150 works to proffer Providers of the type sought by the Seeker. FIG. 3 details an embodiment of step 230. In step 310, the Fulfillment System 150 determines from the Seeker the type of URGS sought—in this example: urgent dental care.

In step 320, the Fulfillment System 150 determines the Seeker's Locale. In this example, the Seeker is imagined to use a “smart phone” mobile communication device, which allows the Fulfillment System 150 to use GPS to geo-locate the Seeker, who at the time is in San Ramon, Calif.

Referencing step 330, the Fulfillment System 150 examines its Database 158 and determines that the corresponding type of Provider sought is: a dentist. In this example, the Fulfillment System 150 uses the dentist office location specified in each Provider's Profile in the Database 158 as that Provider's Locale. Each Provider's Locale, so determined, is compared to the Seeker's Locale—San Ramon in this example—to determine if a given Provider is proximate. A set of proximate Providers is accumulated in this fashion by the Fulfillment System 150. In this example, the Fulfillment System 150 examines the Database 158 for dentists and identifies eight Providers proximate to San Ramon.

In Step 340, the Fulfillment System 150 further vets the potential Providers. FIG. 4 details an embodiment of the vetting process. In Step 430 each of the potential Providers is vetted based on a comparison of preferences—preset by the Seeker in the Seeker's Profile in the Database 158—against a Provider's characteristics found in the Provider's Profile. Mirabella's Seeker Profile in the Database 158 indicates that she requires a Spanish-speaking Provider. Three of the potential Providers are rejected by the Fulfillment System 150 because their Profiles in the Database 158 do not have Spanish selected as one of the languages they speak.

In Step 460, for each potential Provider, the Provider is vetted based on the Provider's willingness to accept the Seeker based in turn on a comparison of preferences—preset by the Provider in the Provider's Profile in the Database 158—against the Seeker's characteristics found in the Seeker's Profile in the Database 158. Two potential Providers have indicated preferences for payment specifically in cash or by pre-approved insurance organization. Mirabella's Seeker Profile indicates that she desires to pay either with V-Pay debit card or by check. Mirabella's Spanish dental insurance does not match the pre-approved insurance payers in these two Provider's Profiles. Therefore, these additional two potential Providers are rejected by the Fulfillment System 150. Three other Providers do accept checks and therefore pass the vetting process.

Referring to step 350, the Fulfillment System 150 has three potential Providers to display to Mirabella, so she can select one from them. One Provider has an office in Berkeley, one has an office in Vallejo, and the third has an office in Walnut Creek. FIG. 10A provides an example of what the display may look like on Mirabella's mobile communication device. Shown there are four icons. The human head and shoulders silhouette icon 1050 represents Mirabella's Locale in San Ramon. The three tooth outline icons represent the three potential URGS Providers—the dentists in Vallejo 1010, Walnut Creek 1020, and Berkeley 1030, respectively.

Referring to FIG. 2 step 240, the Seeker selects an URGS Provider from the three potential Providers proffered by the Fulfillment System 150. In this example, the Seeker Mirabella selects the Provider in Walnut Creek by tapping on the icon 1020 in FIG. 10A. In this example, the Provider—Dr. Keith White—has preset his preferences in his Provider Profile in the Database 158 such that the Fulfillment System 150 prompts the Seeker—Mirabella—to contact Dr. White, as shown in FIG. 11, by the actuating virtual button 1110 to phone or the virtual button 1120 to text directly from her mobile communication device. At the same time, the Fulfillment System 150, sends Dr. White a notice to his mobile communication device—see FIG. 12-alerting him to expect to be contacted by a Seeker—Mirabella Sanchez.

The Fulfillment System 150 can facilitate communication between Seeker and Provider, by either providing contact information for the Provider or—as in this example—providing a facility to contact the Provider directly. In this instance, Mirabella telephones Dr. White by actuating the virtual button 1110 which causes her mobile communication device to place the phone call directly. The Fulfillment System 150 is not a party in the conversation between the Seeker Mirabella and the URGS Provider Dr. White, DDS.

Referring to FIG. 12, the Provider—having been alerted to expect to be contacted by a new Seeker—can view the Locale of the new Seeker by actuating the virtual button 1210, which Dr. White does. In this example, the Fulfillment System 150 responds by displaying FIG. 13A, a tracking map on which Provider Dr. White can look to see what information the Fulfillment System 150 has on the geo-location of any URGS Seekers who may be coming to his Locale. The tracking map includes a new icon—1310—representing the Locale of the new Seeker, Mirabella Sanchez, that the Fulfillment System 150 determines to be in San Ramon.

Dr. White's mobile communication device rings with the call from Mirabella—Dr. White answers. They discuss Mirabella's tooth and her dental history; go over compensation and any final details necessary to decide whether to meet; and agreeing to do so, set up an appointment for Mirabella.

In step 260, the Fulfillment System 150 initiates ongoing tracking of the progress of the Seeker traveling to meet the Provider. Referring to FIG. 13B, the Fulfillment System 150 periodically updates the a tracking map—as it may appear on Provider Dr. White's mobile communication device—to reflect changes in the Locale of Seekers traveling to the Provider's Locale. In the example, Mirabella's icon 1310 has not moved, because Mirabella needs to arrange transport to travel to Dr. White's Locale. Meanwhile, icon 1320 and icon 1330—representing two other Seekers traveling to Provider Dr. White's Locale—have both moved.

In step 270, the Fulfillment System 150 facilitates compensation by logging the transaction that has just occurred whereby Seeker Mirabella Sanchez selected Provider Dr. White. Both Dr. White and Mirabella Sanchez can subsequently look up the Transaction Log record.

Referring to step 280—in this example, Dr. White's Provider Profile in the Database 158 is preset for the Fulfillment System 150 to facilitate follow-ups by alerting Dr. White at a future time to follow-up with a Seeker who has selected him—in this instance with Mirabella Sanchez.

The Fulfillment System 150 facilitates Loyaltization—step 290—as described above.

### Scenario B—Provider Travels to Seeker's Locale

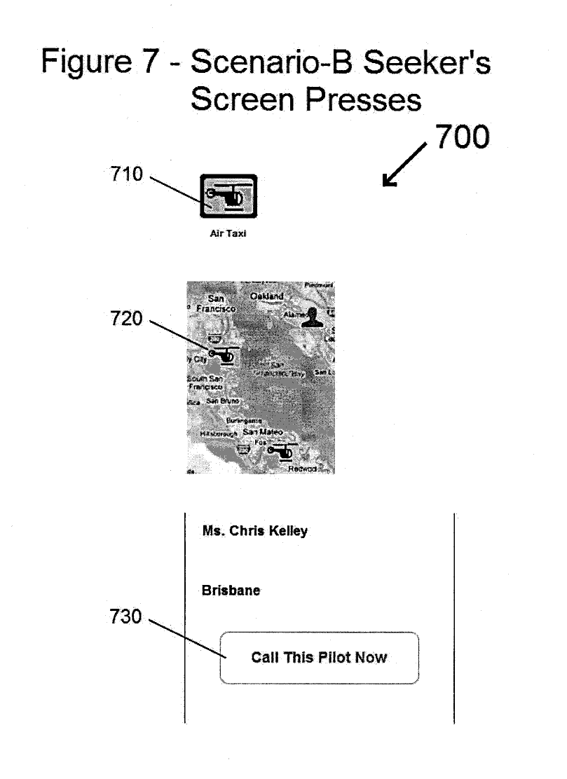

To illustrate the scenario of a Provider traveling to the Seeker's Locale, the Seeker is imagined to be a high-powered corporate executive just arrived at a major airport and running late for a critically important business meeting—Lee Nelson; the URGS is transportation to meeting location in time for his presentation; and the URGS Providers are helicopter operators. Referring back to FIG. 7, it is possible for the Seeker to use a small number of virtual button actuations to: 1) select URGS Service (helicopter)—710; 2) select a Provider (helicopter operator)—720; and 3) contact that Provider (helicopter operator)—730.

Referring to step 230—the Fulfillment System 150 works to proffer Providers of the type sought by the Seeker.

Referring to FIG. 3 step 310, the Fulfillment System 150 determines from the Seeker the type of URGS sought—in this example: urgent helicopter commuter service.

In step 320, the Fulfillment System 150 determines the Seeker's Locale. In this example, the Seeker's Locale is determined by the System 150 via GPS support in his “smart phone” to be Alameda, Calif.

In Step 330, the Fulfillment System 150 examines its Database 158 and determines that the corresponding type of Provider sought is: a helicopter operator. In this example, the Fulfillment System 150 uses the Provider's heliport location specified in each Provider's Profile in the Database 158 as that Provider's Locale. Each Provider's Locale, so determined, is compared to the Seeker's Locale—Alameda—to determine if a given Provider is proximate. A set of proximate Providers is accumulated in this fashion by the Fulfillment System 150. The System 150 examines the Database 158 for helicopter operators and identifies four Providers proximate to Alameda.

Referring to step 340, the Fulfillment System 150 further vets the potential Providers. FIG. 4 shows step 340 in greater detail. Referring to step 430, each of the potential Providers is vetted based on a comparison of preferences—preset by the Seeker in the Seeker's Profile in the Database 158—against a Provider's characteristics found in the Provider's Profile. One helicopter operator is found to be currently unavailable and is vetted accordingly. This leaves three potential Providers.

In step 460, for each potential Provider, the Provider is vetted based on the Provider's willingness to accept the Seeker. Such willingness is determined by a comparison of preferences—preset by the Provider in the Provider's Profile in the Database 158—against the Seeker's characteristics found in the Seeker's Profile in the Database 158. Lee has sterling credit and five major credit cards. He is acceptable to all of the Providers.

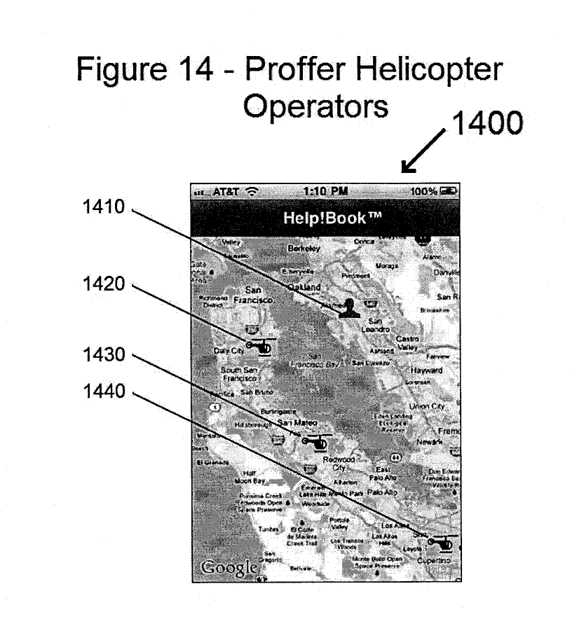

Referring to FIG. 3 step 350—the Fulfillment System 150 has three potential Providers to display to Lee, so he can select one from them—one in Brisbane, the second in San Carlos, and the third in Santa Clara. FIG. 14 provides an example of what the display may look like on Seeker Lee Nelson's mobile communication device. Shown there are four icons. The human head and shoulders silhouette icon 1410 represents Lee's Locale in Alameda. The three helicopter outline icons represent the three potential URGS Providers—the helicopter operators in Brisbane 1420, San Carlos 1430, and Santa Clara 1440, respectively.

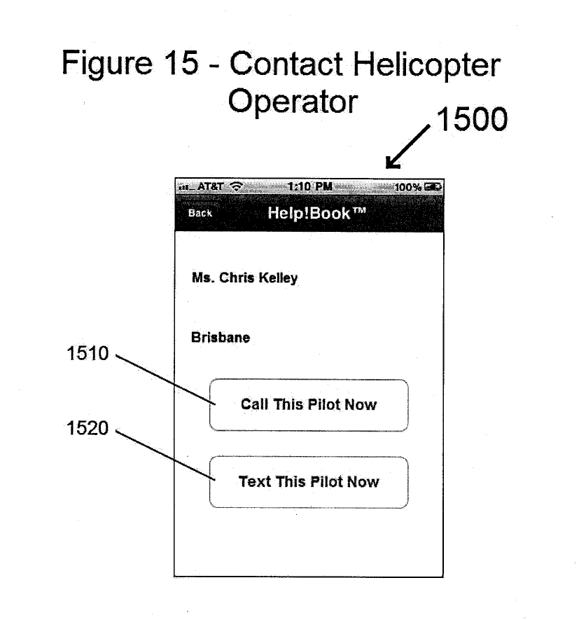

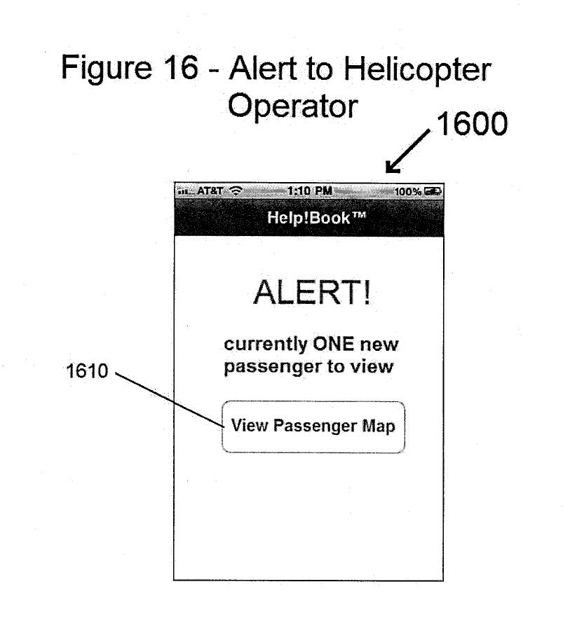

In FIG. 2 step 240, the Seeker selects an URGS Provider from the three potential Providers proffered by the Fulfillment System 150. In this example, the Seeker Lee selects the closest Provider—based in Brisbane—by actuating the virtual button represented by the icon 1420 in FIG. 14. In this instance, the Helicopter operator—Chris Kelley—has preset her preferences in her Provider Profile in the Database 158 such that the System 150 prompts the Seeker—Lee—to contact Ms. Kelley, as shown in FIG. 15, by the actuating the virtual button 1510 to phone or the virtual button 1520 to text directly from his mobile communication device. At the same time, the Fulfillment System 150 sends Ms. Kelley a notice to her mobile communication device—see FIG. 16-alerting her to expect to be contacted by a Seeker—Lee Nelson.

The Fulfillment System 150 can facilitate communication between Seeker and Provider, by either providing contact information for the Provider or—as in this example—providing a facility to contact the Provider directly. In this instance, Lee telephones Ms. Kelley by actuating the virtual button 1510 which causes his mobile communication device to place the phone call directly. The Fulfillment System 150 is not a party in the conversation between the Seeker Mr. Lee Nelson and the URGS Provider Ms. Chris Kelley—helicopter operator.

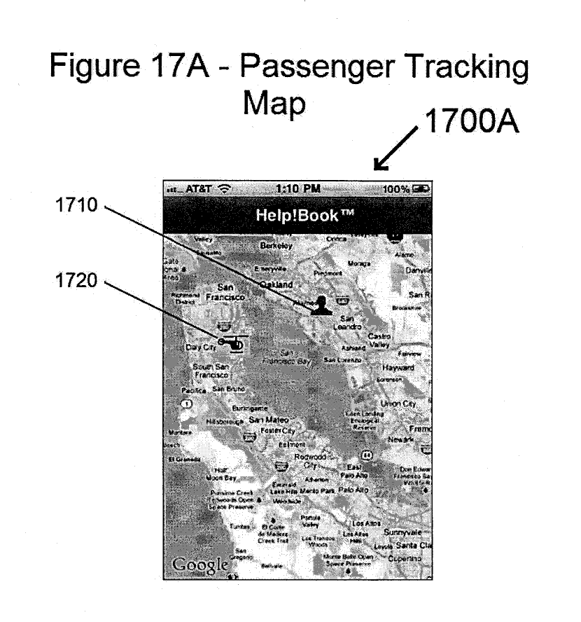

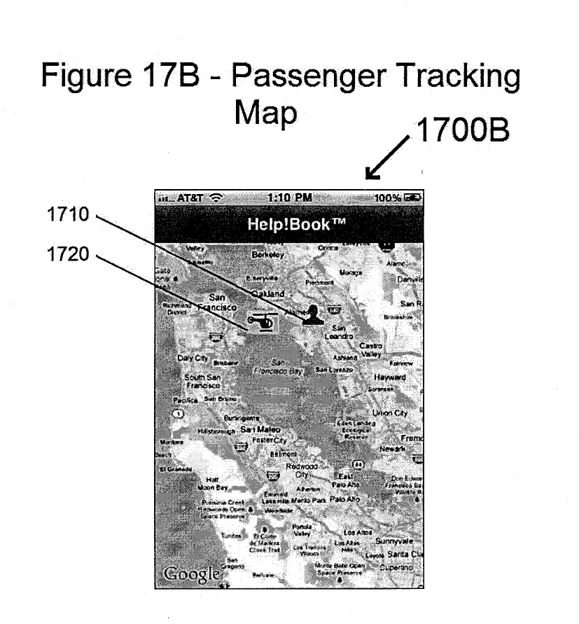

Referring to FIG. 16, the Provider—having been alerted to expect to be contacted by a new Seeker—can view the Locale of the new Seeker by actuating the virtual button 1610, which Ms. Kelley does. In this example, the Fulfillment System 150 responds by displaying FIG. 17A, which Provider Ms. Kelley can examine to see geo-location information the System 150 has on URGS Seekers she may intend to travel to—in this instance, only Mr. Nelson. The tracking map includes a single head and shoulders silhouette icon—1710—representing the new Seeker—Lee Nelson—whose Locale the Fulfillment System 150 displays in Alameda.

Ms. Kelley's mobile communication device rings with the call from Lee Nelson—Ms. Kelley answers. They discuss Lee's urgent need for an immediate helicopter ride to Palo Alto; go over compensation and any final details necessary to be certain that Mr. Nelson is at the correct location at the airport in Alameda; and agreeing to the fare, set up to meet at Lee Nelson's Locale in Alameda.

In step 260, the Fulfillment System 150 starts ongoing tracking of the Provider as the Seeker awaits the Provider's arrival. Referring to FIG. 17B, the Fulfillment System 150 periodically updates a tracking map—as it may appear on Provider Chris Kelley's mobile communication device—to reflect changes in the Locale of the Seeker and/or Provider. In the example, Lee Nelson's icon 1710 has not moved, but Ms. Kelley's icon 1720 is now substantially closer to Seeker Lee Nelson's Locale in Alameda.

In step 270, the Fulfillment System 150 facilitates compensation by logging the transaction that has just occurred whereby Seeker Lee Nelson selected Provider Ms. Kelley—the helicopter operator. Both Ms. Kelley and Lee Nelson may subsequently look up the Transaction Log record.

Referring to step 280—in this example, Ms. Kelley's Provider Profile in the Database 158 is not preset for the Fulfillment System 150 to facilitate follow-ups. However because the Transaction Log record is available to Ms. Kelley, she can follow-up with Lee Nelson if she chooses to do so. In this case she does follow up promptly—step 280—because she would like referrals and hopefully a repeat customer. She subsequently revises her Provider Profile to facilitate follow-ups.

The Fulfillment System 150 facilitates Loyaltization—step 290—as described above.

### Scenario C—the Seeker and the Provider Both Travel to a Rendezvous Location

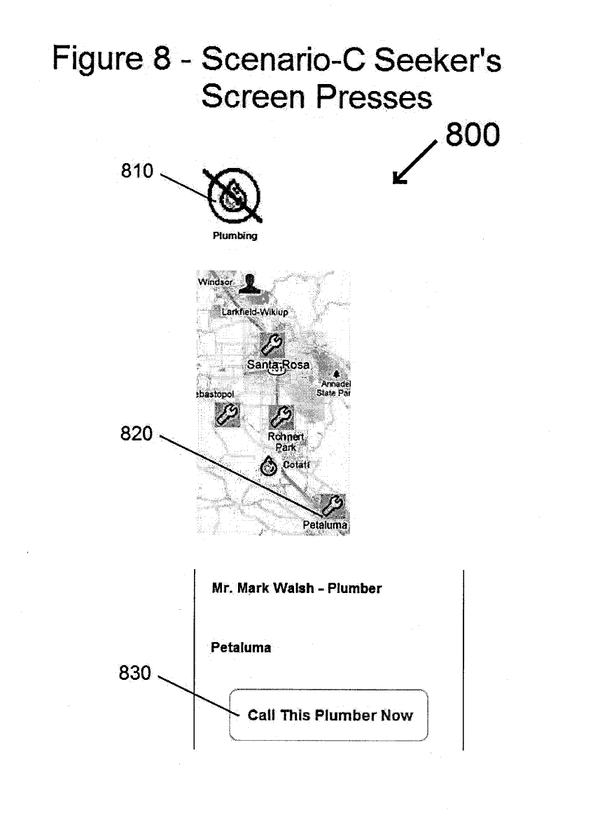

To illustrate the scenario of a Seeker and a Provider both traveling to a rendezvous location, the Seeker is imagined to be a landlord—Rick Sawyer—who has a leaking pipe at a rental home; the URGS is urgent plumbing repair; and the URGS Providers are plumbers. Referring back to FIG. 8, it is possible for the Seeker to use a small number of virtual button actuations to: 1) select URGS (plumbing services)—810; 2) select a Provider (plumber)—820; and 3) contact that Provider (plumber)—830.

FIG. 2, step 230, the Fulfillment System 150 works to proffer Providers of the type the Seeker requires. FIG. 3 details an embodiment of step 230.

Referring to FIG. 3, step 310, the Fulfillment System 150 determines from the Seeker the type of URGS sought—in this example: urgent plumbing.

Referring to step 320, the Fulfillment System 150 determines the Seeker's Locale. In this example, the Seeker is not at the location where the URGS need to be provided—i.e., the rental home with the leaking pipe. Rick Sawyer, the Seeker, enters the address of the rental home—located in Cotati, Calif.—into the Fulfillment System 150. The Fulfillment System 150 processes the address to derive a geo-location and puts both the address and the corresponding geo-location into the Database 158 to set the rendezvous location.

At Step 330, the Fulfillment System 150 examines its Database 158 and determines that the corresponding type of Provider sought is: a plumber. In this example, the System 150 uses the plumber business location specified in each Provider's Profile in the Database 158 as that Provider's Locale. Each Provider's Locale is compared to the rendezvous location—Cotati—to determine if a given Provider is proximate. A set of proximate Providers is figured accordingly by the Fulfillment System 150. Processing plumbers in the Database 158, the System 150 identifies ten Providers proximate to Cotati.

Referring to Step 340, the Fulfillment System 150 further vets the potential Providers. FIG. 4 details an embodiment of the vetting process.

In Step 430, each of the potential Providers is vetted based on a comparison of preferences set by the Seeker in the Seeker's Profile in the Database 158—against a Provider's characteristics set in the Provider's Profile. Rick Sawyer's Seeker Profile indicates that he requires a English-speaking Provider. The Fulfillment System 150 rejects one of the potential Providers because their Profile in the Database 158 does not include English as one of the languages spoken by that plumber. Rick also requires licensed and bonded contractors—all potential Providers comply. Additionally, Rick's Seeker Profile contains a preference for a work guarantee. Two of the potential Providers do not have “work guaranteed” selected in their Profiles, and as a result are rejected by the System 150.

In Step 460, for each potential Provider, the Provider is vetted based on the Provider's willingness to accept the Seeker. That willingness is determined based on a comparison of preferences—the Provider's preferences expressed in the Provider's Profile in the Database 158-against the Seeker's characteristics preset in the Seeker's Profile in the Database. Three potential Providers have indicated preferences for payment specifically in cash. Rick's Seeker Profile reflects his preference to pay by check or credit card—but not cash. Therefore, the Fulfillment System 150 rejects these three additional potential Providers. Four remaining Providers accept check or credit payment—so they pass the vetting process.

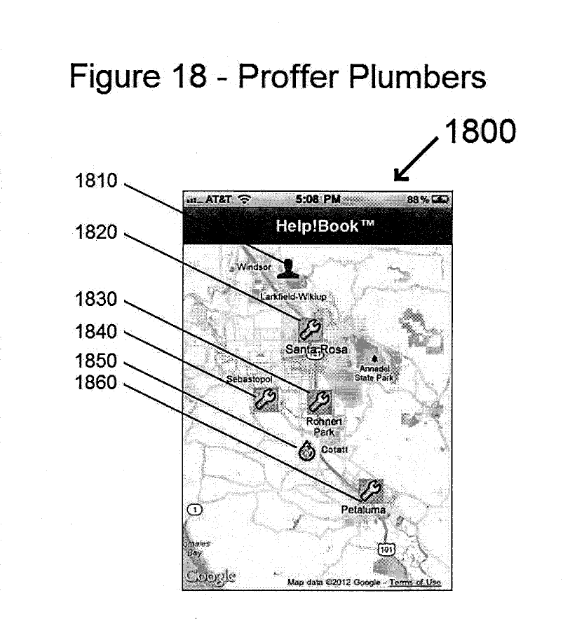

Referring to FIG. 3, step 350, the Fulfillment System 150 has four potential Providers to display to Rick, to allow him to select one of them. One Provider has an office in Sebastopol, the second is based in Santa Rosa, the third works from Rohnert Park, and the fourth has a storefront in Petaluma. FIG. 18 shows a display of proffered Providers as it may appear on Rick's mobile communication device. There are six icons shown. The human head and shoulders silhouette icon 1810 represents Seeker Rick Sawyer's Locale—currently at work in Windsor, where he received the distressed call from his tenant. The four wrench-outline icons represent the potential URGS Providers—the plumbers—in Santa Rosa 1820, Sebastopol 1840, Rohnert Park 1830, and Petaluma 1860. The water drop icon 1850 denotes the rendezvous location in Cotati where the leak is.

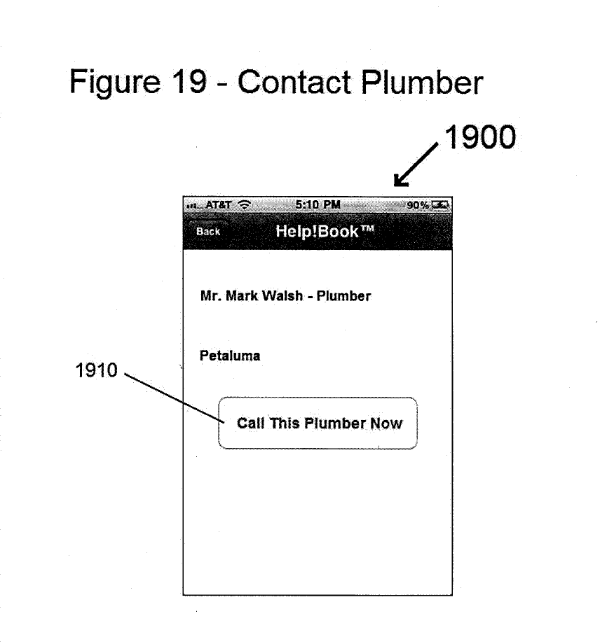

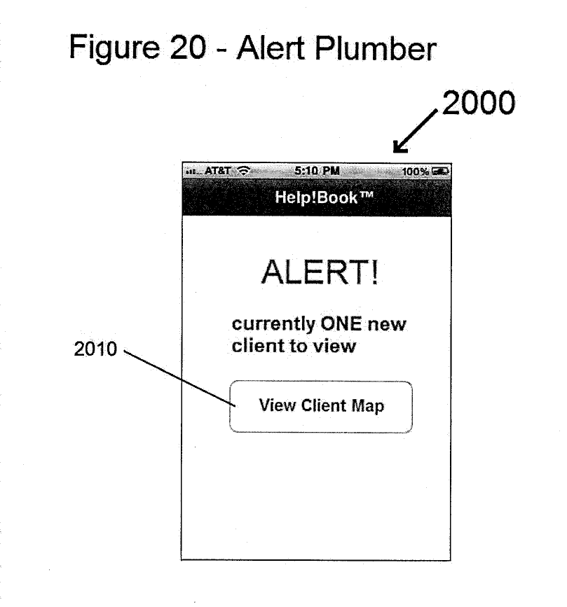

In FIG. 2, at step 240, the Seeker selects a Provider from the four choices proffered by the Fulfillment System 150 in this example. Rick selects the Provider in Petaluma by tapping on the icon 1860 in FIG. 18. The Provider (plumber) in this example—Mark Walsh—has set up his preferences in his Provider's Profile in the Database 158 so that the System 150 prompts the Seeker—Rick—to contact Mark, as shown in FIG. 19. Actuating the virtual button 1910 telephones from Rick's mobile communication device to Mark's. Mark's Provider Profile does not indicate an address for texting, so that option is not offered to Rick. The Fulfillment System 150, sends the Provider Mark a notice to his mobile communication device—see FIG. 20-alerting him to expect to be contacted by a Seeker—Rick Sawyer.

The Fulfillment System 150 can facilitate communication between Seeker and Provider, by either providing contact information for the Provider or—as in this example—providing a facility to contact the Provider directly. In this instance, Rick telephones Mark by actuating the virtual button 1910 which causes his mobile communication device to place the phone call directly. The Fulfillment System 150 is not a party in the conversation between the Seeker Rick and the URGS Provider Mark Walsh.

Referring to FIG. 20, the Provider—having been alerted to expect to be contacted by a new Seeker—can view the Locale of the new Seeker by actuating the virtual button 2010, which Mark Walsh chooses not to do. Instead, he waits for the Seeker to phone. Mark's mobile communication device rings with the call from Rick Sawyer—Mark answers. They discuss the leaking pipe problem and also other work Rick would like done. They discuss Mark's availability, how he guarantees his work, and what his labor rate is. They agree to the work, and arrange to rendezvous at the rental home in Cotati.

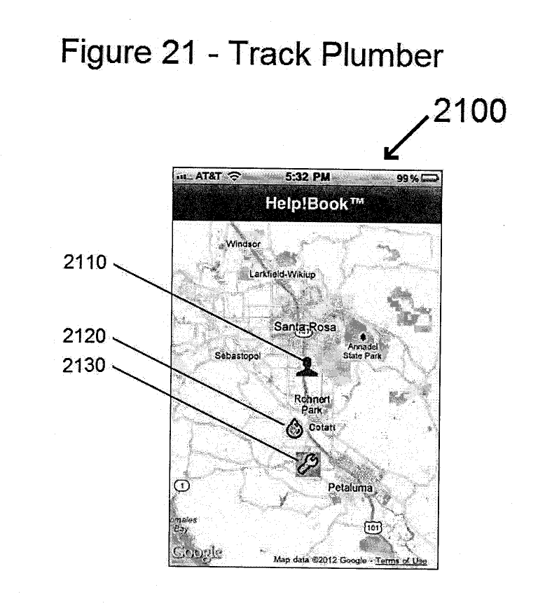

In step 260, the Fulfillment System 150 starts ongoing tracking of the progress of the Provider and/or the Seeker both traveling to meet at the rendezvous location. Referring to FIG. 21, the Fulfillment System 150 periodically updates a tracking map—as it may appear on Seeker Rick Sawyer's mobile communication device—displaying the updated Locales of both the Seeker and Provider.

Referring to step 270, the Fulfillment System 150 facilitates compensation by logging the transaction whereby Seeker Rick Sawyer selected Provider Mark Walsh. Both Seeker and Provider can subsequently look up the Transaction Log record. Each can separately associate additional annotation with the Transaction Log. The Seeker and Provider annotations are separate and private to Seeker and Provider, respectively. They have no indication of, or access to, each other's annotations. In this example, Rick makes notes on the verbal guarantee he received from the Provider Mark. Separately, Mark records the details of the work done including time and materials and the amount charged to the Seeker's credit card.

In step 280, the Fulfillment System 150 facilitates follow-up. Mark's Provider Profile in the Database 158 indicates that the Fulfillment System 150 may, at a set number of days subsequent to a given transaction, prompt him to follow-up with the Seeker—in this case Rick Sawyer. The corresponding annotated Transaction Log reminds him of details of his work for the Seeker that are useful in conducting the follow-up. Mark may add further annotation to the Transaction Log to record the results of a given follow-up.

The Fulfillment System 150 facilitates Loyaltization—step 290. Mark has handled a large number of Seeker's URGS requests and has gotten consistently high ratings for quality and promptness. Accordingly, the Fulfillment System 150 improves the weighting in Mark's Provider Profile so as to increase his ranking and therefore likelihood of selection in the future. In some embodiments, the System 150 notifies the Provider of such improvement in weighting/ranking

Scenario D—Seeker and Provider Both Travel Until they Converge

To illustrate the scenario of a Seeker and a Provider both traveling towards each other—without a fixed rendezvous location—until they converge, the Seeker is imagined to be a baseball fan—Judy Piper—who has arrived at the stadium with her son Bobby on his birthday, but has tickets for the wrong day; the URGS are two tickets for today's baseball game; and the URGS Providers are same-day ticket sellers.

FIG. 2, step 230, the Fulfillment System 150 works to proffer Providers of the type the Seeker requires. FIG. 3 details an embodiment of step 230.

Referring to FIG. 3, step 310, the Fulfillment System 150 determines from the Seeker the type of URGS sought—in this example: two same-day baseball tickets.

Referring to step 320, the Fulfillment System 150 determines the Seeker's Locale. In this example, the Seeker is in the North parking lot of the baseball stadium as geo-located by her “smart phone.”

At Step 330, the Fulfillment System 150 examines its Database 158 and determines that the corresponding type of Provider sought is: a same-day ticket seller. In this example, the Fulfillment System 150 uses the geo-location determined from a given Provider's “smart phone” to determine that Provider's Locale.

Each Provider's Locale is compared to the Seeker's Locale to determine if a given Provider is proximate. A set of proximate Providers is figured accordingly by the Fulfillment System 150. Processing same-day ticket sellers in the Database 158, the System 150 identifies twelve Providers proximate to Judy's Locale at the baseball stadium.

Referring to Step 340, the Fulfillment System 150 further vets the potential Providers. FIG. 4 details an embodiment of the vetting process.

In Step 430, each of the potential Providers is vetted based on a comparison of preferences set by the Seeker in the Seeker's Profile in the Database 158—against a Provider's characteristics set in the Provider's Profile. Judy Piper's Seeker Profile indicates that she requires a positive proof of identification. Six of the potential Providers do not have “will prove identity” selected in their Profiles, and as a result are rejected by the Fulfillment System 150.

In Step 460, for each potential Provider, the Provider is vetted by the Fulfillment System 150 based on the Provider's willingness to accept the Seeker. That willingness is determined based on a comparison of preferences—the Provider's preferences expressed in the Provider's Profile in the Database 158—against the Seeker's characteristics preset in the Seeker's Profile in the Database 158. Four potential Providers have indicated preferences for payment specifically in either cash or by credit card. Judy's Seeker Profile reflects her need to pay by check—not credit card nor cash. Judy assumes she isn't carrying sufficient cash and is not about to give out her credit card info to a stranger in a stadium parking lot. The System 150 rejects these four additional potential Providers. Two remaining Providers accept checks—so they pass the vetting process.

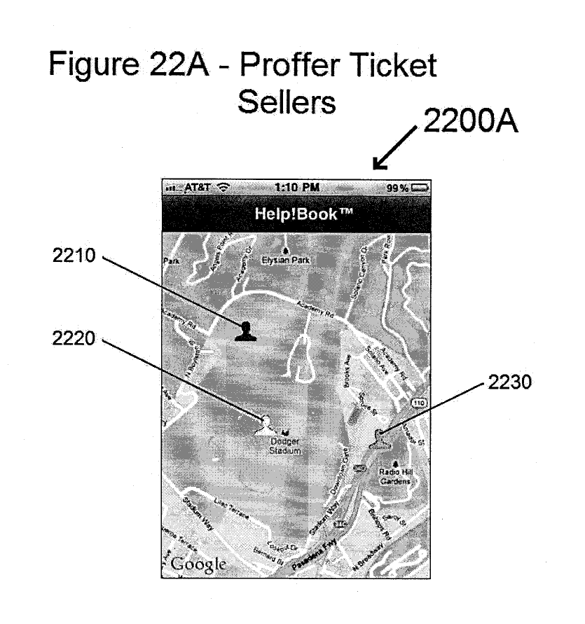

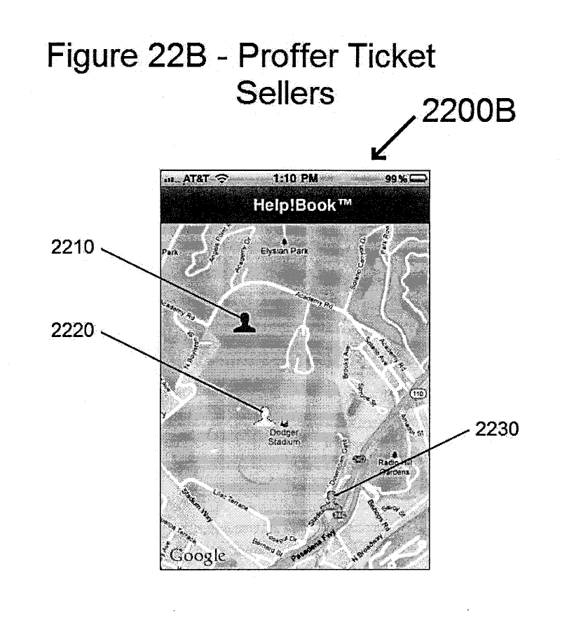

Referring to FIG. 3, step 350, the Fulfillment System 150 has two potential Providers to display to Judy, to allow her to select one of them. One Provider is in the West parking lot of the baseball stadium. The other Provider is caught in traffic a few blocks from the stadium. FIG. 22A shows a display of proffered Providers as it may appear on Judy's mobile communication device. There are three icons shown. The blue human head and shoulders silhouette icon 2210 represents Judy's Locale in the North parking lot. The yellow human head and shoulders silhouette icon 2220 represents the Locale of the Provider in the West parking lot. The violet human head and shoulders silhouette icon 2230 represents the Locale of the other Provider—still approaching the stadium.

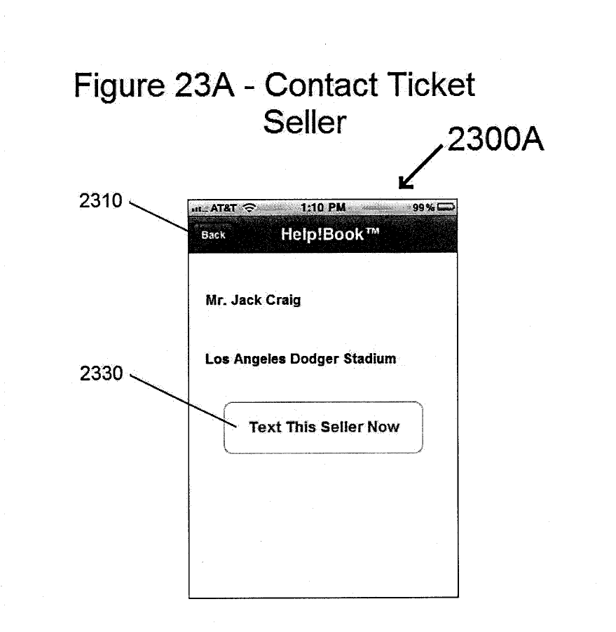

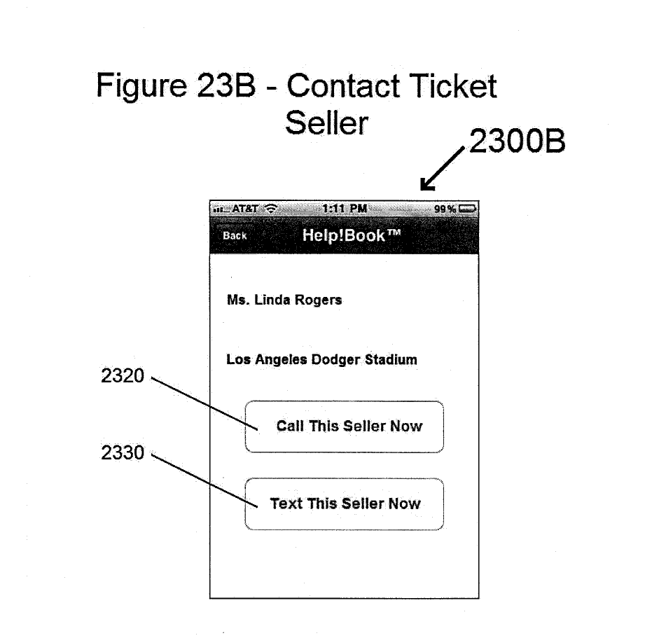

In FIG. 2, at step 240, the Seeker selects a Provider proffered by the Fulfillment System 150—one of two choices in this example. Judy selects the “yellow” ticket seller by tapping on the icon 2220 in FIG. 22A. The Provider in this example—Jack Craig—has set up his preferences in his Provider's Profile in the Database 158 so that the Fulfillment System 150 prompts the Seeker—Judy—to contact Jack, as shown in FIG. 23A. Jack's Provider Profile does not indicate a phone number—only an address for texting. Judy's Profile could—but does not—indicate “no texting”.

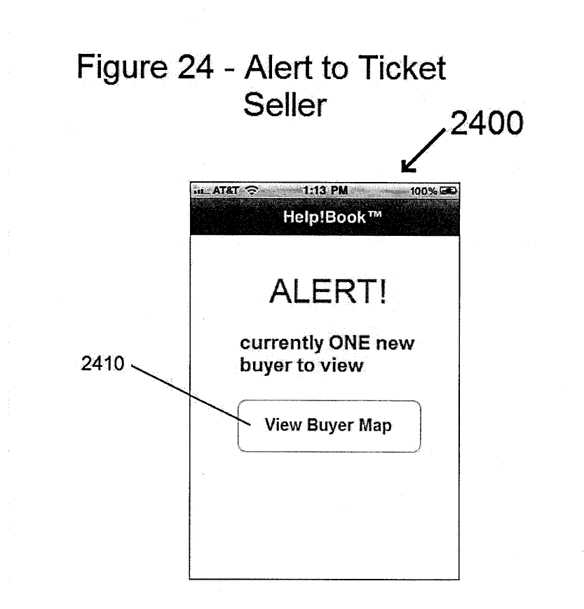

When Judy sees that Jack cannot be phoned, she immediately actuates the “back” virtual button 2310 that returns her to an updated Provider proffer display—FIG. 22B-where she taps the violet icon 2230. The fall back Provider in this example—Linda Rogers—has set up her preferences in her Provider's Profile in the Database 158 so that the Fulfillment System 150 prompts the Seeker—Judy—to contact Linda, as shown in FIG. 23B. Linda's Provider Profile provides both a phone number and a texting address. The System 150 sends Linda the ticket seller a notice to her mobile communication device—see FIG. 24—alerting her to expect to be contacted by a Seeker—Judy Piper.

The Fulfillment System 150 can facilitate communication between Seeker and Provider, by either providing contact information for the Provider or—as in this example—providing a facility to contact the Provider directly. In this instance, Judy telephones Linda by actuating virtual button 2320 which causes her mobile communication device to place the phone call directly. The Fulfillment System 150 is not a party in the conversation between the Seeker Judy and the URGS Ticket Seller Linda Rogers.

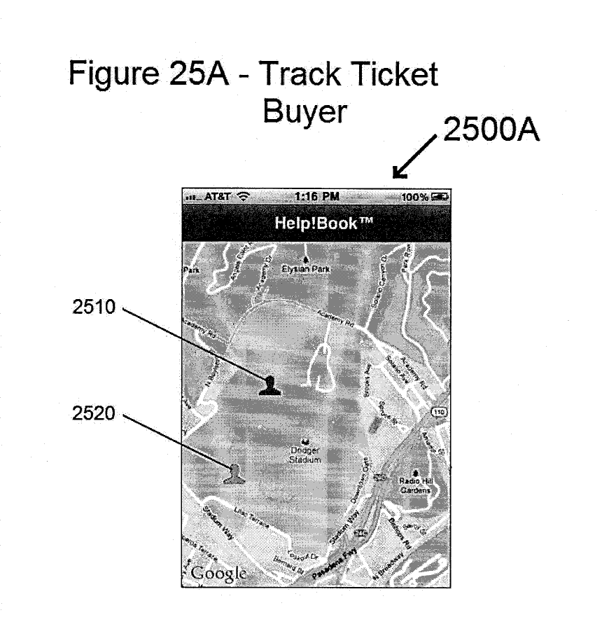

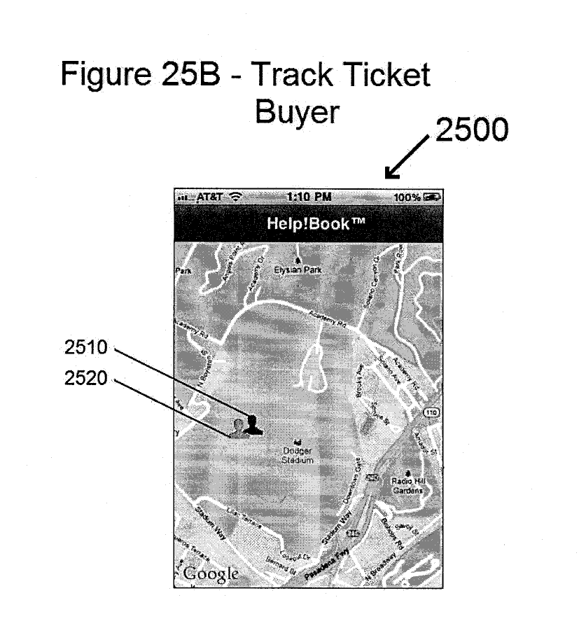

The Provider—see FIG. 24—having been alerted to expect to be contacted by a new Seeker—can view the Locale of the new Seeker by actuating the virtual button 2410, which Linda Rogers chooses to do. This displays a tracking map showing Seeker Judy's Locale as she walks toward the main gate of the stadium and Provider Linda's Locale as she is just pulling into the stadium parking lot—see FIG. 25A.

Linda's mobile communication device rings with the call from Judy Piper—Linda pulls over, parks, and then answers. Judy immediately explains her situation including limited cash. They negotiate a total sale amount—partially to be paid in cash and partially by check. Neither Judy nor Linda are familiar with stadium land marks, but they agree to walk in each other's direction as they both can see on instances of tracking maps on their respective mobile communication devices.

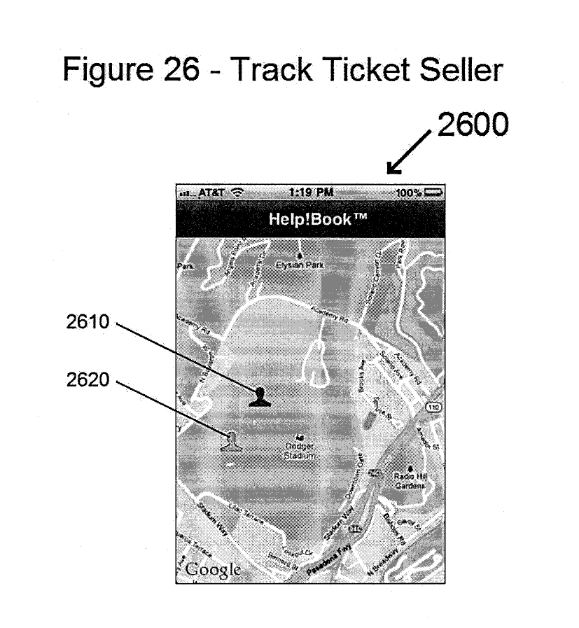

In step 260, the Fulfillment System 150 starts ongoing tracking of the progress of the Provider and/or the Seeker both traveling to meet at an ad hoc rendezvous location. Referring to FIG. 26, the System 150 periodically updates a tracking map as it may appear on Seeker Judy Piper's mobile communication device.

The Seeker and Provider continue walking roughly towards each other—each looking around and at their respective tracking map screens. Referring to FIG. 25B, the System 150 periodically updates a tracking map as it may appear on Provider Linda Roger's mobile communication device. As their geo-locations converge both “smart phones” send a loud audible alert. As they near, Linda sees a woman walking away from the stadium with a worried looking young boy in tow—both staring at a loudly sounding phone. Linda calls out to Judy. They walk towards each other, speak greetings, and then turn to head toward the stadium gate as they finish transacting their business.

Referring to step 270, the Fulfillment System 150 facilitates compensation by logging the transaction whereby the Seeker—Judy Piper—selected the Provider—Linda Rogers. Both Seeker and Provider can subsequently look up the Transaction Log record. Each can separately associate additional annotation with the Transaction Log. In this example, Judy will make a note of Linda's driver license number.

In step 280, the Fulfillment System 150 facilitates follow-up. Linda's Provider Profile in the Database 158 indicates “no follow-up”. Judy's Seeker Profile is set for a next day follow-up, which will turn out to be a brief but heartfelt thank you call.

The Fulfillment System 150 facilitates Loyaltization—step 290—as described above.

### III. Additional Enhancements

### Micro-Casting Distributed URGS Fulfillment System

A micro-casting distributed URGS fulfillment (“MCDUF”) system may typically operate as an intermediary facilitator in a distributed system that matches a seeker with an acceptable appropriate third-party provider of URGS (“Seeker” and “Provider” respectively). Micro-casting provides a highly responsive urgency-mediated regime for URGS fulfillment—directing individual system interactions with a given user (i.e., Seeker or Provider) based in part on evolving assessments of user needs, temperament, condition, and circumstance. A MCDUF system utilizes systems and methods of on-going urgency monitoring, measurement, evaluation and adjustment to provide an individually tailored experience that continually and iteratively adapts in real time to a given Seeker's sense of urgent need and/or a given Provider's business and/or other needs.

In order to succeed commercially, the MCDUF system must be satisfactory to both Seekers and Providers; accordingly, micro-casting may concurrently accommodate the requirements of both Seekers and Providers. However, that said, there may be a substantial asymmetry between the requirements, expectations and time-of-use temperaments of Seekers and Providers. To a Provider, the MCDUF system may be viewed as if it were a type of targeted advertisement and/or lead generation facility—even though it may provide much more service than that. Immediate results may have a very positive effect; yet ongoing longer-term sourcing of additional business may perhaps be more likely to cause a Provider to become not only a dedicated user, but also a positive recommender. Therefore, the MCDUF system additionally may have facilities for satisfying and retaining Providers by determining, measuring and individually fulfilling their needs. For example, scheduling and maintaining a schedule of availability may be an annoying, if not onerous, task for a busy Provider; therefore the MCDUF system provides numerous facilities for simplifying and automating availability and notifications.

To better understand embodiments of a MCDUF system, it is useful to understand the positive user experiences and behaviors such a system is intended to engender and sustain. Perhaps the most direct way of doing that is to consider first the Seeker experience, then the Provider experience and then their combined experiences in exemplary MCDUF system embodiments. In some instances, the facilities and functions of a MCDUF system may be nearly indistinguishable between user types such as Seeker and Provider. In such instances a Seeker and/or Provider may simply be referred to as a “user”. Additionally, other third party “utilizers” such as data providers (e.g., vendor rating sites) and data acquirers (e.g., credit agencies) may utilize facilities of the MCDUF system.

As a distributed system, a MCDUF system may in a multiplicity of embodiments utilize a client-server architecture, or a peer-to-peer architecture, or various hybrid combinations of both. MCDUF system client logic may operate on a variety of remote devices or systems, but perhaps most commonly on a mobile device kept in the personal possession of a user. Typically, MCDUF system client logic for a mobile device may be in the form of an application program (or in common parlance an ‘app’) that either executes natively or in a Web browser hosted on that device, i.e., a “native app” or a “web app” respectively. For simplicity, the description that follows refers to the client logic operating on a Seeker client system/device as the “Seeker device client” or just “Seeker's app”; and the equivalent Provider client logic as the “Provider device client” or “Provider's app”. Although ‘apps’ are most commonly associated with mobile devices, in the description that follows, the terms “Seeker app” and “Provider app” also apply to MCDUF system client logic running on a non-mobile device or system such as a desktop PC. In some embodiments, a MCDUF system client may be embedded in the operating logic of a device or system, but for simplicity, such embodiments are also intended to be encompassed by the term “app”.

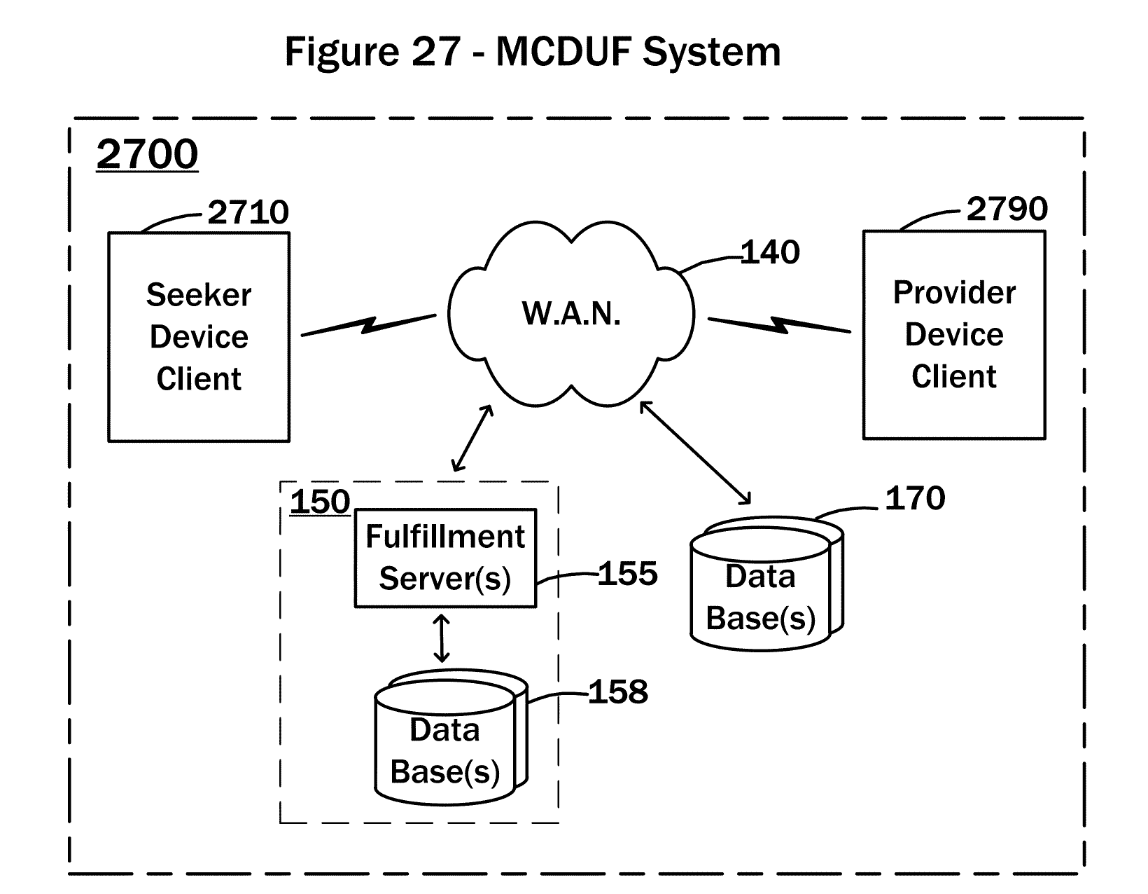

FIG. 27 provides a structural block diagram for an example of a MCDUF system 2700 in accordance with an embodiment of the present invention. Such a MCDUF system 2700 may consist of a multiplicity of: Seeker device clients 2710 (i.e., Seeker's apps), Provider device clients 2790 (i.e., Provider's apps), a wide area network infrastructure 140 (composed of one or more networks), an URGS fulfillment system 150 (including fulfillment server(s) 155 and data base(s) 158), and additional network accessible data base(s) 170 that may be operated by third parties such as, for example, financial institutions and/or rating agencies.

As communication technologies rapidly evolve, a plethora of new devices running a Seeker device client 2710 and/or Provider device client 2790 may operate together in the computerized and network-interconnected MCDUF system 2700. Nonetheless, the basic characteristics of such user devices may share common features including: facilities to communicate over wide area networks 140 with the URGS fulfillment system 150; facilities to obtain input from users; and facilities to present system output to users. Furthermore, a new generation of innovation may provide measurements such as perspiration, pulse, blood pressure, blood sugar level, pupil dilation, respiration rate, skin conductivity and voice pitch that may be particularly useful as additional forms of input—particularly when assessing the status of an individual Seeker or Provider. Wearable or implanted devices are already on the market or in development—for example ‘Smart Glasses’ and ‘Smart Watches’. Overall, the trend in personal electronic devices and systems is toward being smaller; processing faster; having more and better sensors; serving a wider variety of applications; storing and processing larger data; and residing more continuously and in closer proximity to the user's body. The adaptive and user-specific nature of the MCDUF system 2700 may anticipate leveraging such improvements on a user-by-user basis as they come into use.

As described above, a number of facilities may be provided by a user's client device that may be utilized to measure the user's circumstance including the user's sense of urgency. For example, the user's client device may provide a date/time indication, which may be measured in a granularity as fine as milliseconds. Such a facility may be utilized to provide measurements such as “date/time stamping” and “elapsed response time”. Date/time stamping may for example provide information that is included in a “transaction log” by the MCDUF system 2700, wherein such a transaction log may record interaction with a given user in an information repository such as data bases(s) 158. Elapsed response time may for example be utilized to measure the difference in time between when a screen is displayed to the user and when that user enters a corresponding response such as pressing a virtual button to make a selection or entering requested information. The relative length or shortness of elapsed response time may be utilized by the MCDUF system 2700 as a measure of the user's sense of urgency. Elapsed response times may be accumulated to get an ongoing measurement of the user's sense of urgency. In some instances, the elapsed response times may shorten perhaps indicating that the user may be feeling increased urgency or other distress. Or the elapsed response times may be lengthening perhaps indicating that the user may be feeling less distress. Elapsed response times may be compared against earlier measured elapsed response times for the same user and/or against elapsed response times measured for one or more other users or perhaps against other ‘benchmark’ response time data.

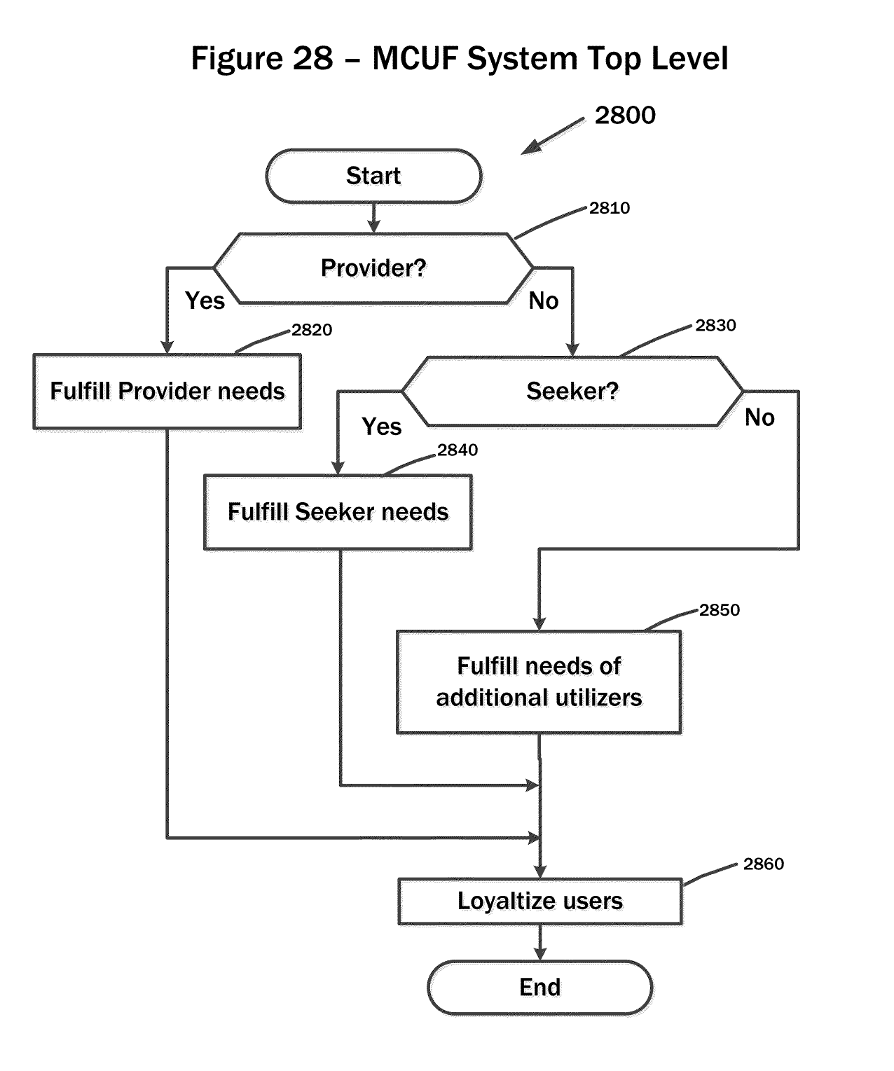

FIG. 28 provides a top level logic flow diagram for some embodiments of a MCDUF system 2700. Referring to FIG. 28, the MCDUF system 2700 may serve to fulfill the needs of several system-differentiated service classes of users/utilizers: i.e., Seekers, Providers and “third party utilizers”. To best serve each class of users/utilizers the MCDUF system 2700 may associate a specific service class with a given user/utilizer. In some embodiments such association may be automatically determined based on the facility utilized to access the MCDUF system 2700. For example, a given user may utilize an app that is dedicated to Seekers or that is dedicated to Providers. Such a user perhaps may utilize a more general purpose app, common say to both Seekers and Providers, but provide information differentiatingly indicative that the user is a Seeker or is a Provider. For example, a user may select and successfully complete a Provider log-in sequence. In some embodiments, third party utilizers may interact via API facilities dedicated specifically to their class of utilizer. So for example, an API may provide a financial services company MCDUF system-mediated access to selected information corresponding to MCDUF system user(s). Further by example, a separate API may be used by the MCDUF system 2700 to acquire third-party information corresponding to a given MCDUF system user. In some embodiments, the same API may be utilized both to provide and to acquire information corresponding to MCDUF system user(s).

In some embodiments an URGS seeker may not be human—such as an animal or a device. In some embodiments an URGS seeker may be human, but not deemed fully legally competent—such as a child or a functionally-challenged adult. Additionally, in some embodiments, an URGS seeker may be ‘proxied’ by an individual or a device acting on the URGS seeker's behalf—for example, a neighbor may arrange an urgent plumbing appointment for an elderly neighbor (the URGS seeker) who may lack the skills and/or ability to operate a Seeker client device. Such an URGS-seeker-proxying or imitating entity may be termed a “proxy-seeker”. In some embodiments, a proxy-seeker may be undetected by the MCDUF system 2700. For example, a husband (the proxy-seeker) may make an urgent appointment for his wife (the URGS seeker) interacting with the MCDUF system as if he were his wife.

In some embodiments, a proxy-seeker may utilize the MCDUF system 2700 explicitly as a proxy-seeker. For example, a computerized controller in a network-connected appliance such as an ‘intelligent’ refrigerator may detect a fault that requires urgent service; or perhaps a human house sitter discovers that the refrigerator is no longer cold. Such a proxy-seeker may utilize the MCDUF system 2700 just as a Seeker would, but perhaps identify themselves (or itself) as a proxy-seeker seeking URGS on the URGS seeker's behalf (i.e., the refrigerator owner's behalf). In some instances, this may be done transparently to the MCDUF system 2700, wherein such proxy-seeker identifying information may be communicated directly to the Provider(s). Or in some embodiments, the MCDUF system 2700 may provide facilities (not shown) for an explicit “associate account” whereby a proxy-seeker may utilize the MCDUF system 2700 explicitly as a proxy-seeker so as to request URGS via proxy-seeker specific or adapted MCDUF system facilities. In some embodiments, non-human proxy-seekers may utilize alternative MCDUF system ‘machine’ facilities rather than the MCDUF system facilities for human URGS seekers. For example, the MCDUF system 2700 may support an “automated proxy-seeker facility” dedicated to exchanging digitally encoded messages with a refrigerator, home monitoring system or other ‘intelligent’ home appliance or system. In some embodiments, a MCDUF system 2700 may support a multiplicity of device-specific automated proxy-seeker facilities (not shown).

In some embodiments, an associate account may be affiliated with a registered Seeker's account and/or may be managed by a registered Seeker. Such an affiliated Seeker may be termed a “Master Seeker”. Furthermore, in some embodiments, the associate account may be configured so that the Master Seeker may be notified by the MCDUF system 2700 should an URGS request be made utilizing the associate account. Additionally, in some embodiments, the micro-casting facilities of the MCDUF system 2700 associated with Providers may be adapted in order to so notify a Master Seeker. For example, the Master Seeker may ‘appear’ to the MCDUF system 2700 to be a “virtual provider” with a priority micro-casting ranking such that the first URGS need request may be sent by the MCDUF system 2700 to the Master Seeker. Accordingly, as a virtual provider, a Master Seeker may utilize the same MCDUF system facilities intended to mediate and route URGS needs requests for Providers. Therefore, in some embodiments a Master Seeker may use MCDUF system 2700 Provider account management facilities such as those to maintain availability schedules and specify notification message routing.

The facilities provided by the MCDUF system 2700 may unintentionally or unknowingly allow a malicious individual to pose as a Seeker or as a proxy-seeker. Accordingly, in some embodiments, the MCDUF system 2700 may utilize authentication, encryption, secure dedicated link communication, device-to-account binding and other security mechanisms to deter or foil such malicious ‘spoofing’ attempts. In some embodiments, a proxy-seeker may be subject to account access controls similar to those for a Seeker—such as a unique proxy-seeker identifier and possibly a shared secret such as a password. In some embodiments, a proxy-seeker communications may be routed through and/or certificated by a third party. As opposed to potentially fraudulent URGS requests, even legitimate proxy-seeker URGS requests may create problems, disputes or liabilities for the Master Seeker; therefore, in some embodiments an associate account may be configured so as to limit the category(s) of URGS that the proxy-seeker may request. Furthermore, for each such Master Seeker-allowed URGS category, the Master Seeker may simply pre-approve it or alternatively may require notification and explicit Master Seeker approval per associate account-initiated URGS need request incident. In some embodiments, the MCDUF system 2700 may be configured to notify the Master Seeker, but not to issue associate account-initiated URGS need requests.

A proxy-seeker may utilize the MCDUF system 2700 facilitated by a Seeker app. Alternatively, in some embodiments, a proxy-seeker may utilize proxy-seeker specific client logic, i.e., a “proxy-seeker app” (not shown). Dedicated proxy-seeker apps may be devised for specific proxy-seeker devices, for example a proxy-seeker app may be devised for an ‘intelligent’ bread-maker so as to utilize the proxy-seeker facilities of the MCDUF system 2700.

At step 2810, a Provider may be distinguished from other service classes of users/utilizers.

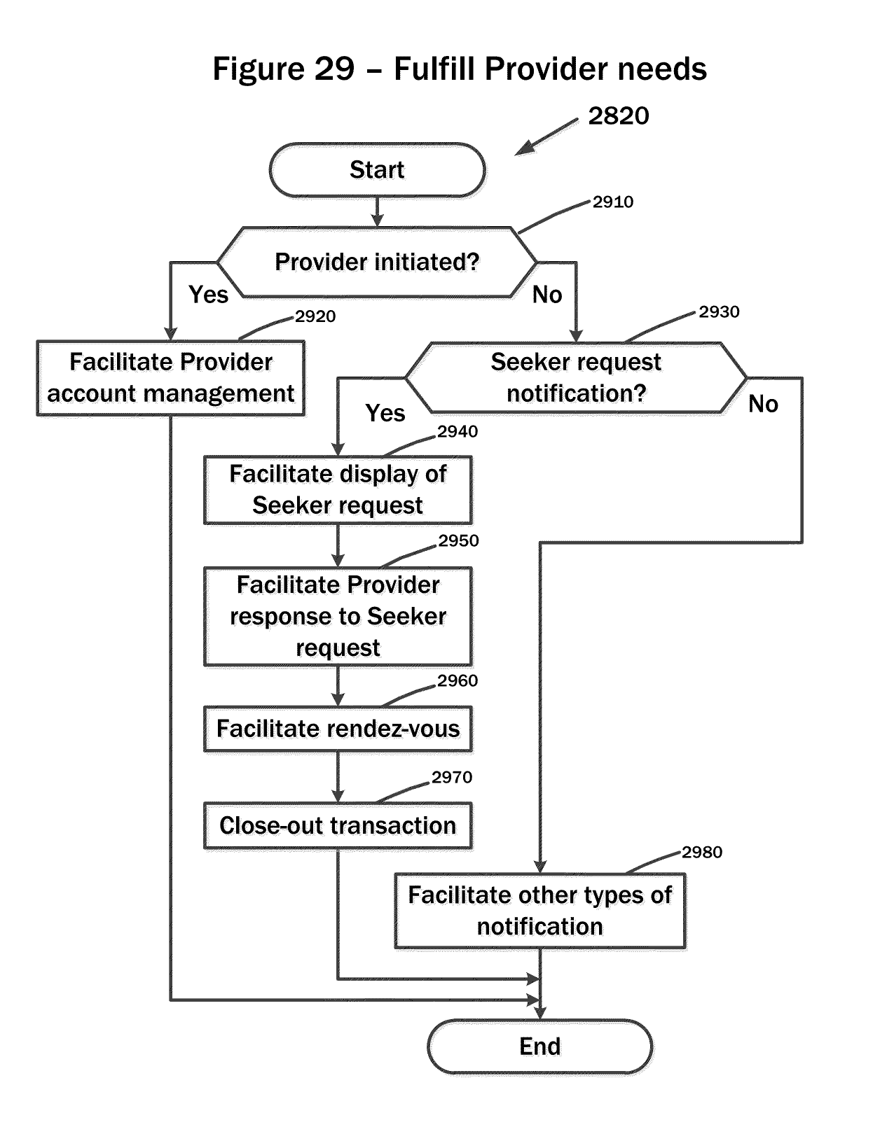

At step 2820, a Provider may be served in order to facilitate the Provider's utilization of the MCDUF system 2700. FIG. 29 shows some embodiments of step 2820 in greater detail. FIG. 29 is described further below.

At step 2830, a Seeker may be distinguished from other service classes of users/utilizers.

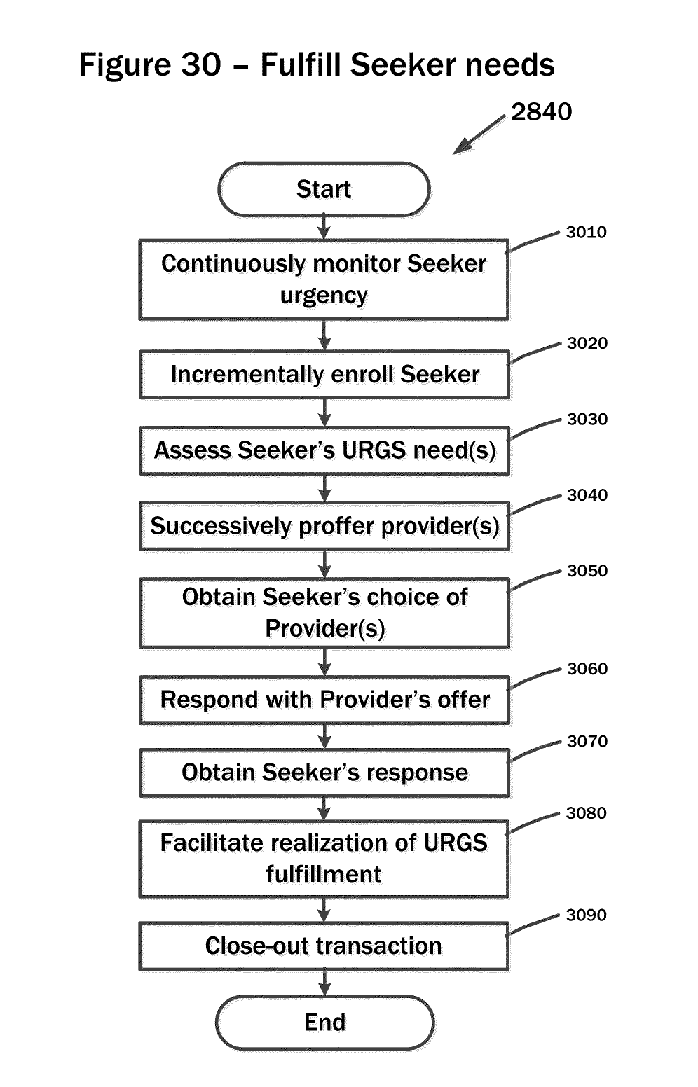

At step 2840, a Seeker may be served in order to fulfill that Seeker's URGS need(s). FIG. 30 shows some embodiments of step 2840 in greater detail. FIG. 30 is described further below.

At step 2850, the MCDUF system 2700 may fulfill the needs of additional utilizers. In some embodiments, the MCDUF system 2700 may provide services to other utilizers in addition to Seekers and Providers. For example, aggregated information about Seekers and/or Providers may be anonymized, aggregated and processed to provide useful statistical data to third parties such as trade organizations, consumer interest groups, government bodies, rating organizations, and many other parties that have interest in commercial transactions involving URGS.

Step 2860 is described further below.

FIG. 29 shows some embodiments of step 2820 in greater detail. Referring to FIG. 29 at step 2910, the MCDUF system 2700 may differentiate between MCDUF system operation initiated by the Provider and MCDUF system operation initiated by the MCDUF system (or otherwise) autonomous of the Provider. In some embodiments, the Provider may initiate MCDUF system 2700 operation via a log-in.

At step 2920, the MCDUF system 2700 may facilitate the Provider to manage the Provider's MCDUF system account. In some embodiments, the MCDUF system 2700 may gather information about a given potential provider in order to attempt to fulfill their needs to acquire customers. (Some embodiments of “Provider account management” may be described in detail further below in this document in the context of exemplary Provider app screen shots.)

At step 2930, the MCDUF system may differentiate between types of autonomous initiation of MCDUF system operation leading to Provider interaction. In some embodiments, such autonomously initiated MCDUF system interaction with a Provider may be facilitated utilizing an indication on the Provider's client device that some ‘event’ may have occurred that requires the Provider to utilize the Provider's app. The provider may then choose to cause the app to execute on the Provider's client device. This process of ‘alerting’ a user is a standard feature supported by most network attached computing devices. On a personal computer for example, a notification virtual window may open, or an application icon on the ‘screen icon tray’ may start ‘hopping’. On many mobile devices, the effected app's icon may be highlighted in some way that draw's the user's attention. For mobile devices, the industry term for such autonomously initiated user interaction is ‘push notification’. In order to alert a Provider that a Seeker has an URGS need that the Provider may have an opportunity to fulfill, in some embodiments, the MCDUF system 2700 may utilize such notification mechanisms as described above. For the purposes of this description, such notification may be termed a “Seeker request notification”; and may be applied agnostic to the type of Provider client device.

In some embodiments, other types of autonomously initiated Provider notifications may be utilized. Referring to FIG. 29, at step 2980, a notification other than a Seeker request notification may be facilitated by the MCDUF system 2700. For example, such a notification may be a ‘client follow-up alert’ or a ‘Provider review posting alert’. Many types of other notifications may be possible and directly related to the utilization of the MCDUF system 2700 by the Provider.

Additionally, in some embodiments, notifications may also be utilized in interactions with Seekers (not shown)—for example to facilitate a ‘follow-up appointment reminder’ or perhaps to provide a ‘Seeker review posting alert’.

The ‘Seeker-to-Provider match’ service(s) provided by the MCDUF system 2700 as part of URGS fulfillment may entail concurrent interactions with a given Seeker and corresponding Provider(s)—in a ‘back and forth’ fashion—as the MCDUF system 2700 intermediates between them. Therefore, as a conceptual aid, some MCDUF system embodiments as exemplified by FIG. 27 may be likened to the ‘multi-threaded execution’ of software in that there may be the conceptual equivalent of a ‘Seeker thread’ and ‘Provider thread(s)’ concurrently following logical paths through FIG. 28 (and therefore through FIGS. 30 and 29—further corresponding conceptually to a respective ‘Seeker thread’ and ‘Provider thread(s)’.)

To help illustrate the ‘back and forth’ intermediation of the MCDUF system 2700 in some embodiments, the following descriptions of respective flows through FIG. 29 and FIG. 30 are interleaved in ‘temporal sequence’. FIG. 30 shows some embodiments of step 2840 in greater detail

Referring to FIG. 30 at step 3010, the MCDUF system 2700 may periodically monitor Seeker urgency. In some instances, there may be a seeming divergence between the inherent urgency of a given Seeker's situation and that Seeker's own perception of urgency. The MCDUF system 2700 may take both “inherent urgency” and Seeker-perceived “experiential urgency” into account when serving a given Seeker. Inherent urgency may be measured in numerous ways including: time of day, distance to the nearest suitable URGS provider, travel conditions, weather conditions, and provider availability. Seeker-perceived experiential urgency may be measured in a multiplicity of ways including: the Seeker choosing to bypass extraneous queries, changes in Seeker voice pitch and volume, indicative vocabulary usage, and perhaps sudden violent movement of the mobile device. Some measurements such as Seeker pupil dilation, body temperature, blood pressure and pulse may reflect both inherent and Seeker perceived experiential urgency. Measuring Seeker urgency may begin in advance of any MCDUF system determination of the Seeker's URGS requirements and, in some embodiments, may begin before the Seeker initiates operation of the Seeker's app 2710.

Clearly, key components that may become increasingly important if not critical in measuring Seeker urgency as well as ascertaining Seeker URGS need(s) may be the set of sensors embedded in the Seeker's device and/or other sensors temporarily or persistently near the Seeker that may be MCDUF system accessible. For example, an office seating system with bio-feedback capability may intercommunicate with the Seeker device and provide bio-metric information measured by the chair's sensors. Such sensor-based measurement of the Seeker, whether by the Seeker device or by other sensors in the Seeker's environment, may be termed “Seeker instrumentation”. A more generic term—“instrumentation”—may apply to sensor-based measuring of MCDUF users, whether Seeker or Provider.

At step 3020, the MCDUF system 2700 may incrementally “enroll” the Seeker. Enrollment may include both acquiring user descriptive information (“registration”) and user selection of service-related preferences (“personalization”). A Seeker may be queried to obtain information that uniquely indentifies that user such as full name, phone number, e-mail address. Such a Seeker may be further queried to create a unique Seeker account user name and password. Such a registration process may be relatively straight forward and quick, yet a highly distressed Seeker may still find it burdensome. Consequently, in some embodiments, a Seeker may be given the option to bypass or postpone registration. In some embodiments, the MCDUF system 2700 may associate a unique identifier with the Seeker; for example, such a “Seeker ID” may be a multi-byte identifier assigned by the fulfillment server 155 (or perhaps the Seeker's app 2710) and stored for subsequent inclusion in transactions back and forth between the Seeker's app 2710 and the fulfillment server 155 of the MCDUF system 2700. In this way, a given Seeker may be distinguished from all other Seekers and yet potentially remain nominally anonymous.

Although it is useful and otherwise desirable to build a data base characterizing MCDUF system users, seemingly extraneous data gathering may annoy or even infuriate a distressed Seeker. Therefore in some embodiments, the MCDUF system 2700 may utilize various “en passant” approaches to collecting enrollment information from the Seeker. Such en-passant information gathering may include querying for specific item(s) of Seeker information when it seems directly applicable to helping immediately further meet the Seeker's URGS or other needs. Such incremental enrollment data gathering may be interspersed throughout the Seeker interaction with the MCDUF system 2700.

At step 3030, the MCDUF system 2700 may assess the Seeker's URGS need(s). Direct Seeker input may provide a primary source of URGS need information. The Seeker may be queried for a description of the needed URGS in a multiplicity of ways including, but not limited to a menu of selections, a Seeker typed description, a Seeker spoken description, as well as URGS need(s) deduced from Seeker instrumentation. Additionally, the MCDUF system 2700 may deduce a secondary set of URGS need(s) based on the Seeker's self-described URGS need(s). For example, the Seeker may indicate the urgent need for a dentist to treat a broken tooth. The MCDUF system 2700 may consequently deduce the secondary URGS need for pain medication. In some embodiments, the MCDUF system 2700 may make suggestions or recommendations to the Seeker and/or Provider based on the MCDUF system's assessment of the Seeker's URGS need(s).

In some embodiments, other facilities for identifying the Seeker's URGS need(s) may be utilized—for example, key word URGS search (not shown).

At step 3040, the MCDUF system 2700 successively proffers Providers. In some embodiments, the Seeker may be offered the choice to select and contact a specific individual Provider or to send out a ‘request for help’ to more than one Provider. A Seeker may be further facilitated in the Provider location process by a “search results map”—a map that may display the location of both the Seeker and pre-qualified Providers the Seeker may choose to contact.

At step 3050, the MCDUF system 2700 may obtain the Seeker's choice of Provider(s). In some embodiments, the MCDUF system 2700 may facilitate the Seeker to simultaneously request URGS from more than one Provider. In some embodiments, a MCDUF system-intermediated ‘back-and-forth’ between Seeker and Provider(s)—to work out details of fulfilling the Seeker's need—may follow step 3050.

Referring to FIG. 29 at steps 2910 and 2930 a MCDUF system initiated Seeker request notification may logically flow on towards step 2940.

At step 2940 in some embodiments, the MCDUF system 2700—utilizing the facilities of the Provider app 2790—may ‘alert’ the Provider so as to display the Seeker's URGS(s) request.

At step 2950 in some embodiments, the MCDUF system 2700—utilizing the facilities of the Provider app 2790—may acquire the Provider's response to the Seeker's URGS(s) request.

Referring once again to FIG. 30, at step 3060 in some embodiments, the MCDUF system 2700—utilizing the facilities of the Seeker app 2710—may display the response of the Provider (or multiple Providers) to the Seeker. Not all Providers may respond in the affirmative. Some Providers may not respond at all. In some embodiments, the MCDUF system 2700 may synthesize a response in lieu of a Provider responding.

At step 3070 in some embodiments, the MCDUF system 2700—utilizing the facilities of the Seeker app 2710—may obtain the Seeker's response to a given Provider's offer of URGS.

Referring both to FIG. 30 at step 3080 and to FIG. 29 at step 2960, the MCDUF system 2700 may facilitate the realization of URGS fulfillment of the Seeker by the URGS Provider. In instances where the Seeker may need to travel to the Provider—say to a dentist—the MCDUF system 2700 may display a “search result map”—utilizing the facilities of the Seeker app 2710—that may show the Provider's and Seeker's respective locations and that may be periodically updated. Similarly, if the Provider may need to travel the Seeker—the MCDUF system 2700 may display a “caller map”—utilizing the facilities of the Provider app 2790—that may show the Provider's and Seeker's respective locations and that may be periodically updated as the Seeker and Provider may approach and subsequently meet. In some embodiments, the MCDUF system 2700 may facilitate a rendezvous at a locale that may be other than either the Seeker's or the Provider's location at the time of the URGS need match—perhaps utilizing a ‘dropped pin’ on both the Seeker's search result map and the Provider's “caller map”. In some instances, the URGS may be goods rather than services. In situations where such goods may be shipped, the MCDUF system 2700 in some embodiments may interoperate with third party systems—for example United Parcel Service—to provide a shipment tracking map.

In some embodiments, post-acceptance communication between the Provider and the Seeker may be facilitated by the MCDUF system 2700 acting as a ‘man-in-the-middle’ proxy.

Such proxying may not only facilitate communication between the Seeker and the Provider, but may enable the MCDUF system 2700 to record details relating to such communication so as to substantiate the likelihood of a corresponding “billable moment” wherein a commercial transaction between the Seeker and Provider may be considered to have been consummated.

Referring to FIG. 29 at step 2970, the MCDUF system 2700 may close out the transaction for the Provider. In some embodiments, the services provided by the MCDUF system 2700 may be paid for by Providers on a per ‘successful transaction’ basis. Depending on the embodiment, a successful transaction may be considered to be a Seeker contacting the Provider to request URGS; or a Seeker accepting the Provider's offer of URGS; or a Provider fulfilling the Seeker's URGS need; or some other billable moment occurrence appropriate to the type of URGS. In some embodiments, all of the former three may be considered types or varying degrees of successful transactions. So for example, a Provider may be charged a small fee for each Seeker request, a larger fee for a Seeker's acceptance, and a more substantial fee based on URGS fulfillment. As with any endeavor wherein valuable services may be provided or exchanged, disputes may arise as to what may have (or may not have) transpired. Therefore, the MCDUF system 2700 may record information derived at each step of the interaction with a given Seeker and with a given Provider in the process of facilitating a match that may lead to successful URGS fulfillment. In some embodiments, the MCDUF system may make appropriate portions of such transaction records available to the Seeker and/or the Provider party to a given transaction. Furthermore, transaction information may be included in any billing statements provided to a Provider.

Referring again to FIG. 30, at step 3090, the MCDUF system 2700 may similarly close-out the transaction for the Seeker. In some embodiments, URGS fulfillment may be provided by the MCDUF system 2700 free of charge. In other embodiments, some sort of Seeker fee may apply. Regardless of whether a Seeker is subject to any fees, the MCDUF system 2700 may maintain a record of the transaction so as to assist the Seeker in resolving any corresponding dispute that may arise with the Provider or with the MCDUF system 2700 or both.

Referring again to FIG. 28, at step 2860, the MCDUF system 2700 may “loyaltize” users—both Seekers and Providers. In some embodiments, Seekers may receive various promotions and incentives such as discount coupons for subsequent use with the MCDUF system 2700. Provider's may be provided promotional opportunities and various premium services as part of their loyalty program participation. For example, Providers may be facilitated to offer premiums—for example discount coupons—as part of offers to Seekers or perhaps rewards for Seekers' business.

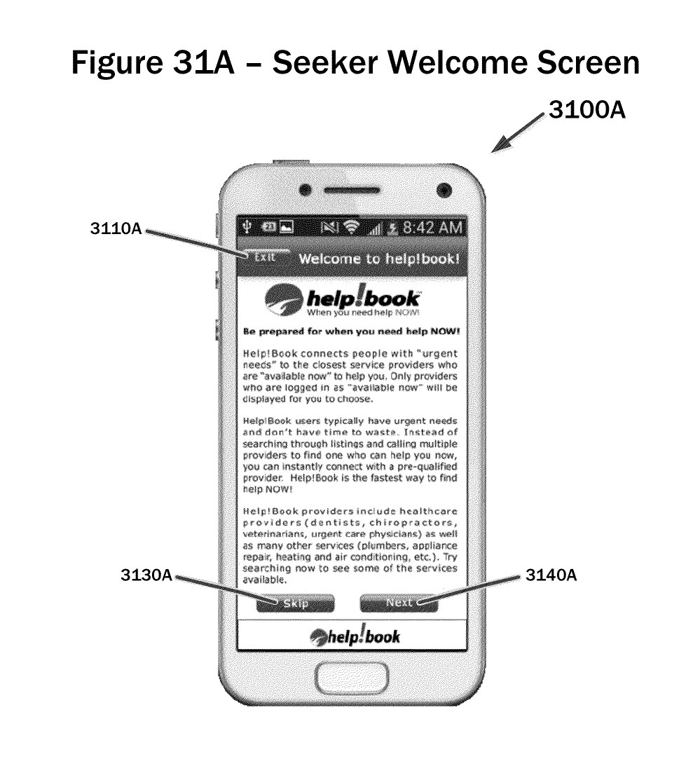

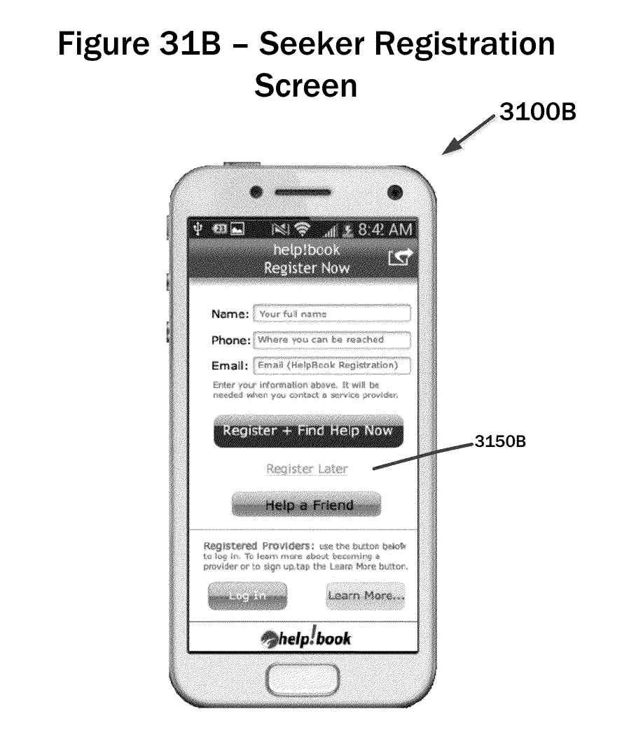

The logic flow diagrams in FIGS. 28, 29 and 30, as described above, may provide a conceptual overview of some embodiments of a MCDUF system 2700. Additionally, to further describe some embodiments of a MCDUF system 2700, various figures including exemplary screen images are described in a narrative below starting with FIG. 31A. Each such exemplary screen may also be explicitly correlated in the descriptive narrative to corresponding steps in FIGS. 28, 29 and 30.

FIG. 31A provides an exemplary screen 3100A to illustrate the introduction process whereby a Seeker is informed of facilities provider by the MCDUF system 2700. Such a screen may also provide a facility to measure the Seeker's perception of urgency. If the Seeker very rapidly presses the ‘skip’ virtual button 3030A (or even the ‘next’ virtual button 3040A) following the display of the introductory screen 3000A, this may be an indication of Seeker urgency or distress. Conversely, a longer elapsed response time prior to pressing the ‘next’ virtual button 3040A (or even the ‘skip’ virtual button 3030A) may indicate the Seeker has taken the time to read the introductory screen 3000A and is therefore less distressed or at least more calmly deliberative.

Referring once again to FIG. 30 at step 3010, in some embodiments, periodically monitoring Seeker urgency may begin with and/or otherwise include measuring the Seeker's perception of urgency starting with the Seeker's very first interaction with the MCDUF system 2700—as exemplified in FIG. 31A as described in the paragraph directly above.

FIG. 31B provides an exemplary screen 3100B to illustrate the registration process that may facilitate enrolling a Seeker. As discussed above, the Seeker may have the option to defer the registration process, for example by selecting a ‘register later’ virtual button 3150B. A Seeker's election to defer or undertake registration may be reflective of the Seeker's relative level of urgency and/or distress. As with all responses, the Seeker's elapsed response time may also be utilized to assess the Seeker's urgency.

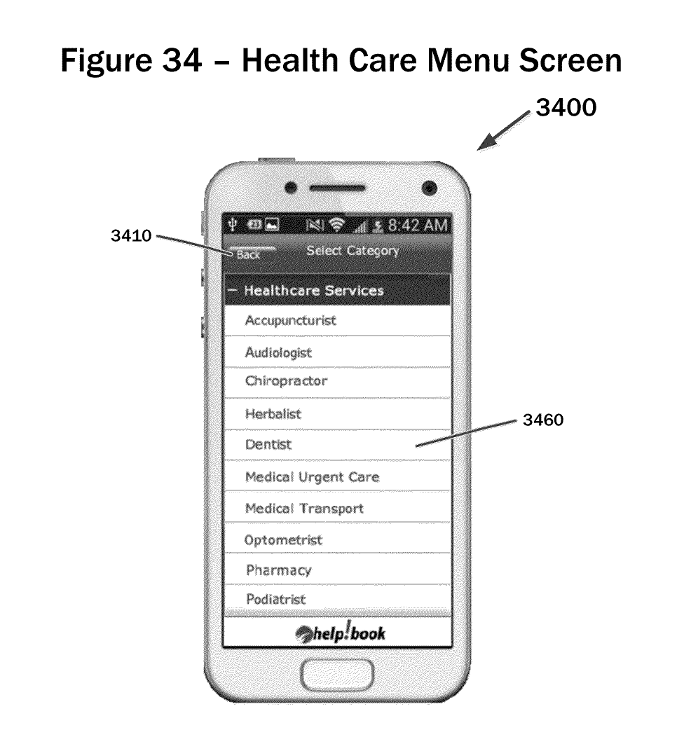

Referring once again to FIG. 30 at step 3020, in some embodiments, incrementally enrolling the Seeker may begin with and/or otherwise include the Seeker selecting the ‘register later’ option in FIG. 34—as described in the paragraph directly above.

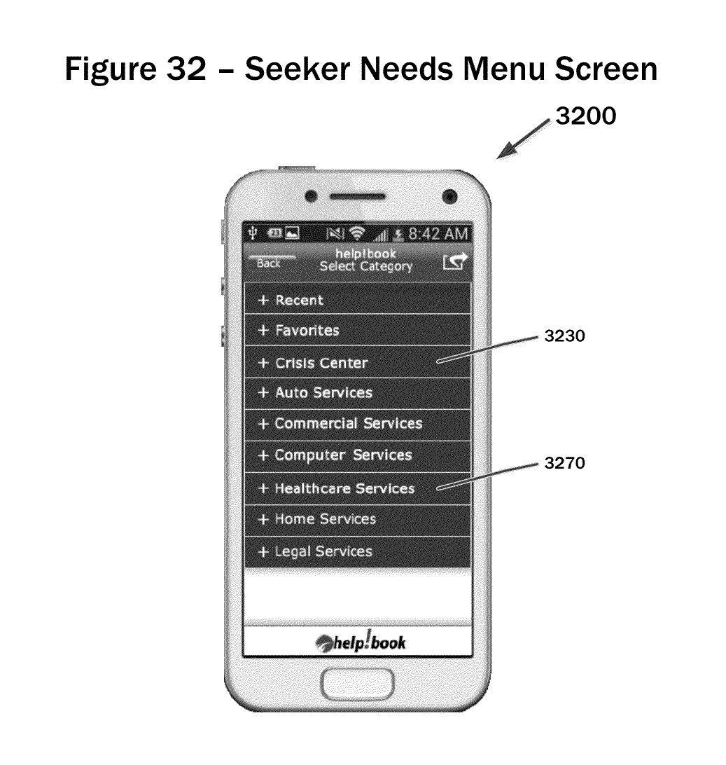

FIG. 32 provides an exemplary screen 3200 to illustrate URGS needs options proffered to the Seeker via a menu 3200. By selecting the ‘Crisis Center’ virtual button 3230, the Seeker may select a set of additional URGS need selections organized on the crisis theme.

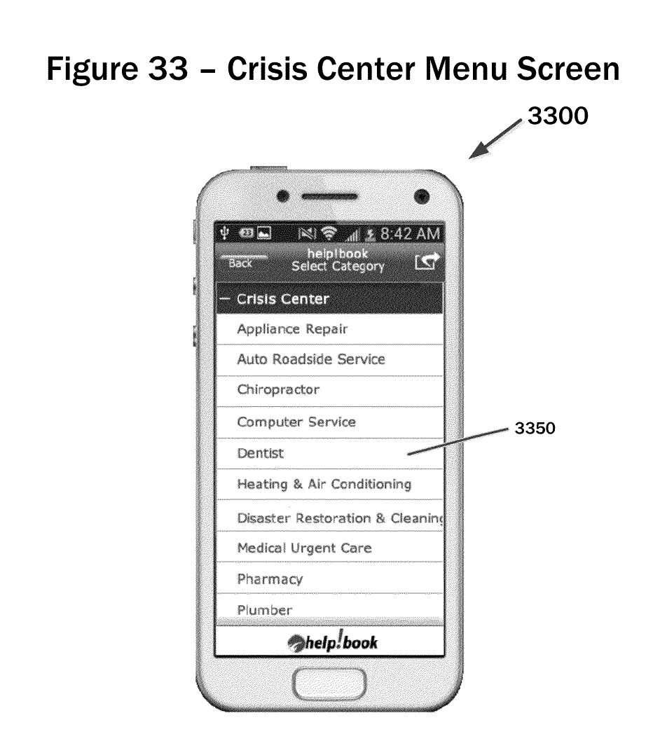

FIG. 33 provides an exemplary screen 3300 to illustrate URGS category options provided to the Seeker via a ‘Crisis Center’ sub-menu 3300. By selecting the ‘Dentist’ virtual button 3350, the Seeker may identify the Seeker's URGS need for a dentist.

Returning to FIG. 32, it should be noted that more than one of the choices in the menu of screen 3200 may be equally effective for the Seeker. For example, the Seeker may choose to select the ‘Healthcare Services’ virtual button 3270 instead of the ‘Crisis Center’ virtual button 3230. Either virtual button may aid navigating to finding a dentist.

FIG. 34 provides an exemplary screen 3400 to illustrate URGS category options provided to the Seeker via a ‘Healthcare Services’ sub-menu 3400. By selecting the ‘Dentist’ virtual button 3460, the Seeker may identify the Seeker's URGS need for a dentist.

In some embodiments, as exemplified by the description above, the MCDUF system 2700 may utilize a user interface navigation topology that is at least partially meshed—as opposed to tree-like—thus for example allowing a distressed Seeker more than one way to navigate to the same result; and thereby decreasing the likelihood that the Seeker unintentionally navigates into a ‘blind alley’ where the desired result cannot be attained. Nonetheless, a distressed Seeker may navigate into a blind alley, perhaps by ‘fat fingering’ the wrong virtual button. A ‘back’ virtual button—for example virtual button 3410 in FIG. 34—may provide a facility for the Seeker to recover from mis-navigation. In some embodiments, any user utilization of a ‘back’ virtual button or similar control may be measured and recorded as a possible indication of user perceived experiential urgency or distress.

Referring once again to FIG. 30 at step 3030, in some embodiments, assessing the Seeker's URGS need(s) may begin with and/or otherwise include the Seeker navigating a set of categorical menus leading to the selection of an URGS category—as exemplified in FIGS. 32, 33 and 34 as described in the paragraphs above.

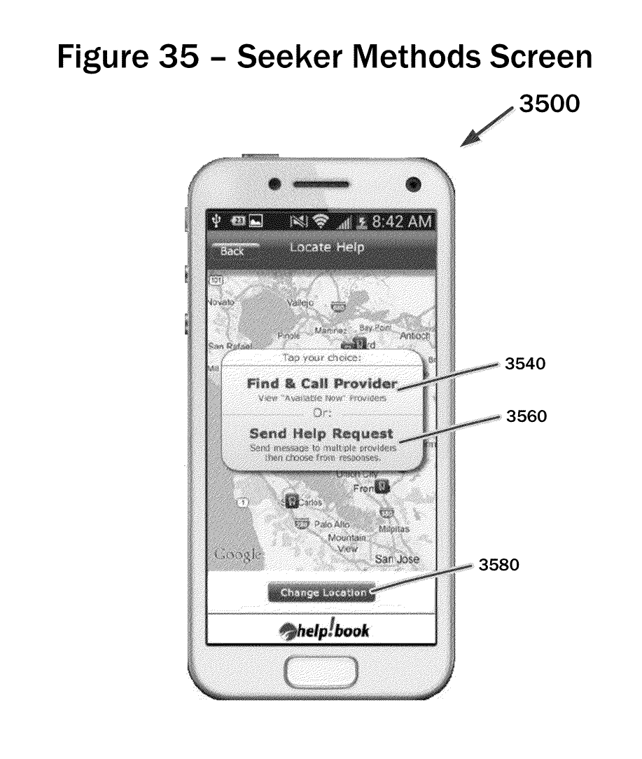

FIG. 35 provides an exemplary screen 3500 to illustrate facilitating a Seeker to locate and subsequently contact an URGS Provider(s). In the example of screen 3500, the Seeker has two choices: choose a Provider from a list of Providers (virtual button 3540); or send an URGS request to more than one Provider at the same time (virtual button 3560) and possibly get more than one Provider reply. Additionally, virtual button 3580 may provide a facility for the Seeker to change the location that may be used as the nexus for searching for Providers by proximity. In some embodiments, the Seeker by selecting virtual button 3540—‘find & call provider’—may facilitate display of screen 3600 described below.

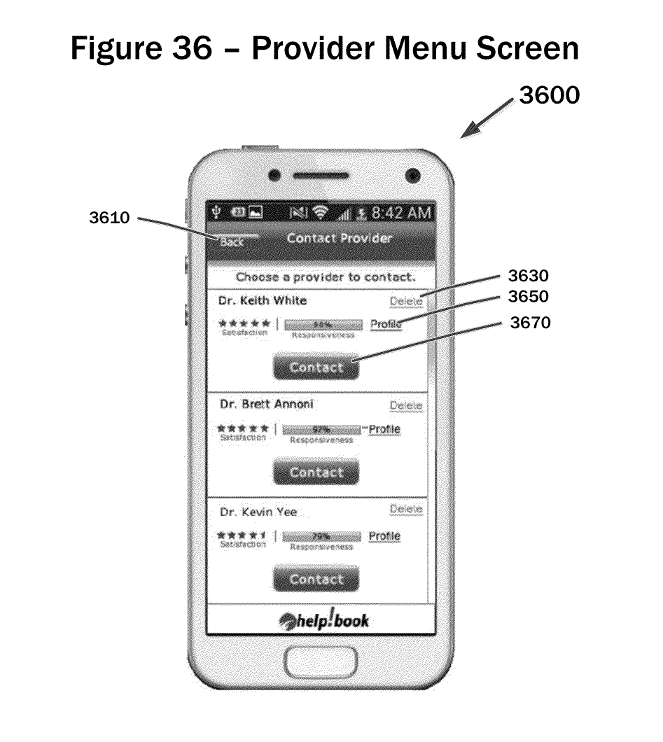

FIG. 36 provides an exemplary screen 3600 to illustrate facilitating a Seeker to send a request for URGS to a multiplicity of URGS Providers simultaneously. A listed menu of available URGS Providers may be displayed, wherein a given menu list item corresponds to an URGS Provider and provides the Seeker options to display a profile of that Provider (e.g., virtual button 3650); delete that Provider's item from the menu list (e.g., virtual button 3630); or facilitate contact with that Provider (e.g., virtual button 3670). Virtual button 3610—the ‘back’ button—facilitates the Seeker returning to screen 3500.

In some embodiments, virtual buttons on screen 3600 (as well as other screens) may be instrumented to facilitate assessing the Seeker's perceived experiential urgency and potential distress.

Regardless of whether the Seeker chooses to select a specific Provider via or to reach out to multiple Providers, some specific information about the Seeker may be useful to any Provider receiving an URGS needs request. Such Seeker specific information may include, but not be limited to: the Seeker's location, the Seeker's contact information, the Seeker's URGS need(s), and the Seeker's desired timeframe for acquiring URGS.

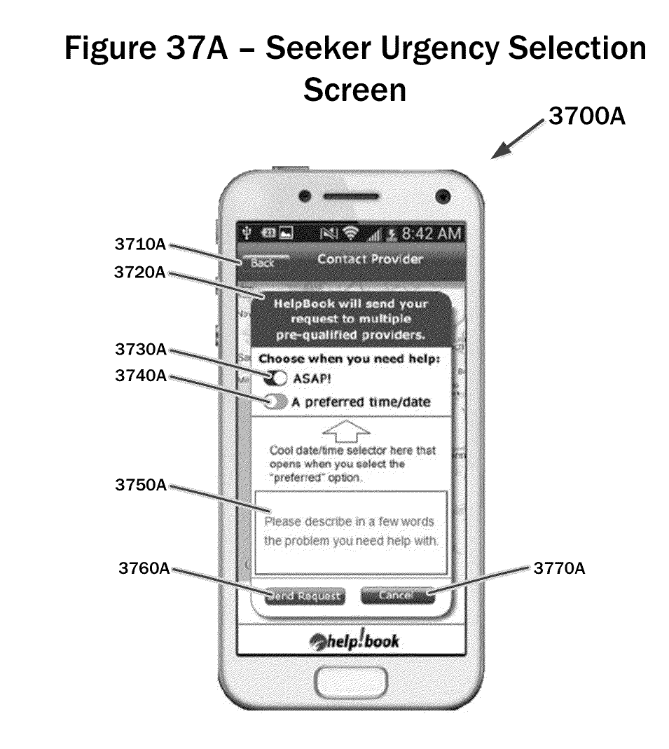

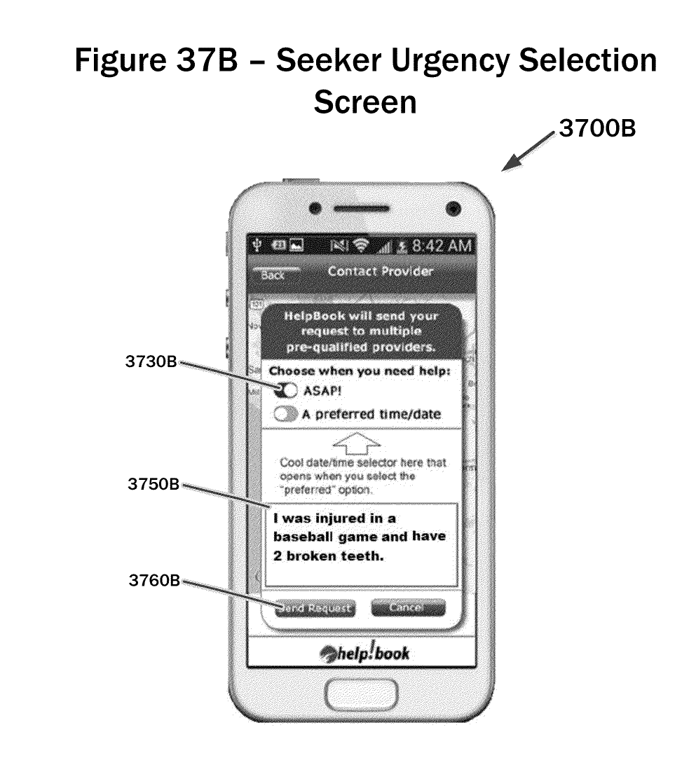

FIG. 37A provides an exemplary screen 3700A to illustrate facilitating a Seeker to specify a desired timeframe for acquiring URGS and to describe the Seeker's URGS need(s). Screen banner 3720A may vary depending on the option the Seeker selected utilizing screen 3500. ‘Radio buttons’ 3730A and 3740A provide the Seeker two time frame options to select from: either ‘ASAP’ (as soon as possible) or ‘a preferred time/date’. Radio buttons may be utilized to facilitate exclusive option selection, whereby turning a given radio button ‘on’ automatically turns to ‘off’ all other radio buttons grouped with that radio button so as to provide a set of ‘choose one of’ options. Selecting radio button 3740A facilitates the Seeker to specify (not shown) a preferred clock time and calendar date to acquire the URGS needed. Input window 3750A provides a facility for the Seeker to enter a verbal description of the Seeker's URGS need(s). The ‘send request’ virtual button 3760A facilitates the Seeker sending a request to either a single Seeker-selected Provider or multiple MCDUF system-selected Providers as corresponds to the Seeker's prior selection using screen 3500 as described previously above. The ‘cancel’ virtual button 3770A facilitates the Seeker cancelling the sending of the URGS request(s). In some embodiments, selecting virtual button 3770A returns the Seeker to screen 3500. Selecting the ‘back’ virtual button 3710A facilitates the Seeker returning to the previous screen, e.g., screen 3600 or screen 3500.

FIG. 37B provides an exemplary screen 3700B to illustrate a Seeker specifying a desired timeframe for acquiring URGS as well as describing the Seeker's URGS need(s). In this example, the Seeker Sam Smith, selects radio button 3730B to indicate that he desires the desired URGS as soon as possible. Sam enters a description of his URGS needs in input box 3750B. Such a Seeker descriptive note may be subsequently sent to any Provider that may be contacted on the Seeker's behalf by the MCDUF system 2700. Sam selects the ‘send request’ virtual button 3760A to initiate the sending of URGS request(s).

The Seeker's self-descriptive note entered in input box 3740B may contain a multiplicity of words and phrases that may be utilized by the MCDUF system 2700 to further assess the Seeker's condition. For example, in the above example, Sam Smith entered the following terms to describe his URGS needs: ‘injured’ and ‘2 broken teeth’. In some embodiments, a natural language processing facility (not shown) may be utilized by the MCDUF system 2700 to identify and process such Seeker condition indicative words and phrases. Such information may be aggregated into the ongoing cumulative assessment of the Seeker's sense of urgency and level of stress.

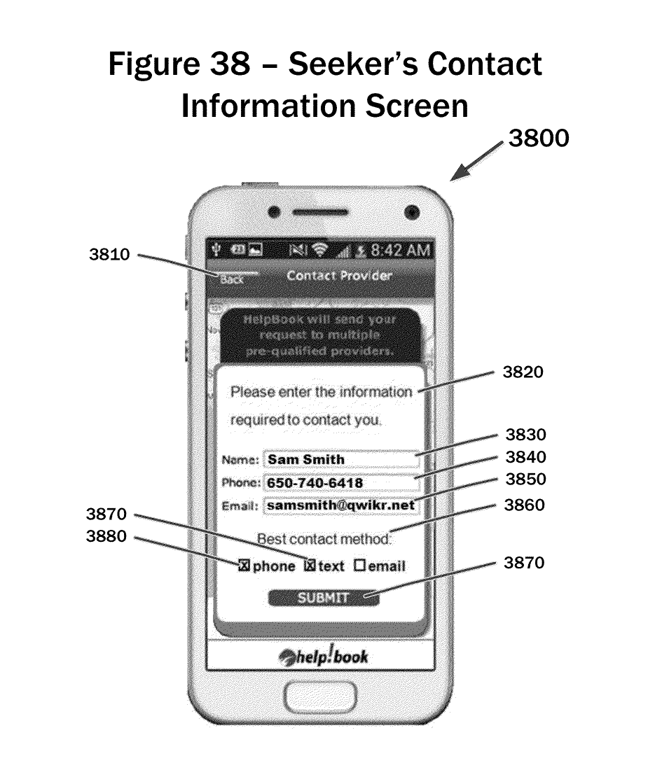

FIG. 38 provides an exemplary screen 3800 to illustrate en-passant gathering of the Seeker's registration information. The Seeker may have previously skipped providing registration information; however, it may be natural and intuitive for the Seeker to provide such information utilizing screen 3800 as it may seem to the Seeker to be reasonably requisite to enabling the desired contact with URGS Providers. Referring further to FIG. 38, at 3820, the Seeker may be prompted for registration information. The Seeker—in this example, Sam Smith—may enter name, phone number and email address into input boxes 3830, 3840 and 3850 respectively. At 3860, the Seeker may be prompted to select best contact methods. In the example of screen 3800, Seeker Sam Smith may have selected phone and text—check boxes 3870 and 3880 respectively. By pressing the ‘submit’ virtual button 3890, the Seeker may initiate a multi-Provider search wherein the MCDUF system 2700 undertakes to proffer the Seeker to several pre-screened Providers concurrently. The Seeker may choose to provide only some or perhaps even none of the registration information. In some embodiments, the Seeker may be proffered to Providers without registered contact information. In some embodiments, lacking Seeker contact information, the MCDUF system 2700 may proxy communication directly between the Provider and the Seeker via the Seeker's app 2710 (thereby potentially forgoing third party communication services such as email or SMS texting).

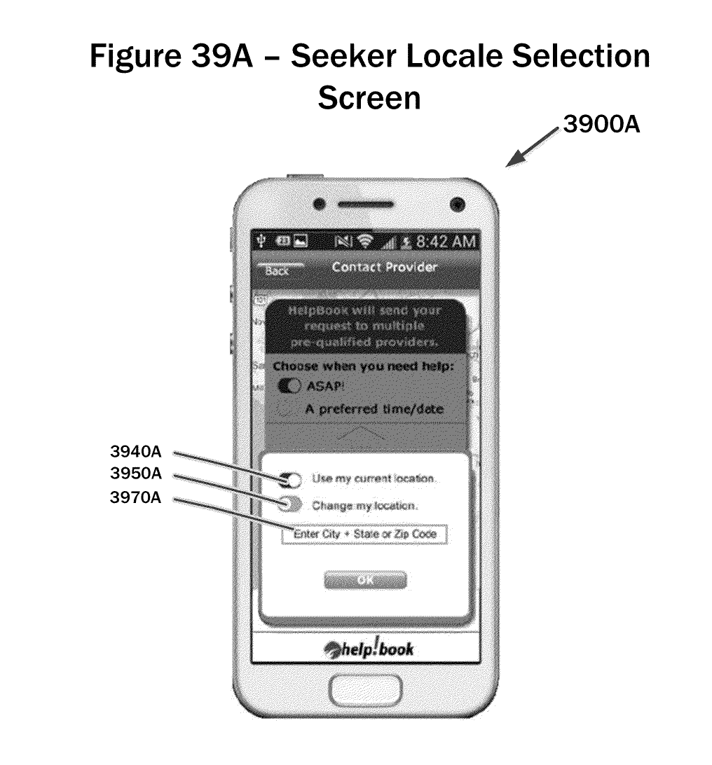

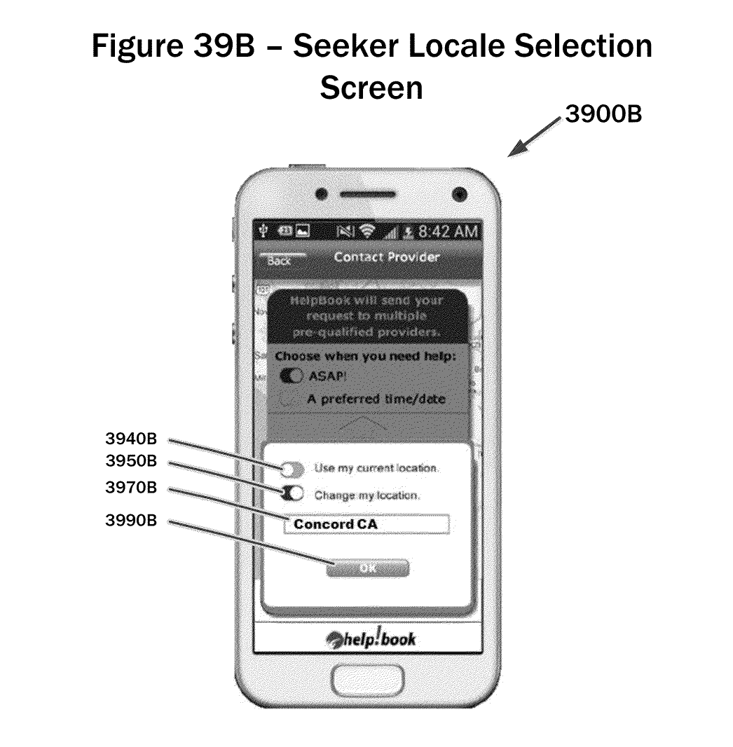

FIG. 39A provides an exemplary screen 3900A to illustrate facilitating the Seeker to verify or revise the nominal Seeker location utilized by the MCDUF system 2700 as the nexus for locating URGS providers based on proximity to the Seeker. The Seeker may choose to either accept or change the nominal Seeker location via one of the two radio buttons 3940A and 3950A. In some embodiments, the Seeker may make an entry in the ‘enter city+state or zip code’ input box 3970A that may automatically cause the ‘change my location’ radio button 3950B to be selected and the ‘use my current location’ radio button 3950A to be de-selected.

FIG. 39B provides an exemplary screen 3900B to illustrate the Seeker revising the nominal seeker location utilized by the MCDUF system 2700 as the nexus for locating URGS providers based on proximity. In this exemplary screen 3900B, the Seeker—Sam Smith—may choose to revise his location by selecting radio button 3950B (automatically de-selecting radio button 3940A). The Seeker may enter a new location via input box 3970B and then pressing the ‘ok’ virtual button 3990B. In this example, Sam Smith, has pre-existing plans to take a train from the San Francisco airport to a hotel in Concord; therefore, Sam revises his location to Concord Calif. via input box 3970B.

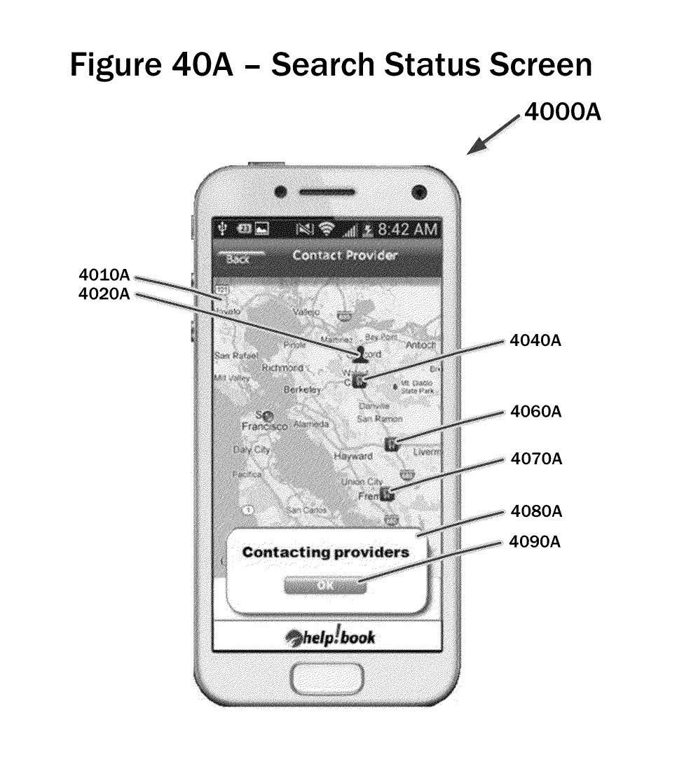

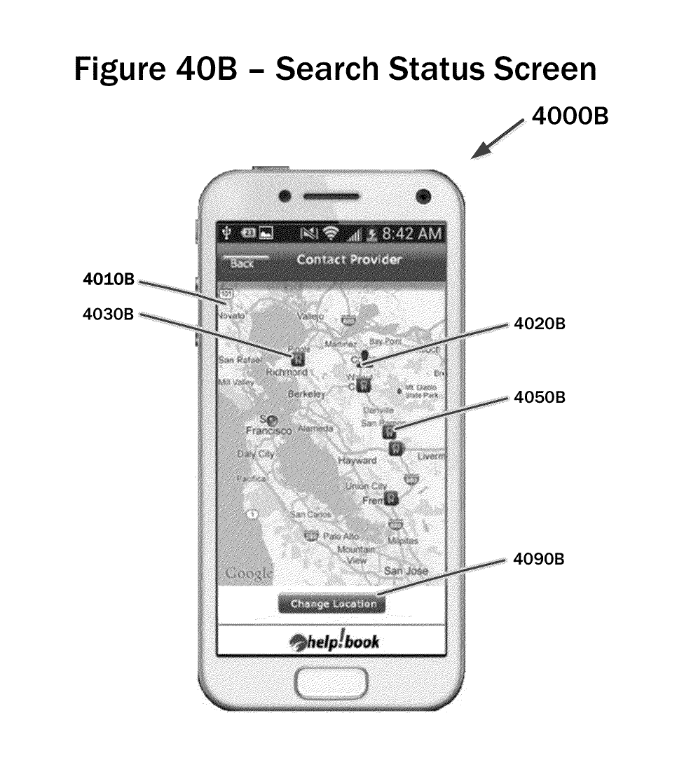

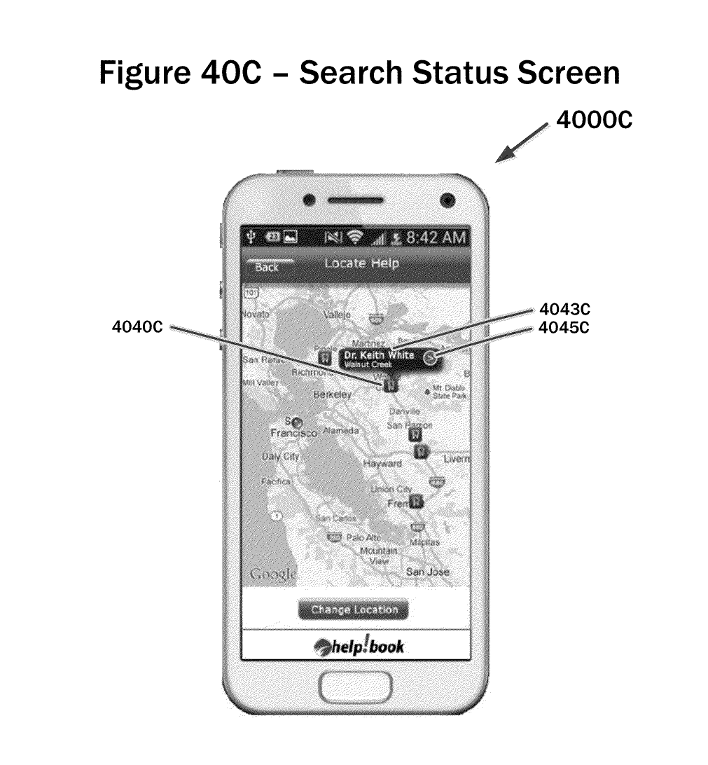

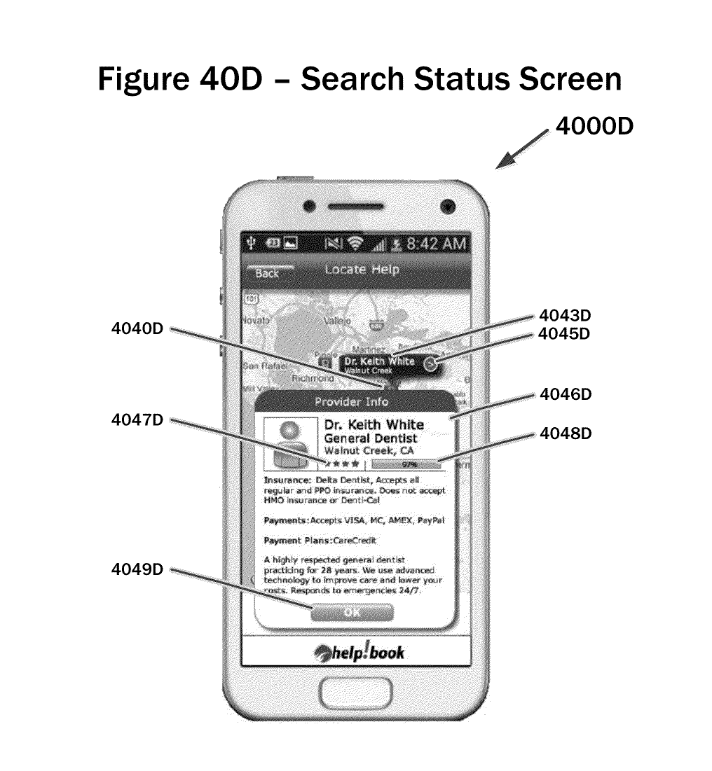

FIG. 40A provides an exemplary screen 4000A to illustrate facilitating an indication to the Seeker that the MCDUF system 2700 may be contacting providers on the Seeker's behalf. Screen 4000A may be dynamically updated such that for each Provider contacted by the MCDUF system 2700, that Provider may be represented by an individual corresponding icon on a “search results display map” 4010A; and wherein each such icon may be dynamically and automatically added to the map 4010A as the corresponding Provider may be contacted. In exemplary screen 4000A, three contacted Providers (in this example, dentists represented) may be represented by icons 4040A, 4060A and 4070A. Furthermore, the search results display map 4010A may facilitate the Seeker in estimating the relative distance from the Seeker's nominal location (as represented by a ‘head and shoulders’ Seeker icon 4020A) to a given Provider represented by a corresponding ‘tooth’ Provider icon on screen 4000A. The virtual subscreen 4080A may be utilized to explicitly inform the Seeker that the MCDUF system 2700 may be contacting Providers. The Seeker may close virtual subscreen 4080A by selecting the ‘ok’ virtual button 4090A. In some embodiments, virtual subscreen 4080A may be closed automatically after allowing some time for the Seeker to read the ‘contacting providers’ message on the subscreen 4080A.

FIG. 40B provides an exemplary screen 4000B to further illustrate facilitating a dynamically updated indication to the Seeker that the MCDUF system 2700 may be contacting providers on the Seeker's behalf. Screen 4000B illustrates subsequent additional updating of the search results map 4010B such that for each additional Provider contacted by the MCDUF system 2700 such additional contact may be represented by adding an individual corresponding icon on the display map 4010B. Provider icons 4030B and 4050B. In some embodiments, the ‘change location’ virtual button 4090B may be included with the search results map such that the Seeker may select virtual button 4090B in order to change the nominal Seeker location known to the MCDUF system 2700.

FIG. 40C provides an exemplary screen 4000C to further illustrate facilitating a dynamically updated indication to the Seeker that the MCDUF system 2700 may be contacting providers on the Seeker's behalf; wherein further, the Seeker may select a Provider icon so as to display a ‘pop-up bubble’ identifying that Provider. Screen 4000C illustrates such a pop-up bubble 4043C corresponding to a Provider icon 4040C. Furthermore, the Seeker may select a ‘greater details’ icon 4045C within the pop-up bubble 4043C so as to request additional details about the corresponding Provider—e.g., additional details about Dr. Keith White in Walnut Creek.

FIG. 40D provides an exemplary screen 4000D to further illustrate facilitating a dynamically updated indication to the Seeker that the MCDUF system 2700 may be contacting providers on the Seeker's behalf; wherein further, the Seeker may select a ‘greater details’ icon so as to display a ‘pop-up subscreen’ providing additional details about the corresponding Provider. Screen 4000D illustrates such a pop-up subscreen 4046D corresponding to Provider icon 4040C. With the exception of the Provider responsiveness rating 4047D and the Provider quality rating 4048D, the Provider details displayed in subscreen 4046D may correspond to self-descriptive information provided by the corresponding provider (see screen 4500, which is described further below). Selecting the ‘ok’ virtual button 4049D may close the pop-up subscreen 4046D.

In some embodiments, the appearance of a Provider icon may be visibly altered in order to convey the status of that responder—including, but not limited to, that responder receiving the Seeker's request and undertaking to respond to the Seeker's request or choosing to decline it.

In some embodiments, micro-casting may be utilized by the MCDUF system 2700 to identify and possibly rank two or more possible URGS-need(s) suitable Providers to attempt to contact on the Seeker's behalf; and further to control the order and timing of such contact attempts. In some embodiments, such contact attempts may be “triaged”, i.e., executed in successive tiers, so as to allow time for a preceding tier or tiers of Providers to receive the Seeker's URGS request and to undertake to respond to it. Such a triaging of possible Providers may be utilized to avoid disturbing Providers other than a tier of Providers adequate in number to likely generate an acceptance offer to the Seeker's URGS request; and utilizing such a tiered approach, successive tiers of Providers may be contacted if preceding tiers of contact attempts fail to result in URGS fulfillment offer(s) to the Seeker. Various “bracketing” processes may be utilized so as to provide a hysteresis that controls pausing and resuming the proffering of successive tiers of triaged Providers. In some embodiments, such a bracketing may pause proffering when a sufficient number of triaged Providers have been proffered and may resume proffering when the number of proffered triaged Providers drops below a minimum threshold due to causes such as: one or more Providers declining a Seeker's request; the Seeker declining one or Provider offers; or one or more Provider's not responding to a Seeker's URGS request within the window of a ‘time-out’ period.

In some embodiments of micro-casting, a number of factors may be utilized by the MCDUF system 2700 to determine and control how the contacting of Providers may be triaged. For example, the MCDUF system 2700 may utilize a preferential system of Provider triage whereby a Provider may be determined to be “suitable” based on factors including, but not limited to proximity, availability and Provider qualification. In some embodiments, such a preferential system may utilize a “current seeker-adaptive micro-casting triaged provider pool” (or more simply “triaged provider pool”), generated in real-time, which essentially may be a collection of Providers deemed suitable to possibly proffer to the Seeker. In some embodiments, during micro-casting, additional newly-available suitable Providers may be triaged into a given triaged provider pool. Similarly, newly-unavailable suitable Providers may be removed from a given triaged provider pool.

In some embodiments, Providers evaluated for a given Seeker's triaged provider pool may be qualified and perhaps ranked utilizing a multi-dimensional gradient wherein the dimensions of the gradient may include but not be limited to “virtual proximity”, “weighted availability”, and “synthesized suitability”. The derived locus of a given Provider on such a gradient may be utilized to determine the relative ranking of that Provider against other Providers for the purpose of ordering the offering of the Providers to the Seeker. A given Provider may be significant enough of an outlier on such a gradient that the Provider may be excluded from the triaged provider pool.

In some embodiments, virtual proximity may be derived from a combination of factors including but not limited to: the Seeker's means of conveyance; mapped travel distance; traffic speed conditions; the Provider's commercial territory (e.g., tow truck service limited to a region); and the projected time of travel. Weighted availability may be derived from a combination of factors including but not limited to: the scheduled explicit availability or unavailability of the provider; the ‘freshness’ of the Provider's schedule (i.e., how recently was the schedule updated); the degree of certainty of the Provider's availability or unavailability (for example a ‘time of day preference’ unavailability vs. a ‘blocked out multi-day’ unavailability); the number of Seeker requests recently received by the Provider; and the number of the Provider's offers accepted and/or rejected by Seekers. Synthesized suitability may be derived from a combination of factors including but not limited to: the Provider's self-categorization of URGS provided; ongoing qualifying evaluation specific to an URGS category; Provider quality based on responsiveness, likelihood to accept Seeker requests, Seeker satisfaction, and third party ratings (e.g., Yelp, Angie's List, Better Business Bureau, etc.); background and performance checks; years of experience; and length of use of the MCDUF system 2700.

Referring once again to FIG. 30 at step 3040, in some embodiments, successively proffering provider(s) may begin with and/or otherwise include the display of some micro-casting triaged URGS providers and acquiring information relating to the Seeker's URGS need so as to facilitate sending a Seeker's URGS need request to such micro-casting triaged URGS providers—as exemplified in FIGS. 35, 36, 37, 38, 39A, 39B, 40A, 40B, 40C and 40D as described in the paragraphs above.

The preceding sequence of figures provided examples of screens a Seeker might utilize in some embodiments of the MCDUF system 2700. A given Provider may also utilize a sequence of one or more screens in order to share the Provider's information with the MCDUF system and also to interact with Seekers facilitated and/or intermediated by the MCDUF system 2700.

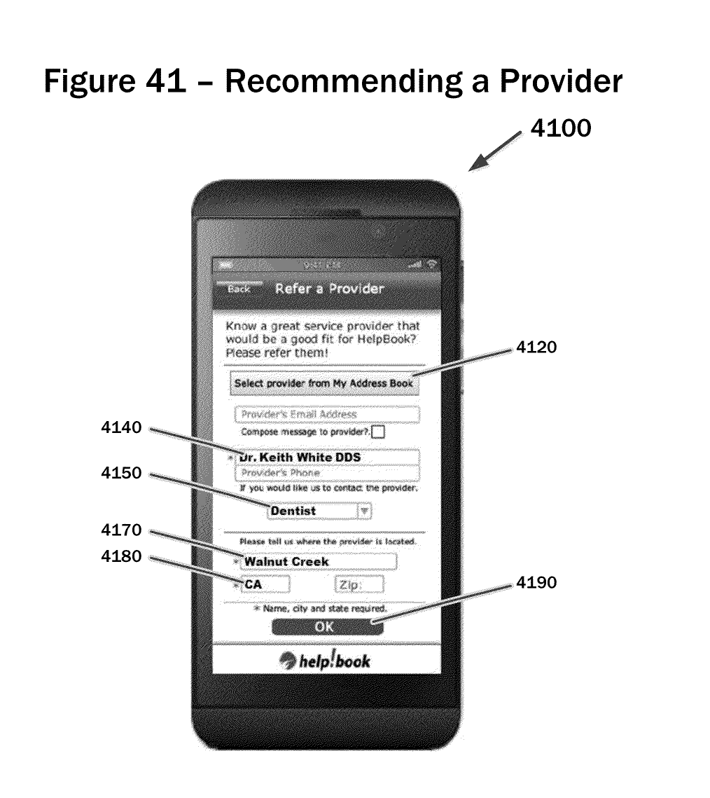

FIG. 41 provides an exemplary screen 4100 to illustrate a MCDUF system user—either a Seeker or a Provider—recommending a potential new Provider for inclusion in the MCDUF system 2700 “provider resource pool”, i.e., the set of Providers that may possibly be proffered to Seekers by the MCDUF system 2700, and from which a given triaged provider pool is selected. In this example, the recommended Provider candidate is Dr. Keith White DDS of Walnut Creek Calif. In some embodiments, credence given by the MCDUF system 2700 to such a recommendation may be weighted more or less favorably based on the status of the recommending user. The status of a given recommending user considered in the evaluation of such a recommendation may include but not be limited to: the user's registration status (i.e., not registered, registered but with partial information, fully registered), history of MCDUF system use, reputation with MCDUF system URGS Providers, reputation with third party social network users (e.g., FaceBook, Twitter, etc.), and the qualities of any MCDUF system URGS Providers that may have been recommended previously by that user. A potential Provider may be recommended by more than one MCDUF system user. The number of user recommendations for a given potential new Provider may serve as an additional weighting factor in the process of considering such a potential new Provider., A MCDUF system user who may have used the MCDUF system 2700 as a Seeker or as a Provider in a different URGS category may in some embodiments recommend themselves as a potential new Provider.

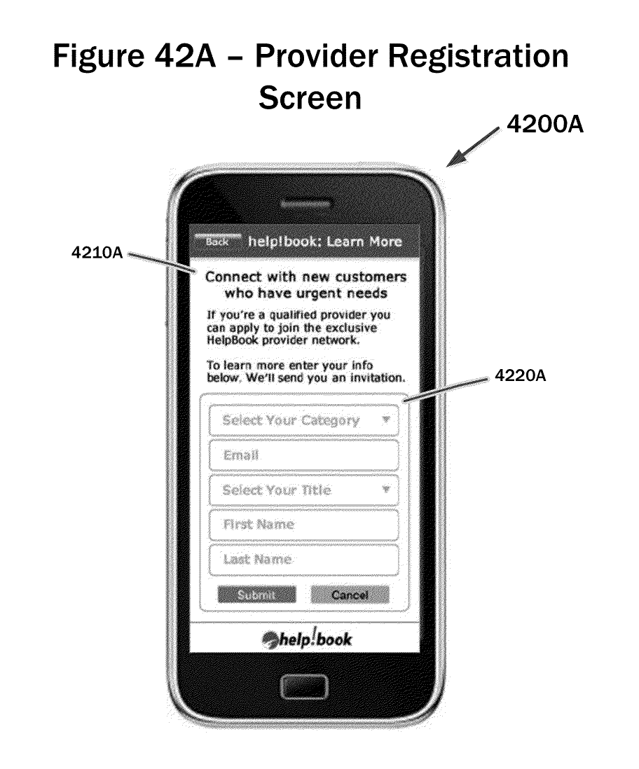

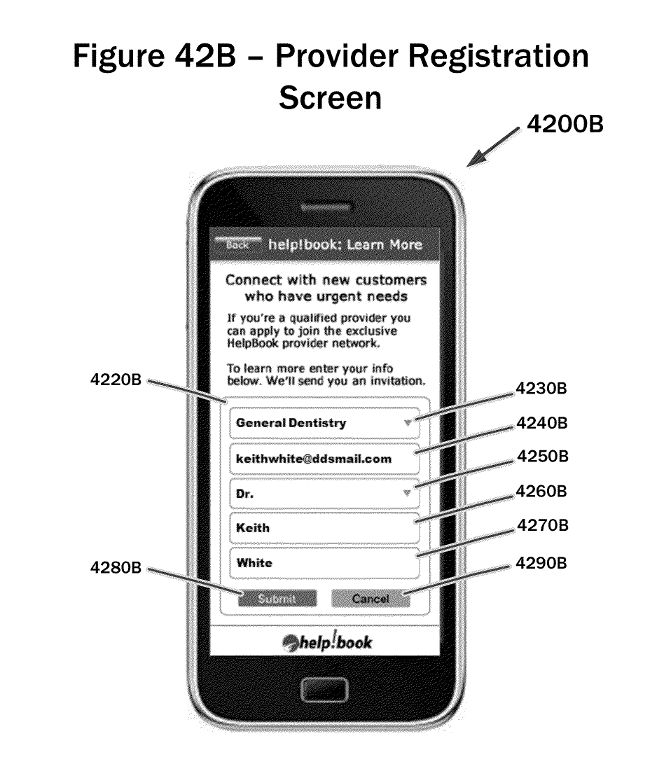

Referring once again to FIG. 29, at step 2920, in some embodiments, facilitating provider account management may begin with and/or otherwise include acquiring and managing information from the Provider (or from third parties such as reviewers, licensing agencies, etc.) relating to the Provider—as exemplified in FIGS. 42A, 42B, 43, 44A, 44B, 45, 46, 47, 48A, 48B, 49, 50, 51, 52, 53A, 53B, 54, 55, and 56 as described in the paragraphs below.

In some embodiments, acceptance of a potential provider as a Provider in a provider URGS category may be perfunctory with little or perhaps no pre-qualification other than providing information sufficiently describing the potential provider so as to facilitate proffering by the MCDUF system 2700. In other embodiments, qualification may be more complex and perhaps more selective. In some embodiments of the MCDUF system 2700, URGS needs Providers may be proffered by the MCDUF system only after pre-qualification vetting. Such an individual pre-qualification “Provider pre-vetting” may include a mixture of automated and human-mediated procedures. Also in some embodiments, Provider pre-vetting may include ongoing evaluation during a probationary acceptance period. Furthermore, qualification evaluation of a Provider may continue subsequent to full acceptance of the Provider into the MCDUF system provider resource pool. Consequently, in some embodiments, a Provider may be disqualified during pre-vetting, during any probationary period, or subsequent to full acceptance; and therefore may be removed from the MCDUF system provider resource pool and therefore may subsequently no longer be a Provider. The factors that may be used to thusly “disqualify” a Provider may include factors including but not limited to those used in pre-qualifying a Provider. In some embodiments, disqualification of a Provider may occur by stages, whereby an intermediate stage may include but not be limited to a renewed probationary trial period that may precede either re-acceptance or full disqualification.

In some embodiments, a potential new Provider may be required to have a prior history as a Seeker in order to be qualified as a Provider. In other embodiments, such a prior history may be a factor in, rather than a pre-condition for, qualification of a Provider.

FIG. 42A provides an exemplary screen 4200A to further illustrate facilitating a potential provider to register with the MCDUF system 2700 so as to be considered for qualification as a Provider. Such a screen 4200A may, for example, be displayed by running a native app down-loaded to a mobile device, or as a page of a web app running in a browser on a mobile device or other device such as a PC. Screen 4200A may include a succinct description 4210A of the qualification process, the value that becoming a Provider may provide, plus an invitation to learn more. A brief automated registration form 4220A may make it visually apparent that registration for consideration as a Provider may be relatively quick and straightforward.

FIG. 42B provides an exemplary screen 4200B to further illustrate registering a potential provider with the MCDUF system 2700 so as to be considered for qualification as a Provider. Automated registration form 4220B may utilize input boxes and drop down selection menus to acquire information from the potential provider including: provider URGS category 4230B (e.g., ‘general dentistry’), email address 4240B, title 4250B (e.g., ‘Dr.’), and first and last names 4260B and 4270B respectively. In some embodiments, an automated registration form may utilize more than one screen and may utilize input facilities including but not limited to check boxes, radio buttons, as well as data importation browsers and/or selectors. Furthermore, in some embodiments such an automated registration form may be adaptive so that for example the composition of the form may differ depending on the URGS provider URGS category selected by the potential provider. Virtual buttons 4280B and 4290B provide the potential provider with the respective options to either ‘submit’ the input registration information so as to continue the process to potentially become a Provider or to ‘cancel’ the process.

A potential provider may actively seek out such an automated MCDUF system provider registration form or may receive a solicitation that directs the potential provider to such a form. Such solicitation may be automated or human mediated or both. In some embodiments, a pre-qualification process may control whether a potential provider is solicited; such a deliberately pre-qualified solicitation may be termed an “invitation”.

In some embodiments, any information provided by a user—either a Seeker or a Provider—may be recorded and perhaps subsequently utilized by the MCDUF system 2700 regardless of whether the user completes or cancels the information acquisition process. So for example, the MCDUF system 2700 may record that a potential provider started the application process and then chose to cancel it. Furthermore, as may be the case with all app screen inputs from a user who is a Seeker, any app screen inputs screens utilized by a potential provider or qualified Provider may be instrumented so as to assess their temperament, degree of patience and/or other detectable or deducible personality traits.

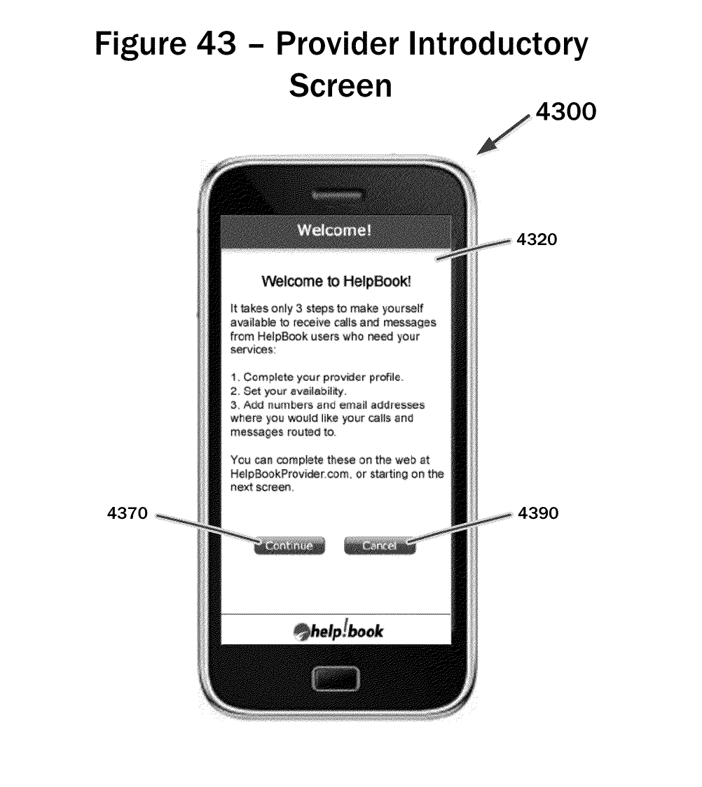

FIG. 43 provides an exemplary screen 4300 to further illustrate facilitating a potential provider to register with the MCDUF system 2700 so as to be considered for qualification as a Provider. Such a screen 4300 may, for example, include a description 4320 further detailing the qualification process so that a potential provider may understand the steps involved and the corresponding value of completing those steps. Virtual buttons 4370 and 4390 may provide the potential provider with the respective options to either ‘continue’ the process to potentially become a Provider or to ‘cancel’ the process.

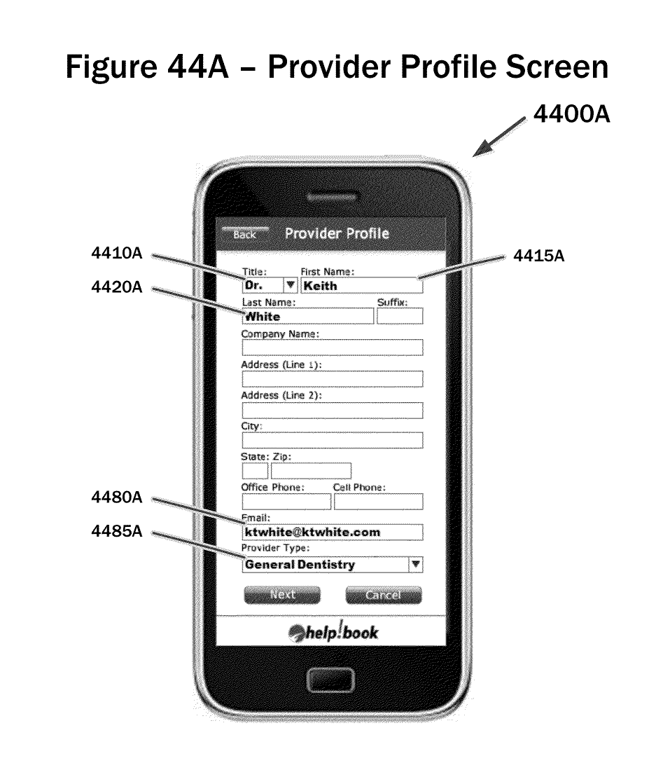

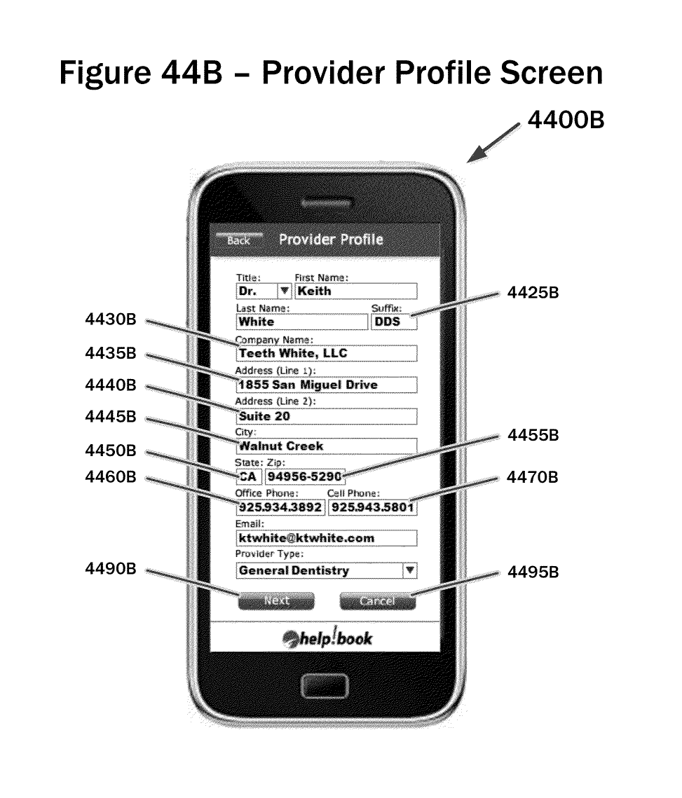

FIG. 44A provides an exemplary screen 4400A to further illustrate facilitating a potential provider to input a provider profile into the MCDUF system 2700 so as to be proffered as a Provider to URGS Seekers. Such a screen 4400A may include input fields pre-populated with information acquired from screen 4200B and/or screen 4100 and/or from other sources. So for example, input fields 4410A, 4415A, 4420A, 4480A and 4485A are pre-populated with the potential provider's title, first name, last name, email address and provider type respectively. Although an input field may be pre-populated, new input may be entered so as to replace a pre-populated value.

FIG. 44B provides an exemplary screen 4400B to further illustrate a potential provider inputting a provider profile into the MCDUF system 2700 so as to be proffered as a Provider to URGS Seekers. In addition to the pre-populated input fields described above, such a provider profile input screen 4400B may include company name (4430B); address (4435B, 4440B, 4445B, 4450B and 4455B); and phone numbers (4460B and 4470B).

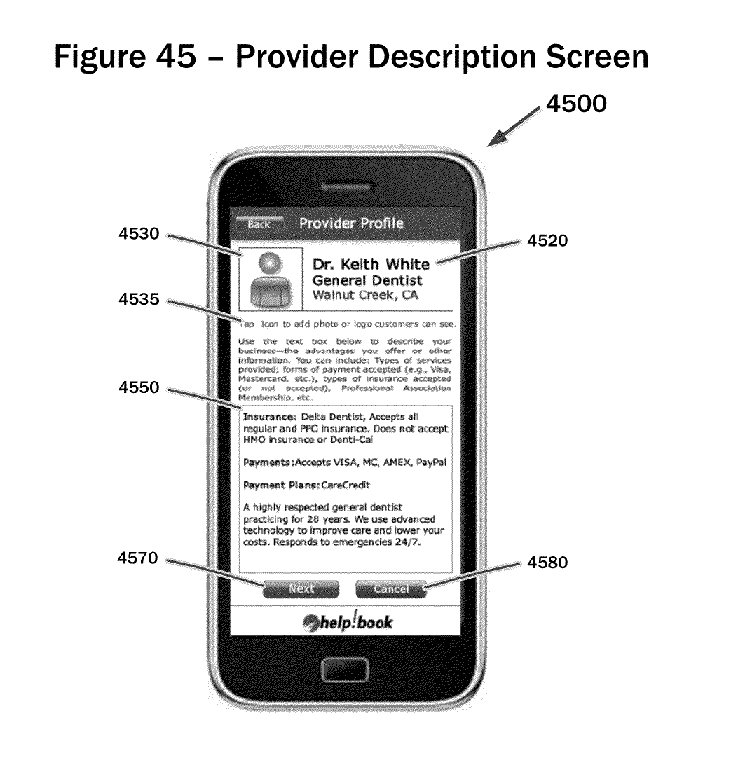

FIG. 45 provides an exemplary screen 4500 to further illustrate a potential provider inputting a provider profile into the MCDUF system 2700 so as to be proffered as a Provider to URGS Seekers. Such a profile may be viewed by a Seeker looking to find an URGS Provider. Furthermore, such a profile may be analyzed by the MCDUF system 2700—perhaps utilizing a natural language processing facility—to locate and record key words and phrases so as to categorize and evaluate the URGS that the MCDUF system may proffer on the Provider's behalf. In the example of screen 4500, much of the provider description is entered directly by the Provider in text. In some embodiments, provider self-descriptive input may be analyzed by the MCDUF system 2700 so as to enforce restrictions on the utilization of words that may, for example, be possibly offensive or misconstrued. In some embodiments, the input of provider self-description may be mediated by a series of prompts and input formats such that the self-description may be acquired in a systematic process that: segments the information into short text sequences (and therefore perhaps easier to analyze by the MCDUF system 2700); addresses specific topics (and therefore provides information consistent with other profiles), and avoids leaving out information that may be of value to a Seeker and/or the MCDUF system 2700.

The information gathered for a given provider profile may vary depending on the URGS involved. For instance, a dentist may accept Delta Dental Insurance for payment whereas a plumber may not.

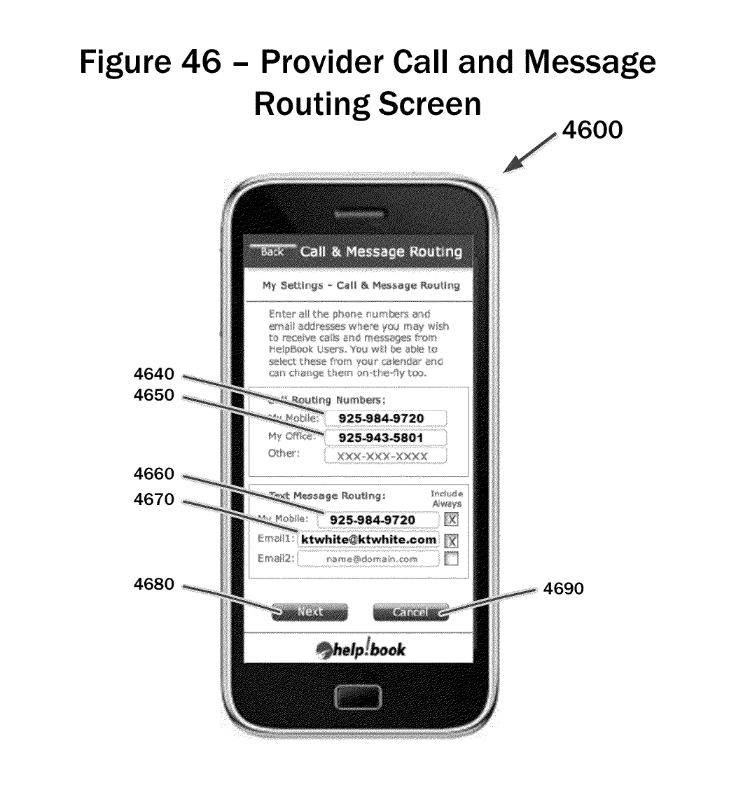

FIG. 46 provides an exemplary screen 4600 to illustrate facilitating a Provider to input address information such that communications may be routed to the Provider in real time or near real time as appropriate to the urgency of a given URGS Seeker. Such a screen 4600 may be pre-populated with information acquired previously such as mobile phone number 4640 and 4660, office phone number 4650, and email address 4670. However, the address information that may be used to contact the Provider for URGS may be different than that used to contact the Provider personally. Therefore, the Provider may alter some or all pre-populated input fields in screen 4600 as well as input additional information (not shown). In some embodiments, provider addresses may be acquired for additional communication facilities as they emerge. So for example, in addition to email addresses, text numbers, and phone numbers, the MCDUF system may also acquire and record IM (instant messaging) and Snapchat handles.

In some embodiments, the MCDUF system 2700 may proxy communications between a given Seeker and a correspondingly selected Provider so as to mediate, control, translate and possibly monitor the communication. For example. communications that are proxied by the MCDUF system 2700 may be subject to recording for quality control and/or other purposes. With the very real possibility, if not certainty, of being drawn into a dispute between a Seeker and a Provider, the MCDUF system 2700 may find recorded communications very useful to help mediate such situations.

Furthermore, with a proliferation of communication devices, media, technologies and providers, mismatches may occur wherein direct communication between a Seeker and a Provider may not be possible without translation. Acting as a ‘man in the middle’ communications proxy (not shown), for example, a MCDUF system 2700 may provide communication translation services such as translating between text and voice media. Furthermore, a MCDUF system 2700 may provide an enhanced service or combination of enhanced services not available to (or otherwise not subscribed to) by a given Provider and/or Seeker. So further by example, a MCDUF system 2700 may provide a Seeker with an automated message delivery and call back service (not shown) whereby a Seeker's message might be recorded, sent to one or several Providers possibly on a time delayed basis, and the Provider's responses routed back to the Seeker via one or several Seeker-specified communication facilities, e.g., voice, instant messaging and texting. Such enhanced communication services may additionally be offered to Seekers for utilization other than satisfying URGS needs.

In an another example, the MCDUF system 2700 may provide an automated electronic communication exchange capability (not shown) for a given Provider, whereby Seekers' requests may be recorded, forwarded, multi-cast, translated, rolled-over and other-wise processed in order to deliver communications to the Provider in real time or on a delayed basis. Such an automated communication exchange capability may also provide services mediated by a schedule such that, for example, communications may be routed differently depending on the time of day or day of the week—say to an office phone and an e-mail address during office hours; and to a personal cell phone and a text number after hours. Additionally, such an exchange may provide access to human-mediated communications services such as a live phone or on-line chat attendant. Such enhanced communication services may additionally be offered to Providers for utilization other than satisfying URGS needs.

Similarly, the routing of communication or the control of other services to a Provider or to a Seeker by the MCDUF system 2700 may be based on “presence”, i.e., the apparent (or deduced) location of that user. Presence may be determined in numerous ways including but not limited to: explicit or predictive scheduling; instrumentation such as smart phone or automotive GPS; cell tower utilization; home, private or public monitoring systems; as well as explicit setting by the user.

In addition to supporting and possibly augmenting a Provider's communication with Seeker's, the MCDUF system 2700 may provide services related to ‘new media’ such as social networks (not shown). So for example, the MCDUF system 2700 may aggregate consumer reviews of a given Provider that may appear on third party sites such as Yelp. Conversely, the MCDUF system may provide selected or aggregated data to third party services such as Yelp or Angie's List. So for example, the MCDUF system 2700 may provide an on-line provider reputation monitoring and enhancement service.

Referring again to FIG. 46, such a provider call and message routing screen 4600 may additionally include facilities (not shown) for configuring and controlling augmented provider communication services such as those described above. Near the bottom of screen 4600, virtual buttons 4680 and 4690 may provide the potential provider with the respective options to either ‘continue’ the process to potentially become a Provider or to ‘cancel’ the process.

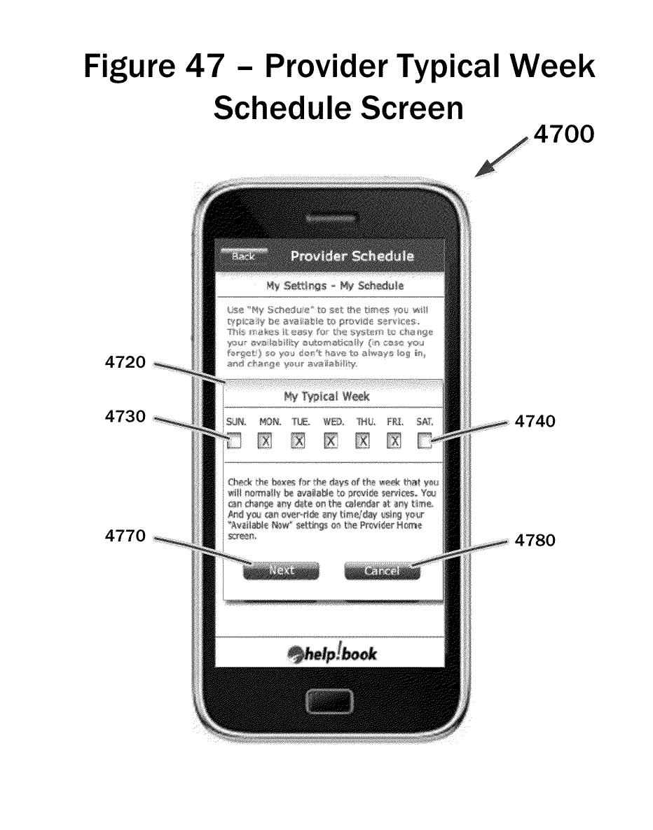

FIG. 47 provides an exemplary screen 4700 to illustrate facilitating a Provider to schedule likely availability on a typically recurring basis such that the MCDUF system 2700 may take that into account when selecting Providers to proffer to a given Seeker. For example, utilizing a subscreen 4720 may the potential provider may input a typical week's schedule of availability to provide URGS. Such a schedule may be indicated with checkboxes for individual days of the week whereby a potential provider may indicate likely availability by checking a given day's check box or indicate likely unavailability by not unchecking (or leaving unchecked) a given day's check box, e.g., checking all check boxes except the weekend days, i.e., Saturday 4780 and Sunday 4770. Near the bottom of subscreen 4720, virtual buttons 4770 and 4780 may provide the potential provider with the respective options to either ‘continue’ the process to potentially become a Provider or ‘cancel’ the process.

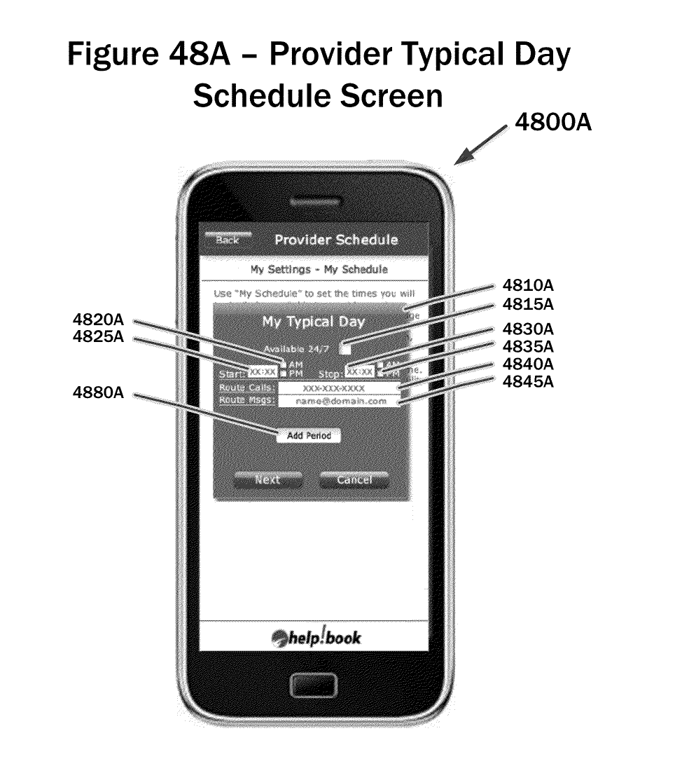

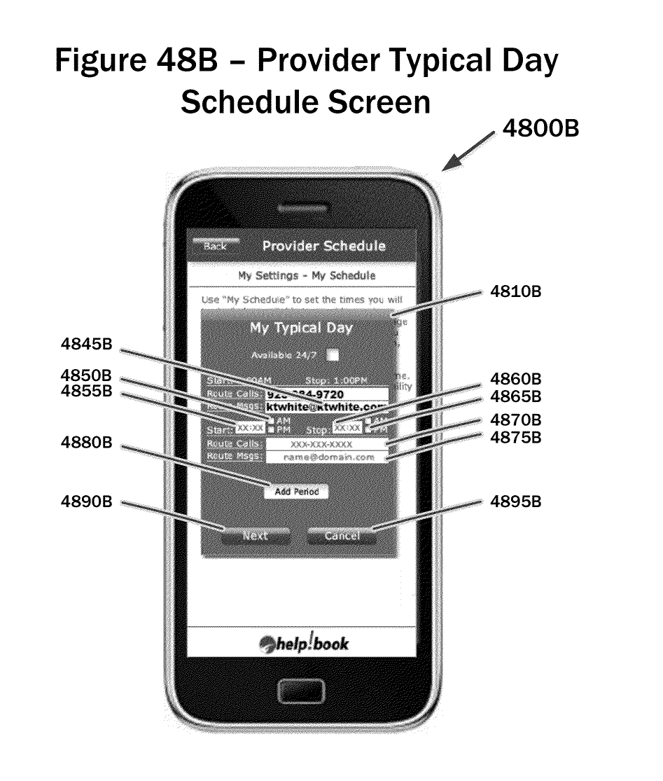

FIG. 48A provides an exemplary screen 4800A to further illustrate facilitating a Provider to schedule likely availability on a typically recurring basis such that the MCDUF system 2700 may take that into account when selecting Providers to proffer to a given Seeker. For example, a subscreen 4810A may facilitate the potential provider's entry of a typical daily schedule of availability to provide URGS. Such a schedule may be indicated utilizing a combination of check boxes and input boxes. For example, check box 4815A may be checked to indicate ‘24/7’ (24 hours per day/7 days a week) availability, i.e., nominally continuous availability. Checking such a ‘24/7’ box 4815A may effectively override any other schedule settings indicated in subscreen 4810A. If a potential provider does not indicate ‘24/7’ availability, a daily period of availability may be indicated instead. So for example, a potential provider may enter a daily start time for availability in input box 4825A and set a corresponding AM or PM indication via one of the check boxes at 4820A. Similarly, a potential provider may enter a daily stop time for availability in input box 4830A and set a corresponding AM or PM indication via one of the check boxes at 4835A. Input boxes 4840A and 4845A provide a facility for the potential provider to indicate a contact phone number and/or contact email address that may take precedence during the indicated daily time period over communication addresses previously indicated utilizing screen 4600. The potential provider may add an additional scheduled daily availability period by selecting the ‘add period’ virtual button 4880A.

FIG. 48B provides an exemplary screen 4800B to further illustrate a Provider indicating likely daily availability on a recurring weekly basis. More specifically, subscreen 4810B illustrates the indication by the potential provider of an additional daily period of availability. One such period, at or above 4845B in subscreen 4810B may already have been completed for the period 7:00 AM to 1:00 PM. By selecting the ‘add period’ virtual button 4880A on the previous screen—screen 4800A—the potential provider may have chosen to indicate a second daily availability period that may be indicated similar to the period above utilizing the functionally equivalent check boxes and input boxes at 4850B and 4860B and at 4855B, 4865B, 4870B, 4875B respectively. Yet more daily availability periods may be added by the potential provider selecting the ‘add period’ virtual button 4880B. Multiple additional periods may be added iteratively in this fashion until all such anticipated periods may be indicated. Near the bottom of subscreen 4810B, virtual buttons 4890B and 4895B may provide the potential provider with the respective options to either ‘continue’ the process to potentially become a Provider or to ‘cancel’ the process.

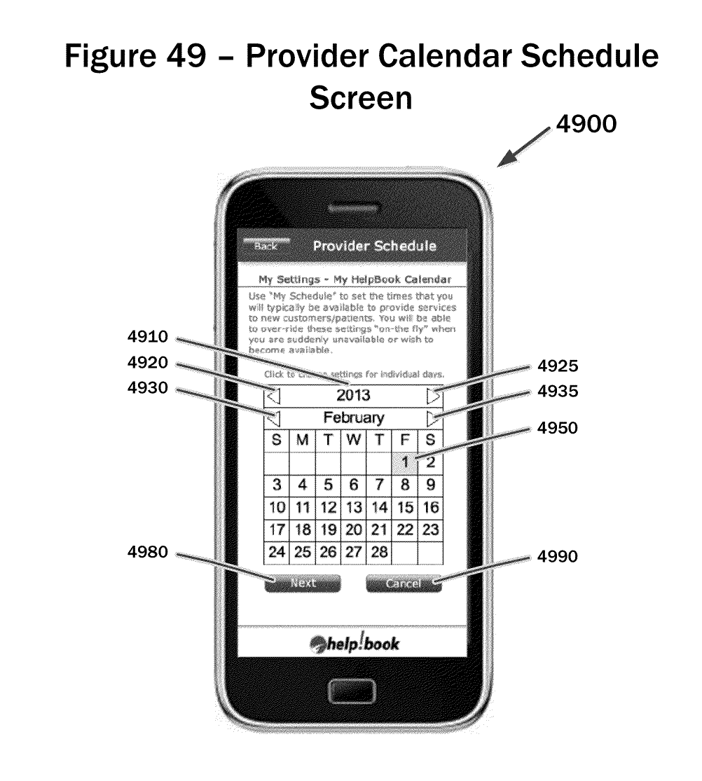

FIG. 49 provides an exemplary screen 4900 to illustrate facilitating a potential provider to schedule likely availability on a one time exception basis such that the MCDUF system 2700 may take that into account when selecting Providers to proffer to a given Seeker. For example, screen 4900 includes a dynamic interactive calendar subscreen 4915 whereby a potential provider may select a year via ‘decrease’ and ‘increase’ selectors 4920 and 4925 respectively. Furthermore, a potential provider may select a month utilizing ‘decrease’ and ‘increase’ selectors 4930 and 4935. Having thusly selected a year and month, subscreen 4915 may automatically display a corresponding grid of calendar days for the selected month/year. Each numbered ‘day’ virtual button on the calendar grid may be individually selected. So for example, the potential provider may select the virtual button 4950 corresponding to Feb. 1, 2013. Selecting a day thusly, may allow the potential provider to indicate day-specific availability for that date as described below in the discussion of screen 5000.

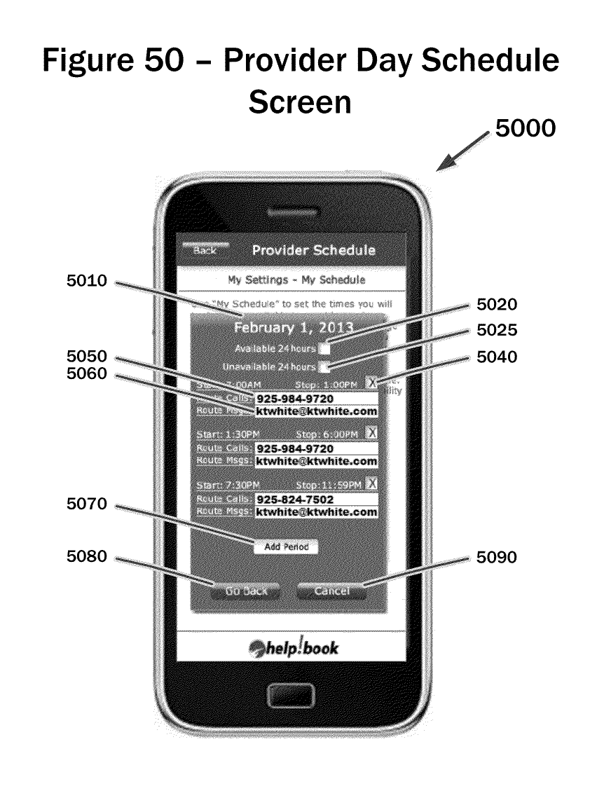

FIG. 50 provides an exemplary screen 5000 to illustrate further facilitating a potential provider to schedule likely availability on a one time exception basis such that the MCDUF system 2700 may take that into account when selecting Providers to proffer to a given Seeker—in some embodiments, effectively temporarily over-riding scheduled availability on a one-time exception basis without altering subsequent scheduled availability. In this example, screen 5000 provides an interactive subscreen 5010 very similar in operation to subscreens 4810A/4810B except that only a single day's scheduled availability is effected as opposed to every recurrence of the day. Subscreen 5010 may include pre-populated availability periods that the potential provider may have set previously via screen 4800. Radio button 5020 may allow the potential provider to set the day's scheduled availability to the full 24 hours. Conversely, radio button 5025 may allow the potential provider to set the day's scheduled availability to 0 hours, i.e., unavailable for the full 24 hours. Each pre-populated scheduled time period displayed in subscreen 5010 may be individually de-scheduled by unchecking a corresponding checkbox. So for example, unchecking the check box 5040 will de-schedule the previously scheduled period 7:00 AM to 1:00 PM specifically on Feb. 1, 2013. In addition to descheduling periods, a potential provider may add one or more additional periods utilizing the ‘add period’ virtual button 5070. Near the bottom of screen 5000, virtual buttons 5080 and 5090 may provide the potential provider with the respective options to either ‘go back’ to screen 4900 so as to continue scheduling potential availability or to ‘cancel’ the process to potentially become a Provider.

Referring again to FIG. 49, utilizing screen 4900, a potential provider may specifically select a multiplicity of days—one at a time—to specifically indicate availability for each one of such individual days. Near the bottom of screen 4900, virtual buttons 4980 and 4990 may provide the potential provider with the respective options to either ‘continue’ the process to potentially become a Provider or to ‘cancel’ the process.

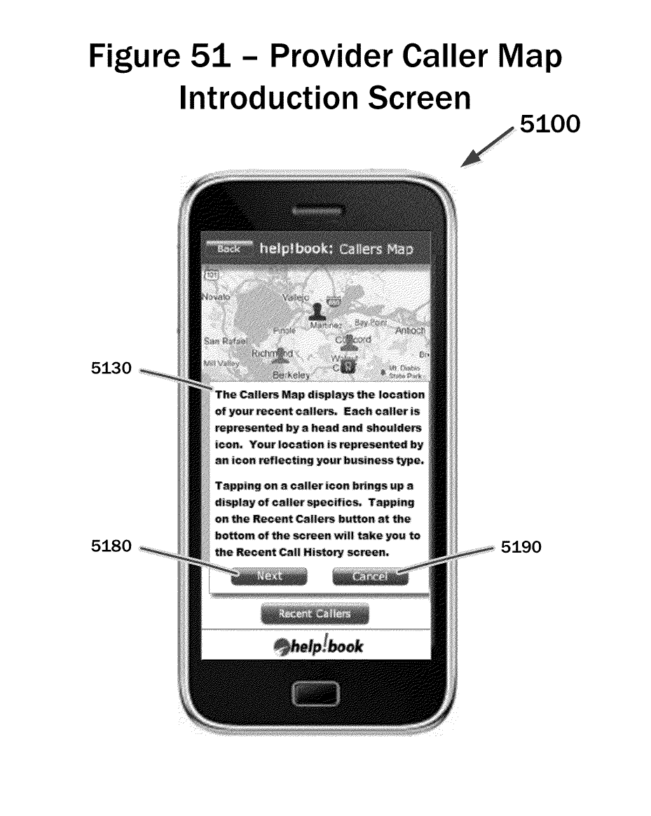

FIG. 51 provides an exemplary screen 5100 to illustrate facilitating a potential provider to view a callers map. Such a screen 5100 may include a subscreen 5130 with a textual description that may explain to the potential provider the utilization of the facilities of a callers map. Near the bottom of subscreen 5130, virtual buttons 5180 and 5190 may provide the potential provider with the respective options to either ‘continue’ the process to potentially become a Provider or to ‘cancel’ the process.

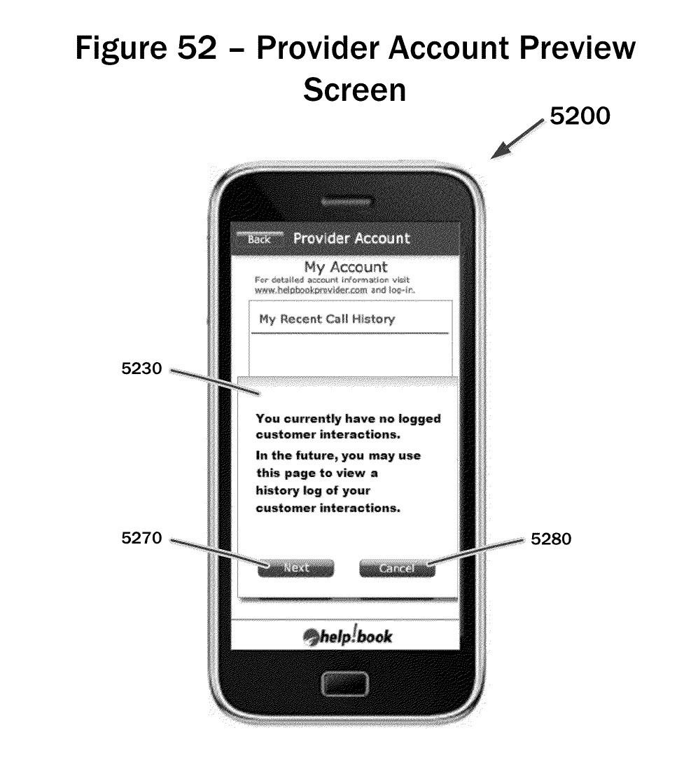

FIG. 52 provides an exemplary screen 5200 to illustrate facilitating a potential provider to view a Call History. Such a screen 5200 may include a subscreen 5230 with a textual description that may explain to the potential provider the utilization of the facilities of the Call History. Near the bottom of subscreen 5230, virtual buttons 5270 and 5280 may provide the potential provider with the respective options to either ‘continue’ the process to potentially become a Provider or to ‘cancel’ the process.

Furthermore, subscreen 5250 may include a textual description that may explain to the potential provider that the profile configuration process may have been successfully concluded. Near the bottom of subscreen 5250, virtual buttons 5270 and 5280 may provide the Provider with the respective options to either ‘continue’ the process to potentially become a Provider or to ‘cancel’ the process.

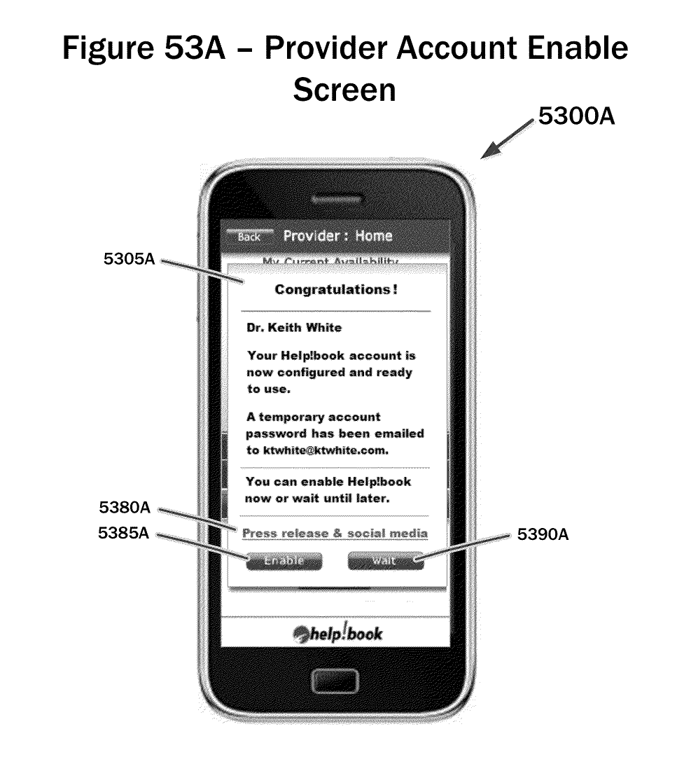

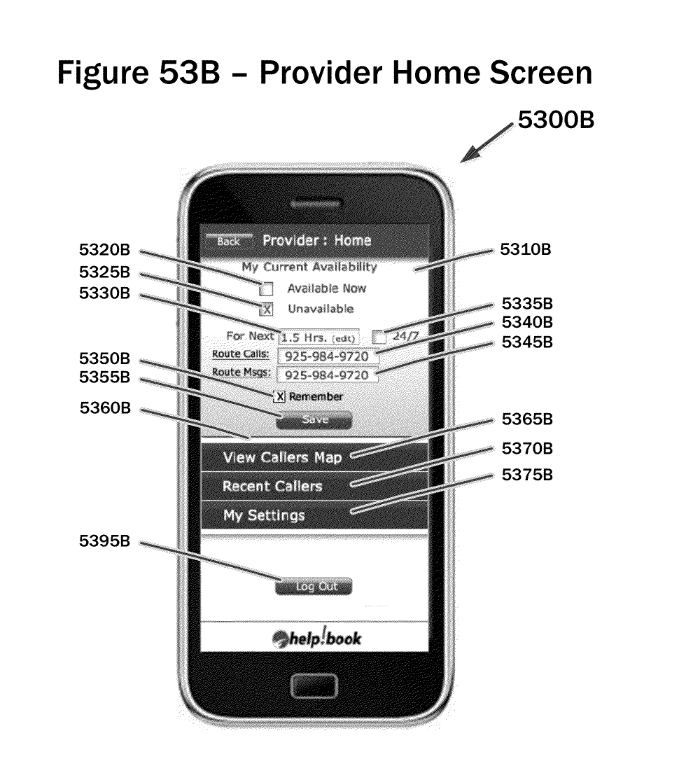

FIG. 53A provides an exemplary screen 5300A to illustrate facilitating a potential provider to complete the process of becoming a Provider. Such a screen 5300A may include a subscreen 5305A that may be displayed overlaying the ‘home screen’ of the Provider app 2790. Subscreen 5305 may include an explanation of how to retrieve a password for subsequent account log-ins. A ‘press release and social media’ link 5380A may be utilized by the new Provider to access marketing tools (not shown) to issue press releases and social media updates in order to publicize the Provider's business and the Provider's new association with the MCDUF system 2700. In some embodiments, such marketing tools may be utilized on a regular basis by the Provider in order to promote the Provider's business. Near the bottom of subscreen 5305A, virtual buttons 5385A and 5390A may provide the new Provider with the respective options to either ‘enable’ the operation of the Provider's MCDUF system account or to ‘wait’ (i.e., postpone enabling the account.) Enabling the account may allow the MCDUF system 2700 to proffer the Provider to Seekers with URGS needs. Selecting either virtual button 5385A or 5390A may conclude the process of making the potential provider a new Provider for the MCDUF system 2700; and additionally such action may close subscreen 5305A so that home screen 5300B may be utilized by the Provider—as described further below.

It may be noted, that by navigating through screens such as 4100, 4200A, 4200B, 4300, 4400A, 4400B, 4500, 4600, 4700, 4800A, 4800B, 4900, 5000, 5100, 5200 and 5300A, a new Provider may have both configured the Provider's account so that the MCDUF system 2700 may proffer that Provider to Seekers of URGS, but additionally may have in effect given the new Provider a guided tutorial for many of the screens that the Provider may utilize subsequently to maintain the Provider's account.

FIG. 53B provides an exemplary screen 5300B to illustrate facilitating a potential provider to utilize the Provider account facilities of the MCDUF system 2700. In some embodiments, screen 5300B may be the ‘home screen’ that may be displayed each occasion the Provider subsequently logs in. Such a home screen 5300B may include a ‘my current availability’ subscreen 5310B pre-populated with the Provider's current scheduled availability (or unavailability) and corresponding current preferences for Seeker call and message routing. Furthermore, subscreen 5310B may provide facilities whereby the Provider may revise such currently scheduled availability/unavailability and routing settings. In the example of screen 5300B, the Provider may select the ‘available now’ radio button 5320B, which may automatically deselect the ‘unavailable’ radio button 5325B. Or the Provider may select the ‘unavailable’ radio button 5325B, which may automatically deselect the ‘available now’ radio button. The resulting setting of these two radio buttons may control the sense of the duration setting that may be viewed and edited utilizing either input box 5330B or the ‘24/7’ check box 5335B—i.e., whether such a duration may pertain to a selection of availability or to a selection of unavailability. The setting of radio buttons 5320B and 5325B may be pre-populated based on existing scheduled availability/unavailability. In some embodiments, lacking an existing schedule of either availability or unavailability, one of the two radio buttons may be automatically pre-selected as a default. Accordingly, in many embodiments, the default pre-selection for the two radio buttons may be ‘unavailable’; however, in some embodiments, the default pre-selection for the two radio buttons may be ‘available now’.

As mentioned above, the Provider may check the ‘24/7’ check box 5335B, thusly overriding the duration setting in input box 5330B as well as any regularly scheduled availability or unavailability; and thereby potentially making the Provider immediately and continuously available (or unavailable) until check box 5335B is unchecked or until such 24/7 availability (or unavailability) is otherwise overridden. The Provider may uncheck (or leave unchecked) check box 5335B such that the duration time setting in input box 5330B may control the duration of availability or unavailability selected utilizing one of radio buttons 5320B and 5325B.

Utilizing input box 5340B, the Provider may specify a contact number where to route Seeker calls for the duration specified by the combined operation of 5330B and 5335B. Similarly, utilizing input box 5345B, the Provider may specify a contact number where to route Seeker text messages for the same duration. In some embodiments, the Provider may utilize facilities (not shown) to specify a multiplicity of alternative contact numbers to route calls as well as a multiplicity of alternative contact texting numbers and/or email addresses to route messages.

The ‘remember’ checkbox 5350B may be checked so as to retain the settings in input box 5340B and 5345B subsequent to expiration or over-ride of the duration specified by 5330B or 5335B, otherwise 5330B and 5335B may revert to values configured via screen 4600 (or otherwise determined by default values in lieu of such configuration utilizing screen 4600). The Provider may select the ‘save’ virtual button 5355B so as to cause the settings 5320B, 5325B, 5330B, 5335B, 5340B, 5345B and 5350B to go into effect immediately. Otherwise, such settings may not go into effect and may be lost at such time as the next scheduled availability occurs, except that 5340B and 5345B may be preserved by the possible selection of the 5355B ‘remember’ checkbox.

A menu 5360B consisting of virtual buttons may appear below subscreen 5310B. Such virtual buttons may include: a ‘view callers map’ virtual button 5360B, a ‘recent callers’ virtual button 5365B and a ‘my settings’ virtual button 5370B. In some embodiments, a ‘my current availability’ virtual button (not shown) may be included in menu 5360B in lieu of subscreen 5310B such that selecting such a ‘my current availability’ virtual button may facilitate navigation to a separate screen with display content and operational utility similar and perhaps equivalent to subscreen 5310B. In some embodiments, other additional virtual button menu selections may be included. For example, such an additional virtual button may be ‘my other businesses’ (not shown) whereby a Provider may be facilitated to offer URGS in more than one URGS category from the same provider account. So for example, Keith White may thusly be proffered by the MCDUF system 2700 say as a watch repair specialist in addition to as a general dentist.

Selecting virtual button 5365B may navigate the Provider to a callers map screen 5400 similar to the callers map previously viewed by the potential provider at screen 5100, but without the explanatory subscreen overlay 5130.

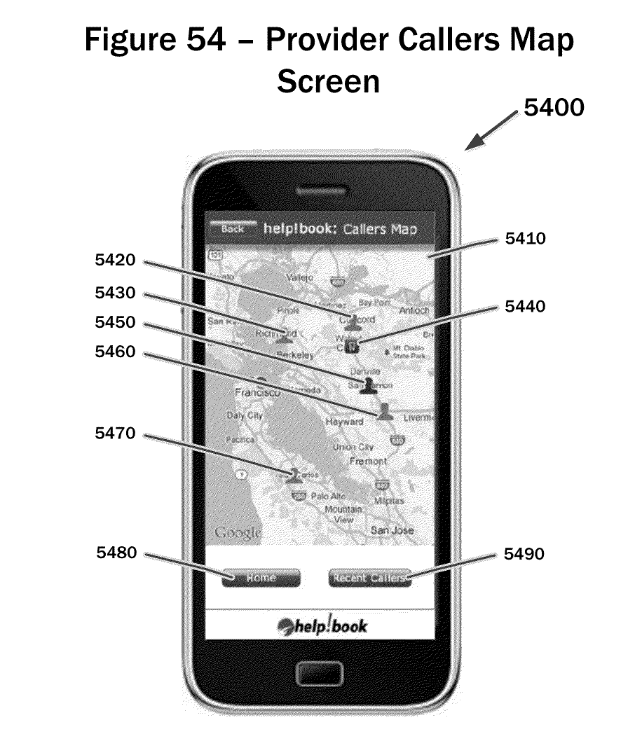

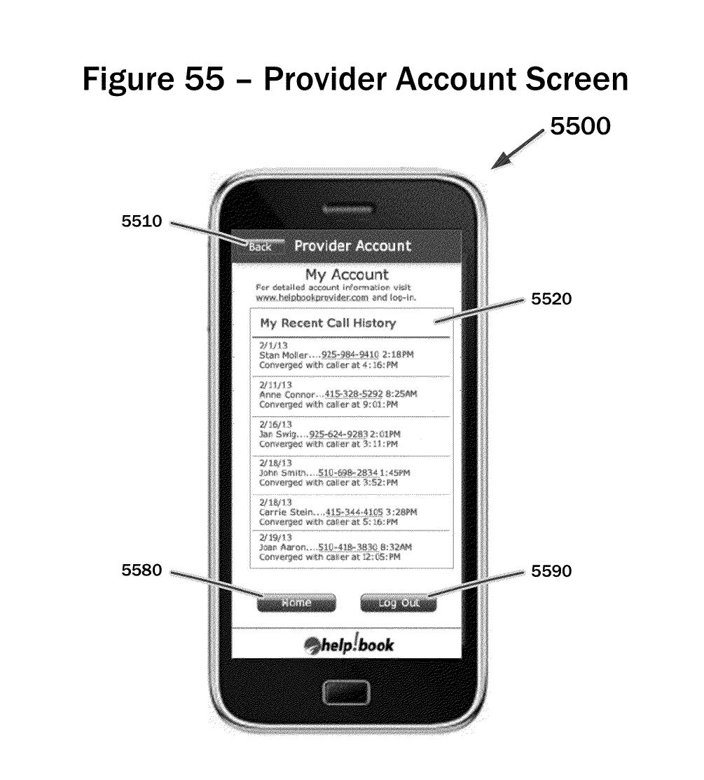

FIG. 54 provides an exemplary screen 5400 to illustrate facilitating a Provider to comprehend the nominal location of recent callers via a ‘callers map’. Such a callers map 5410 may represent the most current nominal location of recent callers, i.e., Seekers who have contacted the Provider via the MCDUF system 2700 to request URGS. Each recent caller may be represented on a map by a corresponding icon, i.e., 5420, 5430, 5450, 5460 and 5470. The Provider may also be represented on such a map by a distinctive icon. Such a provider icon may be specific to the Provider's provider URGS category—for example a tooth icon 5440 representing the Provider who may be a dentist. The callers map 5410 may periodically be dynamically updated so as to animate the progress of recent callers who may be traveling to meet the Provider. Selecting virtual button 5490 may navigate the Provider to a provider account screen 5500 wherein the Provider may view a recent call history as illustrated by FIG. 55 (described below). Selecting virtual button 5480 may navigate the Provider back to home screen 5300B.

FIG. 55 provides an exemplary screen 5500 to illustrate facilitating a Provider to view the specifics of recent calls via a ‘recent call history’ subscreen 5520 of a ‘my accounts screen’ 5500. Such a recent call history 5520 may display a list of the names and originating phone numbers for each of the inbound calls from Seekers logged by the MCDUF system 2700 within a given time period—for example, within the last thirty days. Selecting ‘back’ virtual button 5510 may navigate the Provider back to the previous screen the Provider may have been utilizing—for example screen 5400 described above. Or selecting the ‘home’ virtual button 5580 may navigate the Provider to home screen 5300B. Selecting the ‘log out’ virtual button 5510 may log the Provider out of the Provider app 2790.

Referring back to FIG. 53B and screen 5300B, selecting the ‘recent callers’ virtual button 5370B may navigate the Provider directly to a ‘my accounts’ screen 5500 where recent call history subscreen 5520 may be viewed as described above.

Referring again to FIG. 53B and screen 5300B, selecting the ‘my settings’ virtual button 5375B may navigate the Provider directly to a ‘my settings’ screen 5600 (described below).

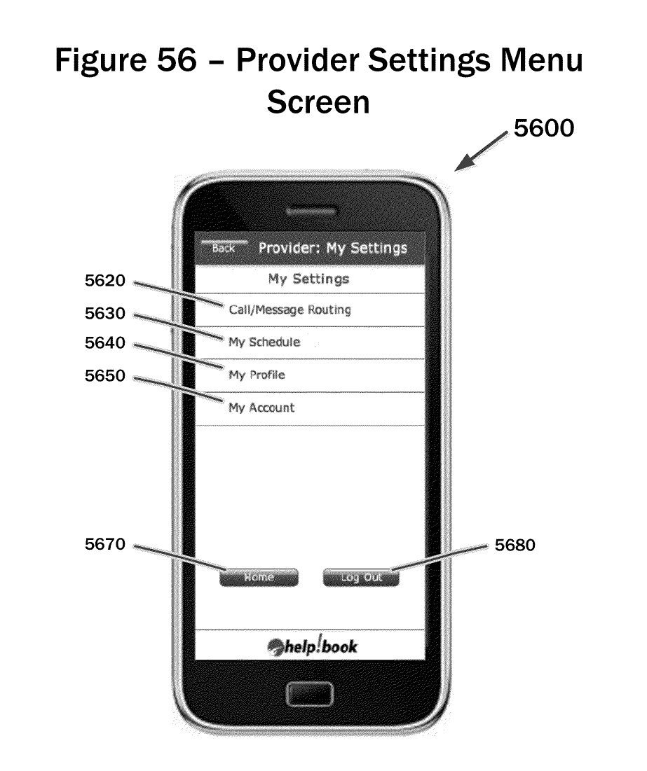

FIG. 56 provides an exemplary screen 5600 to illustrate facilitating a Provider to navigate to various account setting screens. So for example, such a ‘my settings’ menu screen 5600 may include: a ‘call/message routing’ virtual button 5620, a ‘my schedule’ virtual button’ 5630, a ‘my profile’ 5640, and a ‘my account’ virtual button 5650. Each such virtual button within such a menu screen 5600 may facilitate navigation—perhaps via additional menu screens—to a screen or screens that may be utilized to display and potentially alter various groupings of the Provider's account settings. In some embodiments, navigation among such screens may be organized as a mesh so as to facilitate navigation via a variety of different selection paths to access a given desired accounts setting screen. Such a mesh may provide the Provider a more flexible navigation facility than perhaps a navigation facility with a strict tree-like navigational hierarchy wherein a single mis-selection may cause the Provider to fail to navigate to the desired accounts setting screen. So as an example of such a mesh, selecting ‘my account’ virtual button 5650 may provide yet another navigation path to screen 5500.

Referring again to FIG. 53B and ‘home screen’ 5300B, navigational virtual buttons in a menu subscreen 5360B may be arrayed in various embodiments in differing groupings and orderings of such navigational virtual buttons. Furthermore, in some embodiments, the groupings and orderings of such navigational virtual buttons may vary within a given embodiment—subject perhaps to the provider URGS category corresponding to the Provider. So for example, it may perhaps be statistically determined that a typical plumber Provider may have a different navigational utilization pattern than a typical dentist Provider; and therefore may find a menu subscreen that differs from a typical dentist Provider's menu easier and/or more efficient to utilize. Furthermore, in some embodiments the Providers app may include screens that may be accessible by a limited subset of Providers within specific provider URGS categories. For example, a ‘weather map’ screen may be available to flooring water damage repair Provider's and roofing repair Provider's, but not to dentist Providers. Additionally, certain screens may be limited to access by a subset of Providers—determined perhaps based on access fees; or possibly provided as premiums in various embodiments of Provider loyalty programs.

Having configured and enabled operation of the provider account, for example as described above, the Provider may utilize the MCDUF system 2700 via one (or a combination of) Provider apps 2790 so as to receive notifications of Seeker requests. Such Seeker request notifications may seem most valuable to the Provider in instances that the Provider may be both: available to respond to such requests; and also subsequently available to provide the requested URGS in a timeframe and location that may be satisfactory to the corresponding Seeker. The reception of Seekers' URGS requests may be a mixed blessing. Get too many requests and the Provider may become frustrated by distractions that may detract rather than add to business. Or perhaps worse, get too few requests—particularly early on in the utilization of the MCDUF system 2700—and the Provider may lose interest in utilizing the system. Micro-casting may address such dilemmas by dynamically modulating the volume of URGS requests sent by the MCDUF system 2700 to any given Provider.

A number of factors may be considered individually and in concert as the MCDUF system 2700 utilizes micro-casting to modulate the transmission of Seeker requests to URGS Providers. At a high level such factors may include (but not be limited to): Seeker interests, Provider interests, the interests of the MCDUF system 2700 (i.e., system owners and operators), and possibly the interests of third parties in various combinations that may include (but not be limited to): licensing and regulatory organizations, investors, public interest groups, law enforcement, industry special interest groups, and possibly, advertisers. Furthermore, the relative importance of—and therefore the weighting assigned to—any given such factor may vary depending on additional mediating factors such as: the geographic region of the URGS search, the URGS category(s), the density of available URGS suitable Providers, the density of nominally URGS need-equivalent Seekers, external events such as bad weather, traffic jams, catastrophes, as well as predictive statistical patterns related to additional factors such as time of day, season of the year, phase of the moon, weather, holidays and other factors effecting human behavior.

Therefore, it may be understood that micro-casting may utilize densely complex algorithms, and short of listing out algorithmic source code, such algorithms may best be characterized by reduction to a set of decision guidelines wherein such guidelines may be applied in combination with respective relative weightings. Furthermore, in combining the guidelines of micro-casting, it may occur that any given micro-casting guideline may be moderated, i.e., ‘bent’ or even over-ridden by another micro-casting guideline depending on the relative weighting given to each of a set of applicable guidelines and the determining factors controlling the application of those micro-casting guidelines by the MCDUF system 2700 so as to modulate transmissions of a given Seeker's URGS request to URGS Providers.

To illustrate the utilization of micro-casting by the MCDUF system 2700, an example is provided below. As mentioned previously, micro-casting may operate so as to utilize guidelines to attempt to balance the interests of the Seeker, of Providers, of the MCDUF system 2700, and of third parties. Some such guidelines and associated determining factors are represented by the tables and associated descriptions that follow.

A multiplicity of factors and corresponding guidelines may be utilized for a given Seeker and a corresponding set of suitable Providers. The tables below summarize an example of nine potential factors and corresponding guidelines. The first three guidelines may apply to a given Seeker with a need for URGS. The exemplary guidelines related to such a Seeker may be utilized to help rank that Seeker's request for URGS against any potential competing Seeker's request. Therefore, if more than one Seeker is seeking to obtain URGS from a given Provider, the request of a higher prioritized Seeker may be sent to that Provider before the request of a lower prioritized Seeker may be sent to that Provider.

So for example, guideline 1 may be based on the urgency inherent in the type of URGS sought. Such urgency may be determined perhaps by an analysis of the Seeker's description of their needs. Screen 3700B in FIG. 37B provides an example wherein Seeker Sam Smith indicates that he has two broken teeth. If a competing Seeker needs teeth whitened, Sam's requests may be assigned a higher priority.

Guideline 2 may be based on the Seeker's sense of urgency. As described previously, such a sense of urgency may be assessed from instrumentation of the Seeker app.

Guideline 3 may be based on the Seeker's registration status. A fully registered Seeker may perhaps be more likely to commit and therefore be more reliable to obtain the URGS from a proffered Provider.

Seeker Related Guidelines

| | | Guideline | |
|---|---|---|---|
| | Factor | prioritize Seeker request if: | de-prioritize Seeker request if: |
| 1 | Need-based | higher urgency is typical for | lower urgency is typical for the type |
| | urgency | the type of need | of need |
| 2 | Seeker's | Seeker urgency assessed as | Seeker urgency assessed as lower |
| | urgency | higher | |
| 3 | Seeker | Seeker is registered user | Seeker is non-registered user |
| | loyalty | | |

Provider Related Guidelines

| | | Guideline | |
|---|---|---|---|
| | Factor | Favor a Provider if: | Avoid a Provider if: |
| 4 | Availability | scheduled as available | scheduled as unavailable |
| 5 | Unavailability | no preference is | scheduled as unavailable |
| | | scheduled | |
| 6 | Proximity | closer to Seeker's | farther from Seeker's |
| | | location | location |
| 7 | Quality rating | higher rating | lower rating |
| 8 | Likelihood to | higher response ratio | lower response ratio |
| | respond | | |
| 9 | Likelihood to | higher acceptance ratio | lower acceptance ratio |
| | accept request | | |

The example guidelines 4 through 9 above may apply to a given Provider who may be suitable to provide the URGS sought by a given Seeker. The exemplary guidelines may be utilized to rank such a Provider so as to help determine whether to present a given Seeker's request to that Provider or to another suitable Provider before that Provider. So if more than one Provider is suitable to provide the URGS sought by a given Seeker, a Provider ranked higher may be sent such a request before it may be sent to a lower ranked provider.

So further by example, guideline 4 may be based on a Provider's explicitly scheduled availability or unavailability to receive Seeker requests. Screens 4700, 4800A, 4800B, 4900, 5000 as well as screen 5300B illustrate examples of how general dentist Dr. Keith White may schedule availability to receive Seeker requests. Screens 5000 and 5300B illustrate examples of how Dr. White may schedule a period of time as explicitly unavailable (as opposed to explicitly available) utilizing check box 5025 in screen 5000 and/or utilizing check box 5330B in screen 5300B.

Guideline 5 may be closely related to guideline 4. In some instances, periods of a given Provider's time may be left unscheduled—i.e., neither explicitly available nor explicitly unavailable. The MCDUF system 2700 may treat such unscheduled periods to be more likely to be periods of availability than time periods for that Provider that have been explicitly scheduled as unavailable. Guidelines 4 and 5 in combination may result in a continuity of prediction of Provider availability, wherein explicitly scheduled availability may be ascribed the highest certainty, the lack of any scheduling either way may be ascribed a lower degree of certainty, and scheduled unavailability may be ascribed the lowest certainty of availability.

Furthermore, in some embodiments, an explicit scheduling of unavailability may be over-ridden by the MCDUF system 2700 such that a Seeker's request may be sent to a given Provider who is nominally unavailable for Seeker requests. A number of factors may be considered in determining whether to over-ride a Provider's setting of scheduled unavailability—such factors may be termed “supplemental availability characteristics”. For example, if many days or maybe weeks have passed since the Provider scheduled such unavailability, such scheduling may be stale and therefore inaccurate. On the other hand, if the Provider has very recently scheduled the unavailability, it is more likely to correctly reflect the Provider's current intention. As another example, if the Provider is relatively new to the MCDUF system 2700 and perhaps has not yet received many Seeker requests, it may be reassuring to that Provider to receive some requests even if they come at times that the Provider would prefer not to respond. If the Provider wishes to enforce a scheduled unavailability, such scheduling may be updated to make the intention more explicitly current. Scheduling screens such as 5000 and 5300 may be instrumented so that the MCDUF system 2700 may take notice of a Provider's deliberate re-iteration of unavailability and therefore be less likely to over-ride it again soon. On the other hand, if a Provider responds to Seeker requests that over-ride scheduled unavailability—especially if the Provider accepts some such over-riding requests—the MCDUF system may continue to over-ride scheduled unavailability for that Provider. Again, instrumentation of Provider app screens may be utilized by the MCDUF system 2700 to determine how the Provider responds to such over-riding Seeker requests. Finally, the MCDUF system may take into account time temporal circumstances such as time of day, or day of week, in determining whether to over-ride a scheduled unavailability. For example, it may be undesirable to over-ride unavailability late at night or perhaps on a day that is commonly observed as a Sabbath day.

In some embodiments, supplemental availability characteristics may also include factors that may cause a Provider to be triaged as if ‘available’ even if neither availability nor unavailability may be explicitly scheduled for that Provider. For example, a Provider may explicitly schedule weekdays, but neglect to schedule time during week-end days as available or unavailable.

Referring again to the exemplary guideline tables above, guideline 6 is based on the proximity of the Provider's nominal location to the nominal location of a given Seeker requesting URGS. In the example of Provider general dentist Dr. Keith White, his nominal location may be taken to be at his office address as indicated by Dr. White utilizing screen 4400B. The nominal location of a Seeker such as Sam Smith may be determined automatically for example by utilizing a facility such as a GPS reading from the Seeker's mobile device. Alternatively, in some embodiments, a Seeker may explicitly specify the Seeker's nominal location—for example, utilizing screen 3900B.

Guideline 7 is based on a Provider's quality rating. Such a rating may be aggregated from the feedback of a multiplicity of Seekers who have utilized the Provider for URGS needs and therefore have first-hand experience with the Provider. For example, referring to screen 4000D, Dr. Keith White may be seen to have a very laudatory 4 out of 4 stars quality rating. In some embodiments, ratings of Seekers who have not received URGS may be aggregated into a Provider's quality rating. Such Seekers may for example been turned down by the Provider. Additionally, in some embodiments, third party ratings may be aggregated into a Provider's quality rating. A given Seeker's request may be sent to a higher quality rated Provider before it may be sent to a lower rated one. However, in some embodiments a lower rated Provider may be favored. For example, a new Provider may have had very few Seeker requests and therefore any quality rating of that Provider may be based on a small sample size and therefore be perhaps less than reliable. In some embodiments, a loyalty-inducing factor may be included in Provider rankings such that an incremental bias may to some degree favor and thus encourage new Providers to continue utilization of the MCDUF system 2700.

Referring once more to the exemplary guideline tables above, guideline 8 is based on a given Provider's likelihood to respond. A response by a Provider may be both of valued to a Seeker and to the MCDUF system 2700. For a Seeker, a Provider's response may give a very clear acknowledgement that the MCDUF System 2700 may in fact be successfully contacting Providers on the Seeker's behalf. Even if a Provider turns down a Seeker's request, the Seeker may be encouraged a momentary expression of interest and perhaps concern. For example, in turning down a Seeker's request, a Provider may still provide useful advice and/or heartfelt sympathy. A response from a Provider may also be valuable to the MCDUF system 2700 in that it may cause the MCDUF system to stop sending Seeker requests—assuming the Provider responded positively; or to continue sending out Seeker requests to additional Providers—assuming the Provider responded negatively thereby decreasing the number of outstanding Seeker requests.

Guideline 9 is based on the likelihood of a Provider accepting a Seeker's request. Just as it may be more desirable for a Seeker to receive a courteous response in the negative than no response at all, it most certainly may be more desirable—and in fact is a key goal of the MCDUF system 2700—that a Seeker receive a positive response. Accordingly, the MCDUF system 2700 may favor sending Seeker requests sooner to those Providers who are more likely to respond with an acceptance. That said, a given Provider's high acceptance rating may not always be the best indicator of a good potential match. Consider the provider with a high acceptance rating, but a poor quality rating. Conversely, a low acceptance rating may not always be a reliable indicator of a bad potential match. Many factors may play into a Provider's decision to accept or turn down a Seeker's request, therefore in some embodiments, the MCDUF system 2700 comprehensively and exhaustively analyzes Seekers requests and Provider's responses (and non-responses) to develop a multi-factor based assessment of the types of Seeker requests a given Provider is most likely to accept. In this way, the MCDUF system 2700 may increase the likelihood that any given Seeker will quickly find a Provider, and that even the more picky Providers will receive requests from Seekers that may be a good match.

In some embodiments of micro-casting, Seeker requests may be sent out using a metering facility such that a limited number of Seeker requests may be outstanding at any one time. By metering requests thusly, particularly when statistically responsive Provider's may be favored, the MCDUF system 2700 may avoid bothering Providers with requests that they may not respond to in time to obtain the Seeker's business.

In addition to considering the factors and guidelines that may contribute to the operation of micro-casting, it may be informative to consider an example of a Seeker/Provider interaction utilizing the MCDUF system 2700.

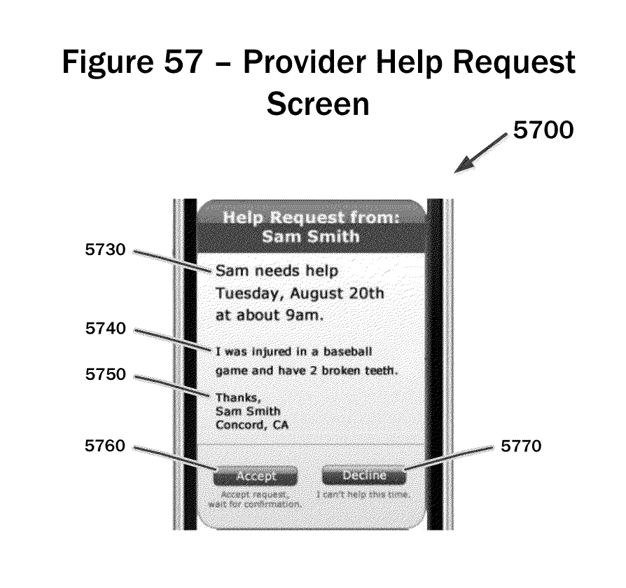

Referring once again to FIG. 29, at step 2930, in some embodiments, facilitating the display of a Seeker's URGS request may begin with and/or otherwise include a notification (e.g., a push notification) from the MCDUF system 2700 (not shown) and a corresponding Seeker URGS request—as exemplified in FIG. 57 as described in the paragraphs below.

FIG. 57 provides an exemplary screen 5700 to illustrate facilitating a Provider to receive a Seeker request for URGS. In this example, the request that Sam Smith initiated utilizing screens 3100, 3200, 3300 (or 3400), 3500, 3600 (or 3700B), 3800 and 3900B was processed by the MCDUF system 2700; and one or more Seeker requests were sent to one or more Providers resulting in the Seeker request notification subscreen 5600 being viewed by general dentist Dr. Keith White.

Referring back to FIG. 35, as discussed previously, screen 3500 may facilitate a Seeker choosing to utilize the MCDUF system 2700: either to individually select and send a Seeker request to a single specific Provider (a process that may be repeated until acceptance); or to send a set of Seeker requests to a tier (or successive tiers) of Providers triaged by the MCDUF system 2700 utilizing micro-casting. In order to further discuss and exemplify multi-casting, it may be assumed that Sam Smith selected the ‘send help request’ virtual button 3560 on screen 3500 and thusly initiated micro-casting by the MCDUF system 2700.

Referring again to FIG. 57, subscreen 5700 may be displayed by any of a variety of Provider app types. In some embodiments, for some Provider app types, subscreen 5700 may be displayed due to a push notification to a possibly dormant native app. For other Provider app types, particularly web apps, subscreen 5700 may be displayed due an active web browser receiving and displaying the subscreen 5700. Regardless of the facilities utilized for notification of, and subsequent display of, subscreen 5700, the appearance and operation of the subscreen may be substantially the same regardless of the Provider app type.

In some embodiments, subscreen 5700 may include a descriptive note 5740 from the Seeker conveying the Seeker's URGS need(s) to the Provider. Such a descriptive note may have been entered by the Seeker—in this example, Sam Smith—utilizing screen 3700B

Referring again to FIG. 57, in some embodiments, subscreen 5700 includes a request description field 5730 generated by the MCDUF system 2700 that contains some of the details of the Seeker's needs, e.g., the desired day and time to receive the URGS. Virtual buttons 5760 and 5770 facilitate the Provider—Dr. Keith White—to either accept or decline Seeker Sam Smith's request. Selecting the ‘decline’ virtual button 5770 may cause the MCDUF system 2700 to send a ‘decline’ notification (not shown) to the Seeker app of Sam Smith. In some embodiments, a ‘decline’ subscreen (not shown) may be displayed by the Provider app such that the Provider may type a note to accompany the ‘decline’ notification. A Provider so declining a Seeker's URGS request (or perhaps not responding to the request) may be termed a “declining Provider”. Alternatively, selecting the ‘accept’ virtual button 5760 may cause the MCDUF system 2700 to send a ‘offer’ notification (not shown) to Sam Smith's Seeker app resulting in the display of an ‘offer’ screen 5800 as described below.

Referring once again to FIG. 29, at step 2950, in some embodiments, facilitating the Provider's response to the Seeker's URGS request may begin with and/or otherwise involve the Provider accepting or declining the Seeker's URGS request—as exemplified in FIG. 57 as described in the paragraph above.

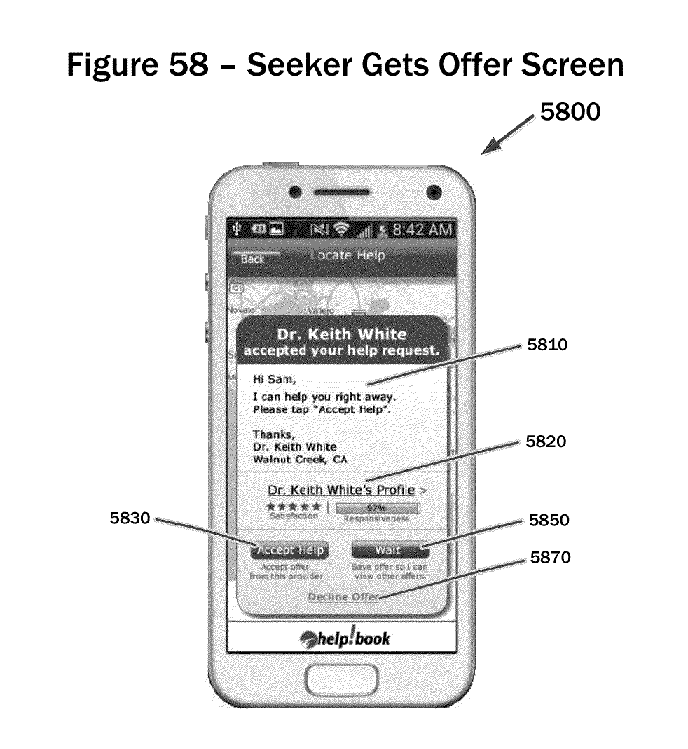

Referring once again to FIG. 30, at step 3060, in some embodiments, responding to the Seeker with the Provider's offer to accept the Seeker's URGS request may involve a notification to the Seeker from the MCDUF system 2700 (not shown) and a corresponding Provider offer to accept the Seeker's URGS—as exemplified in FIG. 58 as described in the paragraph below.

FIG. 58 provides an exemplary screen 5800 to illustrate facilitating a Seeker to receive a notification of a Provider offer of URGS. In some embodiments, screen 5800 may include a note 5810 from the Provider. Additionally, a subscreen 5820 may facilitate the Seeker to learn about the Provider prior to deciding whether or not to accept the Provider's offer. Virtual buttons 5830, 5850 and 5870 facilitate the Seeker—Sam Smith—to either accept, hold off, or decline Provider Dr. White's offer of URGS. Selecting the ‘decline’ virtual button 5870 may cause the MCDUF system 2700 to send a ‘declined’ notification (not shown) to the Provider app of Dr. Keith White resulting in the display of a ‘declined’ screen (not shown). In some embodiments, a ‘decline’ subscreen (not shown) may be displayed by the Seeker app such that the Seeker may type a note to accompany the ‘decline’ notification. Alternatively, selecting the ‘accept help’ virtual button 5830 may cause the MCDUF system 2700 to send an ‘acceptance’ notification (not shown) to Dr. Keith White's Provider app resulting in the display of an ‘acceptance’ screen (not shown). Selecting the ‘wait’ virtual button 5850 may hold off on any notification to the Provider Dr. White and facilitate the Seeker, Sam Smith, to determine if additional Provider offer(s) have come in, and if so, consider such additional offer(s) as well.

Referring once again to FIG. 30, at step 3070, in some embodiments, obtaining the Seeker's response to the Provider's offer to accept the Seeker's URGS request may involve a notification to the Seeker accepting the Provider's offer, declining the Provider's offer or setting aside the Provider's offer—as exemplified in FIG. 58 as described in the paragraph above.

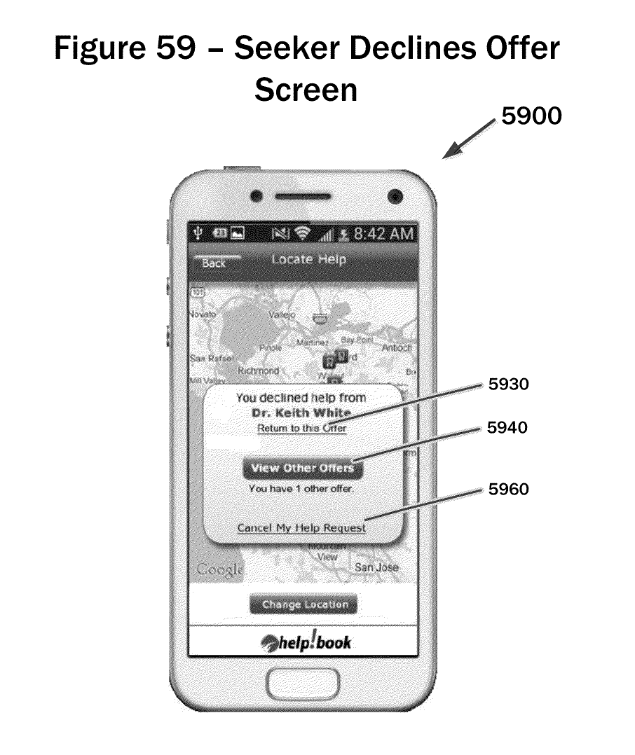

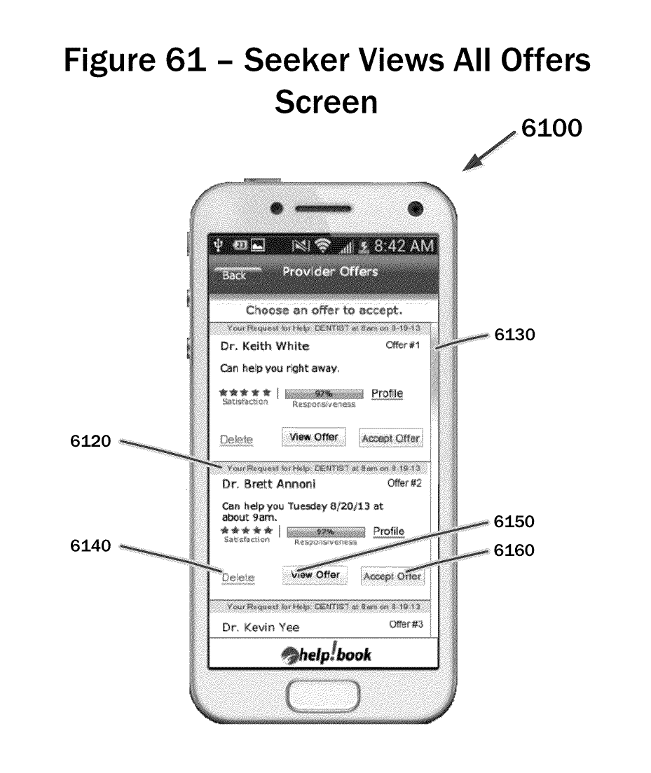

FIG. 59 provides an exemplary screen 5900 to illustrate confirming to a Seeker that the Seeker declined a Provider offer. Subscreen 5930 contains an informative message confirming that the Seeker declined the Provider's offer. In some embodiments, if additional offer notifications are received, the ‘view other offers’ virtual button 5940 may allow the Seeker to navigate to a screen or screens displaying additional Provider offers. In some embodiments, such additional offers may be reviewed by the Seeker utilizing a single screen 6000 as illustrated in exemplary FIG. 61 and described further below.

Referring further to FIG. 59 and screen 5900, in some embodiments, virtual link 5960 may facilitate the Seeker to cancel the Seeker's ‘help request’, thereby causing the MCDUF system 2700 to halt additional micro-casting on the Seeker's behalf and to automatically send ‘declined’ notifications to all Provider apps having been previously been sent the Seeker's now canceled request.

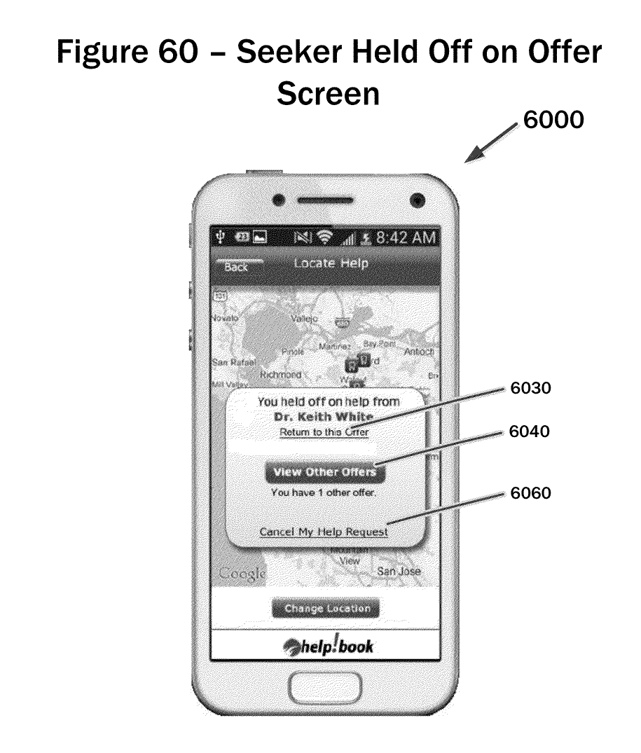

FIG. 60 provides an exemplary screen 6000 to illustrate confirming to a Seeker that the Seeker elected to ‘hold off’ on a Provider offer. Such a screen 6000 may closely resemble the offer deletion confirmation screen—screen 5900 described above—in that screen 6000 may also include a ‘return to this offer’ virtual link 6030, a ‘view other offers’ virtual button 6040 and a ‘cancel my help request’ virtual button 6060. Such virtual links may provide facilitation to the Seeker that may be equivalent to the corresponding virtual button and virtual links—5930, 5940 and 5960—described above relating to FIG. 59.

FIG. 61 provides an exemplary screen 6100 to illustrate facilitating a Seeker to review all Provider offers received by the MCDUF system 2700 in response to the Seeker request. Such a screen 6100 may be composed of one or more sequentially arrayed ‘provider offer’ subscreens each resembling subscreen 6120 and wherein each such subscreen may represent a different Provider's offer. Should such a screen 6100 include more Provider offer subscreens than may be displayed legibly on a Seeker's device display, a virtual screen scrolling slider 6130 may facilitate the Seeker to scroll up and down among such sequentially arrayed subscreens. It may be noted that micro-casting may function so as to limit the number of outstanding Provider offers and therefore scrolling may be utilized so as to accommodate larger more easily utilized subscreens rather than being utilized to manage a virtual deluge of Provider offers. A given provider subscreen 6120 may contain information describing the Provider—including for example quality and responsiveness ratings. A ‘delete’ virtual link 6140 within such a subscreen 6120 may allow the Seeker to delete that subscreen if for whatever reason the Seeker is no longer interested in considering the corresponding Provider's offer. A ‘view offer’ virtual button 6150 within such a subscreen 6120 may allow the Seeker to view a screen closely resembling screen 5800 (described above in FIG. 58) that corresponds to that offer and provides additional details about the Provider and/or the Provider's offer. A ‘accept offer’ virtual link 6160 within such a subscreen 6120 may allow the Seeker to accept that Provider's offer and may facilitate the Seeker's acceptance of the Provider's offer in an equivalent way as described previously for the ‘accept help’ virtual button 5830 in FIG. 58 above.

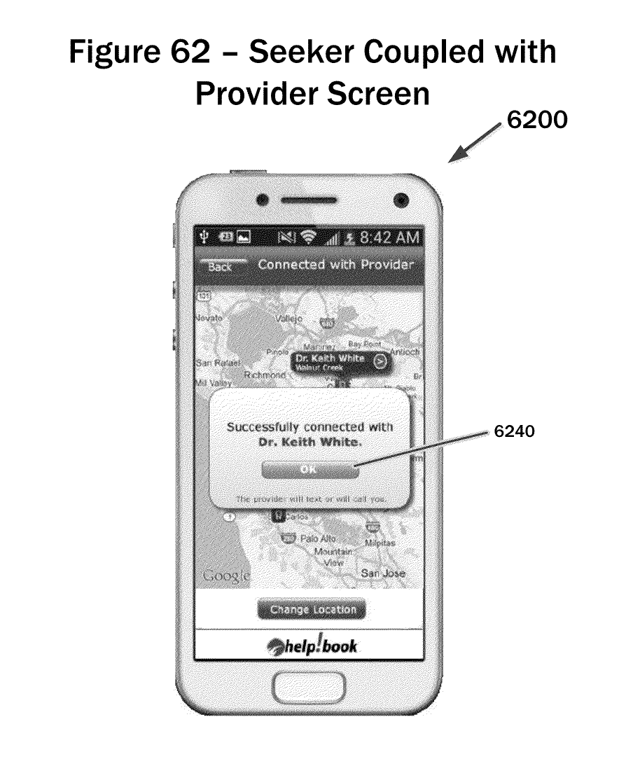

FIG. 62 provides an exemplary screen 6200 to illustrate confirming to a Seeker that the Seeker is ‘connected’ with the Provider whose offer the Seeker accepted utilizing say the ‘accept help’ virtual button 5830 or the ‘accept offer’ virtual link 6160 (each described previously above). Screen 6200 may include explanatory text informing the Seeker to expect a communication such as a phone call or a text message from the Provider. An ‘okay’ virtual button 6240 may be selected by the Seeker to acknowledge the display of screen 6200 and perhaps indicate that the Seeker has read and understands the contents of screen 6200.

Referring once again to FIG. 30 at step 3080, in some embodiments, facilitating realization of the URGS fulfillment so as to meet the Seeker's URGS need(s) may include the MCDUF system 2700 informing the Seeker via the Seeker's app that the Seeker and the Seeker's selected Provider may have mutually accepted to facilitate together the fulfillment of the Seeker's URGS need(s)—as exemplified in FIG. 62 as described in the paragraph directly above. Furthermore, realization of the URGS fulfillment may be facilitated by updates to the search result map displayed by the Seeker's app similar to the search result map update sequence exemplified by FIGS. 40A, 40B, 40C and 40D wherein the Seeker and the Provider may be represented as respective icons on the search result map such that the Seeker may ascertain proximity of the Provider.

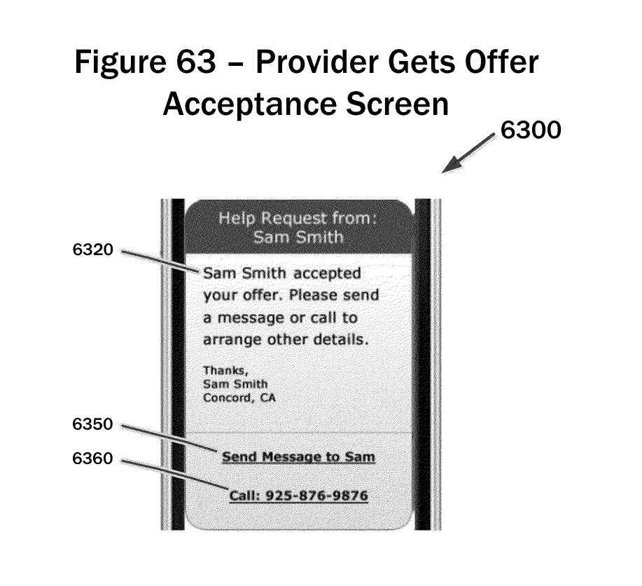

Similarly, referring once again to FIG. 29 at step 2960, in some embodiments, facilitating realization of the URGS fulfillment so as to meet the Seeker's URGS need(s) may include the MCDUF system 2700 notifying the Provider via the Provider's app that the Seeker accepted the Provider's offer; and therefore the Provider and the Seeker may have mutually accepted to facilitate together the fulfillment of the Seeker's URGS need(s)—as exemplified in FIG. 63 as described in the paragraph directly below. Furthermore, realization of the URGS fulfillment may be facilitated by updates to the callers map displayed by the Provider's app similar to the callers map exemplified in FIG. 54 wherein the Seeker and the Provider may be represented as respective icons on the callers map such that the Provider may ascertain proximity of the Seeker.

In some embodiments, the Seeker's search result map and/or the Provider's caller map may include a facility (not shown) that displays an estimated ‘time of arrival’ based on potentially predictive factors including, but not limited to: travel progress, average travel speed, time of day, traffic and weather conditions, and conveyance type.

FIG. 63 provides an exemplary subscreen 6300 to illustrate notifying the Provider that a Seeker has accepted the Provider's offer. In some embodiments, a given Provider may have more than one offer outstanding, therefore subscreen 6300 may include descriptive text 6320 indentifying the Seeker. Such a subscreen 6300 may include virtual links 6350 and 6360 to facilitate text messaging and telephone communication (respectively) between the Provider and the Seeker. In some embodiments, the ‘send message to’ virtual link 6350 may enable the Provider to send a textual message (not shown) to the Seeker—perhaps by SMS or email or other facility as determined by the MCDUF system 2700—so as to automatically be compatible and best suited for communication between the Provider and the Seeker. Thusly, the MCDUF system 2700 may provide automatic translation between a Provider that utilizes text messaging and a Seeker that utilizes email rather than text messaging. Selecting the ‘call’ virtual link 6360 may facilitate the Provider to telephone the Seeker perhaps by initiating an auto-dialing facility native to the Provider's communication device (not shown).

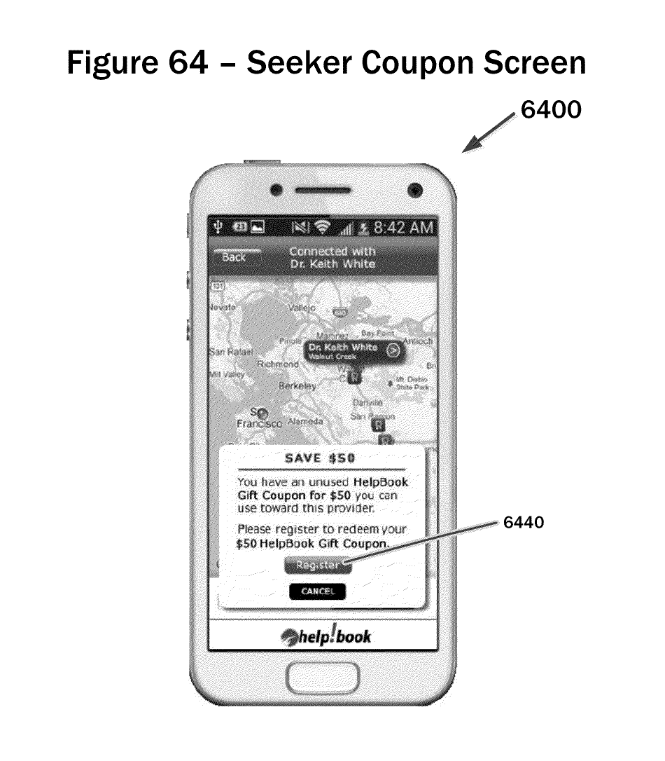

Referring once again to FIG. 28 at step 2860, in some embodiments, facilitating realization loyaltization of users—Seeker or Provider or both—may include the MCDUF system 2700 facilitating the Seeker to utilize a discount coupon for the Provider—as exemplified in FIG. 64 as described in the paragraph directly below.

FIG. 64 provides an exemplary subscreen 6400 to illustrate offering the Seeker a loyalty program incentive—in this example a ‘gift coupon for $50’. Such a ‘loyalty incentive’ screen 6400 may facilitate ‘en passant’ registration of a Seeker who may be utilizing the MCDUF system 2700 as an anonymous user; or perhaps may facilitate the solicitation of additional Seeker information as part of the registration for a MCDUF system Seeker loyalty program. A ‘register’ virtual button 6440 selected by the Seeker may facilitate the display of a corresponding registration screen (not shown).

It may be apparent from the foregoing discussion of micro-casting that efficacy of the MCDUF system 2700 relies substantially on a detailed and accurate assessment of Seekers'needs and Providers' likelihood to accept Seeker's requests and satisfy Seeker's needs. Any and all information that may be gathered relating to any Seeker's request and also any Provider's response (or lack thereof) and subsequent delivery of URGS may be recorded for subsequent analysis and ongoing aggregation and reanalysis. The operation of micro-casting may be highly dynamic and adaptive based on ongoing measurement, recording and thorough analysis of Seeker and Provider interactions. Not only may the data acquired and recorded from Seeker and Provider inputs be valued, but also information that may be gleaned from instrumentation of Seeker apps and Provider apps may provide the MCDUF system with a seeming intuitive like quality that statistically improves the likelihood of both Seeker and Provider satisfaction.

In some embodiments, the MCDUF system 2700 may utilize micro-casting with the goals of: satisfactorily matching as many Seekers as possible as quickly as possible with suitable Providers who accept the Seeker's requests and subsequently satisfy the Seekers' URGS needs; or in instances where they cannot or choose not to attend to Seekers' URGS needs, they respond so as to make the Seekers feel valued. Additionally, micro-casting may be utilized so as to achieve the foregoing while causing as little inconvenience as possible to Providers and to Seekers such that both Providers and Seekers have on balance a positive experience utilizing the MCDUF system 2700; and further are motivated to utilize it on an ongoing basis as well as to recommend it to others.

In sum, the present invention provides systems and methods for micro-casting in urgent needs fulfillment matching. Such systems and methods may enable a Seeker to utilize a computerized MCDUF system to automatically and systematically search for, list, profile, select, and establish communication with a per-qualified Provider who may satisfy the Seeker's URGS need(s). Such systems and methods may include micro-casting facilities that may optimize the matching of a Seeker and an suitable pre-qualified Provider utilizing micro-casting techniques to balance the interests of the Seeker, the Provider, the MCDUF system, and perhaps related third parties in such a way as to provide a higher probability of not only locating suitable Providers, but also exchanging Seeker requests and corresponding Provider responses so as to quickly establish a match while disturbing a limited number of possible Providers.

### IV. Additional Enhancements

### Systemic Incentivized Loyaltization Coupled with a Micro-Casting Distributed URGS Fulfillment System

Systemic incentivized loyaltization coupled with a micro-casting distributed URGS fulfillment (“MCDUF”) system—i.e., “SILCM”—may typically operate as a facilitator that may engender “loyaltization binding”, which comprises an association of mutual trust and benefit between users of the MCDUF system.

Furthermore, the SILCM system may facilitate “plural-partite loyaltization binding”—i.e., the SILCM system may engender loyaltization bindings among URGS Seekers, URGS Providers and the MCDUF system. This is not to say that the SILCM system binds only among those three, but rather they may be the primary participants in the SILCM system. Other third party participants subject to loyaltization binding by the SILCM system may be MCDUF/SILCM system utilizers—for example financial institutions and rating services that may acquire information and/or services from the MCDUF/SILCM system. Additional third parties such as vendors may also be participants subject to loyaltization binding by the SILCM system. Examples of such vendors may include computer hardware and software vending and servicing entities.

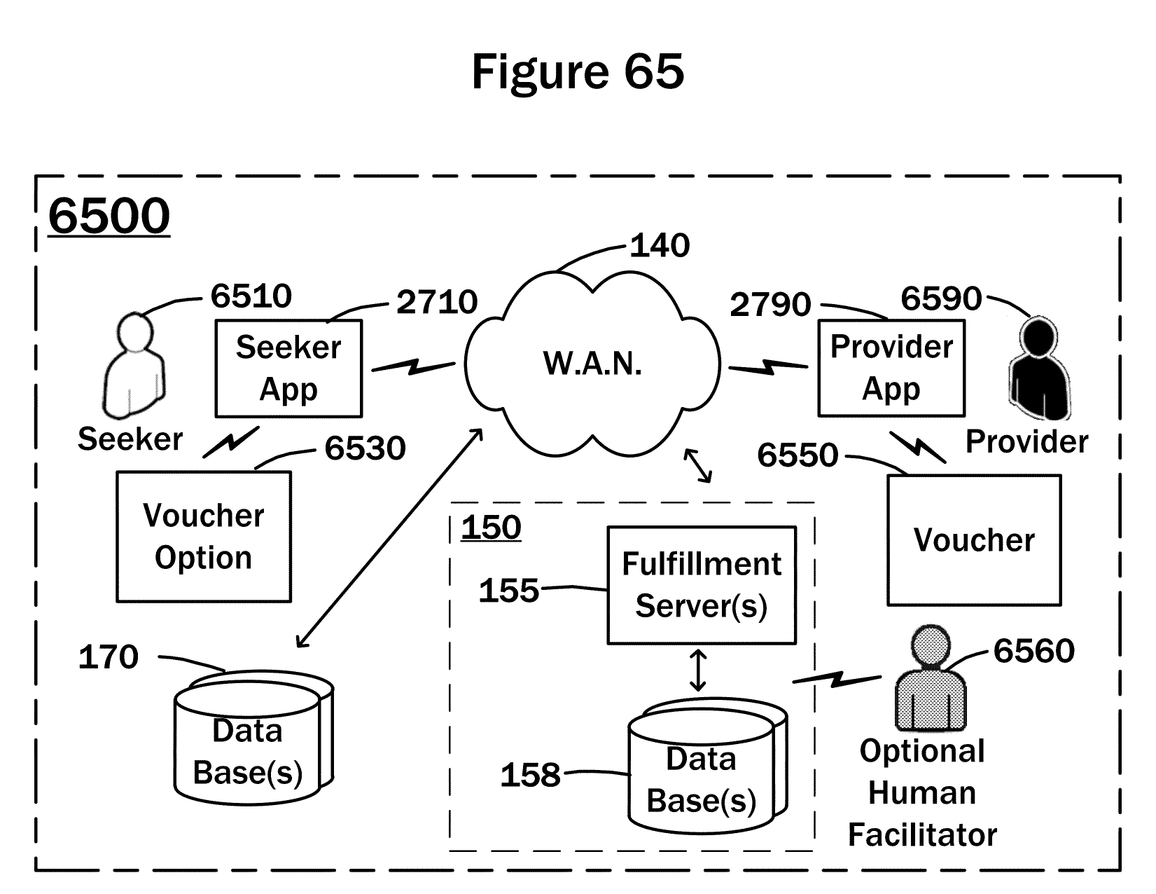

To facilitate discussion, FIG. 65 shows a structural block diagram for an example of systemic incentivized loyaltization coupled with a MCDUF system—i.e., a SILCM system 6500—in accordance with an embodiment of the present invention. The SILCM system 6500 may include substantially the same components as the MCDUF system 2700 (as shown in FIG. 27) since the SILCM system 6500 may be coupled to and inherent in the operation of the MCDUF system 2700. The SILCM system 6500 may consist of: two or more Seekers 6510 facilitated by Seeker device clients (i.e., “Seeker apps”) 2710 and voucher options 6530; two or more Providers 6590 facilitated by Provider device clients (i.e., “Provider apps”) 2790 and vouchers 6550; a wide area network infrastructure 140 (composed of one or more networks), an URGS fulfillment system 150 (including fulfillment server(s) 155 and data base(s) 158) with an associated optional human facilitator 6560; and additional network accessible data base(s) 170 that may be operated by third parties who may assist in, benefit indirectly from and/or be subject to loyaltization binding. Such third parties may include among others: financial institutions, social networks and/or rating and licensing agencies.

A primary function of the SILCM system 6500 may be to engender loyaltization binding between an URGS Seeker and an URGS Provider—as opposed to the primary purpose of a traditional loyalty system, which is to engender loyalty of a user to the system itself. That said, the SILCM system 6500 may also engender the loyaltization binding of a user to the MCDUF system 2700 and the SILCM system 6500, but in most embodiments as a secondary purpose.

Unlike loyalty systems incorporating or operating with computerized systems, the SILCM system 6500 may minimize and stream-line computer-to-human interaction in favor of facilitating and improving human-to-human interaction. The responsiveness and utility of the MCDUF system 2700 and the SILCM system 6500 to Seekers with URGS needs may in part derive from providing as ‘thin’ and transparent a layer as possible in that human-to-human interaction. Simply put, it is nearly impossible for interaction with a computer to engender the same sort of binding in a human that a relationship with another human may.

A further differentiator between the SILCM system 6500 and a traditional loyalty system is the fundamental role that urgency plays in loyaltization binding. The SILCM system 6500 may bind Seekers 6510 with Providers 6590—and perhaps secondarily with itself—by facilitating easy, quick, dependable and nearly transparent matching of such Seekers to such Providers that may expeditiously fulfill the Seeker's urgent need(s).

Human behavior may be too variable to perhaps pinpoint or rank the most efficacious elements of the SILCM system 6500. Nonetheless, urgency and human-to-human interaction may play key roles in the Provider-Seeker loyaltization binding as well as plural-partite loyaltization binding facilitated by the SILCM system 6500; and therefore, urgency and human-to-human interaction and their roles are emphasized in the discussion that follows.

In some embodiments, the Seeker 6510 may be loyaltized utilizing voucher options 6530 and corresponding vouchers 6550 as incentives—i.e., as a participant in a “morphable voucher program” (not shown). In some embodiments, such a morphable voucher program may include distributing to two or more Seekers 6510 two or more “morphable” voucher options 6530 that may be “morphed” into vouchers 6550 that may potentially be redeemed in exchange for discounts from participating Providers 6590.

Correspondingly, in some embodiments, a Provider 6590 may be loyaltized utilizing morphable voucher programs (not shown) that may in turn incentivize Seekers 6510 to seek out and obtain URGS from such a Provider participating in morphable voucher program(s) in order for such Seekers to receive corresponding payment discounts. A key incentive, therefore, for Providers 6590 to participate in such morphable voucher programs may be attracting additional Seekers 6510 incentivized by vouchers 6550 to obtain URGS from such participating Providers and increasing such Providers' revenues and/or profits.

The utilization of voucher options 6530—as separate and distinct from redeemable vouchers 6550—may serve to ensure that a given corresponding voucher 6550 may be redeemed for the benefit of an intended “voucher option beneficiary”, or by a Seeker 6510 that otherwise may be authorized and/or qualified to morph the voucher option 6530 so as to redeem the corresponding voucher 6550. Such a separate and distinct voucher option 6530 may serve to increase the difficulty of counterfeiting—or of otherwise unauthorizedly inflating the quantity of corresponding vouchers—by potentially de-coupling the quantity of voucher options 6530 from the quantity of corresponding redeemable vouchers 6550. Consequently, it may be possible to have an equal quantity of vouchers 6550 and corresponding voucher options 6530, or a lesser quantity of voucher options relative to corresponding vouchers 6550; but it may also be possible (and perhaps more likely) to have a greater quantity of voucher options 6530 than vouchers 6550.

In some embodiments, the SILCM system 6500 may facilitate two or more morphable voucher programs concurrently. Other systems and methods may be utilized for incentivized loyaltization that may be similar to, or substantially different from, systems and methods relating to voucher options 6530 and/or vouchers 6550. For example, the SILCM system 6500 may facilitate a program for donating to charity for each new Seeker 6510 acquiring a Seeker app 2710 and enrolling utilizing the Seeker app. A variety of systems and methods of incentivized loyaltization may be facilitated concurrently by the SILCM system 6500.

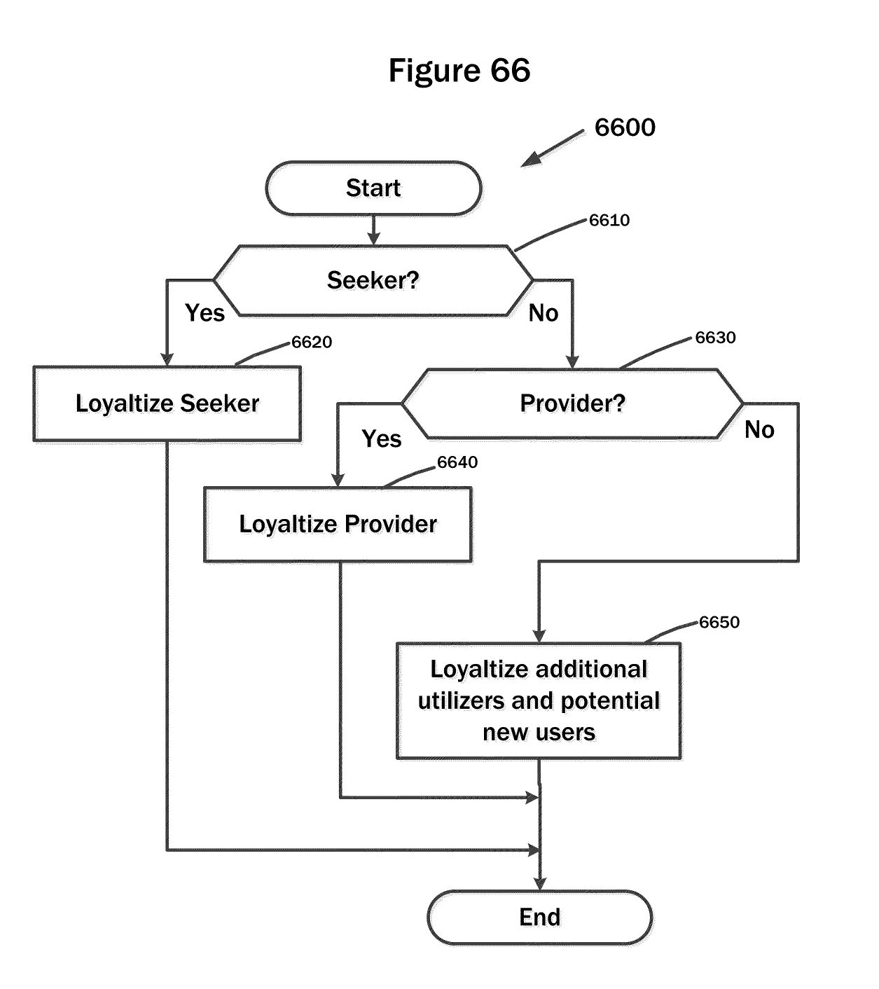

FIG. 66 provides a top level logic flow diagram 6600 for some embodiments of the SILCM system 6500. The discussions of FIG. 66 and embodiments thereof, which follow below may apply equivalently to both an individual user/utilizer as well as two or more users/utilizers of the same user-type. For simplicity, the discussion below may utilize user-descriptive terms in the singular form such as “Seeker” and “Provider” rather than the potential plural ‘Seeker(s)’ and ‘Provider(s)’. However, it may be understood that for any embodiment detailed relative to such singular form of a user-descriptive term, that embodiment may as well be repeated or otherwise embodied so as to apply equivalently to each of two or more appropriately corresponding user/utilizer types. For example, an embodiment relative to a given Seeker 6510 may apply equivalently to two or more Seekers 6510; and an embodiment relative to a given Provider 6590 may apply equivalently to two or more Providers 6590.

At step 6610, in some embodiments. the SILCM system 6500 may differentiate between users/utilizers so as to distinguish a given user of user-type Seeker 6510 for loyaltization.

At step 6620, in some embodiments. the SILCM system 6500 may loyaltize the Seeker 6510.

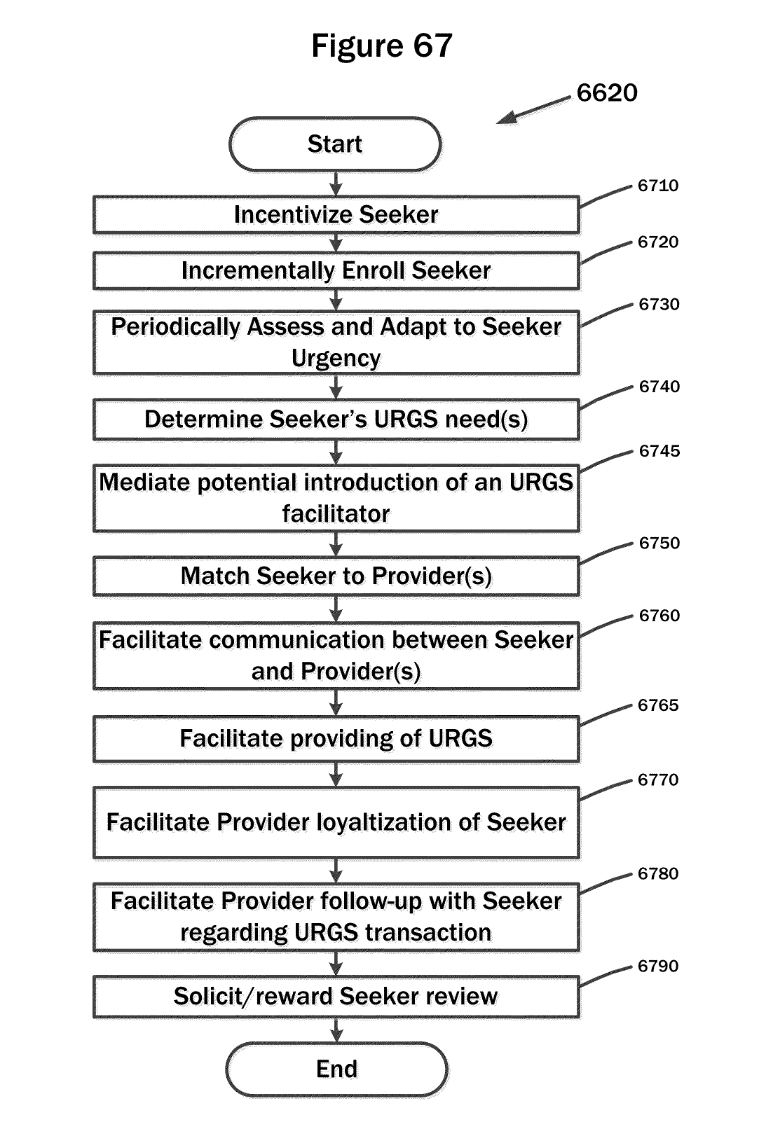

FIG. 67 shows some embodiments of step 6620 in greater detail. At step 6710 in some embodiments the SILCM system 6500 may directly or indirectly incentivize two or more Seekers 6510 to first-time utilize (or to re-utilize) the MCDUF system 2700 to fulfill URGS need(s)—i.e., “recruit” Seekers 6510. Such incentivized loyaltization of a given recruited Seeker 6510 may therefore be in progress before first time utilization—since such utilization may likely be the result of some preceding motivation. Perhaps such incentivizing may be due to a friend's recounting of a good experience as a Seeker 6510 utilizing the MCDUF system 2700. Or perhaps that incentive may be a recommendation from a doctor or plumber or some other person with a commercial relationship who may recommend the MCDUF system 2700—perhaps because they or someone they know is an URGS Provider 6590 for the MCDUF system 2700. In addition to such ‘word of mouth’ human-propagated promotion, systematized and/or automated methods of incentivized loyaltization may be utilized by the SILCM system 6500—either passively or actively—to incentivize a thusly recruited Seeker 6510 to utilize the MCDUF system 2700 in order to obtain URGS. So for example, a voucher option 6530—perhaps gifted by a friend or other trusted recommender—may result in such SILCM system incentivization of a recruited Seeker 6510.

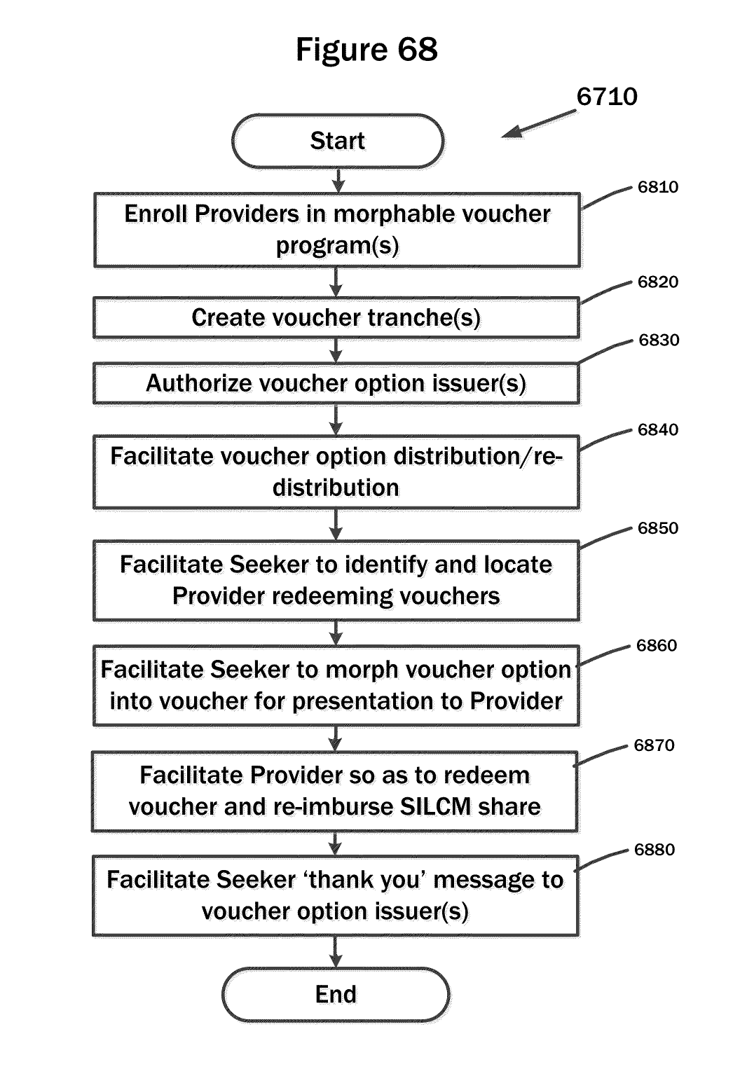

FIG. 68 shows some embodiments of step 6710 in greater detail as relates to incentivized loyaltization of a given recruited Seeker 6510. In addition to incentivizing methods related to Seekers' urgent needs for URGS and/or related to personal relationships, the SILCM system 6500 may utilize incentivized loyaltization methods such as morphable voucher program(s).

At step 6810, in some embodiments the SILCM system 6500 facilitates enrollment of Providers 6590 in a morphable voucher program—i.e., a SILCM system 6500 facility whereby prospective recruited seekers or other voucher option beneficiaries may be “gifted”, “issued” or otherwise distributed voucher options 6530 that may be configured so as to incentivize such recruited seekers and other voucher option beneficiaries to become enrolled Seekers 6510 in the MCDUF system 2700 and the SILCM system 6500; and further enabling the enrolled Seeker(s) to morph voucher option(s) 6530 into a corresponding voucher 6550 that may potentially be redeemed for discount and/or payment by one of a plurality of Providers 6590 that may be enrolled in a corresponding morphable voucher program. The Provider 6590 may enroll in a given morphable voucher program as part of the process of enrolling as a MCDUF system 2700 URGS Provider 6590; or may enroll subsequently utilizing morphable voucher program specific provider account management facilities (not shown) of the Provider app 2790. In some embodiments, enrollment in a given morphable voucher program may require explicitly ‘opting in’ by the Provider 6590; whereas in other embodiments such enrollment may be automatic for Providers 6590 and may therefore require explicitly ‘opting out’. In some embodiments, a Provider 6590 may be enrolled in the SILCM system 6500 as one of a group of associated or affiliated providers—for example a franchise or partnership—wherein a group administrator may opt-in or opt-out for all Providers in such a group. In some embodiments, an individual Provider 6590 within such a group, may over-ride the morphable voucher program opt-in or opt-out selected by such a group administrator. In some embodiments, a Provider 6590 may be enrolled in two or more morphable voucher programs; or may be enrolled in a single voucher program that facilitates two or more voucher categories; or both.

Additionally, in some embodiments of morphable voucher programs, voucher options 6530 may be concurrently applicable to two or more categories of URGS Providers 6590. So for example, such an “agnostic” morphable voucher program may utilize voucher options 6530 that may potentially be morphed and the corresponding voucher 6550 redeemed in exchange for a discount from a dentist Provider or potentially for a discount from a plumber Provider. Furthermore, such an agnostic morphable voucher program may utilize voucher options 6530 that may be morphed into vouchers 6550 for different discounts from different Providers 6590. So for example, the discount for a participating tow truck Provider may be $50 off, whereas the discount for a participating tailor Provider may be 10% off. In some embodiments, the discount may potentially vary between participating Providers 6590 in a given Provider category possibly down to a per-Provider specificity.

In some embodiments, two or more Providers 6590 of two or more different URGS category types (e.g., dentist and plumber) may participate in a given morphable voucher program. In some embodiments, different categories of Providers 6590 may participate in separate URGS-category-segregated morphable voucher programs, so for example there may be a morphable voucher program for dentists that may be segregated from a separate morphable voucher program for plumbers. In some embodiments, such categorized morphable voucher programs may be supported by voucher options 6530 that may be “morphable voucher program agnostic”. So for example, such a morphable voucher program agnostic voucher option 6530 may be morphable to a voucher 6550 appropriate for the voucher program that the Provider 6590 may participate in. So further by example, a morphable voucher program agnostic voucher option 6530 may be morphable to one of a plurality of voucher program categories such as dentist, plumber, tow truck, etc. Such a morphable voucher program agnostic voucher option 6530 may morph to a morphable voucher program-appropriate voucher. So for example, such a morphable voucher program agnostic voucher option 6530 may be equally morphable to category segregated dentist, plumber, and tow truck morphable voucher programs. In some embodiments, such a voucher program agnostic voucher option 6530 may morph to the morphable voucher programs-appropriate voucher 6550 based on the category of the Seeker's Provider 6590. In some embodiments, URGS-category-segregated morphable voucher programs that utilize agnostic voucher options 6530 may be a form of agnostic morphable voucher program.

In some embodiments, a given voucher option 6530 may have a physical form—for example have the form of a printed QR code—or may be embodied in a physical entity of some sort (e.g., a ‘token’) that may be utilized subsequently to morph the voucher option 6530 into the corresponding voucher 6550.

In some embodiments, a given voucher option 6530 may be a “virtualized” voucher option—i.e., it may have one or more than one virtual representations in place of, or in addition to a physical form—including but not limited to: verbal, visual, symbolic, tactile (e.g., Braille), analog, and digital form(s).

In some embodiments, the voucher option 6530 may have an associated “redemption limit”, perhaps indicating the maximum amount of discount or payment the corresponding voucher 6550 may potentially be utilized for. In some embodiments, the redemption limit associated with a voucher option that has physical form may visibly appear on that voucher option 6530 as a ‘face value’. For voucher options in virtual form and for voucher options with physical form as well, the redemption limit associated with the voucher option 6530 may be recorded as a “virtual face value” by the SILCM system 6500.

In some embodiments, the voucher option 6530 may be “temporally morphable”—i.e., have an associated “expiration event” wherein upon the occurrence of the expiration event the voucher option 6530 may no longer be morphable. In some embodiments, an expiration event may be composed of a combination of sub-events. For example, a voucher option 6530 may have the following expiration event composed of sub-events: ‘expiration occurs on Jan. 1, 2016, or when 100 voucher options have been morphed and the corresponding vouchers redeemed, whichever occurs first.’ In some embodiments, the voucher option 6530 may lack an associated expiration event and may therefore be “immortally morphable”. In some embodiments, some voucher options 6530 may be temporally morphable and some voucher options 6530 may be immortally morphable. Further in some embodiments, a given morphable voucher program may utilize temporally morphable voucher options 6530, immortally morphable voucher options 6530, or a mix of both.

At step 6820, in some embodiments the SILCM system 6500 may facilitate creating a “SILCM voucher tranche” (not shown)—i.e., a set of vouchers 6550 morphed via voucher options 6530 that may have a common “expiration event” (or the lack thereof). In some embodiments, the voucher options 6530 corresponding to a SILCM voucher tranche may share additional common characteristics including, but not limited to: the set of authorized issuers; the set of applicable MCDUF system URGS Provider categories; and the set of voucher redemption discount/payment amount limits corresponding to the set of applicable MCDUF system URGS Provider categories. In some embodiments, there may be a limit to the quantity of voucher options 6530 that may be issued for the SILCM voucher tranche, whereas in some embodiments the quantity of voucher options 6530 that may be issued may be unlimited. Similarly, in some embodiments, the quantity of redeemable vouchers 6550 in a given voucher tranche may be capped, specifically set, unlimited, or maybe left unset. In some embodiments, a given morphable voucher program may be configured without utilizing SILCM voucher tranche(s).

In some embodiments of morphable voucher programs, there may be a “provider split” value wherein the provider split specifies how much of the payment amount or discount credited to the Seeker 6510 for the voucher 6550 redeemed by the Provider 6590 participating in the morphable voucher program may be absorbed by the Provider. The remainder of the split (“SILCM matching share”) may be credited by the SILCM system 6500 to the Provider's MCDUF system provider payments account (not shown) so as to offset a portion of the cost of the payment amount or discount credited to the Seeker 6510. So for example, the Seeker 6510 may redeem a voucher 6550 for a $50 discount corresponding perhaps to a SILCM voucher tranche where the provider split is 60%—resulting in the MCDUF system crediting the Provider $20 (i.e., 40% of $50) and the Provider absorbing the remaining $30 discount (i.e., 60% of $50).

In some embodiments, the utilization of voucher options 6530—as separate and distinct from redeemable vouchers 6550—may serve to incentivize both the Seeker 6510 and the Provider 6590 to respectively report morphing the voucher option 6530 and redeeming the corresponding voucher 6550 such that the SILCM system 6500 may determine and enforce that the Seeker 6510 morphing the voucher option 6530 may also be the Seeker 6510 presenting the corresponding voucher 6550 to the Provider 6590 leading to successful redemption. The Seeker 6510 may so report or the voucher option 6530 may not be morphed; and the Provider 6590 may so report or the voucher 6550 may not be successfully redeemed and the corresponding SILCM matching share may not be credited. Furthermore, such incentivized reporting facilitates the tracking by the SILCM system 6500 every successful morphing of voucher options 6530 and the successful redemption of corresponding vouchers 6550. Furthermore, the SILCM system 6500 may detect patterns of a Provider or Provider's 6590 not honoring redeemable vouchers 6550 based on discrepancies between the morphing of voucher options 6530 and redemption of voucher options 6550.

In some embodiments, the SILCM system 6500 may follow-up (not shown) via the Seeker app 2710 with a given voucher option beneficiary Seeker 6510 that successfully morphs a voucher option 6530 that subsequently remains unredeemed. Such follow-up may be utilized by the SILCM system 6500 to determine if the voucher 6550 was received by the Seeker 6510; accepted by the Provider 6590; and how the Provider 6590 may have explained and/or handled any difficulty that may have occurred prevented successful redemption of the voucher 6550. Such follow-up may enforcement by the SILCM system 6500 of voucher program agreements with Providers 6550 and/or improvements to the SILCM system 6500 so as to minimize avoidable unsuccessful voucher 6550 redemptions.

At step 6830, in some embodiments the SILCM system 6500 may authorize “issuers”—i.e., individuals or organizations authorized to distribute at least one of a plurality of voucher options 6530. Issuers (not shown) may be selected from MCDUF system users—Seekers 6510 and/or Providers 6590. Additionally, in some embodiments, non-user third parties may be authorized to be issuers. In some embodiments, voucher options 6530 issued by MCDUF system users are termed “gifts” and those issued by paid or otherwise compensated third parties may be termed “promotions”. In some embodiments, voucher options issued by the SILCM system 6500 or by Provider(s) 6590 may be termed “bonus” voucher options 6530. In some embodiments, gift, promotion, and/or bonus voucher options 6530 may require separate SILCM voucher tranches; whereas in other embodiments, gift, promotion and/or bonus voucher options 6530 may be issued from the same tranche or without a tranche.

In some embodiments, the issuer may have a relationship to a given Seeker 6530, prospective recruited seeker or other voucher option beneficiary by one or more of numerous means including but not limited to: previous introduction, paid introduction, promotion/advertising, word of mouth, social networking, chance encounter, and recommendation. In addition to being gifted or possibly exchanged for something of value, the voucher option 6530 received by a recruited Seeker 6510 may be solicited or unsolicited. In some embodiments, issuers may report to the SILCM system 6500 the issuance of voucher options 6530 so as to associate a given prospective recruited seeker or other voucher option beneficiary with the corresponding voucher option(s) 6530 they may have been issued. For example, an issuer may report the names, telephone numbers and/or email addresses of voucher option beneficiaries. In some embodiments, the issuer may so report utilizing a photograph, video, audio recording and/or biometric measurement of a given voucher option beneficiary. In some embodiments, the Seeker 6510 associated with a given voucher option 6530 may also be associated by the SILCM system 6500 with the corresponding voucher 6550 that may be morphed from that voucher option. In some embodiments, issuers may be incentivized with bonus voucher option(s) 6530 (or other rewards) provided by the SILCM system 6500 perhaps in some way proportional to the recruitment of new seekers and the redemption of vouchers 6550 resulting from the issuer's issuance efforts. In some embodiments, issuers may be rewarded with higher nominal value voucher options to issue and/or to utilize personally.

In some embodiments, “gift issuers” and/or “promotion issuers” may be separately registered with the SILCM system 6500 as MCDUF system utilizers as opposed to Seeker 6510 and/or Provider 6590 MCDUF system users. In some embodiments, a gift issuer may be required to be a Seeker 6510 or a Provider 6590. In some embodiments, a gift issuer may be identified by the issuer's email address registered with the SILCM system 6500 as a “gift ID”. Similarly, a promotion issuer may be identified by a unique identifier (which may also be the issuer's email address) registered with the SILCM system 6500 as a “promo ID”.

In some embodiments, a given issuer may be limited to issuing voucher options 6530 solely from one voucher tranche or one morphable voucher program. In others, the issuer may distribute voucher options 6530 for more than one tranche and/or voucher program. In some embodiments, the issuer's gift ID or promo ID may be utilized as a virtual form of voucher option 6530. For example. Nick Smith may be registered with the SILCM system 6500 with an issuer's gift ID set to his email address of saintnick@brandx.net, and therefore the voucher options 6530 that he may issue may simply be the same as his email address, i.e., ‘saintnick@brandx.net’. Such a gift ID (or promo ID) that may be utilized as a virtualized voucher option 6530 may be termed a “option ID”. By using a option ID that may be very easy to recall, an issuer may easily issue virtualized voucher options 6530 verbally, simply by reciting the option ID from memory. Additionally, such an issuer-identifying option ID—utilizable as a voucher option 6530—may serve to remind the voucher option beneficiary who it was that gifted or otherwise issued that voucher option and thereby engender loyaltization binding between the issuer and the voucher option beneficiary.

More generally, in some embodiments, the issuer may utilize one or more option IDs—perhaps assigned or otherwise managed by the SILCM system—that may correspond to one or more morphable voucher programs. In some embodiments, a given option ID may correspond to a specific SILCM tranche or tranches. For example, voucher options 6530 may be issued in the virtual form of a option ID that may be an email address at a domain that may resolve to the SILCM system 6500. Or perhaps the option ID is a unique handle utilized with a third party networking facility account(s)—for example, Twitter—that may be administered via the SILCM system 6500. In some embodiments, the voucher option beneficiary may subsequently contact the issuer by utilizing the option ID that had been issued as the Seeker's voucher option 6530. In this way perhaps, a Seeker 6510 may send a ‘thank you’ and/or ask for an additional voucher option 6530 for the voucher option beneficiary Seeker 6510 or for maybe someone else—thereby further engendering and extending loyaltization binding.

At step 6840, in some embodiments the SILCM system 6500 may facilitate the distribution (and/or re-distribution) of voucher options 6530. For example, the gift issuer or promotion issuer may utilize facilities of the SILCM system 6500 to communicate the issuance of the voucher option 6530 to a given prospective recruited seeker or other voucher option beneficiary. In some embodiments, a voucher option beneficiary may re-distribute or “re-gift” a voucher option 6530 to someone else who may either be a Seeker 6510 or who may subsequently register as a MCDUF system Seeker 6510 so as to utilize the voucher option 6530. Such a “re-gifter” may therefore facilitate additional voucher option distribution and additional loyaltization binding as an unofficial ‘virtual issuer’.

In some embodiments, a voucher option beneficiary Seeker 6510 may “bank” a voucher option 6530 with the SILCM system 6500—i.e., register the voucher option with the SILCM system so as to utilize facilities for associating the voucher option(s) 6530 with the voucher beneficiary Seeker 6510 as well as recording, tracking, monitoring, combining, exchanging, trading, and otherwise managing the voucher option(s). Such banking of voucher option(s) 6530 may not alter the Seeker's ability to subsequently morph a voucher option into a corresponding redeemable voucher 6550, but may allow the SILCM system 6530 to keep track of any voucher options the Seeker 6510 banks and to remind the Seeker to utilize such voucher options 6530. For example, the SILCM system 6500 may alert the Seeker prior to a voucher option expiring. Additionally, the SILCM system 6500 may provide facilities to combine voucher options 6530, extend the expiration of a voucher option, and perhaps to trade voucher options with other Seekers who may also bank their voucher options 6530 with the SILCM system 6500. Furthermore, the SILCM system 6500 may provide facilities to re-gift voucher options 6530.

In some embodiments. the voucher option 6530 may potentially be a “fungible” voucher option—e.g., traded as a sort of synthetic currency—depending on whether and how the voucher option 6530 may be transferrable. In some embodiments, whether a voucher option 6530 may be transferrable, and the ways and degree to which a voucher option may be transferrable, may be facilitated and controlled by the SILCM system 6500 including voucher option banking facilities for recording, tracking, validating and morphing voucher options 6530. In some embodiments, voucher options 6530 may be nominally denominated similar to currency. In some embodiments, voucher options may be named so as to suggest their potential and/or inherent value to recruited Seekers 6530 and other voucher option beneficiaries—for example, “HelpBuck$”.

In some embodiments, the SILCM system 6500 may require registering the re-gifting of the voucher option 6530 with the SILCM system 6500. In this way, the SILCM system 6500 may track the re-gifting of voucher options 6530 as well as accumulating information about issuers, Seekers 6510, and prospective recruited seekers and other voucher option beneficiaries. For example, in registering a voucher option, the SILCM system 6500 may request information about the voucher option beneficiary, the issuer, the relationship of the voucher option beneficiary to the issuer, and perhaps gather information as well on the Seeker 6510 or prospective recruited seeker that the voucher option beneficiary may want to re-gift the voucher option 6530 to. In some embodiments, the SILCM system 6500 may provide a facility whereby a voucher option beneficiary may directly utilize the SILCM system 6500 to re-gift a voucher option 6530 to a Seeker 6510 or prospective recruited seeker or perhaps request a separate voucher option 6530 be issued to such a beneficiary. Additionally, in some embodiments, the SILCM system 6500 may require a ‘re-gifter’ to register with the SILCM system 6500 as an issuer in order to re-gift a voucher option 6530; and in this way new issuers may possibly be identified and more effectively utilized.

In some embodiments, the voucher option beneficiary of a voucher option 6530 may endeavor to acquire URGS from a morphable voucher program participating Provider 6590 who redeems corresponding vouchers 6550; or may choose instead to transfer the voucher option to yet another voucher option beneficiary. Of course, in some circumstances, a voucher option beneficiary may let a voucher option 6530 expire. The SILCM system 6500 may utilize recorded information relative to issuance and transfer to contact such a voucher option beneficiary or otherwise endeavor to determine why such a voucher option 6530 may be allowed to go unused and perhaps replace it with a new voucher option 6530.

At step 6850, in some embodiments the SILCM system 6500 may facilitate the Seeker 6510 who may be a voucher option beneficiary to identify and locate an URGS Provider(s) 6590 that redeems vouchers 6550. For example, the search result map displayed by the Seeker app 2710 may utilize a distinctive icon to differentiate Providers 6590 who redeem vouchers 6550. Additionally, or alternatively, the Seeker app 2710 may facilitate identifying Providers 6590 that redeem vouchers 6550 via, for example, a label, symbol and/or link in that Provider's description. A Seeker 6510 who may not currently be a voucher option beneficiary, may be made curious about voucher options 6530 and subsequently endeavor to acquire voucher options 6530. In some embodiments, the SILCM system 6500 may offer a voucher option to a Seeker who may currently not have a voucher option 6530. In some embodiments, the Seeker App 2710 may facilitate the Seeker 6510 to input (not shown) a voucher option ID(s) such that the SILCM system 6500 may facilitate the voucher option beneficiary Seeker 6510 to identify and locate an URGS Provider(s) 6590 that participates and redeems vouchers 6550 in a voucher program(s) corresponding to the Seeker's voucher option(s). In some embodiments, the Seeker 6510 need not so input voucher option IDs that may already be banked with the SILCM system 6500 as they may be automatically included by the SILCM system 6500 with any additional voucher option ID(s) input by the Seeker 6510 for utilization to locate and identify such a participating redeeming Provider(s) 6590.

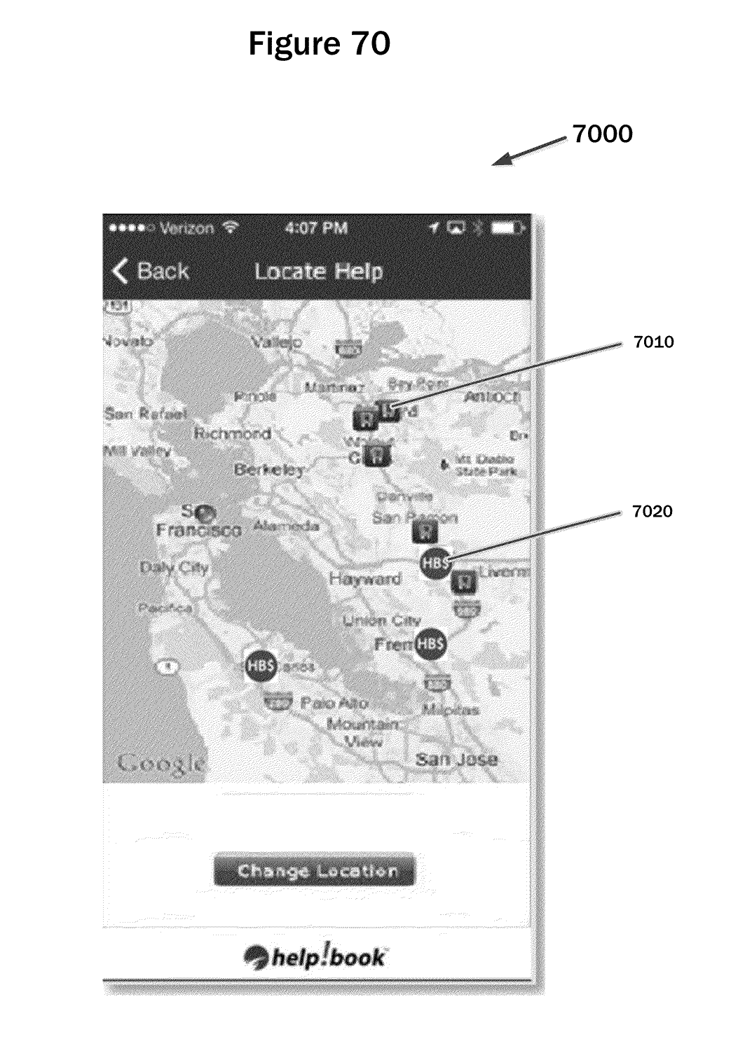

FIG. 70 provides an exemplary screen image 7000 to further illustrate, in some embodiments, a search result map as displayed by the Seeker app 2710 that may facilitate the voucher option beneficiary Seeker 6510 to locate an URGS Provider 6590 that may redeem vouchers 6550. The search result map in exemplary screen 7000 may contain icons representing URGS Providers 6590 matching the Seeker's URGS need—in this example, for a dentist. Some provider icons, such as 7010 may represent Providers who do not redeem vouchers 6550. Other provider icons, such as 7020 may represent Providers who do redeem vouchers 6550.

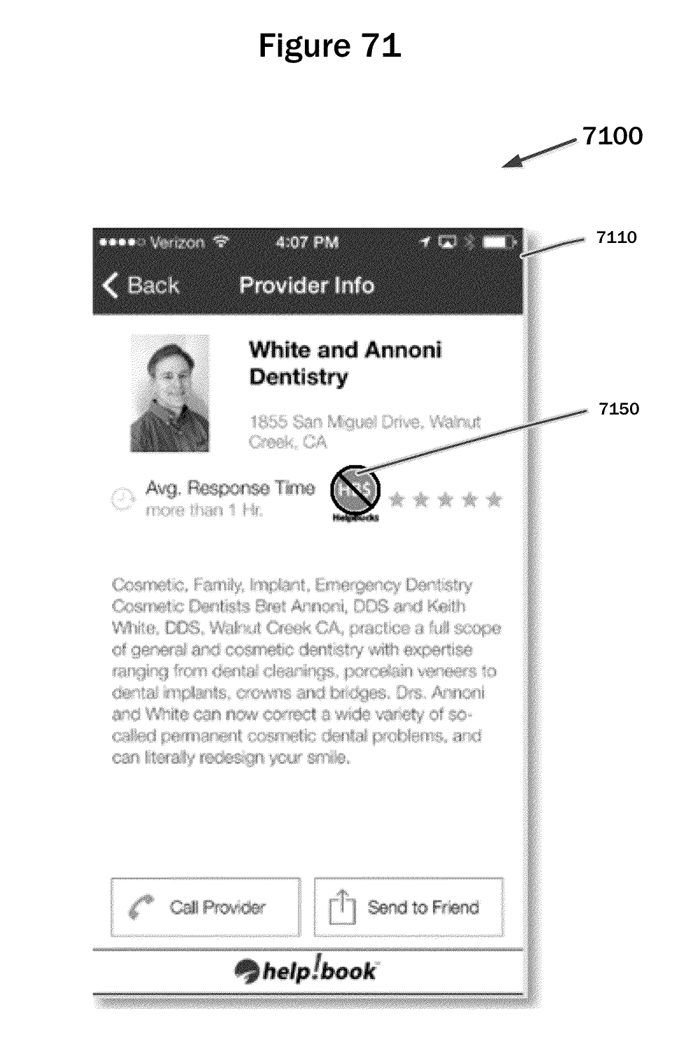

FIG. 71 provides an exemplary screen image 7100 to further illustrate, in some embodiments, a provider descriptive ‘info’ screen 7110 as displayed by the Seeker app 2710 that may facilitate the voucher option beneficiary Seeker 6510 to recognize an URGS Provider 6590 that does not redeem vouchers 6550. The Provider descriptive information screen 7100 may contain an icon 7150 indicative that the described Provider 6590 does not redeem vouchers 6550. In some embodiments, such an icon may be ‘active’, i.e., it may operate as a ‘clickable’ hyperlink to facilitate display of additional information relative to vouchers 6550.

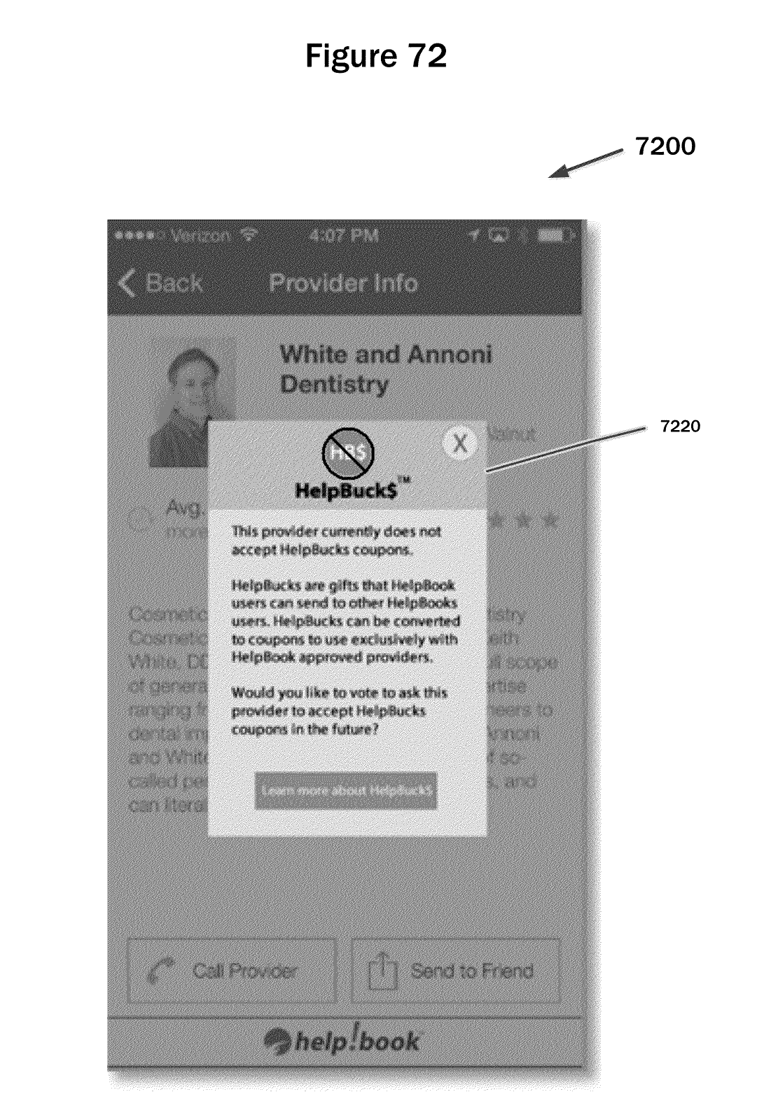

FIG. 72 provides an exemplary screen image 7200 to further illustrate, in some embodiments, a voucher options detail subscreen 7220 within a provider descriptive information screen as displayed by the Seeker app 2710 that may facilitate the voucher option beneficiary Seeker 6510 to consider additional information regarding vouchers 6550 and the non-redemption of them by the described Provider 6590. In some embodiments, the SILCM system 6500 may provide a facility for the potentially disappointed voucher option beneficiary Seeker 6510 to request that the Provider 6590 consider redeeming vouchers 6550. The SILCM system 6510 may record navigation by voucher option beneficiaries to Seeker app 2710 screens such as provider description information screen 7110 and voucher options detail subscreen 7220 for Providers not redeeming vouchers 6550—so as to aggregate and synthesize ‘missed opportunity’ statistics that may be communicated to such Providers 6590 by the Provider app 2790 or other facilities for communication between the SILCM system 6500 and the Provider 6590, so as to potentially incentivize such non-redeeming Providers 6590 to participate in morphable voucher program(s).

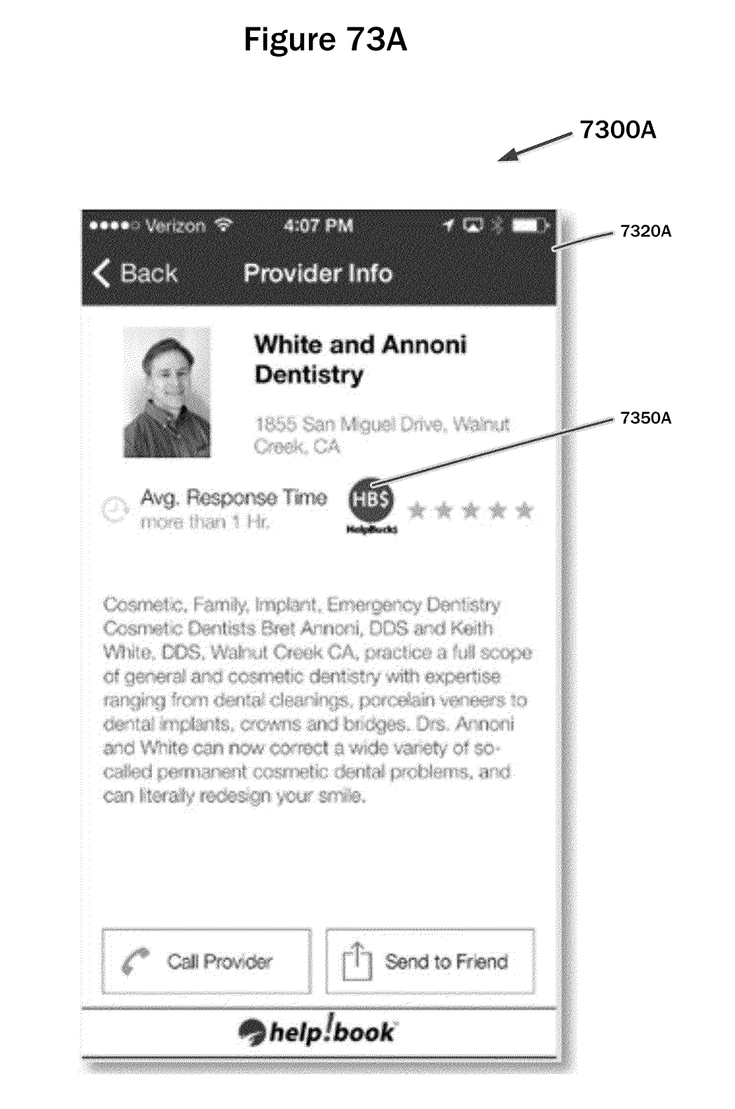

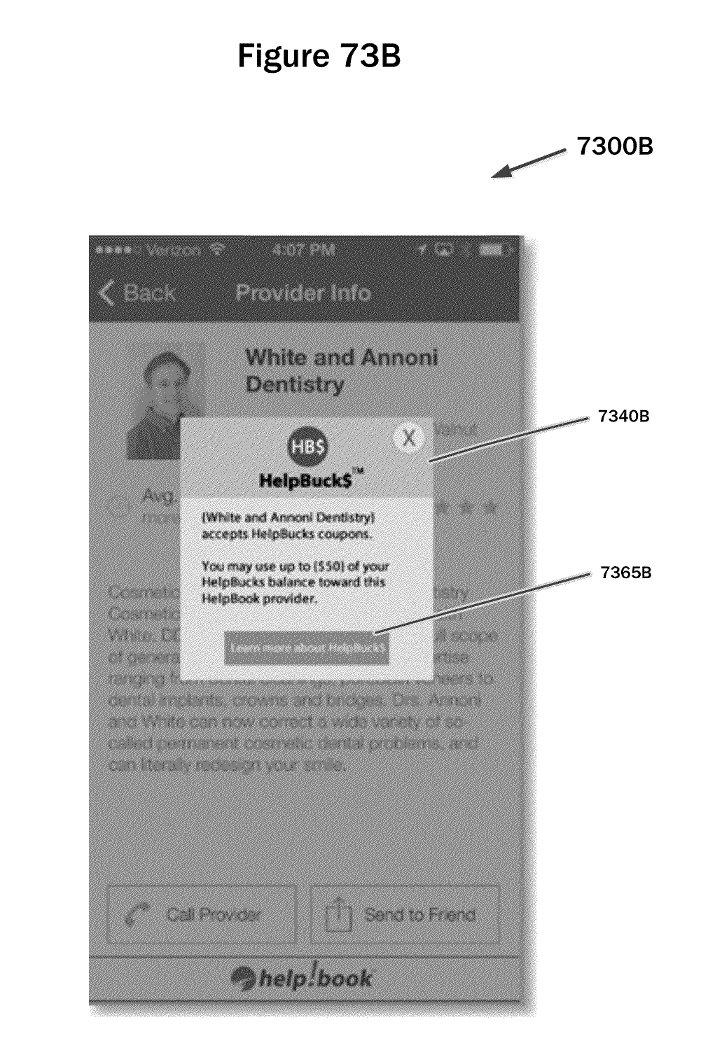

FIG. 73A provides an exemplary screen image 7300A to further illustrate, in some embodiments, a provider descriptive ‘info’ screen 7320A as displayed by the Seeker app 2710 that may facilitate the voucher option beneficiary Seeker 6510 to locate an URGS Provider 6590 that redeems vouchers 6550. The provider descriptive information screen 7320A may contain an icon 7350A indicative that the described Provider 6590 redeems vouchers 6550. In some embodiments, such an icon may be ‘active’, i.e., it may operate as a ‘clickable’ hyperlink (e.g., a virtual button) to facilitate display of additional information relative to voucher options.

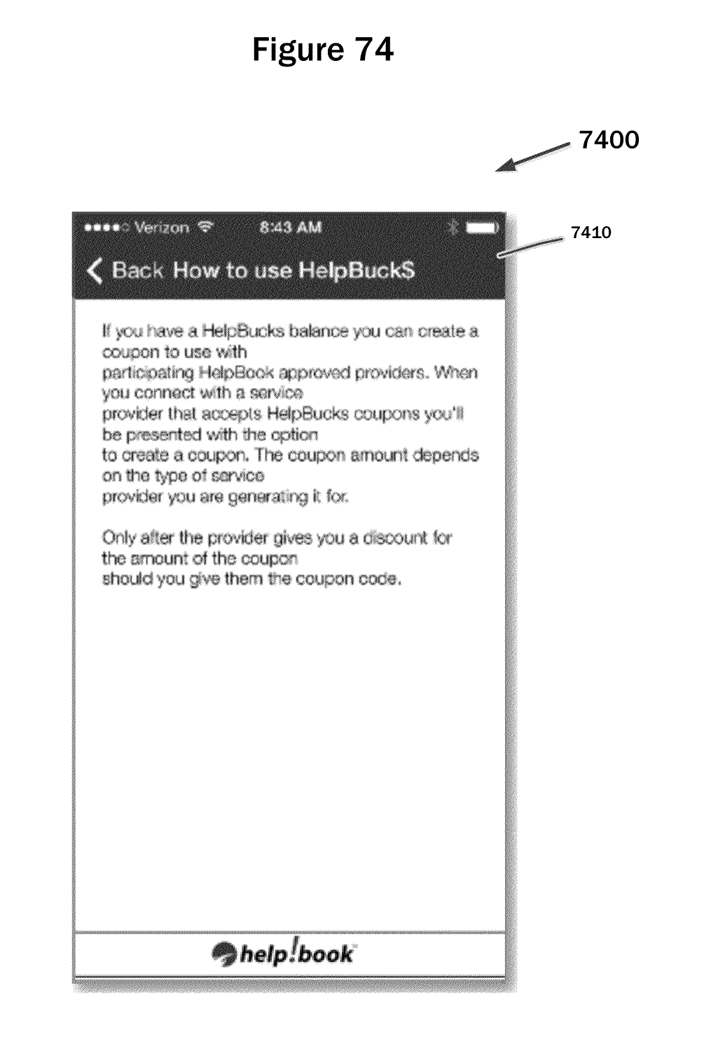

FIG. 73B provides an exemplary screen image 7300B to further illustrate, in some embodiments, a voucher options detail subscreen 7340B within a provider descriptive information screen as displayed by the Seeker app 2710 that may facilitate the Seeker 6510 to consider additional information regarding vouchers 6550 and the redeeming of them by the described Provider 6590. In some embodiments, such a voucher options detail subscreen 7340B may include a ‘learn more about helpbucks’ virtual button 7365B. Selecting virtual button 7365B may facilitate display of a voucher option morphing and voucher redemption information screen via the Seeker app 2710 (see FIG. 74).

FIG. 74 provides an exemplary screen image 7400 to further illustrate, in some embodiments, a voucher option morphing and voucher redemption information screen 7410 within a provider descriptive information screen as displayed by the Seeker app 2710 that may facilitate the Seeker 6510 to morph a voucher option 6530 into a corresponding voucher 6550 and redeem the voucher. Such a voucher redemption information screen 7410 may for example advise the Seeker 6510 to get concurrence with the Provider regarding redeeming the corresponding voucher 6550 prior to morphing the voucher option 6530.

In some embodiments, a given morphable voucher program(s) may be facilitated by the SILCM system 6500 in cooperation with a third-party payer for URGS—such as an insurance company—such that vouchers 6550 may be redeemed as co-payment and/or deductible payment accepted by such a third-party payer. In some embodiments, a Provider 6590 that receives payment from such a third-party payer, may automatically be enrolled in corresponding morphable voucher program(s) accepted by that third-party payer. Such “cooperative morphable voucher programs” may be given ‘brand’ names so as to be explicitly associated with a third-party payer. For example, a morphable voucher program may be named ‘Delta Dental voucher program’. Consequently, payer utilizers of the MCDUF system 2700—as well as Seekers 6510 and Providers 6590—may be subject to loyaltization binding by the SILCM system 6500.

Referring again to FIG. 68 at step 6860, in some embodiments, the SILCM system 6500—via the Seeker app 2710—may facilitate the Seeker 6510 to morph the voucher option 6530 into a corresponding voucher 6550 that may be received by the Seeker 6510 as a voucher redemption code via the Seeker app 2710 and given by the Seeker to the matched URGS Provider 6590 participating in the corresponding voucher program so that the Provider may subsequently accept it—exchanging the corresponding discount for the voucher 6550—and redeem it utilizing the Provider app 2790. In some embodiments, the Seeker 6510 may provide the voucher option to the Provider 6590 such that the Provider may utilize the Provider app 2790 to morph the voucher beneficiary Seeker's voucher option 6530 into a corresponding voucher 6550 on that Seeker's behalf and subsequently redeem that voucher. This latter form of morphing a voucher option may be useful should the Seeker 6510 lack the Seeker app 2710—perhaps because the Seeker's mobile device may be out of charge or not in the Seeker's possession. In some embodiments, a Provider 6590 may gift or otherwise issue a bonus voucher option 6530 to a Seeker 6510. For example, such a Seeker 6510 may have lost their voucher option 6530, or may have a voucher option of lesser value, or perhaps their voucher option 6530 may be expired or otherwise unsuccessfully morphed.

In some embodiments, the quantity of morphable voucher options 6530 corresponding to a morphable voucher program may be “variable”—i.e., different morphable voucher programs may have differing quantities of voucher options 6530. Furthermore, in some embodiments, the quantity of voucher options 6530 corresponding to a given morphable voucher program may be dynamic. In some embodiments, the potentially variable quantity of voucher options 6530 for a given morphable voucher program may be set, limited or otherwise bounded by the SILCM system 6500. In some embodiments, the quantity of such voucher options 6530 may be unlimited by the SILCM system 6500. Additionally, as mentioned previously, the quantity of morphable voucher options 6530 may differ from the corresponding quantity of redeemable vouchers 6550—perhaps substantially exceeding the quantity of redeemable vouchers 6550. Such a substantial differential may serve to increase the ubiquity of voucher options as well as result in an incentive for expedited utilization of a given voucher option 6530 by a voucher option beneficiary Seeker 6510, i.e., while the voucher option 6530 may still be morphed for the substantially scarcer voucher 6550 (as well as before possible cessation of the corresponding morphable voucher program). For voucher programs wherein the quantity of voucher options 6530 may exceed the quantity of corresponding vouchers 6550, attempting to morph the ‘excess’ voucher options 6530 may be unsuccessful. Unsuccessful morphing may occur for other and/or additional reasons—for example the voucher option 6530 may be expired. In some embodiments, the Provider 6590 may utilize the Provider app 2710 to request an “over-ride” of the unsuccessful voucher option morphing (not shown). Such an over-ride may be made or declined by the SILCM system 6500. Should the Provider 6590 succeed with such an over-ride, the Seeker 6510 may be grateful to the Provider for helping morph the voucher option 6530 and redeem the corresponding voucher 6550. Conversely, should the Provider 6590 not succeed with such an over-ride, the Seeker 6510 may be appreciative of the Provider's attempt. Regardless, the Seeker 6510 may be made aware that vouchers 6550 may be scarce and that voucher options 6530 may best be utilized expeditiously. In some embodiments, the Provider 6590 utilizing the Provider app 2790 may request of the SILCM system 6500 the immediate issuance of a bonus voucher option 6530 (not shown) to the Seeker 6510 so as to substitute for the unsuccessfully morphed voucher option 6530.

In some embodiments, subsequent to morphing the voucher option 6530, the corresponding voucher 6550 may have a “time-to-live” such that such a voucher may expire so as to no longer be redeemable by the SILCM system 6500 after having been previously redeemable. Such a time to live—especially if it may perhaps be on the order of minutes or a few hours—may serve as a deterrent for Seekers 6510 expeditiously morphing a newly received voucher option 6530 into a voucher 6550 with the intention of redeeming it much later or possibly not at all. Such vouchers 6550 that have a time-to-live or that may otherwise subsequently go from redeemable to unredeemable may be termed “potentially redeemable vouchers” 6550.

In some embodiments, the morphing of a given voucher option 6530 may be denied by the SILCM system 6500 regardless of the redeemability of the corresponding voucher 6550. For example, the given voucher option 6530 may be temporally morphable, but past its expiration. Or the voucher event may be un-expired, but the entirety of the corresponding vouchers 6550 in the voucher tranche or in the voucher program may have been issued such that there may be no voucher 6550 to morph the voucher option 6530 into. Or the voucher program may have ceased—the entire program or possibly a tranche or tranches including the voucher tranche corresponding to the voucher option 6530. Or the voucher option ID or other representation of the voucher option may be unrecognizable due to a transcribing error or some other problem. In some embodiments, the voucher option 6530 may be successfully morphed into a corresponding potentially redeemable voucher 6550 that may subsequently become unredeemable if not redeemed expeditiously. In some embodiments, the voucher option 6530 may be morphed into a corresponding potentially redeemable voucher 6550 that may be configured so as to remain redeemable indefinitely or have such a long time-to-live as to be effectively an “immortal” voucher 6550. In some embodiments, potentially redeemable vouchers and/or immortal vouchers may be made unredeemable by cessation of the corresponding voucher program.

In some embodiments, the Seeker's voucher 6550 may be redeemed by the participating URGS Provider 6590 for a maximum amount of discount and/or payment. Such maximum amount may be the redemption limit associated with the voucher option 6530, or may be otherwise associated with the voucher option 6530, the corresponding voucher 6550, the Provider 6590, the MCDUF system URGS category of the URGS provided by the Provider to the Seeker, or some entity or abstraction relating to or associated with the Provider 6590, the Seeker 6510 or the URGS provided by the Provider to the Seeker.

In some embodiments, the voucher option 6530 may have an associated redemption limit that may be less than, equal to, or greater than the maximum voucher redemption amount allowed by the SILCM system 6500 for the Provider's URGS category. If such a redemption limit may be less than the maximum voucher redemption amount, the Seeker 6510 may morph a voucher option into a voucher 6550 redeemable for the full redemption limit. If the redemption limit may be equal to the maximum voucher redemption amount, again the Seeker 6510 may morph into a voucher for that full amount. In some embodiments, if the redemption limit may be greater than the maximum voucher redemption amount for the Provider 6590, the Seeker 6510 may morph into a voucher 6550 only for the portion of the redemption limit equal to the maximum voucher redemption amount; but may subsequently utilize the voucher option 6530 again later with a correspondingly reduced redemption limit lessened by the actual amount redeemed. In other embodiments, such un-utilized portions of the redemption limit of a voucher option (i.e., in excess of the maximum voucher redemption amount for the Provider) may be forfeit. In some embodiments, the Seeker 6510 may be facilitated to redeem a voucher for a ‘selectable redemption amount’ that may be less than maximum allowable amount—i.e., less than the lesser of the redemption limit associated with the voucher option 6530 and the maximum voucher redemption amount. In other words, a Seeker may be provided the option to utilize a selectable portion of the allowable amount of the voucher option 6530. Any ‘held-back’ amount so selected to be left unredeemed by the voucher option beneficiary may be included in the residual redemption limit associated with the voucher option and may be available to be utilized subsequently by the Seeker 6510. In some embodiments, such ‘held-back’ residual redemption limit amounts may be protected from voucher option forfeiture.

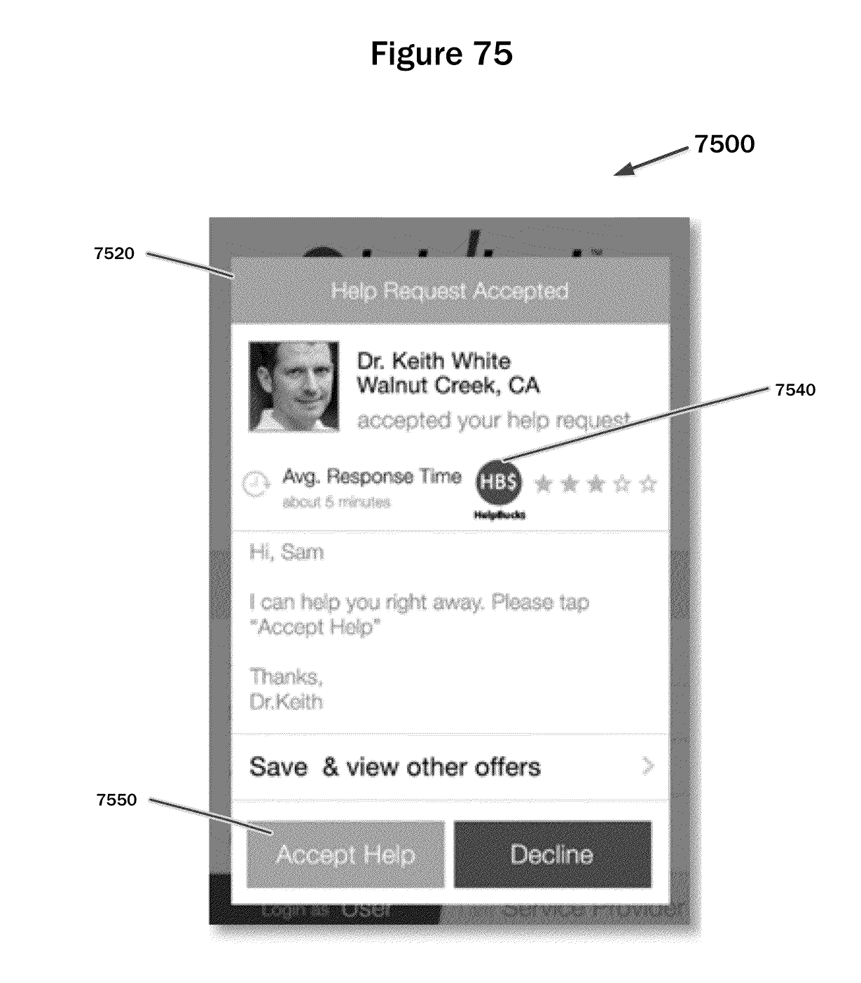

FIG. 75 provides an exemplary screen image 7500 to further illustrate, in some embodiments, a ‘help request accepted by Provider’ subscreen 7520 as displayed by the Seeker app 2710 that may facilitate the voucher option beneficiary Seeker 6510 to communicate with a matched URGS Provider 6590 that redeems vouchers 6550 (as indicated in the affirmative by the ‘voucher redemption’ icon, e.g., 7540). In some embodiments, such a Seeker 6510 selecting the ‘accept help’ virtual button 7550 may result in the SILCM system 6500 ‘locking-in’ the Seeker's voucher option 6530 by “conditionally morphing” it pending the matched Provider 6590 redeeming the voucher corresponding to the voucher option 6530. Furthermore, the SILCM system 6500 may determine if a corresponding voucher 6550 may be redeemable—i.e., valid, not expired and potentially redeemed by the matched Provider 6590 (i.e., that the Provider is a participant in the corresponding morphable voucher program).

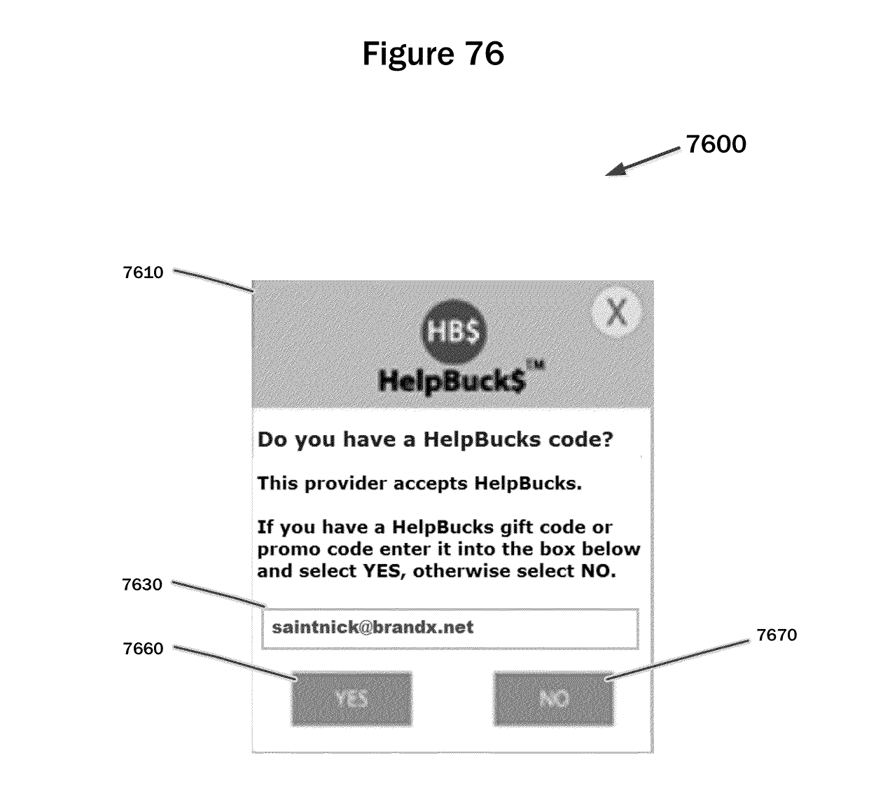

FIG. 76 provides an exemplary screen image 7600 to further illustrate, in some embodiments, an option ID entry subscreen 7610 as displayed by the Seeker app 2710 that may facilitate the voucher option beneficiary Seeker 6510 to input the Seeker's option ID so as to determine the corresponding morphable voucher program and to obtain the status of the Seeker's voucher option 6530. The Seeker 6510 may input the option ID for the Seeker's voucher option in the virtual entry box 7630 and select the corresponding ‘yes’ virtual button 7660 such that the SILCM system 6500 may record—perhaps in data base(s) 158—the option ID so as to virtually ‘date and time stamp’ it and also to associate it with the Seeker's MCDUF system account. Additionally, the SILCM system 6500 may endeavor to ascertain the morphable voucher program corresponding to the Seeker's voucher option 6530 and to further ascertain whether the voucher 6550 corresponding to such a voucher option 6530 may be available for redemption. In some embodiments, should the Seeker 6510 select the ‘no’ virtual button 7670, the SILCM system 6500 via the Seeker app 2710 may issue (not shown) a bonus voucher option 6530 to the Seeker 6510—perhaps for future (or perhaps immediate) use—perhaps in consideration for the disappointment the Seeker 6510 may experience due to lacking a voucher option 6530.

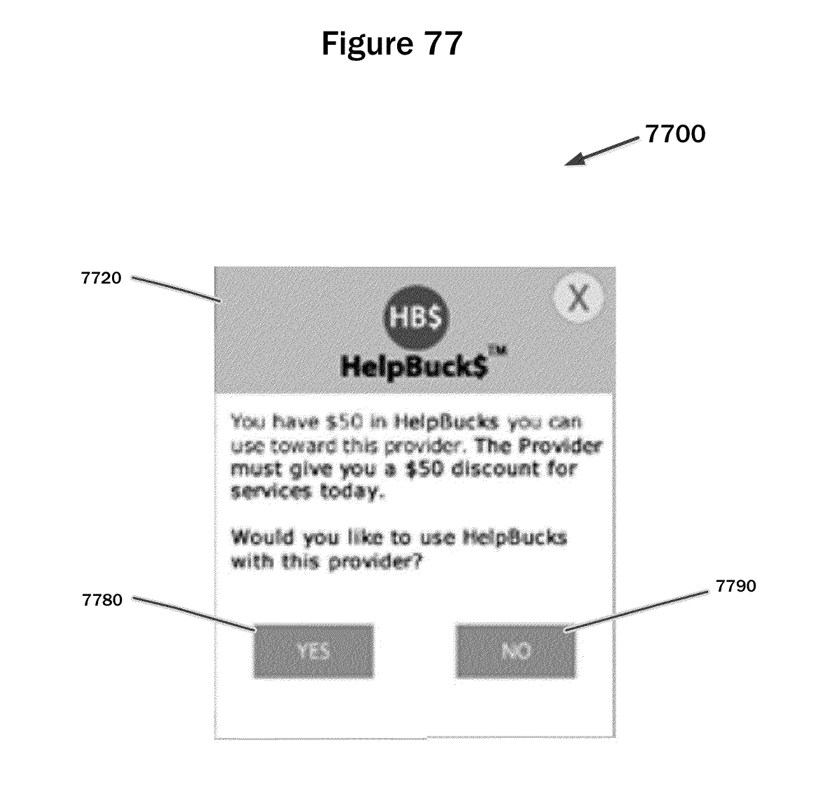

FIG. 77 provides an exemplary screen image 7700 to further illustrate, in some embodiments, a voucher option subscreen 7720 as displayed by the Seeker app 2710 that may facilitate the voucher option beneficiary Seeker 6510 to indicate the Seeker's intention to morph the voucher option into the corresponding voucher 6550 for redemption by the matched Provider 6590. In some embodiments, should the Seeker have voucher option(s) banked with the SILCM system 6500, the Seeker App 2710 may display to the Seeker 6510 the amount of such banked voucher option(s) that the Seeker 6510 may potentially morph into the corresponding voucher 6550 to redeem with the matched Provider 6590 as well as display (not shown) corresponding adjustments to such banked voucher option(s) that may subsequently result from morphing the voucher option 6530. In some embodiments, should the Seeker 6510 select the ‘yes’ virtual button 7780, the SILCM system 6500 may alert (not shown) the matched Provider 6590 via the Provider app 2790 that the Seeker intends to morph the voucher option 6530 and redeem the corresponding voucher 6550. Furthermore, should the Seeker 6510 and/or the matched Provider 6590 travel so as to meet and should the SILCM system 6500 determine that they have subsequently converged (say based on GPS information), the SILCM system 6500 may alert (not shown) the Seeker 6510 via the Seeker app 2710 and/or the matched Provider 6590 via the Provider app 2790 with a reminder to redeem the Seeker's voucher 6550. Should the Seeker 6510 select the ‘no’ virtual button 7790, the SILCM system 6500 may remind (not shown) the Seeker 6510 via the Seeker app 2710 that the voucher option(s) 6530 may expire if not morphed and the corresponding voucher 6550 redeemed expeditiously. In some embodiments, the Seeker app 2710 may display (not shown) a status for each banked voucher option 6530, including but not limited to: option ID, virtual face value, expiration event, quantity of available corresponding vouchers 6550, date of issue, and the issuer. Additionally, in some embodiments the Seeker app 2710 may display (not shown) a history of previously banked voucher option(s) 6530—morphed and expired.

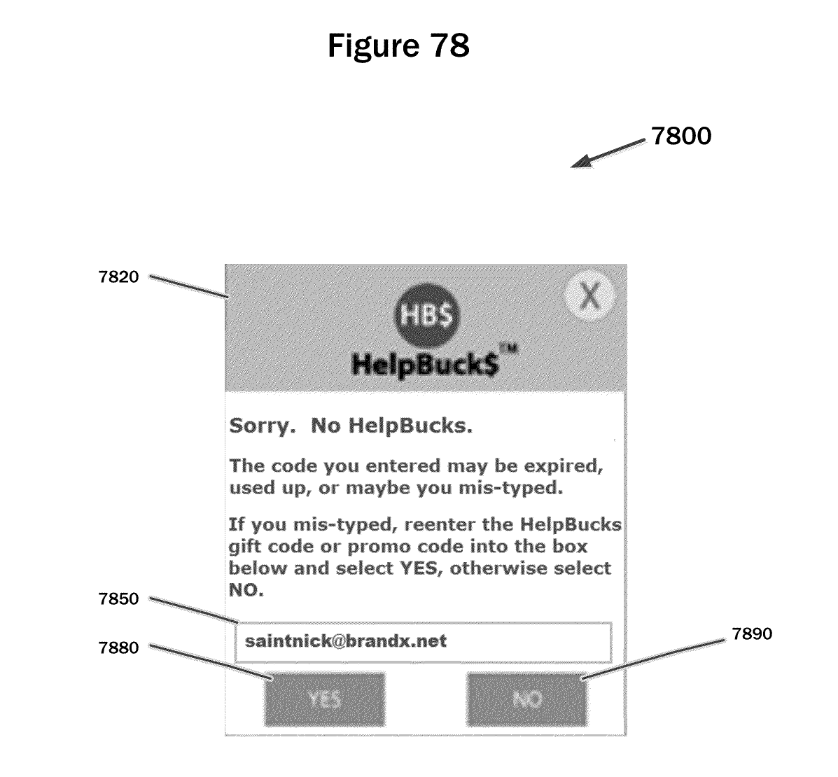

FIG. 78 provides an exemplary screen image 7800 to further illustrate, in some embodiments, a voucher option re-try option subscreen 7820 as displayed by the Seeker app 2710 that may facilitate the voucher option beneficiary Seeker 6510 to determine that the voucher option may be expired or is otherwise invalid. Furthermore, should the Seeker 6510 have mistyped, the Seeker may re-enter the option ID via virtual entry box 7850 and selecting the ‘yes’ virtual button 7880. In some embodiments, should the Seeker 6510 select the ‘no’ virtual button 7890, the SILCM system 6500 via the Seeker app 2710 may offer (not shown) a bonus voucher option 6530 to the Seeker 6510—perhaps for future use—perhaps in consideration for the disappointment the Seeker 6510 may experience due to lacking a voucher option 6530 that may be morphed into a redeemable voucher 6550. Should the Seeker 6510 forget the option ID of the voucher option, in some embodiments, the Seeker app 2710 may display (not shown) a status for each banked voucher option 6530—as discussed above—including the corresponding option ID of each banked voucher option 6530.

Referring again to FIG. 68 at step 6870, in some embodiments the SILCM system 6500 may facilitate the Provider 6590 to redeem the voucher beneficiary Seeker's voucher 6550 and to credit to the Provider 6590 re-imbursement for honoring and redeeming the Seeker's voucher 6550. The matched Provider 6590 may report receiving the Seeker's voucher (and honoring the corresponding discount) to the SILCM system 6500 via the Provider app 2790 so as to redeem the voucher and obtain a credit to the Provider's MCDUF system provider payments account (not shown) from the SILCM system 6500 in the amount of the SILCM matching share. In some embodiments, as a condition of redemption, the SILCM system 6500 may verify that the morphed voucher is associated with the Seeker 6510. For example, the SILCM system 6500 may query via the Provider app 2710 for the name of the client that may have presented the voucher 6550 to the Provider 6590 so as to verify a match with the Seeker 6590 that previously morphed the corresponding voucher option 6530. In this way, for example, the SILCM system may inhibit the use of morphed vouchers by individuals who are not recruited Seekers 6510.

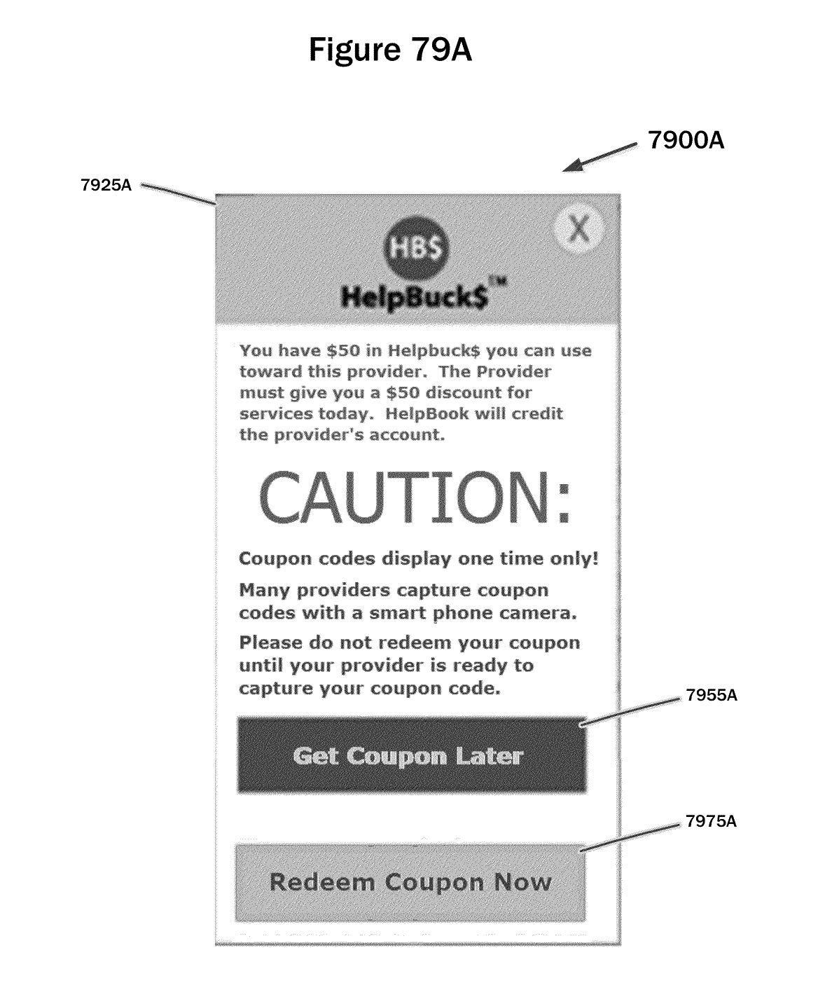

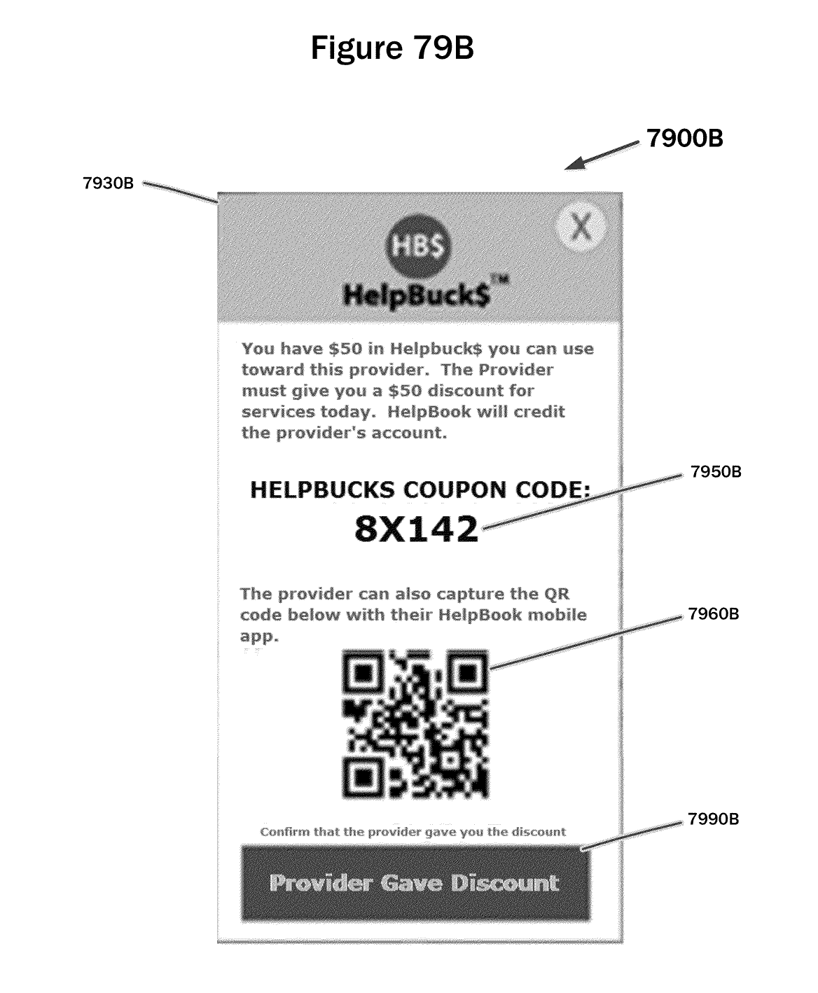

FIG. 79A provides an exemplary screen image 7900A to further illustrate, in some embodiments, a voucher redemption advisory subscreen 7925A as displayed by the Seeker app 2710 that may confirm that a voucher 6550 (corresponding to the voucher option 6530) may be available to redeem; may display the potential value of such a voucher; and may advise the voucher option beneficiary Seeker 6510 of motivations to appropriately time the redeeming of such a voucher 6550. So for example, in some embodiments, such a voucher 6550 may be represented by a “voucher redemption code” (not shown in 7900A) that, in some embodiments, may only be displayed one time by the Seeker app 2710. Therefore, the Seeker may be motivated to avoid losing the voucher redemption code, and along with it, the corresponding voucher 6550. Consequently, the Seeker may select to delay redeeming the voucher and displaying the corresponding voucher redemption code so as to display the voucher redemption code in physical proximity to the Provider such that the Provider 6590 may capture it and the Seeker 6510 may be receive a discount or credit for the voucher's value. By selecting the ‘get coupon later’ virtual button 7955A, the Seeker 6510 may defer morphing the voucher option 6530. In some embodiments, Seeker 6510 selecting such a deferring virtual button may result in the SILCM system 6500 ‘locking-in’ the Seeker's voucher option 6530 by conditionally morphing it (perhaps subject to a time limit) pending the matched Provider 6590 subsequently redeeming the voucher corresponding to the voucher option 6530. By selecting the ‘redeem coupon now’ virtual button 7975A, the Seeker 6510 may morph the voucher and display the corresponding voucher redemption code (see FIG. 79B). In some embodiments, should the Seeker have voucher option(s) banked with the SILCM system 6500, the Seeker App 2710 may display to the Seeker 6510 the amount of such banked voucher option(s) that the Seeker 6510 may morph and potentially redeem the corresponding voucher(s) 6550 with the matched Provider 6590 as well as display (not shown) corresponding adjustments to such banked voucher option(s) resulting from morphing the voucher option 6530.

FIG. 79B provides an exemplary screen image 7900B to further illustrate, in some embodiments, a voucher redemption subscreen 7930B as displayed by the Seeker app 2710 that may facilitate the voucher option beneficiary Seeker 6510 to redeem a voucher corresponding to the Seeker's voucher option 6530 utilizing the Seeker app 2710. In some embodiments, such a voucher 6550 may be represented by a voucher redemption code that may be represented as a character string 7950B and/or a QR code 7960B or perhaps some other human or machine-readable form(s). In some embodiments, the Seeker 6510 may re-display the voucher redemption code via the voucher redemption subscreen 7930B as desired prior to redemption of the corresponding voucher by the matched Provider 6590. By selecting the ‘provider gave discount’ virtual button 7990B, the Seeker 6510 may report to the SILCM system 6500 that the Seeker 6510 gave the matched Provider 6590 the voucher redemption code as well as indicating that the Provider 6590 honored the corresponding discount. Such a virtual button 7990B may motivate the Seeker 6510 to verify that the Provider 6590 has rebated the Seeker the discount and/or payment credit corresponding to the voucher 6550. The SILCM system 6500 may record a ‘time and date stamp’ corresponding to the Seeker 6510 selecting virtual button 7990B. In some embodiments, such a record (not shown) may be utilized subsequently to help resolve any corresponding billing issues. In some embodiments, crediting the SILCM matching share to the Provider's MCDUF system provider payments account (not shown) may be conditioned on such a report from the Seeker 6510. In some embodiments, the SILCM system 6500 may issue the Seeker a new voucher option 6530 as an incentivizing reward for reporting receipt of the discount from the Provider 6590 (e.g., by pressing virtual button 7990B).

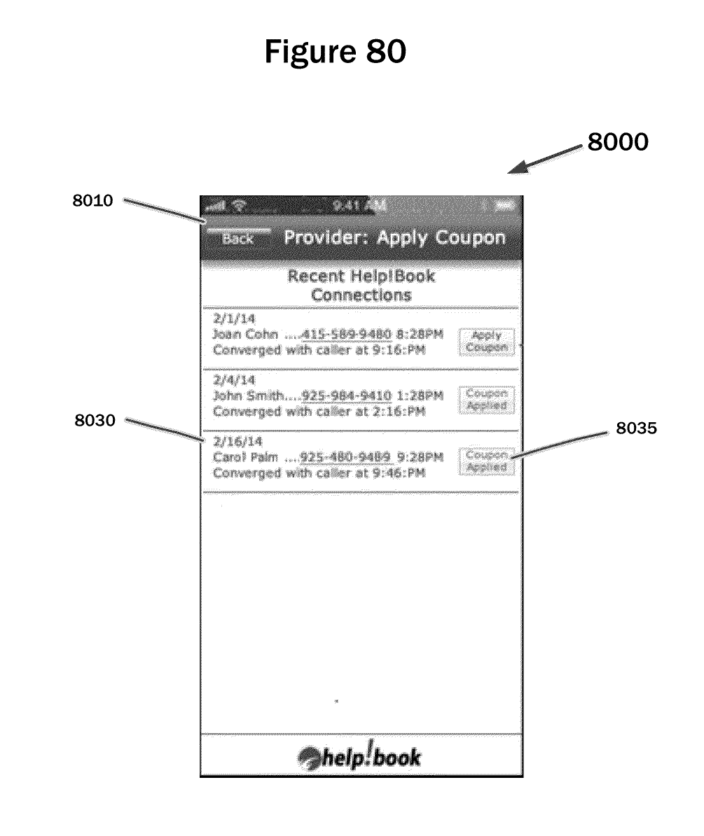

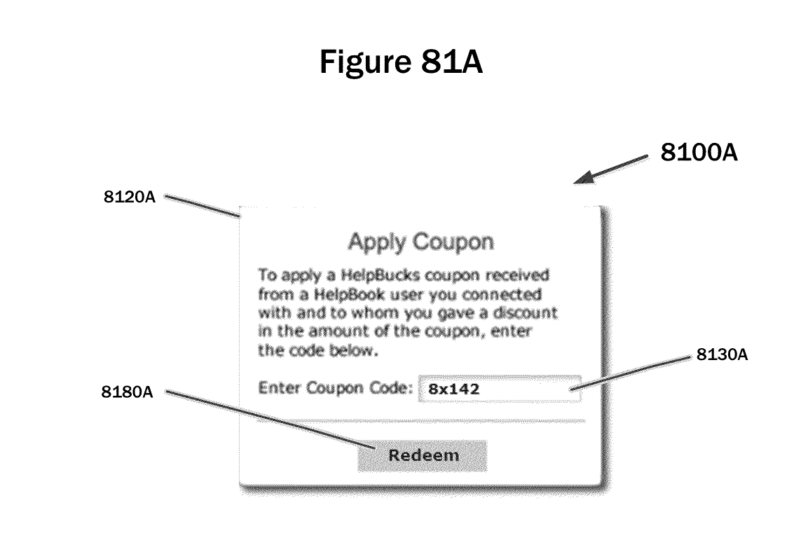

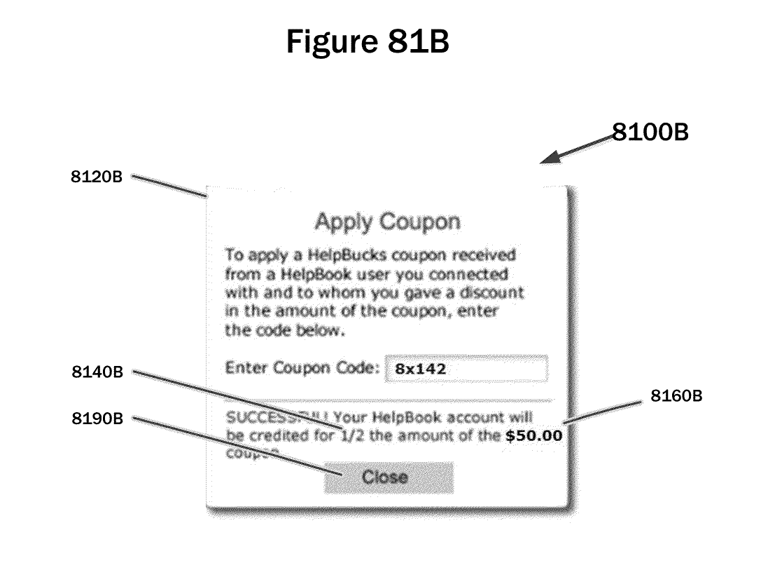

FIG. 80 provides an exemplary screen image 8000 to further illustrate, in some embodiments, a voucher-to-caller match selection screen 8010 as displayed by the Provider app 2790 that may facilitate the matched Provider 6590 to associate the Seeker 6510 with the Seeker's voucher redemption request so as to report that association to the SILCM system 6500. The Provider 6590 may locate the ‘recent caller’ entry 8030 corresponding to the voucher option beneficiary Seeker 6590 and select the ‘apply coupon’ virtual button 8035. The SILCM system 6500 may record a ‘time and date stamp’ corresponding to the Seeker selecting virtual button 8035. In some embodiments, such a record (perhaps in data base(s) 158) may be utilized subsequently to help resolve any corresponding billing issues. In some embodiments, selecting the ‘apply coupon’ virtual button 8035 may facilitate display of a voucher redemption code entry subscreen via the Provider app 2790 so as to input the Seeker's voucher redemption code (see FIG. 81A). In some embodiments, the voucher-to-caller match selection screen 8010 may serve as a reminder to the Provider 6590 of which Seeker's vouchers may remain to be redeemed.

FIG. 81A provides an exemplary screen image 8100A to further illustrate, in some embodiments, a voucher redemption code entry subscreen 8120A as displayed by the Provider app 2790 that may facilitate the matched Provider 6590 to report receiving and honoring the Seeker's voucher 6550 to the SILCM system 6500. The matched Provider 6590 may obtain the Seeker's voucher redemption code from the Seeker 6510 and enter it—for example via the virtual entry box 8130A and selecting the ‘redeem’ virtual button 8180A. The SILCM system 6500 may record the voucher redemption code along with a ‘time and date stamp’ corresponding to the Provider 6590 selecting virtual button 8180A. In some embodiments, such a record may be utilized subsequently to help resolve any corresponding billing issues. Subsequent to such reporting of the matched Provider's receiving and honoring of the Seeker's voucher 6550 utilizing the voucher redemption code, the SILCM system 6500 may record an expiration event (i.e., redemption) for the voucher 6550. Furthermore in some embodiments, subsequent to such reporting, the SILCM system 6500 may credit the Provider's MCDUF system provider payments account (not shown) in the amount of the SILCM matching share.

FIG. 81B provides an exemplary screen image 8100B to further illustrate, in some embodiments, a voucher redemption credit confirmation subscreen 8120B as displayed by the Provider app 2790 that may confirm to the matched Provider 6590 that the SILCM system 6500 may have credited the Provider's MCDUF system provider payments account (not shown) in the amount of the SILCM matching share. In some embodiments, the ratio 8140B for the SILCM matching share may be explicitly displayed (e.g., ‘½’). Also, in some embodiments, the amount 8160B of the SILCM matching share may be explicitly displayed (e.g., ‘$50’). Subsequent to the matched Provider 6590 selecting the ‘close’ virtual button 8190B, the SILCM system 6500 may record a corresponding ‘time and date stamp’. In some embodiments, such a record may be utilized subsequently to help resolve any corresponding billing/crediting issues.

Referring again to FIG. 68 at step 6880, in some embodiments the SILCM system 6500 may facilitate the Seeker 6510 to send a ‘thank you’ message to the issuer(s) corresponding to the Seeker's morphed voucher option 6530.

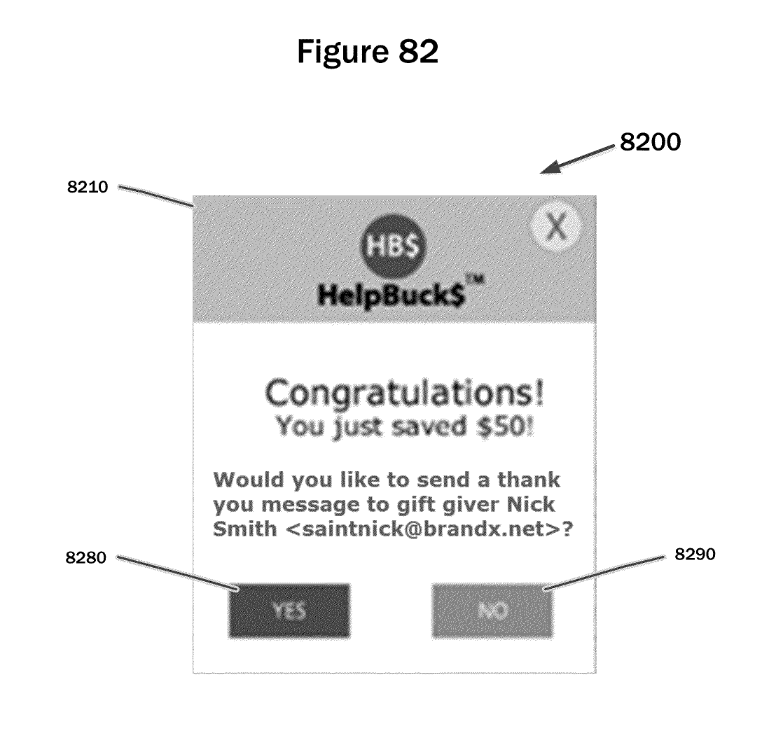

FIG. 82 provides an exemplary screen image 8200 to further illustrate, in some embodiments, a thank you to gifter subscreen 8210 as displayed by the Seeker app 2710 that may facilitate the Seeker 6510 to convey gratitude to the issuer of the Seeker's morphed voucher option 6530. Subsequent to the Seeker 6510 selecting the ‘yes’ virtual button 8280, the SILCM system may send such a ‘thank you’ message to the issuer on the Seeker's behalf. In some embodiments, the thank you gifter subscreen 8210 may include a virtual entry box (not shown) allowing the Seeker 6510 to input a personal message for the issuer. In some embodiments, should the Seeker 6510 select the ‘no’ virtual button 8290, the SILCM system 6500 may send a ‘thank you’ message from the SILCM system 6500 to the issuer.

Referring again to FIG. 67 at step 6720, in some embodiments the SILCM system 6500 may facilitate incremental enrollment of the Seeker 6510 as the Seeker ‘first time’ utilizes and/or subsequently re-utilizes the MCDUF system 2700 to fulfill the Seeker's URGS need(s). (Incremental enrollment is discussed above in Section III. ADDITIONAL ENHANCEMENTS—Micro-Casting Distributed URGS Fulfillment System.) In some embodiments, incremental enrollment may utilize en-passant gathering of the Seeker's registration information so as to facilitate the Seeker's utilization of the MCDUF system 2700 efficiently and yet also obtain the Seeker enrollment information that may be utilized by the MCDUF system 2700 to fulfill the Seeker's URGS needs and by the SILCM system 6500 to loyaltize the Seeker 6510. In some embodiments, incremental enrollment combines gathering Seeker information with educating and facilitating the Seeker 6510 to effectively utilize the MCDUF system 2700. Loyaltization may be advanced by the MCDUF system 2700 and the SILCM system 6500 being relatively unobtrusive and easy to utilize while being effective in facilitating the Seeker 6510 to benefit from SILCM incentives and fulfill URGS need(s). In some embodiments, the Seeker 6510 may be enrolled in the MCDUF system 2700/SILCM system 6500 as a benefit of a membership in a third party entity such as AARP.

At step 6730 the SILCM system 6500 may periodically assess and adapt to Seeker urgency. (Assessing and adapting to Seeker urgency is discussed above in Section III. ADDITIONAL ENHANCEMENTS—Micro-Casting Distributed URGS Fulfillment System.) The Seeker's urgency may be productive and useful when it drives the Seeker 6510 to focus and to act effectively. However, urgency may be counterproductive should it drive the Seeker 6510 towards panic, frustration, and non-helpful reactions—either over-reacting or under-reacting. The SILCM system 6500 by adapting to assessed urgency may facilitate the Seeker 6510 to effectively focus and act to fulfill the Seeker's URGS needs while avoiding and calming Seeker panic and frustration. For example, the utilization of assessed urgency as a ranking factor in micro-casting the Seeker's request for help may result in expeditiously matching a well-suited Provider 6590, which may therefore have a strong calming and loyaltizing effect on the Seeker 6510.

At step 6740 the SILCM system 6500 may determine the Seeker's URGS need(s), since doing so—both easily and correctly—may be essential to fulfilling the Seeker's URGS need(s) and to loyaltizing the Seeker 6510. (Determining the Seeker's URGS need(s) is discussed above—including in Section III. ADDITIONAL ENHANCEMENTS—Micro-Casting Distributed URGS Fulfillment System.) Facilitating the Seeker's navigation of the MCDUF system 2700 and quickly narrowing needs categories down to a match so as to expeditiously determine the Seeker's may help loyaltize the Seeker. Whereas sluggish, confusing, overly-wordy and/or inconclusive navigation may annoy or upset and perhaps alienate a Seeker 6510.

Nonetheless, relative to loyaltization, even misnavigation of the Seeker app 2710 by a given Seeker 6510 may more broadly serve the purpose of loyaltization by exposing opportunities to improve the Seeker app 2710 for subsequent Seekers' utilization. To benefit from such opportunities, the SILCM system 6500 may utilize “app-flow tracking and analysis”—an ongoing system of self-measurement and analysis of the MCDUF system 2700 by the SILCM system 6500. App-flow tracking and analysis may utilize instrumentation of the Seeker 6510 at each Seeker-MCDUF system interaction point in the Seeker's utilization of the Seeker app 2710—assessing both the Seeker's urgency and progress navigating the Seeker app. Furthermore, by aggregating the Seeker app utilization experiences of a multiplicity of Seekers, App-flow tracking and analysis may support rapid incremental improvements and enhancements to the MCDUF system 2700.

In some embodiments, App-flow tracking and analysis, in addition to leading to improvements in Seeker loyaltization, may also be utilized to enhance Provider 6590 loyaltization by providing existing Providers 6590 and potential providers a data-driven ‘picture’ of MCDUF system 2700 and SILCM system 6500 operation.

At step 6745 the SILCM system 6500 may mediate potential introduction of an URGS facilitator. As alluded to above, some Seekers 6510 may have difficulty utilizing the Seeker app 2710. Or the MCDUF system, although utilized well by the Seeker, may not be producing a successful URGS Provider match in a timely fashion. Regardless, of the cause, some Seekers 6510 may need some “additional facilitation” to achieve a match with an URGS Provider 6590. In some embodiments, such additional facilitation may be automated utilizing a computerized facilitator. In some embodiments, additional facilitation may be provided by a human facilitator 6560; and in some embodiments, additional facilitation may be both automated and human-provided. In the case of the latter, initial additional facilitation may for example be automated, but may escalate to a human facilitator 6560 should automated additional facilitation seem inadequate. Furthermore, in some embodiments, a human facilitator 6560 may monitor and mediate additional facilitation and may make the decision to take over the additional facilitation. Automated additional facilitation may be facilitated by the fulfillment server(s) 155 and/or Seeker app 2710. In some embodiments, a human facilitator may be a third-party, perhaps located at a remote call center.

In some embodiments, the SILCM system 6500 may anticipate and provide additional facilitation for users (Seekers 6510 and Providers 6590) with special needs based on MCDUF system account configuration information that may be entered by a given user and/or upon real-time monitoring and assessment. For example, an additional facilitator may facilitate communication between Seeker and Provider—say if the Seeker 6510 is a Tagalog speaker and the Provider 6590 is most fluent in Hindi. That help by the SILCM system 6500 may transform the seemingly near impossible situation into a successful match and satisfied users outcome—loyaltizing the Seeker 6510 and the Provider 6590 in doing so.

Regardless of whether the additional facilitation is automated or provided by a human facilitator 6560, the SILCM system 6500 may utilize additional facilitation to provide ‘extra help’ for struggling Seekers. So for example, if the Seeker 6510 may be having difficulty selecting an URGS category, the additional facilitator may query the Seeker 6510 about their URGS need(s) to determine if the MCDUF system 2700 may support a corresponding URGS category. If the appropriate category may not currently be supported, the facilitator may for example suggest an alternative search strategy to the Seeker 6510. Conversely, if the appropriate category is supported by the MCDUF system 2700, the facilitator may assist the Seeker 6510 to utilize the Seeker app 2710 to select that category or may otherwise navigate the MCDUF system 2700 for the Seeker 6510.

Additional facilitation—depending on the embodiment—may use one or more media to facilitate the Seeker's successful utilization of the MCDUF system 2700. Such media may include but not be limited to: image, text, chat, voice and video. The additional facilitation may be pre-produced or live or a combination of both. Live additional facilitation may be human-enacted or machine-synthesized or a combination of both. Regardless of the components in the additional facilitation ‘tool-kit’, an essential capability of the SILCM system 6500 may be to assess a given Seeker's experience utilizing the MCDUF system 2700 in a timely way so as to provide additional facilitation that may be determined to be appropriate for that given Seeker 6510 and the difficulties they may be determined to be experiencing in utilizing the Seeker app 2710. Such assessment may be provided by app-tracking and analysis by the SILCM system 6500 as described previously above. In some embodiments, additional facilitation may be introduced without being solicited by the Seeker 6510. In some embodiments, additional facilitation may intentionally be requested the Seeker 6510 via facilities such as a ‘help’ virtual button located in a given Seeker app screen.

At step 6750 the SILCM system 6500 may match the Seeker 6510 to an URGS category-appropriate Provider 6590. (Matching the Seeker to a URGS Provider(s) is discussed above—including in Section III. ADDITIONAL ENHANCEMENTS—Micro-Casting Distributed URGS Fulfillment System.) The expeditiousness (as well as the eventual success) of such matching may be quite important in the loyaltization of the Seeker 6510. First of all, such expeditiousness provides the Seeker 6510 some sense of successful progress towards attaining the URGS needed by the Seeker. Furthermore, it may provide the opportunity for the Seeker 6510 to interact with one or more Provider(s) 6590 thus, importantly for the SILCM system 6500, facilitating Seeker to Provider loyaltization binding. That such matching may be accomplished expeditiously may have the added benefit of helping loyaltize the Seeker 6510 to the MCDUF system 2700.

At step 6760 the SILCM system 6500 may facilitate communication between the Seeker 6510 and the matched Provider 6590. (Facilitating communication between Seeker and matched Provider is discussed above—including in Section III. ADDITIONAL ENHANCEMENTS—Micro-Casting Distributed URGS Fulfillment System.) The MCDUF system 2700 may facilitate virtually direct communication that otherwise may be shunned. We may all have had the experience of calling our doctor and getting the nurse; calling the dentist and getting the receptionist; calling the taxi driver and getting the dispatcher; calling our lawyer and getting the paralegal assistant; calling our customer service representative and getting the automated voice messaging system. It is a fact of modern life that many professionals may actively avoid having direct conversations with their customers. But with the MCDUF system 2700 as intermediary, the Seeker 6510 may send help requests to a matched Provider 6590 via the MCDUF system 2700; and the matched Provider 6590 may respond with an offer via the MCDUF system 2700; and the Seeker may accept the Provider's offer via the MCDUF system 2700. They may transact the match without seemingly ever directly interacting—and yet virtually, they may in fact be. Or for those who may want more personal interaction, the MCDUF system 2700, may for example facilitate a phone conversation. Additionally, the MCDUF system 2700 may be better at finding the matched Provider 6590 than a human—such as a receptionist—may be able to do. Bottom line, the SILCM system 6500 may loyaltize Seekers (and Providers too) by facilitating near-direct and/or direct communication between Seeker 6510 and matched Provider 6590 while perhaps giving both a greater sense of control, and of results, than if they were attempting to communicate directly.

At step 6765 in some embodiments, the SILCM system 6500 may facilitate the providing of URGS to the Seeker 6510. (Facilitating the providing of URGS to the Seeker 6510 is discussed above—including in Section III. ADDITIONAL ENHANCEMENTS—Micro-Casting Distributed URGS Fulfillment System.) For example, the MCDUF system 2700 may facilitate the meeting of the Seeker 6510 and the Provider 6590 via respective Seeker's search result and Provider's caller maps. Facilitating the Seeker to acquire the needed URGS—subsequent to the Seeker 6510 accepting the matched Provider 6590—may serve to loyaltize both the Seeker 6510 and Provider 6590. But additionally, by providing the Seeker 6510 and the matched Provider 6590 status updates regarding each other (e.g., via search results maps and caller maps respectively) they may also actively assist each other. For example, if a Seeker 6510 is driving to a Provider 6590 but may be stuck in freeway traffic, the Provider may perhaps contact the Seeker via the MCDUF system 2700 and suggest an alternative travel route. Such helpful collaboration between the Seeker 6510 and the Provider 6590 may engender loyaltization binding between them. An appreciation of the SILCM system 6500 as a facilitator may also engender loyaltization to the MCDUF system 2700 and SILCM system 6500.

In some embodiments, such an alternative route may be displayed via the search results maps and caller maps. Furthermore, in some embodiments the MCDUF system 2700 may facilitate determining possible alternative routes which may be displayed via respective maps utilizing the Seeker app 2710 and Provider app 2790.

Much may go awry between the acceptance of a matched Provider 6590 by the Seeker 6510 and the eventual fulfillment of the URGS need(s). App-tracking and analysis facilitated by the SILCM system 6500 may record the progress of fulfillment. For example, say again that the Seeker with a toothache may be traveling to the dentist matched Provider 6590. GPS location measurements via the Seeker app 2710 may periodically be recorded by the SILCM system 6500. Additionally, communications facilitated by the MCDUF system 2700 between Seeker 6510 and Provider 6590 may be recorded. Furthermore, in some embodiments, the SILCM system 6500 may detect a travel delay—for example the Seeker is stuck in traffic—and send an alert (perhaps including an updated ‘ETA’) to the traveler's counterpart—in this example, the Provider 6590. Such recordings may be useful in avoiding upset and disappointment; and if need be, may be utilized in resolving disputes between Seekers 6510 and Providers 6590 and/or between users and the MCDUF system 2700. By aggregating and analyzing a multiplicity of MCDUF system records resulting from app-tracking and analysis corresponding to a multiplicity of attempted and successful URGS fulfillments, the SILCM system 6500 may facilitate the prediction of the progress and outcome of a given URGS fulfillment attempt.

At step 6770 in some embodiments, the SILCM system 6500 may facilitate the Provider 6590 to loyaltize the Seeker 6510. For example, the SILCM system 6500 may facilitate the Provider 6590 to issue a voucher option 6530 to the Seeker 6510.

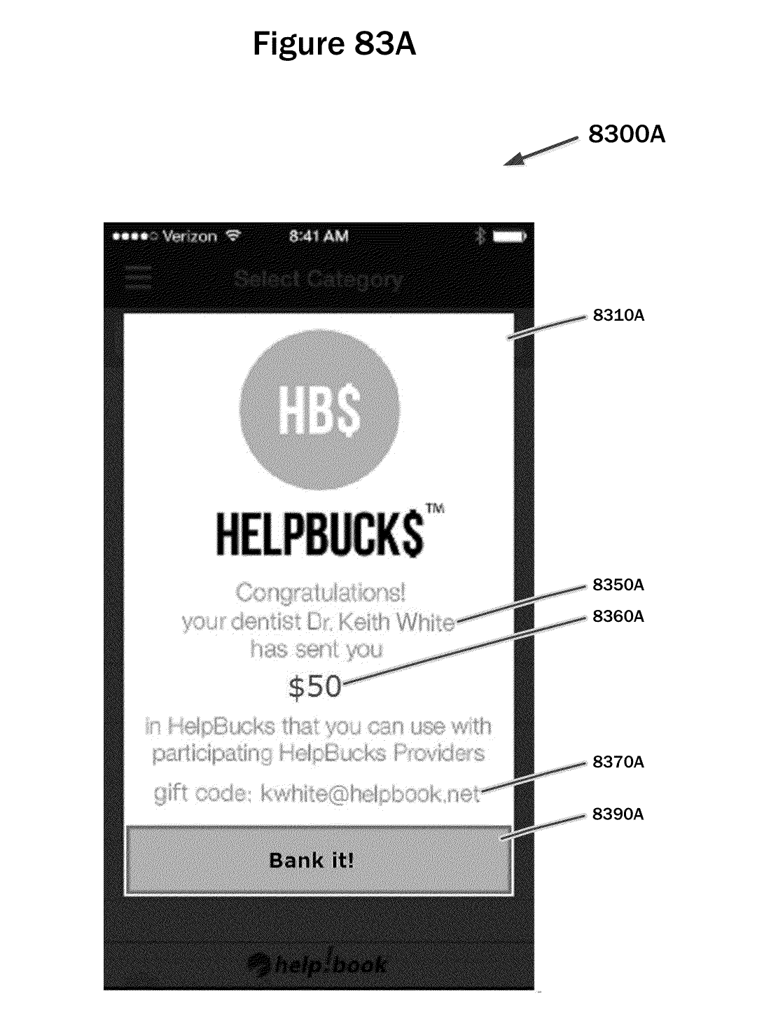

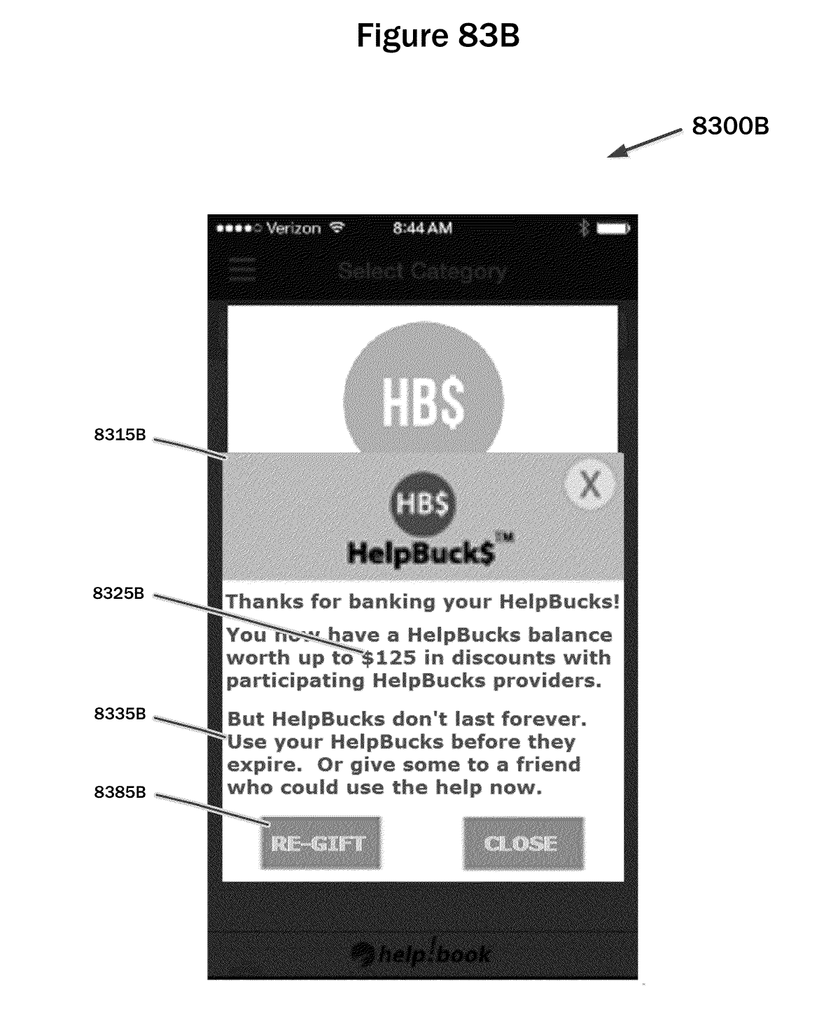

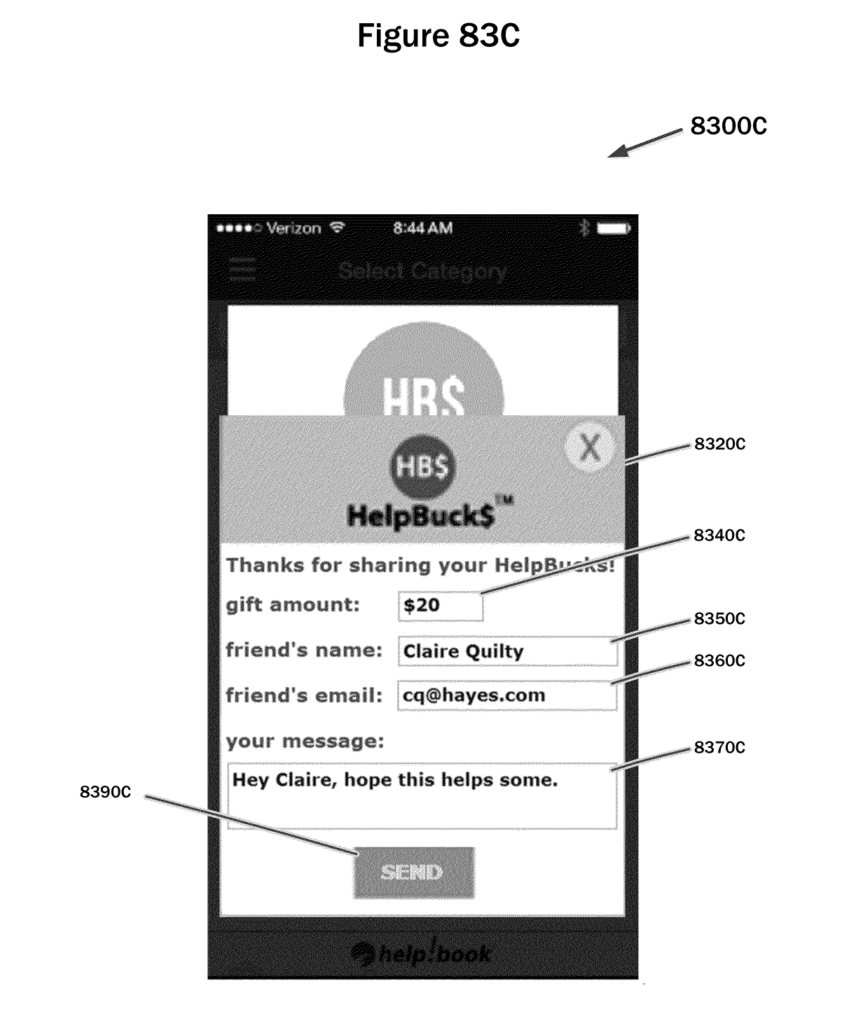

FIG. 83A provides an exemplary screen image 8300A to further illustrate, in some embodiments, a voucher option gifted by provider subscreen 8310A as displayed by the Seeker app 2710 that may facilitate informing the Seeker 6510 of a given Provider's gift of a bonus voucher option 6530 to that Seeker 6510 and explicitly attributing the gift to the Provider 6590. The Provider 6590—in this example, Dr. Keith White 8350A—may gift the Seeker 6510 a bonus voucher option 6530 with a virtual face value amount 8360A of $50. In addition to informing the Seeker 6510 as to who the gift issuer may be, and also the virtual face value of the voucher option 6530, the SILCM system 6500 via the Seeker App 2710 may also display the option ID 8370A for the voucher option 6510. In this example, the option ID may be in the form of an email address corresponding to the issuer—the Provider 6590 Dr. White. In addition to utilizing, the option ID 8370A as the voucher option 6530, the Seeker 6510 may utilize the email address corresponding to the option ID to communicate with the Provider 6590—perhaps to send a thank you and maybe request an appointment.

In some embodiments, a Provider 6590 may issue a bonus voucher option 6530 to a Seeker 6510 that may be morphed into a voucher 6550 that may only be redeemed for URGS from that Provider. In some embodiments, a Seeker 6510 may utilize a voucher for acquiring—from an URGS Provider 6590—goods and/or services that may not be URGS. So perhaps the Seeker 6510 in the example above, may utilize the voucher option 6530 issued by Provider 6590 Dr. White to acquire a service of whitening the Seeker's teeth. Such a broader utilization of vouchers may further loyaltization binding between Seekers and Providers and may motivate additional business for Providers 6590 and make additional URGS and perhaps other goods and/or services more affordable and therefore more desirable for Seekers 6510.

Referring again to FIG. 83A, in some embodiments, by selecting the ‘bank it’ virtual button 8390A, the voucher option beneficiary Seeker 6510 may bank the Seeker's voucher option 6530 utilizing the SILCM system 6500. In some embodiments, selecting the virtual button 8390A may facilitate the display by the SILCM system 6500 via the Seeker app 2710 of additional information associated with the Seeker's banked voucher option(s) 6530 (see FIG. 83B).

FIG. 83B provides an exemplary screen image 8300B to further illustrate, in some embodiments, a voucher option banking information subscreen 8315B as displayed by the Seeker app 2710 that may facilitate informing the Seeker 6510 regarding voucher option(s) 6530 the Seeker 6510 may have banked with the SILCM system 6500. Such information may include a total balance 8325B of the virtual face value(s) of all such banked voucher option(s) 6530 (e.g., $125). Furthermore, in some embodiments, the SILCM system 6500 may inform the Seeker 6510 of the possibility of voucher options expiring 8335B and further may facilitate the Seeker 6510 to gift some portion of the Seeker's voucher options to another Seeker 6510 (or potential new seeker that may subsequently be incentivized to become a Seeker). By selecting the ‘re-gift’ virtual button 8385B, the Seeker 6510 may facilitate the display by the SILCM system 6500 via the Seeker app 2710 of an additional subscreen that may facilitate the Seeker's re-gifting of banked voucher option(s) 6530 (see FIG. 83C).

FIG. 83C provides an exemplary screen image 8300C to further illustrate, in some embodiments, a voucher option gifted by Seeker subscreen 8320C as displayed by the Seeker app 2710 that may facilitate the Seeker 6510 to gift voucher option(s) 6530 that the Seeker 6510 may have banked with the SILCM system 6500. Such a subscreen 8320C may include virtual entry boxes to facilitate the Seeker to input: the gift amount (virtual face value) 8340C (e.g., $20), the voucher option beneficiary's name 8350C (e.g., Claire Quilty), the voucher option beneficiary's email address 8360C (e.g., cq@hayes.com), and the Seeker's accompanying message 8370C to the voucher option beneficiary. By selecting the ‘send’ virtual button 8390C, the Seeker may utilize the SILCM system 6500 to communicate the Seeker's gifting to the new voucher option beneficiary (not shown). Facilitating gifting may engender loyaltization binding between Seeker and the original gifting issuer; between Seekers; and also with the MCDUF system 2700 and 6500. Facilitating gifting may also recruit new Seekers to utilize the MCDUF system 2700.

At step 6780 in some embodiments, the SILCM system 6500 may facilitate the Provider 6590 to follow-up with the Seeker 6510. For example, the SILCM system 6500 may communicate an alert (not shown) via the Provider app 2790 to inform the Provider that some amount of time (perhaps also displayed) has passed subsequent to a match with a given Seeker 6510. In some embodiments, the SILCM system 6500 via the Provider app 2790 may facilitate the Provider 6590 to communicate with the Seeker 6510—perhaps asking after the Seeker and maybe suggesting a follow-up appointment. Furthermore, in some embodiments, the SILCM system 6500 may facilitate the Provider 6590 to issue a bonus voucher option 6530 as a ‘thank you’ gift rewarding such a Seeker 6510 subsequent to the Provider 6590 redeeming the voucher 6550 corresponding to the voucher option 6530 successfully morphed by the Seeker 6510.

At step 6790 in some embodiments, the SILCM system 6500 may facilitate the Seeker 6510 to input a review of the Seeker's experience with, and evaluation of, the matched Provider 6590 that may have fulfilled the Seeker's URGS need(s). Additionally, in some embodiments, the SILCM system 6500 may solicit the Seeker's 6510 feedback regarding the Seeker's experience utilizing the MCDUF system 2700 and the SILCM system 6500 (as well as, perhaps, anything else the Seeker may choose to communicate). In some embodiments, such feedback information may be utilized by the SILCM system 6500 to identify and prioritize MCDUF system 2700 and/or SILCM system 6500 enhancements, including but not limited to enhancements to the Seeker app 2710. The SILCM system 6500 may solicit such feedback reviews from the Seeker 6510 utilizing an alert via the Seeker app 2710. Such an alert may include an incentive to input a review—perhaps such a review may be ‘highlighted’ to other Seekers 6510 and/or perhaps a voucher option 6530 may be issued to the reviewing Seeker 6510 (potentially with the disclaimer that the review need not be ‘slanted’ for the voucher option to be issued).

Referring again to FIG. 66 at step 6610, the user-type may not be a Seeker 6510 and therefore at step 6630, in some embodiments. the SILCM system 6500 may differentiate between users/utilizers so as to distinguish a given user of user-type Provider 6590 for loyaltization.

At step 6640, in some embodiments. the SILCM system 6500 may loyaltize the Provider 6590.

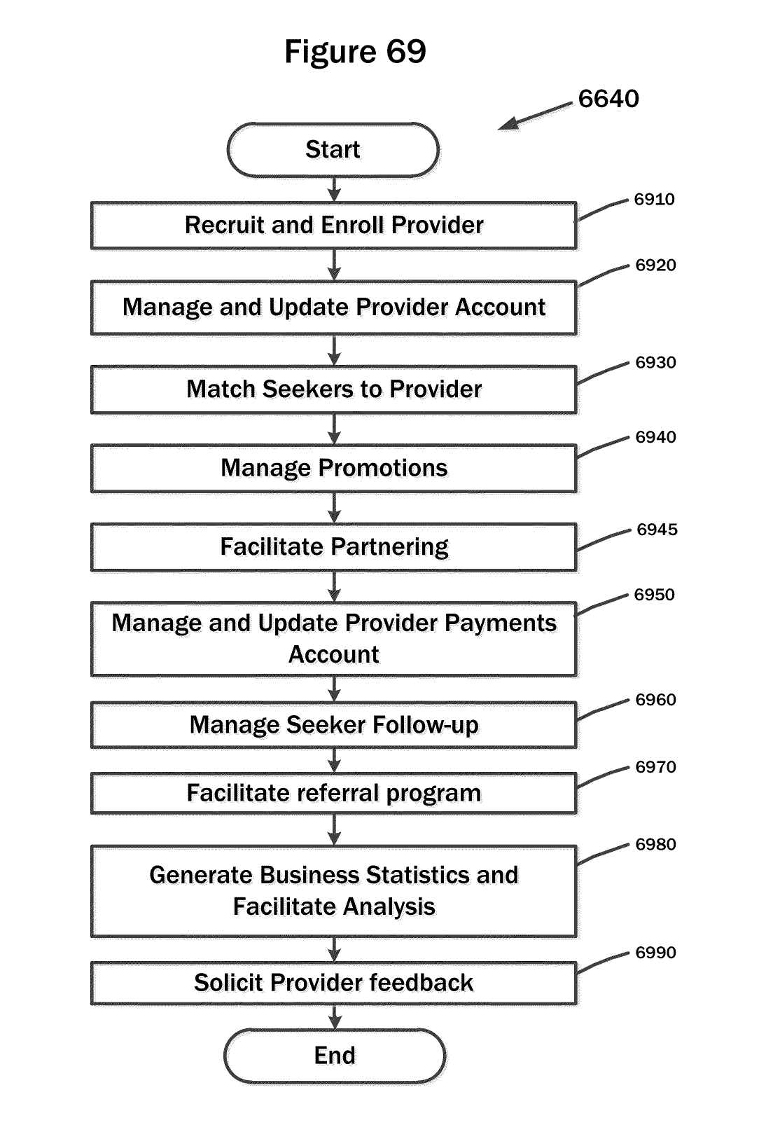

FIG. 69 shows some embodiments of step 6640 in greater detail. At step 6910 in some embodiments the SILCM system 6500 may facilitate recruiting and enrolling a given new Provider. A new Provider 6590 may be recruited by a variety of individuals or methods. For example—by a MCDUF system 2700 user, by a voucher issuer, a third party utilizer or vendor, or by the SILCM system 6500. Also the new Provider 6590 may first utilize the MCDUF system 2700 as a Seeker and may effectively self-recruit or be cross-recruited by the SILCM system 6500. The SILCM system may encourage and perhaps incentivize MCDUF system 2700 users to recommend or actively recruit the new Provider 6590. (Recommending a new Provider is discussed above in Section III. ADDITIONAL ENHANCEMENTS—Micro-Casting Distributed URGS Fulfillment System and is illustrated in some embodiments by exemplary screen 4100.) As is the case with incentivizing and enrolling new Seekers 6510, in some embodiments recruiting new Providers 6590 may involve motivating such a new Provider 6590 to utilize the Provider app 2790 to enroll and subsequently utilize the MCDUF system 2700 and SILCM system 6500 as a Provider 6590. A given Provider 6590 for example may have a PC at their business location and may carry a mobile computing device such as an iPad or iPhone. Further by example, such a Provider 6590 may run a web-based Provider app 2790 on their PC and a native or web-based Provider app 2790 on their mobile computing device. In some embodiments, the Provider 6590, or the Provider's staff (not shown), or both the Provider 6590 and the Provider's staff may be utilizing more than one Provider app 2790 so as to access and utilize the same provider account. Therefore, in some embodiments, the MCDUF system 2700 and the SILCM system 6500 may include facilities protecting critical resources such as file records from problems such as ‘over-writing’ as well as preventing resource contention problems such as ‘dead-locks’ and ‘stand-offs’ utilizing systems and methods familiar to one skilled in the arts.

In some embodiments, a given new Provider 6590 may for example be motivated to enroll by one or more factors including but not limited to: an expectation to attract more Seekers and other clients, a desire to have a broader presence on-line, an intention to better match the ‘mobile app’ habits of ‘gen-Xers’, ‘gen-Yers’ and ‘millennials’ who may be younger and more technically savvy than say ‘baby-boomers’. Many more factors may be recited, but the key underlying common thread in many instances may be that the Provider 6590 wants more clients and/or higher paying clients so as to increase revenue and/or profitability. Potentially, a Provider 6590 may shift away from other promotional venues—such as ‘Google words’—and towards a greater reliance on the MCDUF system 2700 and SILCM system 6500.

The MCDUF system 2700 and SILCM system 6500 may facilitate a potential provider to enroll as a new Provider 6590. (Enrolling a new Provider is discussed above in Section III. ADDITIONAL ENHANCEMENTS—Micro-Casting Distributed URGS Fulfillment System and is illustrated in some embodiments by exemplary screens 4200A, 4200B, 4300, 4400A, 4400B, 4500, 4600, 4700, 4800A, 4800B, 4900, 5000, 5100, 5200 and 5300A.) In some embodiments, the SILCM system 6500 via the provider enrollment facilities of the MCDUF system 2700 may loyaltize the new Provider 6590 by facilitating an ‘easy-to-understand’ and ‘quick-to-complete’ enrollment that may both guide the new Provider 6590 through the enrollment, but may also inform the new Provider 6590 how to use facilities that may be utilized both for enrollment and ‘day-to-day’ account management. The Provider 6590 may thereby be loyaltized as a consequence of the Provider appreciating the efficiency of the simultaneous enrollment and training of the Provider 6590 by the MCDUF system 2700 and the SILCM system 6500.

At step 6920 in some embodiments the SILCM system 6500 may facilitate a Provider 6590 to manage the Provider's MCDUF system 2700 account. (Managing a MCDUF system 2700 provider account is discussed above in Section III. ADDITIONAL ENHANCEMENTS—Micro-Casting Distributed URGS Fulfillment System and is illustrated in some embodiments by exemplary screens 4400A, 4400B, 4500, 4600, 4700, 4800A, 4800B, 4900, 5000 and 5300B.) The Provider 6590 may be loyaltized as a consequence of the Provider appreciating the ‘ease-of-use’ of the MCDUF system 2700 and the SILCM system 6500—for example as they may facilitate management of the provider descriptive information (illustrative screen 4500) and availability schedule (illustrative screens 4700, 4800A, 4800B, 4900 and 5000). In some embodiments, the Provider Day Schedule Screen (illustrative screen 5000) may be used often by the Provider 6590 to make quick updates to the Provider's availability schedule. The convenience of such an important facility may facilitate loyaltization of the Provider 6590 to the MCDUF system 2700 and the SILCM system 6500.

In some embodiments, the MCDUF system 2700 and SILCM system 6500 may facilitate ‘batch’ account management for a related group of Providers 6590. Such a related group of Providers 6590 for example may be franchise owners in a regional franchise business chain that may be administered centrally by the franchisor organization (not shown). For example, such a regional franchise business chain may be an associated group of Roto-Rooter franchises in Livermore Calif. In some embodiments, an authorized group administrator for Roto-rooter may have provider account management access for each of the Livermore Roto-rooter franchises. Furthermore, in some embodiments, such an authorized group administrator may utilize MCDUF system 2700 facilities to make “cloned” settings or updates simultaneously to two or more of such group related accounts. In some embodiments, an authorized group administrator may utilize the Provider app 2790. In other embodiments, an authorized may utilize a separate “administrator” app (not shown).

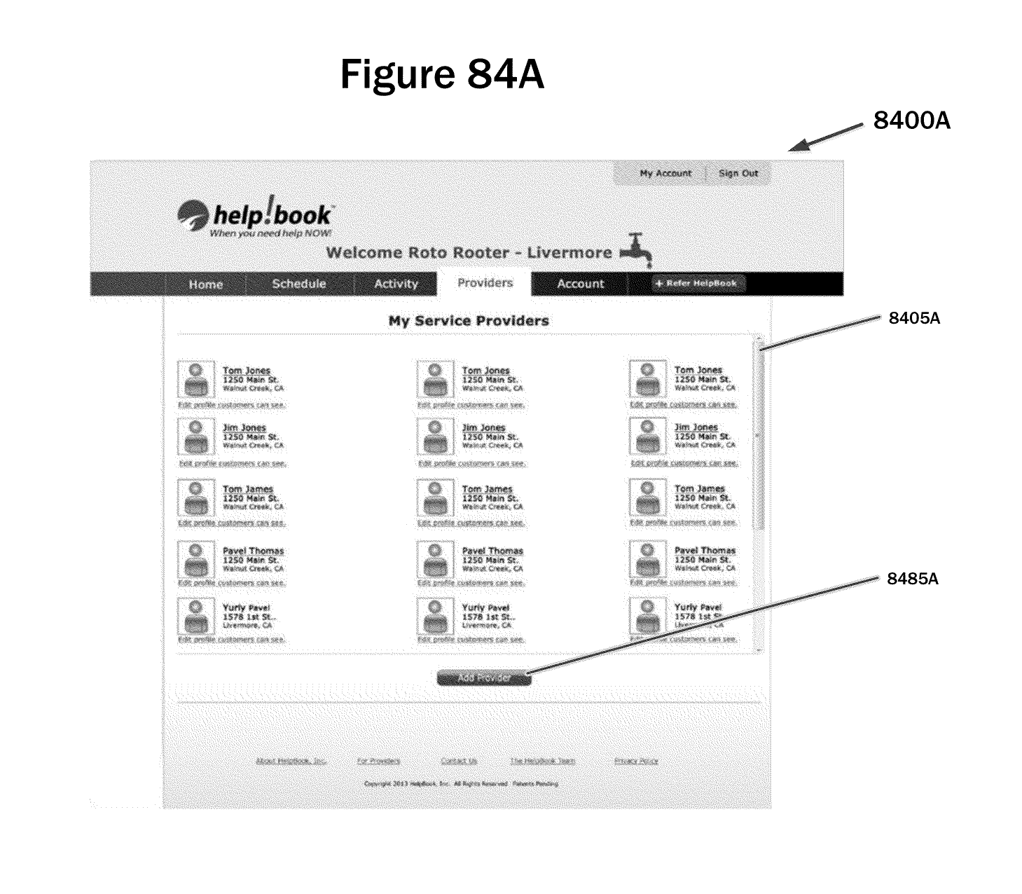

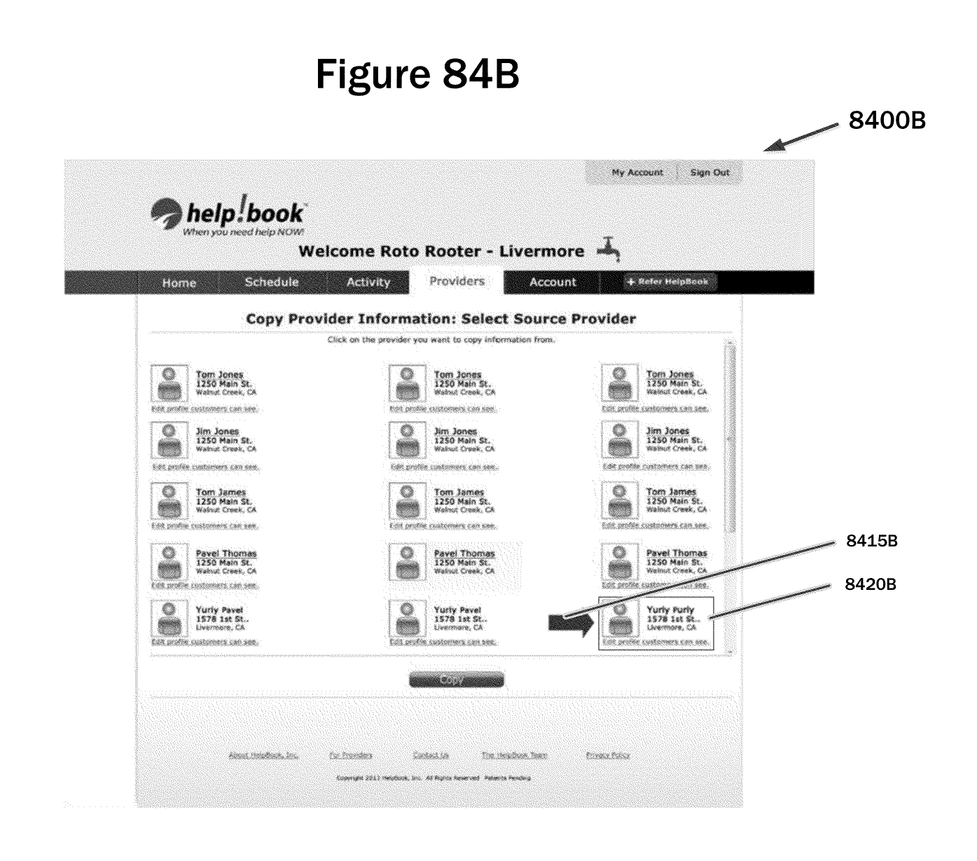

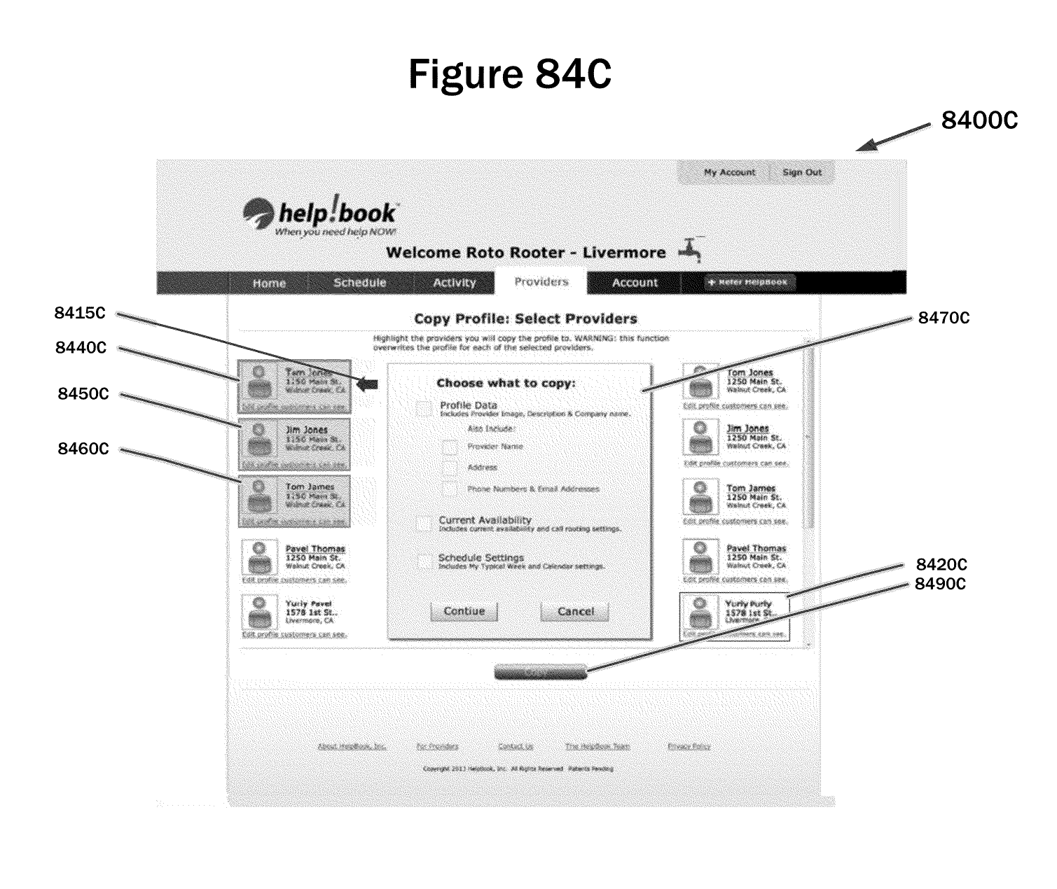

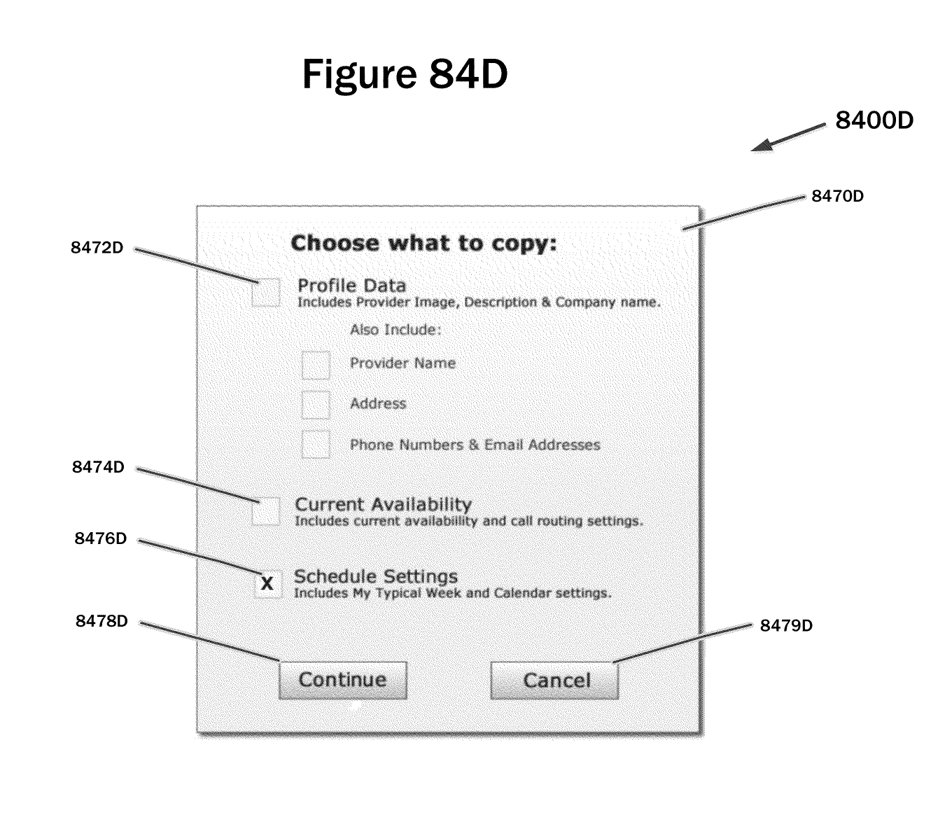

FIG. 84A provides an exemplary screen image 8400A to further illustrate, in some embodiments, a provider group screen as displayed by the Provider app 2790 of an authorized group administrator (not shown). Such a provider group screen may be scrollable utilizing a scroll bar 8405A or similar facility for viewing a virtual screen that may be larger than the viewing area of the physical display of the device running the Provider app 2790. Therefore such a provider group screen may allow an authorized group administrator to effectively view all such grouped providers and manage information utilizing such a scrollable screen. For example, such a screen may facilitate the addition of an additional related provider(s) to the provider group utilizing an ‘add provider’ virtual button 8485A.

FIG. 84B provides an exemplary screen image 8400B to further illustrate, in some embodiments, an provider group copy screen as displayed by the Provider app 2790 (or other specialized app) of an authorized group administrator (not shown). Such a screen may be utilized by such an authorized group administrator to copy the settings from one provider management account (the “copy source”) to one or more other provider management accounts in the provider group (the “copy destination(s)”), so as to ‘clone’ such settings. In some embodiments, such a copy source 8420B may be selected utilizing a moveable selection indicator 8415B.

FIG. 84C provides an exemplary screen image 8400C to further illustrate, in some embodiments, a provider group copy screen as displayed by the Provider app 2790 (or other specialized group administration app) of an authorized group administrator (not shown). Such a screen may be utilized by such an authorized group administrator to copy the settings from the copy source 8420C to one or more copy destinations so as to ‘clone’ such settings. In some embodiments, such copy destinations may be selected by indicating individual copy destinations one-at-time utilizing a moveable selection indicator 8415C. In some embodiments, the moveable selection indicator 8415C may be utilized so as to select more than one copy destinations at a time. In the example of screen 8400C, three copy destinations—8440C, 8450C and 8460C—may be selected.

FIG. 84D provides an exemplary screen image 8400D to further illustrate, in some embodiments, a provider group copy selection subscreen 8470D as displayed by the Provider app 2790 (or other specialized app) of an authorized group administrator (not shown). Such a subscreen 8470D may facilitate selection of specific settings to copy from the copy source to the copy destination(s). For example, such an authorized group administrator may be facilitated to select from a menu of copy source settings such as: ‘Profile Data’ 8472D, ‘Current Availability’ 8474D, and ‘Schedule Settings’ 8476D. The authorized group administrator may therein select individual copy source settings to be copied to the copy destination(s)—for example selecting ‘Schedule Settings’ 8476D. The authorized group administrator may discard such selections by selecting the ‘cancel’ virtual button 8479D. The authorized group administrator may be facilitated to view and select from additional provider group copy selection subscreen(s) by selecting the ‘continue; virtual button 8478D.

Returning to FIG. 84C, the authorized group administrator may be facilitated to copy the selected settings from the copy source to the copy destination(s) by selecting the ‘copy’ virtual button 8490C.

In some embodiments, MCDUF system 2700 and SILCM system 6500 facilities for ‘batch’ account management of a related group of Providers 6590 may simplify the task of provider account management for the authorized group administrator. Such ‘batch’ facilities may motivate related groups of Providers such as franchise chains to enroll in the MCDUF system 2700. The SILCM system 6500 may utilize the value of such ‘batch’ facilities to such related groups of Providers and such authorized group administrators so as to loyaltize bind related groups of Providers 6590 with the authorized group administrator; and to bind the related groups of Providers and the authorized group administrator to the MCDUF system 2700 and the SILCM system 6500.

At step 6930 in some embodiments the SILCM system 6500 may facilitate a matching of Seekers 6510 to the Provider 6590. (Matching a Seeker to a Provider is discussed above including in Section III. ADDITIONAL ENHANCEMENTS—Micro-Casting Distributed URGS Fulfillment System and is illustrated in some embodiments by exemplary screens 5700, 6300 and 5400). In some embodiments, loyaltization of the Provider 6590 may be very strongly facilitated by the MCDUF system 2700 matching Seekers 6510 to the Provider 6590 such that the Seekers may select the Provider to fulfill their URSG needs. Getting the Provider 6590 business that otherwise may have gone to some other competitor may very likely have a strong loyaltization effect—binding the Provider 6590 to the MCDUF system 2700 and SILCM system 6500. Such loyaltization may be strengthened further by repeat business from such matched Seekers 6510—perhaps incentivized by voucher options gifted by the Provider 6590 utilizing the SILCM system 6500.

At step 6940 in some embodiments the SILCM system 6500 may facilitate management of promotions for the Provider 6590. The Provider 6510 may utilize the Provider app 2710 to manage participation in morphable voucher program(s). As described previously above (i.e., in discussing Seeker 6510 incentivization from the Seeker's perspective (see FIG. 68)), systematized and/or automated methods may utilized by the SILCM system 6500—either passively or actively—to motivate a given Seeker 6510 to utilize the MCDUF system 2700 so as to be matched with the Provider 6590 and to subsequently be facilitated by the Provider 6590 so as to fulfill the Seeker's URGS need(s). Passive methods may include, for example, benefitting from and leveraging independent and unsolicited promotion and publicity for the MCDUF system 2700 via internet forums such as Yelp, Facebook, and Twitter and via search engines such as Google, Yahoo, and Bing. Such passive methods may be further leveraged, amplified and augmented utilizing active techniques such as ‘segment-targeted’ and ‘search-triggered’ internet advertisement, search engine optimization of internet-exposed components of the MCDUF system 2700, and other more traditional means of promotion such as mixed-media advertisements—for example print media, radio, TV and movie advertisements.

The SILCM system 6590 may facilitate the increased promotional exposure of the Provider 6590 significantly beyond what the Provider otherwise may be doing (or capable of doing) so as to promote the Provider's business; and thereby incentivize and motivate additional Seekers 6510 to fulfill their URGS needs with the Provider 6590. Such business from additional Seekers incentivized and motivated by promotional activities facilitated by the SILCM system 6500 may not be directly distinguishable from other Seekers matched with the Provider by the MCDUF system 2700. However, the Seeker 6510 may mention such promotions to the Provider 6590; the Provider may ask the Seeker about such promotions; the SILCM system 6500 may survey Seekers such that the Provider may subsequently consider such survey results and analytics; or the Provider 6590 may redeem a voucher corresponding to a voucher option 6530 morphed by a given Seeker 6510 who may be thusly incentivized by the SILCM system 6500. Seeker 6510 match and fulfillment activity that may be readily apparent and/or discernable attributable to such SILCM system 6500 facilitated promotion may facilitate Provider loyaltization to the MCDUF system 2700 and the SILCM system 6500.

At step 6945 in some embodiments the SILCM system 6500 may facilitate Providers 6590 to work together, i.e., “partner” so as to jointly or serially fulfill Seekers' 6510 URGS needs, Furthermore, the SILCM system 6500 may facilitate cooperative promotions wherein two or more Providers 6590 may participate together—for example in a morphable voucher program. In some embodiments, third parties, for example one or more MCDUF system 2700 utilizers or perhaps vendors, may be facilitated by the SILCM system 6500 to join in cooperative promotions with one or more Providers 6590. Such partnering and cooperative promotion facilitated by the SILCM system 6500 may facilitate loyaltization binding between Providers 6590. Furthermore, such cooperative promotion may facilitate loyaltization binding between any two or more of: Provider 6590, Seeker 6510, MCDUF system utilizer, MCDUF system vendor, MCDUF system 2700 and SILCM system 6500.

At step 6950 in some embodiments the SILCM system 6500 may facilitate the managing and updating of the MCDUF system 2700 provider payment account (not shown), which may in some embodiments be recorded in the data base(s) 158. The SILCM matching share—i.e., the portion of a given voucher redemption amount ‘covered’ by the SILCM system 6500—may be credited by the SILCM system 6500 to the Provider's MCDUF system provider payments account. Furthermore, in some embodiments, such an account may be utilized for other rebates or payments made by the SILCM system 6500 to the Provider 6590. The payment of the SILCM matching share into the provider payments account (not shown) may represent to the Provider 6590 the MCDUF system commitment to, and active participation in morphable voucher programs thus loyaltizing the Provider 6590 to the MCDUF system 2700 and the SILCM system 6500.

At step 6960 in some embodiments the SILCM system 6500 may facilitate follow-up interaction with the Seeker 6510 by, or on behalf, of the Provider 6590. A given URGS Provider may be very busy and therefore find it difficult to find time, or even the recollection, to follow-up with Seekers 6520 previously fulfilled by the Provider 6590. For example, making follow-up phone calls may be extremely time consuming for the Provider 6590—perhaps with the Provider ‘trapped’ on the phone. A Provider 6590 may undertake to follow-up with Seekers 6510 from time to time and may perhaps utilize the Provider app 2790 to facilitate such follow-up. In some embodiments, the SILCM system 6500 may automatically facilitate following up with a given Seeker 6510, for example by alerting the Provider 6590—via the Provider app 2790—some time period subsequent to fulfilling the Seeker's needs. So further by example, in some embodiments the provider App may display a provider follow-up screen (not shown) wherein the Provider 6590 may have the option of inputting a message for the Seeker 6590 or perhaps leaving it to the SILCM system 6500 to generate a message derived from MCDUF system 2700 records of the Seeker's URGS search. In some embodiments, the SILCM system 6500 may be configured to automatically follow-up with Seekers 6510 on the Provider's 6590 behalf without disturbing the Provider 6590.

In addition to loyaltizing the Seeker 6510 to the Provider 6590, such a follow-up perhaps displayed to the Seeker 6510 by the Seeker app 2710 may in some embodiments query the Seeker to determine any additional needs fulfillment. An affirmative response may be facilitated by the MCDUF system 2700 so as to match the Seeker 6510 up with the Provider 6590 for additional needs fulfillment. Such follow-up derived additional business facilitated by the SILCM system 6500 may further loyaltize bind the Seeker 6510 and Provider 6590 as well as increase the Provider's loyaltization to the MCDUF system 2700 and the SILCM system 6500.

In some embodiments, a third party—facilitated by the SILCM system 6500—may follow-up with a given Seeker 6510. Such a third party may for example survey the Seeker relating to the Seeker's URGS requirements or relating to other subjects. In some embodiments, information so acquired from a Seeker 6510 may be recorded by the SILCM system 6500 and perhaps subsequently analyzed.

At step 6970 in some embodiments the SILCM system 6500 may facilitate a given Provider 6590 or a given Seeker 6510 to refer a Seeker 6510 or new potential seeker to a Provider 6590. The SILCM system 6500 may facilitate such referrals via the Provider app 2790 and the Seeker app 2710. The SILCM system 6500 may incentivize such referrals by issuing a voucher option to a referring Seeker 6510 and perhaps crediting a ‘referral fee’ to the provider payments account of a referring Provider 6590. Such referrals may include a notification of the referral to the referred Provider from the SILCM system 6500 whereby the SILCM system may identify the referring Seeker 6510 or Provider 6590 to the referred Provider 6590, and perhaps facilitate a ‘thank you’ message from the referred Provider 6590 back to the referring user. Such a “referral program” facilitated by the SILCM system 6500 may engender loyaltization binding between the referred Provider 6590 and the referring Seeker 6510 or Provider 6590.

At step 6980 in some embodiments the SILCM system 6500 may facilitate the utilization of the MCDUF system 2700—and perhaps also the business—of a given Provider 6590 with statistics and analytics (not shown). For example, such statistics and analytics may enable the Provider 6590 to determine how and to what extent the MCDUF system 2700 and SILCM system 6500 may augment the Provider's business. Additionally, such statistics and analytics may enable the Provider 6590 to determine how other businesses may utilize the MCDUF system 2700 and SILCM system 6500 and how such businesses may be comparable to or differ from the Provider's business. Such statistics and analytics facilities may assist the Provider 6590 to improve the Provider's business. Such assistance, particularly as reflected by statistics and analytics, may loyaltize the Provider 6590 to the MCDUF system 2700 and SILCM system 6500.

At step 6990 in some embodiments, the SILCM system 6500 may facilitate the Provider 6590 to input a review of the Provider's experience with, as well as an evaluation of, a given Seeker 6510 matched to that Provider. Additionally, in some embodiments, the SILCM system 6500 may solicit the Provider's 6590 feedback regarding the Provider's experience utilizing the MCDUF system 2700 and the SILCM system 6500 (as well as, perhaps, anything else the Provider may choose to communicate). In some embodiments, such provider feedback may be utilized by the SILCM system 6500, but perhaps not published for other Providers 6590 or Seekers 6510 to view. In some embodiments, such provider feedback information may be utilized by the SILCM system 6500 to identify and prioritize MCDUF system 2700 and/or SILCM system 6500 enhancements, including but not limited to enhancements to the Provider app 2790 and/or the Seeker app 2710. The SILCM system 6500 may notify and thank the Provider 6590 regarding such feed-back relating to such an enhancement. Furthermore, in some embodiments, the SILCM system may perhaps credit an ‘appreciation credit’ to the Provider's 6590 provider payments account (not shown) for feedback deemed to be particularly valuable to the MCDUF system 2700.

In some embodiments, the SILCM system 6500 may facilitate loyaltization of Seekers 6510 and Providers 6590 by engendering “investment” in the MCDUF system 2700—i.e., a sense of loyaltization binding resulting from or otherwise relating to: time, money, information, effort, reputation or other resources—tangible or intangible—that a MCDUF system 2700 “invested user” may have invested, or otherwise contributed to, the MCDUF system 2700. For example, a Seeker 6910 may contribute a review of a Provider that may be published by the SILCM system 6500 such that it may be viewed by other MCDUF system 2700 users. As another example, a Provider 6590 may have worked with one or several voucher issuers such that the vouchers they issue may be helping a number of needy individuals. It should be noted that investment differs from incentivization in that there may be no direct tangible inducement or incentive engendering investment in the Seeker 6510 or the Provider 6590.

Some embodiments of the SILCM system 6500 may leverage user investment in the MCDUF system 2700 in a multiplicity of ways. For example, the SILCM system 6500 may display a list via the Seeker app 2710 and/or Provider app 2790 of other potential new seekers or potential new providers that a given invested user may have induced to utilize the MCDUF system 2700 along with displaying various attributes or properties for each of the potential new seekers or potential new providers. For example, such various attributes or properties may be denoted by graphical indicators (e.g., downloaded the app; enrolled in the MCDUF system 2700; morphed voucher options issued by the invested user). Additionally, in some embodiments, the SILCM system 6500 may assign each MCDUF system 2700 user a comparative ranking (not shown) that may be displayed and viewed by other MCDUF system users—both Seekers 6510 and Providers 6590. Such rankings may have associated numeric values, or symbols; or names—e.g., ‘Samaritan’, ‘Hero’, and ‘Champ’—which may be based on an aggregate evaluation of a plurality of behaviors. Such behaviors may be widely varied.

For example, say a given Seeker 6510 may bank several voucher options 6530 and subsequently may re-gift such banked voucher options to other Seekers 6510 or potential new seeker. Such a beneficial act may raise such a re-gifting Seeker's comparative ranking. Furthermore, in some embodiments, within displays of such comparative rankings, the MCDUF system user that induced the Seeker 6510 to enroll in the MCDUF system 2700 may be prominently displayed as an on-going honor. Such an apparent honor may encourage the Seeker 6510 to endeavor to be similarly prominently displayed as an honor as displayed to other MCDUF system 2700 users.

Some embodiments of the SILCM system 6500 may facilitate the “unmorphing” of a voucher 6550 back into the corresponding voucher option 6530, so that that voucher option 6530 may be utilized subsequently. So for example, a Seeker 6510 may morph a voucher option 6530 to the corresponding voucher 6550 while sitting in the waiting room for a dental appointment with the URGS Provider dentist who is a participant in the corresponding morphable voucher program. Apologetically the receptionist may inform the Seeker 6510 that the Provider 6590 had to leave unexpectedly due to a personal emergency and that a new appointment is available on a subsequent day. By unmorphing the voucher, the Seeker 6510 may avoid effectively forfeiting it; and may be able to use the unmorphed voucher option 6530 and corresponding voucher 6550 for the re-scheduled appointment or some other URGS need. In some embodiments, unmorphing may be preformed or authorized by the Provider 6590 on the Seeker's behalf. In some embodiments, such unmorphing by the Provider 6590 may utilize facilities similar to those utilized for the redemption of vouchers 6550.

Some embodiments of the SILCM system 6500 may facilitate the morphing of the Seeker's 6510 voucher option 6530 and the redemption by the Provider 6590 of the corresponding potentially redeemable voucher 6550 by ‘tapping’ together the Seeker's and the Provider's respective client devices. Such ‘tapping’ may perhaps require only physical proximity allowing inter-device communication and not actual physical contact (as is the case today using say NFC). Such a ‘tapping’ morphing/redemption may be automated such that the SILCM system 6500 transacts the entire process electronically—perhaps with all debiting and/or crediting of funds being transacted on the Seeker's and/or Provider's behalf by the SILCM system 6500 possibly in cooperation with third-party(s) such as a payments card processor(s) with only appropriate confirmation required of the Provider 6590 and possibly the Seeker 6510. Additionally, physical proximity may be measured individually for each of the Seeker and Provider such that they may be determined to have physically rendezvoused—perhaps with a confirmation provided by the Provider 6590 and possibly the Seeker 6510. Such a streamlined morphing/redemption process may still utilize the voucher option morphing process but may eliminate the need for option ID entry by the Seeker 6510 and corresponding voucher code entry by the Provider 6590. In some embodiments, the SILCM system 6500 may be the front-end for or may be otherwise coupled with or integrated into a payments network(s).

Some embodiments of the SILCM system 6500 may facilitate a Seeker 6510 to share media content—such as a digital photograph, a video segment, or an audio recording—with an URGS Provider 6590. Such media content may be utilized to assist the Provider to better comprehend the Seeker's URGS need(s) and perhaps also the degree of urgency associated with such URGS need(s) and may be termed “URGS need contextual media content”. The Seeker App 2710 may include facilities to record, upload and share URGS need contextual media content utilizing for example the camera and microphone of Seeker's mobile device. The SILCM system 6500 may provide secured limited access storage and sharing of URGS need contextual media content so as to protect the Seeker's privacy. Additionally, the SILCM system 6500 may facilitate copying, sharing and/or otherwise accessing URGS need contextual media content from third party media content sites such as Flickr or Youtube. Furthermore, the SILCM system 6500 may facilitate copying, sharing and/or otherwise transferring URGS need contextual media content from the SILCM system 6500 to third party media content sites such as Flickr or Vimeo or Gmail as directed and controlled by the Seeker 2710 via the Seeker App 6510 and subject to SILCM system 6500 privacy policies and controls. Complementarily, the SILCM system 6500 may facilitate the Provider 6590 utilizing the Provider App 6590 to similarly capture, upload, store and share URGS need contextual media content with the Seeker 2710 and possibly third party media content sites subject also to SILCM system 6500 privacy policies and controls.

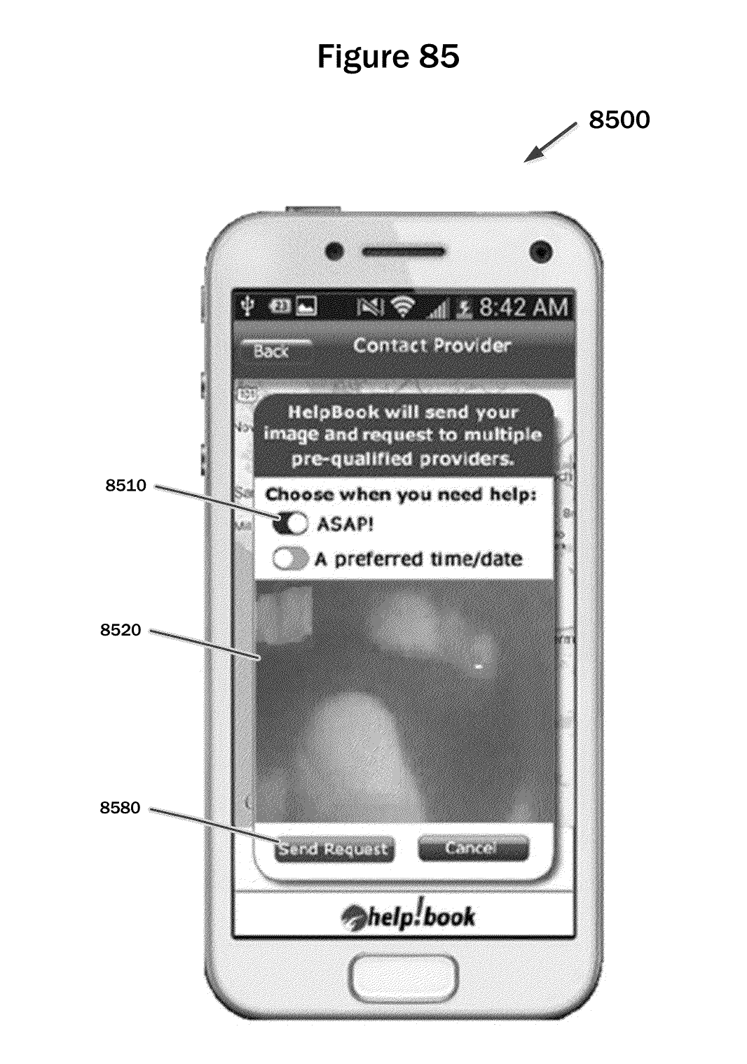

In some embodiments, automated additional facilitation by the SILCM system 6500 and/or an optional human facilitator 6560 may serve to facilitate, moderate and curate URGS need contextual media content—e.g., select, edit, transfer, highlight, narrate, caption and/or otherwise enhance, manage, simplify, order and/or analyze such content so as to facilitate and possibly improve communication between Seeker 2710 and Provider 2790 and possibly third parties. Such URGS need contextual media content may be cataloged, linked, copied and/or stored by the SILCM system 6500 for subsequent access by the Seeker 2710 or Provider 2790 or possibly sharing with third party media content sites or other third parties subject also to SILCM system 6500 privacy policies and controls. Such subsequent SILCM system 6500 facilitated subsequent access to URGS need contextual media content may for example be utilized to document and/or substantiate the Seeker's urgent need for a third party such as an insurance company. In addition to directly facilitating communication between Seeker 2710 and Provider 2790 and appropriately interested third parties, SILCM system 6500 facilities for storing and managing URGS need contextual media content may facilitate plural-partite loyaltization of such parties as well as other third parties. For example, the Seeker 2710 may share ‘before and after’ images on one or several social networking sites so as to recommend and promote the Provider 2790. The SILCM system 6500 may facilitate additional subsequent copying and management of stored copies of URGS need contextual media content such that the Seeker 2710, Provider 2790 and appropriate third parties may to some extent control, ‘curate’ and share with other third parties such copied stored content. FIG. 85 provides an exemplary screen image 7000 to further illustrate, in some embodiments, utilization of the Seeker App 2710 by the Seeker 6510 to share with a dental URGS Provider(s) 6590 an image of the Seeker's missing tooth 8520 and Seeker urgency 8510 by selecting the ‘send request’ virtual button 8580.

In sum, the present invention provides systems and methods for plural-partite and incentivized loyaltization binding facilitated by the SILCM system 6500. The advantages of such a system include the ability to loyaltize MCDUF system users to each other—particularly engendering loyaltization binding between Seeker 6510 and Provider 6590—so as: to benefit such MCDUF system users; to improve the MCDUF system 2700 and SILCM system 6500; and to incentivize and/or motivate MCDUF system 2700 users—both Seekers 6510 and Providers 6590—to promote the MCDUF system 2700 to new potential seekers and new potential providers thus increasing the benefits of utilizing the MCDUF system 2700 for both Seekers 6510 and Providers 6590. Seekers 6510 in particular may be incentivized by voucher options 6530 that may be distributed to and subsequently morphed by Seekers 6510 into vouchers 6550 that may be redeemed by Providers 6590 in exchange for discounts on URGS provided by such Providers 6590 participating in morphable voucher programs facilitated by the SILCM system 6500.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized fulfillment system, a method for incentivized loyaltization between providers and seekers, the method comprising:
enrolling a plurality of providers in an agnostic morphable voucher program for recruiting a plurality of seekers, the agnostic morphable voucher program having a variable plurality of morphable fungible virtualized voucher options;
wherein the plurality of providers includes at least two categories of providers;
wherein the voucher options are configured to be morphed by at least one recruited seeker of the plurality of seekers thereby morphing one of the voucher options into a potentially redeemable voucher redeemed in exchange for discounting for an urgent goods or service by one of a plurality of providers; and
distributing the plurality of morphable fungible virtualized voucher options to the plurality of seekers.

2. The method of claim 1 wherein the at least two participating providers of the agnostic morphable voucher program provide at least two differing categories of urgent goods or service.

3. The method of claim 1 wherein the distributing of the plurality of morphable fungible virtualized voucher options is to the at least one recruited seeker of the plurality of seekers, and wherein the distributing includes issuance of the at least one of the plurality of morphable fungible virtualized voucher options by an at least one third-party issuer,

4. The method of claim 1 wherein the at least one distributed plurality of morphable fungible virtualized voucher options is at least one of:
unsolicited;
solicited;
exchanged for something of value; and
gifted.

5. The method of claim 3 wherein the at least one third-party issuer is related to the at least one prospective recruited seekers by at least one of:
previous introduction;
paid introduction;
word of mouth;
social networking;
chance encounter; and
recommendation.

6. The method of claim 1 further comprising incentivizing a recruited seeker to become an enrolled seeker thereby enabling the enrolled seeker to morph the at least one of the morphable fungible virtualized voucher options.

7. The method of claim 6 wherein the at least one morphable fungible virtualized voucher option is recorded and tracked when banked by the enrolled seeker.

8. The method of claim 1 wherein at least one seeker distributes the at least one morphable fungible virtualized voucher option.

9. The method of claim 1 wherein the at least one morphable fungible virtualized voucher option is virtually represented by at least one of:
an audible representation;
a verbal representation;
a visual representation;
a symbolic representation;
a tactile representation;
an analog representation; and
a digital representation.

10. The method of claim 1 wherein the plurality of morphable fungible virtualized voucher options substantially numerically exceeds the plurality of corresponding potentially redeemable vouchers available to be morphed from the morphable fungible virtualized voucher options thereby increasing ubiquity of the morphable fungible virtualized voucher options and increasing incentivization of the at least one recruited seeker to morph the at least one morphable fungible virtualized voucher option before cessation of the corresponding agnostic morphable voucher program.

11. The method of claim 1 wherein the at least one morphable fungible virtualized voucher option presented by the at least one recruited seeker so as to receive a correspondingly morphed potentially redeemable voucher is morphed into a potentially redeemable voucher.

12. The method of claim 1 wherein morphing is denied for the at least one morphable fungible virtualized voucher option presented by the at least one recruited seeker due to at least one of:
cessation of the corresponding agnostic morphable voucher program;
the plurality of vouchers have all been redeemed; and
a virtualized representation of the morphable fungible virtualized voucher option is not recognizable.

13. The method of claim 1 wherein the morphed voucher is associated with the recruited seeker.

14. The method of claim 13 wherein the morphed voucher associated with the recruited seeker is verified as a condition of redemption.

15. The method of claim 1 wherein the redeeming includes at least one of:
accepting the potentially redeemable voucher from the at least one provider of a plurality of providers participating in the morphable voucher program;
crediting a matching share to the at least one provider of a plurality of providers participating in the morphable voucher program so as to offset a portion of the cost of the discount.

16. The method of claim 1 wherein at least one bonus morphable fungible virtualized voucher option is distributed to the at least one recruited seeker subsequent to morphing the at least one morphable fungible virtualized voucher option.

17. The method of claim 16 wherein the at least one bonus morphable fungible virtualized voucher option distributed to the at least one recruited seeker is attributed to the one of a plurality of providers who redeemed the at least one potentially redeemable voucher that was morphed from the at least one morphable fungible virtualized voucher option by the at least one recruited seeker.

18. The method of claim 16 wherein the at least one bonus morphable fungible virtualized voucher option is distributed to the at least one recruited seeker in consideration for unsuccessfully morphing the at least one morphable fungible virtualized voucher option.

19. The method of claim 16 wherein the at least one bonus morphable fungible virtualized voucher option is distributed to the at least one recruited seeker as reward for successfully morphing the at least one morphable fungible virtualized voucher option and the one of a plurality of providers correspondingly redeeming the at least one potentially redeemable voucher.

20. In a computerized seeker device, a method for utilization of a loyaltization system for providers and seekers, the method comprising:
identifying at least one provider participating in at least one corresponding morphable voucher program having a plurality of morphable fungible virtualized voucher options;
morphing one of a plurality of morphable fungible virtualized voucher options into a potentially redeemable voucher redeemed in exchange for discounting for an urgent goods or service by the at least one provider participating in the at least one corresponding morphable voucher program.

21. The method of claim 20 further comprising presenting the potentially redeemable voucher to the at least one provider participating in the at least one corresponding morphable voucher program,

22. The method of claim 20 wherein the seeker is enrolled in the loyaltization system associated with the morphed at least one morphable fungible virtualized voucher option of the at least one corresponding morphable voucher program.

23. In a computerized provider device, a method for utilization of a loyaltization system for providers and seekers, the method comprising:
accepting an at least one potentially redeemable voucher from an at least one recruited seeker in exchange for discounting for urgent goods or service provided by the provider, wherein the at least one potentially redeemable voucher resulted from morphing of an at least one morphable fungible virtualized voucher option; and
redeeming the at least one potentially redeemable voucher accepted from at least one recruited seeker in exchange for discounting for urgent goods or service provided by the provider.

24. The method of claim 23 further comprising managing participation in at least one agnostic morphable voucher program.

25. The method of claim 23 wherein the provider is rebated a share of the discounting exchanged with the recruited seeker for the at least one potentially redeemable voucher presented for discount on urgent goods or service provided by the provider.
